(19) United States
(12) Patent Application Publication
(10) Pub. No.: US 2022/0309037 A1
(43) Pub. Date: Sep. 29, 2022

(54) DYNAMIC PRESENTATION OF SEARCHABLE CONTEXTUAL ACTIONS AND DATA

(71) Applicant: Comake, Inc., Los Angeles, CA (US)

(72) Inventors: Andres Gutierrez, Los Angeles, CA (US); Adler Faulkner, Los Angeles, CA (US)

(73) Assignee: Comake, Inc., Los Angeles, CA (US)

(21) Appl. No.: 17/707,888

(22) Filed: Mar. 29, 2022

Related U.S. Application Data
(60) Provisional application No. 63/191,852, filed on May 21, 2021.
(60) Provisional application No. 63/167,401, filed on Mar. 29, 2021.

(51) Int. Cl. G06F 16/14; G06F 16/16

(52) U.S. Cl. CPC G06F 16/156; G06F 16/16

(57) ABSTRACT

A method comprises linking a pair of nodes in a nodal data structure based on a first node within the pair of nodes having an identifier that satisfies a relevance threshold with respect to a second node within the pair of nodes, wherein each node within the set of nodes corresponds to an action performed on at least one computing device of a plurality of computing devices; in response to determining that at least one computing device within the plurality of computing devices is accessing electronic content determining at least one node within the set of nodes of the nodal data structure that corresponds to the electronic content; and presenting context data associated with the electronic content accessed by the at least one computing device accessing the electronic content and at least one of the identified node and any other node linked to the identified node.

### CROSS-REFERENCE TO RELATED APPLICATIONS

This application claims priority to U.S. Provisional Application No. 63/167,401, filed Mar. 29, 2021, and U.S. Provisional Application No. 63/191,852, filed May 21, 2021, each of which is incorporated by reference in its entirety for all purposes.

### TECHNICAL FIELD

This application relates generally to data management and mapping.

### BACKGROUND

Productivity tools utilize software to track, manage, and/or store files, contacts, messages, comments, tasks, and more within different computing environments. Most conventional productivity tools systems are capable of keeping records of various versions, edits, collaborations, and/or related data (files, tasks, contacts, messages, comments, etc.) created or accessed by different users. Utilizing conventional productivity software systems, users can access and interact with various units of work, such as files, messages, tasks, etc. within different computing environments. Users can also monitor a revision/edit history of various units of work. However, conventional productivity systems suffer from at least two technical problems.

First, conventional productivity systems require users to store all files/data on a central electronic data repository (e.g., database, cloud storage, and the like). Storing large volumes of data on a central data repository requires high amount of data storage, which is costly, inefficient, and/or even impractical when working with clients or collaborators that prefer using repositories from competing providers. For instance, managing interrelated units of work in a central repository requires significant processing power due to number, size, content, and relationships between the units of work. Online collaborative applications are increasingly emerging where multiple users can simultaneously access, store, share, edit, comment on, and create tasks for online files. Many of these applications come with their own file types, their own file storage, their own messaging or commenting features, their own project management, contact lists, and even their own file browser. Ultimately, many people today find themselves in a digital reality defined by data/content that is highly fragmented. As a result, conventional productivity software systems either require high processing power, which is costly, or do not monitor the files in a timely manner, which is highly undesirable and inefficient.

Second, conventional productivity software systems may require users to designate related units of work. For instance, conventional workflow management systems require users to either tag related files/messages/tasks, designate a related project to a file/message/task, or name files/tasks/contacts in accordance with predetermined naming requirements. Therefore, conventional productivity software systems shift the burden of identifying relationships between units of work (e.g., files, messages, tasks, contacts) onto users, which is highly undesirable and creates a negative user experience.

### SUMMARY

For the aforementioned reasons, there is a need for a workflow management system and method that can automatically and efficiently identify related units of work, collect relevant actions and data surrounding the related units of work across various systems, services, and provides, and display the results in real-time or near real-time. There is a need for a workflow management system that does not require users to manually identify related files, communication, projects, or other context. Furthermore, there is a need for a workflow management system that does not require users to store all their data in a single central electronic data repository.

The methods and systems described herein allow for a knowledge operating system to identify and present shared knowledge, the abstraction of ideas, the groupings of perspectives, and the intangible contexts. The methods and systems described herein can be implemented to build a knowledge and information sharing system.

Even though certain embodiments herein are described in the context of files, it is expressly understood that the methods and systems described herein apply to any units of work. For instance, while methods, systems, and embodiments disclosed herein describe analytics server (or any other server or computing device) identifying whether two files are related, the same servers or other computing devices can use the disclosed methods, systems, and embodiments to identify related units of work. Non-limiting examples of a unit of work may include messages, tasks, contacts, deals, clients, employees, contacts, notifications, online articles, videos, songs, websites, applications, addresses, time, tags, and the like.

In one embodiment, a method comprises linking, by a processor, a pair of nodes within a set of nodes of a nodal data structure based on a first node within the pair of nodes having an identifier that satisfies a relevance threshold with respect to a second node within the pair of nodes, wherein each node within the set of nodes corresponds to an action performed on at least one computing device of a plurality of computing devices; in response to determining that at least one computing device within the plurality of computing devices is accessing electronic content determining, by the processor, at least one node within the set of nodes of the nodal data structure that corresponds to the electronic content; and presenting, by the processor, context data associated with the electronic content accessed by the at least one computing device accessing the electronic content and at least one of the identified node and any other node linked to the identified node, the context data identifying at least one of a file, a user, or a message associated with the identified node or any other node linked to the identified node.

The context data may comprise identification data associated with at least one of a file or a message associated with the at least one node or the at least one other node linked to the at least one node.

The context data may comprise identification data associated with at least one of a uniform resource locator, a note, a task, an event, an email address, or a physical address associated with the at least one node or the at least one other node linked to the at least one node.

The context data may comprise identification data associated with a person, a team, or an organization associated with the at least one node or the at least one other node linked to the at least one node.

The context data may be organized based on a category associated with the context data.

At least a first part of the context data may be stored in a first data repository and a second part of the context data may be stored within a second data repository.

A first node from the nodal data structure may be stored in a first data repository and a second node from the nodal data structure may be stored in a second data repository.

The processor may execute an artificial intelligence model to identify a likelihood of relevance value for each pair of nodes.

The method may further comprise displaying, by the processor, an input element configured to receive a query term; and displaying, by the processor, data associated with the query term.

In another embodiment, a system comprising a server comprising a processor and a non-transitory computer-readable medium containing instructions that when executed by the processor causes the processor to perform operations comprising linking a pair of nodes within a set of nodes of a nodal data structure based on a first node within the pair of nodes having an identifier that satisfies a relevance threshold with respect to a second node within the pair of nodes, wherein each node within the set of nodes corresponds to an action performed on at least one computing device of a plurality of computing devices; in response to determining that at least one computing device within the plurality of computing devices is accessing electronic content determining at least one node within the set of nodes of the nodal data structure that corresponds to the electronic content; and presenting context data associated with the electronic content accessed by the at least one computing device accessing the electronic content and at least one of the identified node and any other node linked to the identified node, the context data identifying at least one of a file, a user, or a message associated with the identified node or any other node linked to the identified node.

The context data may comprise identification data associated with at least one of a file or a message associated with the at least one node or the at least one other node linked to the at least one node.

The context data may comprise identification data associated with at least one of a uniform resource locator, a note, a task, an event, an email address, or a physical address associated with the at least one node or the at least one other node linked to the at least one node.

The context data may comprise identification data associated with a person, a team, or an organization associated with the at least one node or the at least one other node linked to the at least one node.

The context data may be organized based on a category associated with the context data.

At least a first part of the context data may be stored in a first data repository and a second part of the context data may be stored within a second data repository.

A first node from the nodal data structure may be stored in a first data repository and a second node from the nodal data structure may be stored in a second data repository.

The processor may execute an artificial intelligence model to identify a likelihood of relevance value for each pair of nodes.

The instruction may further cause the processor to display an input element configured to receive a query term; and display data associated with the query term.

In yet another embodiment, a computer system comprises a data repository storing data associated with a set of nodes within a nodal data structure; a plurality of computing devices having access to the set of data; and a processor in communication with each computing device and the electronic data repository, the processor configured to: link a pair of nodes within a set of nodes of a nodal data structure based on a first node within the pair of nodes having an identifier that satisfies a relevance threshold with respect to a second node within the pair of nodes, wherein each node within the set of nodes corresponds to an action performed on at least one computing device of a plurality of computing devices; in response to determining that at least one computing device within the plurality of computing devices is accessing electronic content determine at least one node within the set of nodes of the nodal data structure that corresponds to the electronic content; and present context data associated with the electronic content accessed by the at least one computing device accessing the electronic content and at least one of the identified node and any other node linked to the identified node, the context data identifying at least one of a file, a user, or a message associated with the identified node or any other node linked to the identified node.

The context data comprises identification data associated with at least one of a file or a message associated with the at least one node or the at least one other node linked to the at least one node.

### BRIEF DESCRIPTION OF THE DRAWINGS

Non-limiting embodiments of the present disclosure are described by way of example with reference to the accompanying figures, which are schematic and are not intended to be drawn to scale. Unless indicated as representing the background art, the figures represent aspects of the disclosure.

FIG. 1 illustrates components of an electronic workflow management system, in accordance with an embodiment.

FIG. 2 is a flow diagram of a process executed in an electronic workflow management system, in accordance with an embodiment.

FIG. 3 is a nodal data structure representing multiple identified files within a computing environment, in accordance with an embodiment.

FIG. 4 is a nodal data structure representing multiple identified files within a computing environment, in accordance with an embodiment.

FIG. 5 is a graphical user interface displaying file context information, in accordance with an embodiment.

FIG. 6 is a graphical user interface displaying a file and its context information, in accordance with an embodiment.

FIG. 7 illustrates a messaging application, in accordance with an embodiment.

FIG. 8 is a flow diagram of a process executed in an electronic workflow management system, in accordance with an embodiment.

FIG. 9 is a visual representation of a nodal data structure, in accordance with an embodiment.

FIG. 10 is a visual representation of a nodal data structure, in accordance with an embodiment.

FIG. 11 is a flow diagram of a process executed in an electronic workflow management system, in accordance with an embodiment.

FIG. 12 is a visual representation of a nodal data structure, in accordance with an embodiment.

FIG. 13A is a flow diagram of a process executed in an electronic workflow management system, in accordance with an embodiment.

FIG. 13B illustrates a nodal data structural corresponding to an organization's hierarchy, in accordance with an embodiment.

FIGS. 13C-D illustrate graphical user interfaces displaying an organization's hierarchy, in accordance with an embodiment.

FIG. 14 is a flow diagram of a process executed in an electronic workflow management system, in accordance with an embodiment.

FIGS. 15A-D illustrate graphical user interfaces displaying an enhanced timesheet application, in accordance with an embodiment.

FIG. 16A illustrates a flow diagram of a process executed in an electronic workflow management system, in accordance with an embodiment.

FIGS. 16B-M illustrate graphical user interfaces displayed by an electronic workflow management system, in accordance with an embodiment.

FIG. 17 illustrates a graphical user interface displayed by an electronic workflow management software, in accordance with an embodiment.

FIG. 18 is a flow diagram of a process executed in an electronic workflow management system, in accordance with an embodiment.

FIGS. 19A-C illustrate graphical user interfaces displayed by the electronic workflow management system, according to an embodiment.

FIGS. 20A-B illustrate graphical user interfaces displayed by the electronic file management system, according to an embodiment.

FIGS. 21-36 illustrates graphical user interfaces displayed by the electronic workflow management system, according to an embodiment.

FIG. 37 is a flow diagram of a process executed in an electronic workflow management system, in accordance with an embodiment.

FIGS. 38A-D illustrates a representation of data associated with the nodal data structure, in accordance with an embodiment.

FIG. 39 illustrates a representation of user activities, in accordance with an embodiment.

FIG. 40 illustrates a representation of user activities, in accordance with an embodiment.

FIGS. 41-73 illustrate various graphical user interfaces displayed by a workflow management system, in accordance with various embodiment.

FIG. 74 illustrates an electronic workflow management system communicating with multiple nodal data structures, in accordance with an embodiment.

FIG. 75 illustrates various functionalities of a workflow management system, in accordance with various embodiment.

FIGS. 76-78 illustrate graphical user interfaces displayed by a workflow management system, in accordance with various embodiments.

FIG. 79 is a flow diagram of a process executed in an electronic workflow management system, in accordance with an embodiment.

### DETAILED DESCRIPTION

Reference will now be made to the illustrative embodiments depicted in the drawings, and specific language will be used here to describe the same. It will nevertheless be understood that no limitation of the scope of the claims or this disclosure is thereby intended. Alterations and further modifications of the inventive features illustrated herein, and additional applications of the principles of the subject matter illustrated herein, which would occur to one skilled in the relevant art and having possession of this disclosure, are to be considered within the scope of the subject matter disclosed herein. Other embodiments may be used and/or other changes may be made without departing from the spirit or scope of the present disclosure. The illustrative embodiments described in the detailed description are not meant to be limiting of the subject matter presented.

### Detailed Description

Reference will now be made to the illustrative embodiments depicted in the drawings, and specific language will be used here to describe the same. It will nevertheless be understood that no limitation of the scope of the claims or this disclosure is thereby intended. Alterations and further modifications of the inventive features illustrated herein, and additional applications of the principles of the subject matter illustrated herein, which would occur to one skilled in the relevant art and having possession of this disclosure, are to be considered within the scope of the subject matter disclosed herein. Other embodiments may be used and/or other changes may be made without departing from the spirit or scope of the present disclosure. The illustrative embodiments described in the detailed description are not meant to be limiting of the subject matter presented.

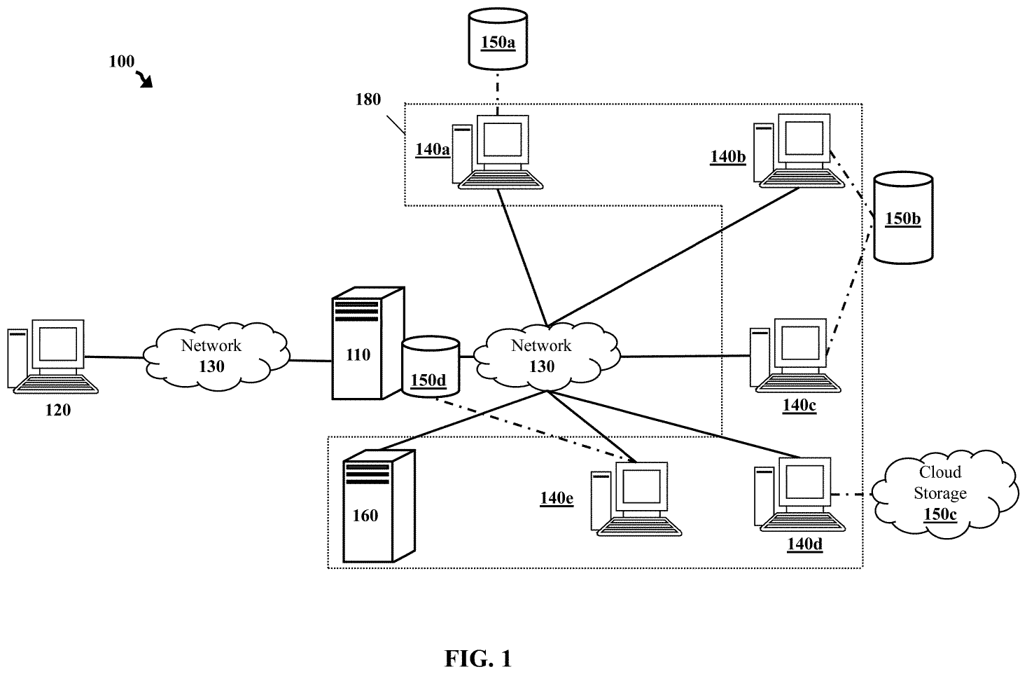

FIG. 1 illustrates components of an electronic workflow management system 100. The electronic workflow management system 100 may also be referred to herein at the electronic workflow management system. The electronic workflow management system 100 may include an analytics server 110, an administrator computing device 120, user computing devices 140a-e (collectively user computing devices 140), electronic data repositories 150a-d (collectively electronic data repositories 150), and third-party server 160. The above-mentioned components may be connected to each other through a network 130. The examples of the network 130 may include, but are not limited to, private or public LAN, WLAN, MAN, WAN, and the Internet. The network 130 may include both wired and wireless communications according to one or more standards and/or via one or more transport mediums.

The communication over the network 130 may be performed in accordance with various communication protocols such as Transmission Control Protocol and Internet Protocol (TCP/IP), User Datagram Protocol (UDP), and IEEE communication protocols. In one example, the network 130 may include wireless communications according to Bluetooth specification sets, or another standard or proprietary wireless communication protocol. In another example, the network 130 may also include communications over a cellular network, including, e.g., a GSM (Global System for Mobile Communications), CDMA (Code Division Multiple Access), EDGE (Enhanced Data for Global Evolution) network.

The electronic workflow management system 100 is not confined to the components described herein and may include additional or alternate components, not shown for brevity, which are to be considered within the scope of the electronic workflow management system 100.

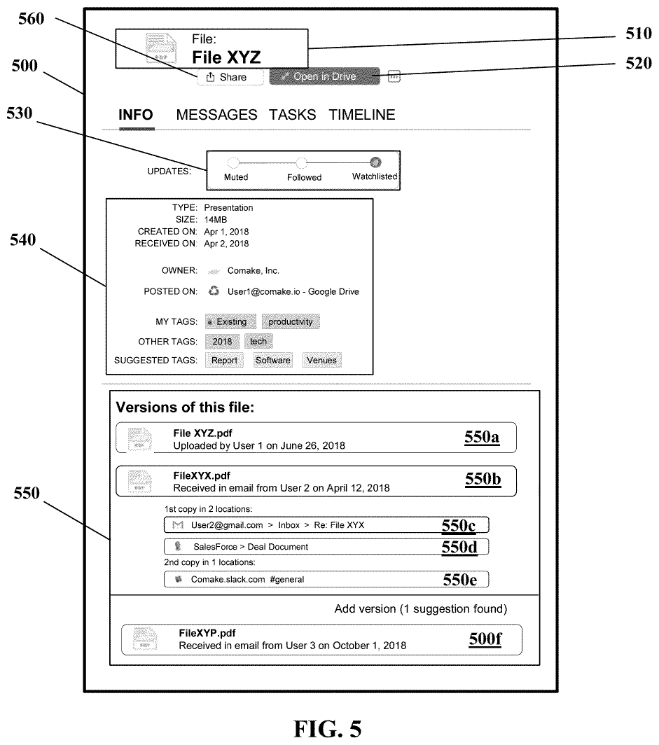

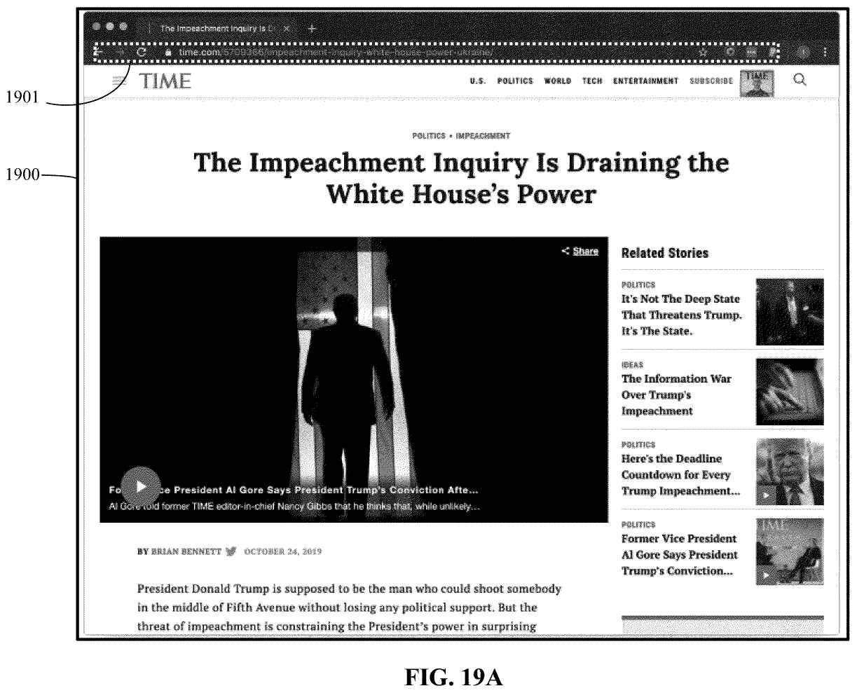

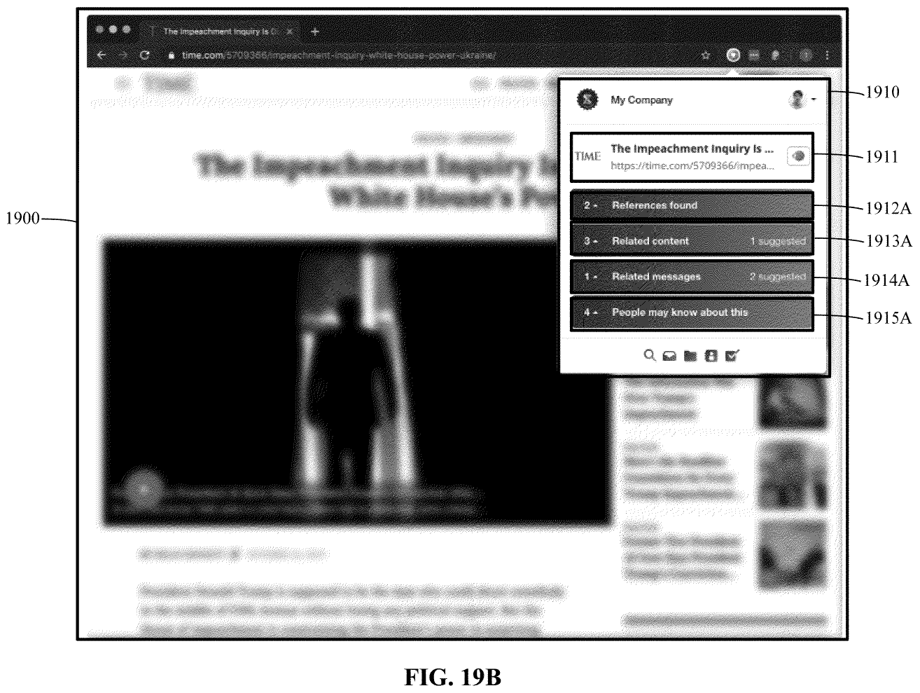

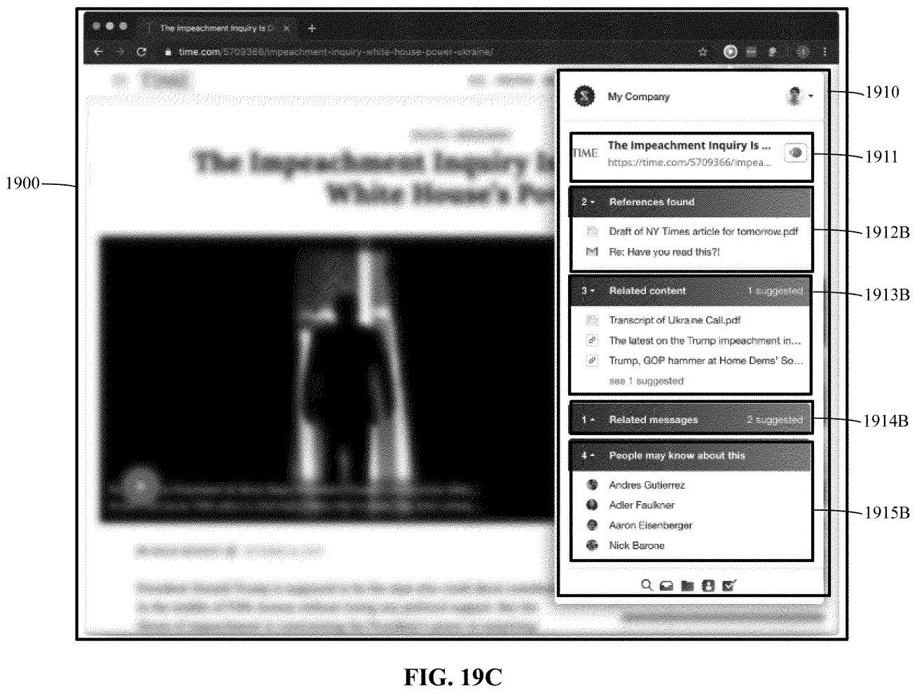

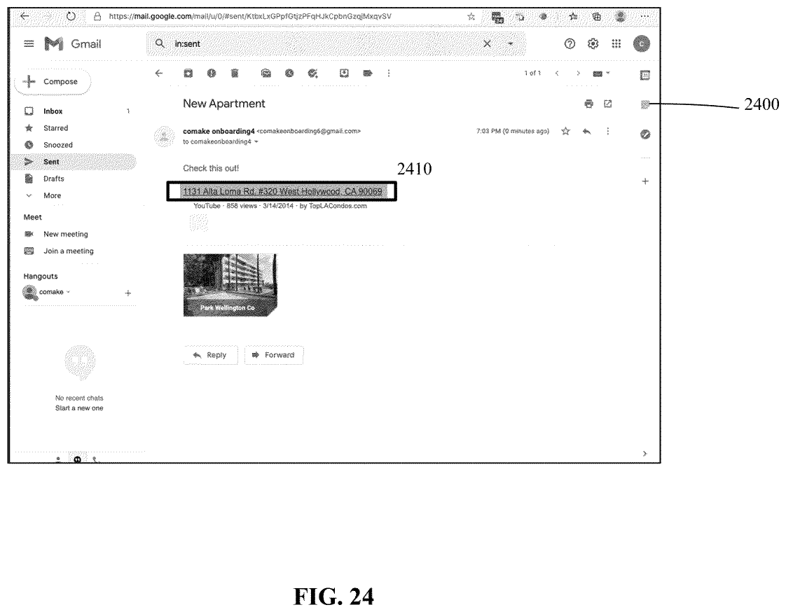

The analytics server 110 may generate and display a graphical user interface (GUI) on each user computing devices 140 within a network 180. The analytics server 110 may also display the GUI on the administrator-computing device 120. An example of the GUI generated and hosted by the analytics server 110 may be a web-based application or a website, as depicted in FIGS. 5, 6, 7, 15, and 19-29.

The analytics server 110 may host a website accessible to end-users, where the content presented via the various webpages may be controlled based upon each particular user's role. The analytics server 110 may be any computing device comprising a processor and non-transitory machine-readable storage capable of executing the various tasks and processes described herein. Non-limiting examples of such computing devices may include workstation computers, laptop computers, server computers, cell phones, and the like. While the electronic workflow management system 100 includes a single analytics server 110, in some configurations, the analytics server 110 may include any number of computing devices operating in a distributed computing environment to achieve the functionalities described herein.

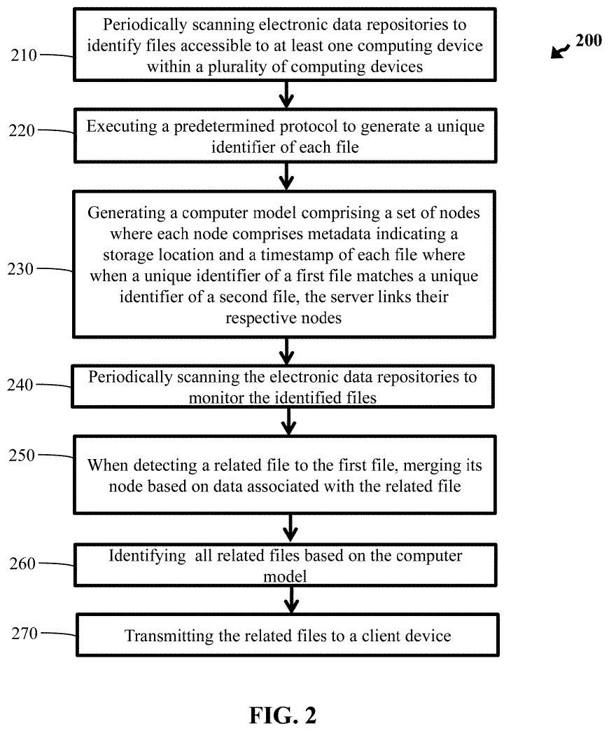

The analytics server 110 may execute software applications configured to display the GUI (e.g., host a website), which may generate and serve various webpages to each user computing device 140 and/or the administrator computing device 120. Different users operating the user computing devices 140 may use the website to generate, access, and store data (e.g., files) stored on one or more of the electronic data repositories 150, as described in detail in FIGS. 2, 5, 6, and 7. In some implementations, the analytics server 110 may be configured to require user authentication based upon a set of user authorization credentials (e.g., username, password, biometrics, cryptographic certificate, and the like). In such implementations, the analytics server 110 may access a system database 150d configured to store user credentials, which the analytics server 110 may be configured to reference in order to determine whether a set of entered credentials (purportedly authenticating the user) match an appropriate set of credentials that identify and authenticate the user.

As described herein a file refers to contained data available to at least one operating system and/or at least one software program. A file may contain data, such as text, video, computer program, audio, and the like. Furthermore, a file can also refer to a path associated with data. For example, a file, as used herein, can refer to a traditional file or folder on a local machine, a shortcut to a file/folder on a different machine, and/or a reference to a file/folder in an email message. Another non-limiting example of a file may include a reference to the location of a file/folder by website URL or file/folder path, a file/folder that only exists online or is not traditionally saved to a local machine's normal file. The path may not be accessible through the main system's file browser (e.g., Google Docs®, Evernote Notes®, and the like) that are not typically accessible through a computer's Windows Explorer or MacOS Finder unless explicitly downloaded to a folder in a different format that might lose either functionality or context such as related content and comments). In some configurations, the analytics server 110 may provide an application native to the user computing devices 140 or other electronic devices used by users where users may access the native application using the user computing devices 140 or any other computing devices (e.g., personal electronic devices) to generate, access, store, or otherwise interact with data stored onto the electronic data repositories 150. The native application may be any application that is directly in communication with the analytics server 110. For example, the native application may be a mobile application, cloud-based application, universal GUI, and/or virtual/cloud-based “desktop” where users (upon being authenticated) can access, interact with, and manipulate data stored onto the electronic data repositories 150.

In some configurations, the analytics server 110 may generate and host webpages based upon a particular user's role within the electronic workflow management system 100 (e.g., administrator, employee, or the employer). In such implementations, the user's role may be defined by data fields and input fields in user records stored in the system database 150d. The analytics server 110 may authenticate each user and may identify the user's role by executing an access directory protocol (e.g., LDAP). The analytics server 110 may generate webpage content, access or generate data stored in the electronic data repositories 150, according to the user's role defined by the user record in the system database 150d. For instance, a user may be defined as a lower level employee who may not be authorized to view all related content to a particular sensitive file. Therefore, the analytics server 110 may customize the GUI according to the user's authentication level. Furthermore, the analytics server 110 may customize the GUI according to a user's role (e.g., function type). For instance, the analytics server 110 may customize the GUI based on whether a user is a designer or an account manager.

In operation, when instructed by the administrator-computing device 120 and/or any user-computing device 140, the analytics server 110 may execute various scanning and crawling protocols to identify and map data stored onto each electronic data repository 150. As described herein, the analytics server 110 may also execute various predetermined protocols to generate unique identifiers for the above-described files/data, identify related files, create a nodal data structure, periodically scan the electronic data repositories, update the nodal data structure, and display related files and context information on the above-described GUI. In some implementations, the analytics server 110 may incorporate the GUI into a third-party application, such as a third-party email application or a file sharing/management application while preserving the “look and feel” of the third-party application.

In some configurations, the analytics server 110 may compare unique identifiers included in the metadata of each file. For instance, a file may have metadata that includes unique identifiers associated with elements related to the file (e.g., email, tasks, storage location, and the like). In some embodiments, the analytics server 110 may use these unique identifiers to determine whether the file is related to any other files.

User computing devices 140 may be any computing device comprising a processor and a non-transitory machine-readable storage medium capable of performing the various tasks and processes described herein. Non-limiting examples of a user-computing device 140 may be a workstation computer, laptop computer, tablet computer, and server computer. As depicted in FIG. 1, the user computing devices 140 may each be operated by a user within the network 180. In a non-limiting example, the network 180 represents an internal network and/or collection of computing devices connected within an entity. For instance, network 180 may represent all computing devices operated by all employees of a company. User computing devices 140 may be internally interconnected via an internal and/or private network of the network 180 (not shown). For instance, a company's intranet or any other private network may connect all the company's computing devices. In FIG. 1, user-computing devices 140 are interconnected within the network 180 (e.g., belong to the same company).

Even though the depicted user computing devices 140 are within the same network (e.g., network 180), it is expressly understood that the services provided by the analytics server 110 may not be limited to computers within the same network. For instance, the analytics server 110 may scan files accessible to one or more user computing devices that are not interconnected and are not within the same network. In some other embodiments, the analytics server 110 may only monitor a customized and/or predetermined portion of the computing devices 140. For instance, the administrator-computing device 120 may customize a list of user computing device 140 and their corresponding electronic repository 150 to be monitored by the analytics server 110.

Each user computing device 140 may access one or more electronic data repositories 150 to access (e.g., view, delete, save, revise, share, send, communicate around, and the like) data stored onto the one or more electronic data repositories 150. For instance, user-computing device 140a may access data within a local database 150a. User computing device 140b and 140c may access a shared database 150b. User computing device 140d may access a cloud storage 150c. Furthermore, user-computing device 140e may access a database operationally managed by the analytics server 110, such as the system database 150d. The network 180 may also include the third-party server 160 where one or more user computing devices 140 utilize the third-party server 160 to access, store, and/or manage data. An example of the third-party server 160 may be an email server, a third party (or homegrown) electronic file management server, a public website for hosting and sharing specific file types (e.g., YouTube® for videos, Behance® for graphic files, and LinkedIn Slideshare® for presentations), or any other server used to access and/or store data files.

In some configurations, data accessible to the user computing devices 140 may be stored in a distributed manner onto more than one electronic repositories. For instance, one or more files may be stored onto a blockchain accessible to the user computing devices 140 where the blockchain comprises multiple distributed nodes storing data onto disparate electronic repositories. The analytics sever 110 may retrieve a public or private blockchain key associated with each user and/or each user computing device 140 to access the blockchain and monitor data stored onto the blockchain.

Even though different user computing devices 140 are depicted as having, access to different electronic data repositories 150, it is expressly understood that in different embodiments and configurations, one or more user computing devices 140 may have access to a combination of different electronic repositories 150. For instance, user-computing device 140a may utilize the third-party server 160 and the local database 150a to store data. In another example, user-computing device 140c may utilize database 150b, cloud storage 150c and the third-party server 160 to access files/data. For the purpose of brevity, different combinations of different user computing devices 140 having access to different electronic data repositories 150 are not shown.

FIG. 2 illustrates a flow diagram of a process executed in an electronic workflow management system, in accordance with an embodiment. The method 200 includes steps 210-270. However, other embodiments may include additional or alternative execution steps, or may omit one or more steps altogether. In addition, the method 200 is described as being executed by a server, similar to the analytics server described in FIG. 1. However, in some embodiments, steps may be executed by any number of computing devices operating in the distributed computing system described in FIG. 1. One or more user computing devices or an administrator-computing device may, locally perform for instance, part or all the steps described in FIG. 2. Furthermore, even though some aspects of the method 200 is described in the context of a web-based application, in other configurations, the analytics server may display related data in a mobile application or an application native to the user's desktop.

At step 210, the analytics server may periodically scan a plurality of electronic data repositories accessible to a plurality of computing devices to identify a plurality of files stored onto the plurality of electronic data repositories where each file is accessible to at least one computing device within the plurality of computing devices. As discussed above, the analytics server may periodically scan one or more electronic data repositories to identify electronic files stored onto such electronic repositories.

The analytics server may require all users to create accounts and grant permission to the analytics server to periodically monitor files accessible to each user and/or computing device operated by each user. In some configurations, the analytics server may provide a web-based application displaying various prompts allowing each user to grant the analytics server permission to periodically monitor all files accessible and/or revised by each user. The web-based application may provide at least five monitoring functionalities: 1) files saved on any electronic data repository accessible by each user; 2) each user's email communication; 3) each user's chat/messaging activity; 4) each user's task management or project management; and 5) each user's calendar events.

During the account registration process, the web-based application may display one or more prompts allowing each user to connect his or her email accounts, messaging tools, task management tools, project management tools, calendars, organizational or knowledge management tools (e.g., Evernote®, Atlassian Confluence®, etc.), other collaborative tools (e.g., Basecamp®, Smartsheet®, etc.) and/or electronic repository systems (e.g., local database, cloud storage systems, and the like) to the analytics server. The prompt may also include one or more text input fields where each user can input identification and authentication credentials for his email accounts, messaging tools, electronic repository systems, and/or third party applications, such as project management tool, time tracking applications, billing, issue tracking, web accounts (e.g., YouTube®), online applications (e.g., Figma®, Onshape®, Google Docs®, and the like). For example, a user may enter his email address and password in the input fields displayed by the analytics server. Upon receipt, the analytics server may use the authentication credentials to remotely login the above-described portals and monitor all files accessible and/or revised by each user and/or all files saved on the electronic data repositories.

Upon receiving permission and/or authorization from users, the analytics server may scan the one or more electronic data repositories accessible to each user. The analytics server may execute a scanning or crawling protocol where the analytics server crawls different databases to identify all files accessible to each user.

As discussed above, an electronic repository may represent any electronic repository storing files that are accessible to one or more computers within an entity or a network. Non-limiting examples of an electronic repository may include a database, cloud storage system, third-party shared drives, third-party application as described above, internal file transfer protocol (FTP), and internal or external database operated by the analytics server, email storage, HR systems, accounting systems, customer relationship management (CRM) systems, and the like.

The analytics server may, upon receiving permission from one or more computing devices periodically scan the above-described electronic repositories and identify one or more files stored onto these electronic repositories. For instance, an administrator of an entity may grant permission to the analytics server to scan all repositories accessible to all computers within the entity.

Upon identification of each file, the analytics server may search data associated with the identified files and may re-create an activity timeline for each user. The activity timeline may present historical data associated with each file and each user. For instance, when the analytics server identifies a file (e.g., Sample.doc), the analytics server may further identify a history of Sample.doc by analyzing said file's history (e.g., revision, communication, and access history of the file). As a result, the analytics server may create a timeline that indicates every interaction (e.g., file generation, revisions, modification, and the like) with Sample.doc.

In some configurations, the analytics server may retrieve the file history and other related data (e.g., context data) using an application programming (API) interface in communication with the electronic data repositories. For instance, the analytics server may be prohibited from accessing a third-party shared drive. In those embodiments, the analytics server may use an API configured to communicate with the third party shared drive to identify and monitor files. The analytics server may further use a similar protocol to determine whether a file has been revised/modified. For instance, the analytics server may cause an API to connect/sync with a third-party document sharing application. The analytics server may also cause the API to transmit a notification for each instance that a file, stored on the third-party document sharing application, is accessed and/or revised by a user.

In some configurations, third-party service providers of shared document drives may not allow the API to transfer detailed data regarding file revisions. For instance, third-party service providers may only transmit a notification that a file has been accessed and/or revised by a user. However, the API notification may not contain the revision (e.g., change of text, formatting, and the like) to the file. In those embodiments, the analytics server may remotely access the shared drive, using credentials obtained from the user during the account registration process, obtain a copy of the file, and compare the file to a previous version.

The analytics server may also include the API notification in the metadata profile of each identified file. For instance, the analytics server may receive an API notification that a first user has shared File X with a second user on a third-party document sharing application. The API notification may not include any specific data regarding the content of File X because the analytics server may be prohibited from retrieving a copy of File X. The analytics server may include the document sharing activity in the metadata of File X (within the nodal data structure described herein), which may include a timestamp of the document share and data associated with the first user and the second user. As a result, the analytics server may reconstruct an activity timeline for File X that includes information on how File X was shared (e.g., medium and timestamp) and different users who interacted with File X.

In another example, user 1 may share File X with user 2 using a third-party file management application. Using an API connect to the third-party file management application, the analytics server may receive a notification that File X was shared between two users at a certain time. The API notification may not include user identifiers and may not identify the sender or the receiver of File X. The third-party file management application may also notify user 1 and/or user 2 regarding the file sharing. For instance, the third-party file management application may send an email to user 2 informing user 2 that user 1 has shared File X with user 2. The email may also include an identifier associated with File X (e.g., URL of File X). Because the analytics server has access to emails of user 1 and user 2, the analytics server can identify that user 1 has shared File X with user 2. The analytics server may then include the file path, timestamp of the email, and timestamp of the file share, in the File X's metadata file. In some configurations, the analytics server may create a node for the email and/or the file path (e.g., URL) included in the email.

At step 220, the analytics server may execute a predetermined protocol to generate a unique identifier of each file within the plurality of files. Upon identifying each file, the analytics server may execute a predetermined hashing algorithm and generate a unique identifier for each file identified in step 210. A hashing algorithm or protocol may be a function that converts a data string into a numeric string output of fixed lengths. The output string is generally much smaller than the original data. Hash algorithms are designed to be collision-resistant. In other words, there is a very low probability that the same string would be created for files with dissimilar content. Simply put, the analytics server may create a unique identifier for each file identified in step 210. As described herein, the analytics server may use the unique identifier (e.g., generated hash string) to compare files with each other and/or with their previous versions.

Using the hashing algorithm, the analytics server may eliminate the need to retrieve files and to execute file-comparison protocols, which requires extensive computing power and increases the chance of unintended file corruption. For instance, the analytics server may store the unique identifier for each file in a database. Upon detecting a revision of a file, the analytics server may execute the same hashing protocol using the purportedly revised file and compare the newly generated unique identifier with the previously stored unique identifier. In this way, the analytics server identifies whether the file has been revised using less processing power than conventional systems.

In some configurations, the analytics server may use message-digest protocol 5 (MD5) hashing protocol to generate the unique identifier for each identified file. Using the MD5 hashing protocol, the analytics server may generate a unique identifier for each file that contains a 128-bit hash value representing the content of each identified file. Because the unique identifier comprises an output string, which is smaller than the original file, executing data-comparing protocols on the unique identifier (rather than performing the same protocols on the original file) requires much less processing power.

Each element related to a file may include a unique identifier. For instance, where a file is stored (storage drive or a storage folder) may have its unique identifier. When a file is sent via an email message, the email may have its own unique identifier. In some configurations, the analytics server may use these identifiers to compare files and determine whether they are related. For example, a PDF stored on a shared data repository (e.g., GOOGLE DRIVE) may have 3 unique identifiers: (1) a unique URL, (2) a unique ID generated by the shared data repository, and (3) a unique content-based hash ID generated by the analytics server. The analytics server may use all the unique identifiers to compare files.

In a non-limiting example, file 1 may be associated with a unique identifier of a related task, a unique identifier of a related email, and a unique identifier of a storage drive. File 2 may be associated with a unique identifier of a related email and a unique identifier of a related task. In some configurations, the analytics server may compare the unique identifiers of files 1 and 2 (e.g., unique identifier of the email related to file 1 compared to unique identifier related to file 2). When a number of similar unique identifiers satisfy a threshold, the analytics server may determine that the files are related.

As a result, when two web-based files (e.g., two files saved on a third-party file sharing application) share the same drive identifier (e.g., are saved within the same storage drive or folder), the files may be associated with similar unique identifiers associated with the folder or the storage drive. Consequently, the analytics server may determine that they are related.

In some configurations, the analytics server may generate the unique identifier for each file based on a combination of one or more of the above-described methods. For example, the analytics server may generate the unique identifier for each file using the hashing protocol, and an identifier of where the file is saved. As described herein, a “unique” identifier is unique to each file. Furthermore, other elements described herein can have unique identifiers. For instance, a storage drive on which a file is stored may have a unique identifier. In another example, an email sent to a user may have its own unique identifier. For instance, the analytics server generates unique identifiers such that a unique identifier cannot be generated for two unrelated files.

When the analytics server determines that the file is a file path, shortcut, link/URL, bookmark, or an identifier of an online file (e.g., Google Docs®, OnShape®, and the like), the analytics server ay generate the unique identifier based on the file's URL. For instance, a unique identifier may be embedded within the URL of a file.

At step 230, the analytics server may generate a computer model comprising a set of nodes where each node comprises metadata indicating context data of each file within the plurality of files, wherein when a first unique identifier of a first file matches a second unique identifier of a second file, the server links a first node corresponding to the first file to a second node corresponding to the second file. The analytics server may create a computer model comprising a nodal data structure (or data graph) where each node represents an identified file. The analytics server may store the nodal data structure in the system database (or any other electronic data repository, such as a cloud bases storage, local/internal data storage, distributed storage, blockchain, and the like) described in FIG. 1.

The nodal data structure may be a complete map of all the files identified in step 210. Each node may also contain metadata further comprising historical (e.g., context) data associated with the file, such as the generated unique identifier of the file, title, mime type, file permissions, comments, and the like. The metadata may also indicate a revision history associated with each file. For instance, the metadata may include timestamp of every revision for each file, a unique identifier (e.g., user ID, IP address, MAC address and the like) of the user and/or the computing device who accessed and/or revised the file, and the like. Other context data may include, but not limited to, email identifiers (e.g., unique email identifiers, sender identifier, receiver identifier, and the like), tasks associated with the files, user identifiers, mime type, collaboration information, viewing permission, title of each file, and the like.

The metadata may also include context information associated with each file. For instance, the metadata may include email/chat communication that are related to each file. In another example, if the analytics server determines that a file has been transmitted via an email or other electronic communication protocols (e.g., referenced or attached in an email message, referenced in a chat session, and the like), the analytics server may include a transcript of the electronic communication (e.g., body of the email) in the node, as metadata. The analytics server may index each node based on its associated metadata and make each node searchable based on its metadata.

The analytics server may compare the unique identifiers for of all the files identified in step 210. When the unique identifiers of two or more files match, the analytics server may link the nodes representing the two or more files in the above-described nodal data structure. A link (or edge) may connect similar or associated nodes within a nodal data structure such that the analytics server may retrieve context metadata more efficiently. Edges can be directed, meaning they point from one node to the next, or undirected, in which case they are bidirectional. The analytics server may use different directed or undirected edges to link different nodes. Edges between nodes can be given special classifications, including but not limited to “copy,” “version,” “parent,” “child,” “derivative,” “shared email,” “shared task,” “shared tag,” and “shared folder.” The analytics server may also combine relevant metadata from related files and display to the client (e.g., files A and B are copies of each other, and file B is attached in an email message. When user previews file A, the email message for file B can be displayed). As described herein, the analytics server may use the links to identify a latest version of a related family of files.

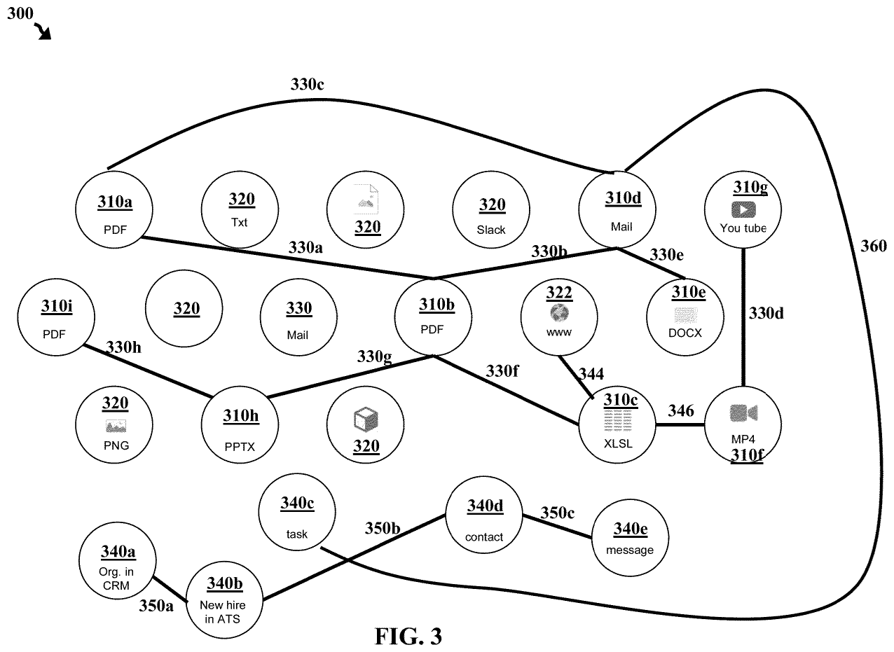

Referring now to FIG. 3, nodal data structure 300 represent a nodal structure created based a set of identified files and related nodes connected via different edges. As depicted in FIG. 3, the analytics server identifies 17 files and creates a node for each file (nodes 310a-i and nodes 320). For instance, node 310b represent a pdf file stored locally on a computer of an entity (e.g., computer within a network of computers); node 310h may be a PowerPoint Open XML, file stored on a cloud storage accessible to another computer within the same network. As described above, each node may include an indication of a location where the file is stored. For instance, node 310e may represent a DOCX file stored in a local database. Therefore, node 310e may include metadata comprising a path of the DOCX file to the local database. Additionally, as described above, multiple nodes may be linked together. For instance, links 330a-h connect nodes 310a-i that represent related files. Furthermore, because the analytics server identifies that nodes 320 are not related, the analytics server does not link nodes 320, as depicted in FIG. 3. As described above, a “file” may also refer to a path associated with data. For instance, a file may refer to the underlying data regardless of where the data is stored and/or hosted or the application needed to view the data. For instance, a file may include a link (directing a user to view the underlying file). The file may only exist as on online file and may only be accessible through an internet browser or mobile application, and in some cases, it may not be able to be downloaded to a local machine without some type of conversion (e.g., Google Docs® or Google Slides® only exist online, but can be downloaded as DOCX or PPTX).

A path may specify a unique location of a file within a file system or an electronic data repository. In some configurations, a path may point to a file system location by following the directory tree hierarchy expressed in a string of characters in which each component of the string, separated by a delimiting character, represents a directory. In some configurations, the analytics server may use a uniform resource locator (URL) to identify each file's stored location. For instance, when a file is stored onto a cloud storage or when a file is stored onto a third-party shared drive, the analytics server may include a URL of the file in the nodal data structure.

In some configurations, and as described above, the nodal structure may not include the identified files and may only comprise nodes representing file locations (and other metadata) and edges representing how different files are related. For instance, instead of storing multiple files (and possibly multiple version of the same file and/or related files) the analytics server may only store the nodal data structure in a local or external database. In this way, the analytics server may conserve significant storage space because storing a representation of a file requires significantly less storage capacity than storing the file itself. Furthermore, as described herein, identifying relationships (and executing various protocols to identify context, relationship or other related data for each file) is much less computationally intensive when performed on the above-described nodal data structure than executing the same protocols on the files themselves. In this way, the analytics server may conserve significant computing and processing power needed to provide file management services. As a result, the analytics may deliver results in a faster and more efficient manner than provided by conventional and existing file management methods.

As depicted, the nodal data structure 300 may include all data associated with users' workflow. For instance, the wild the nodes described above represent different files, nodes 340a-e may represent workflow components generated because of users' work. For instance, the node 340a corresponds to organization chart generated based on customer relationship management (CRM) software solution (internal or third party solution). The node 340b may correspond to new employees hired where the data is generated based on an applicant tracking system software solution (internal or third party solution).

The node 340c may correspond to one or more tasks associated with one or more employees. For instance, an organization may use an internal or third party software solution to help employees execute various tasks efficiently. The analytics server may identify the tasks I may generate a node for each task. Accordingly, the analytics server may identify that one or more tasks may be related to one or more files and/or work components within the nodal data structure 300.

The node 340d may correspond to a contact within a contact list of an employee/user. The analytics server may scan various software solutions (internal and/or external) and may identify contacts associated with each user/employee. The analytics server may then generate a node for each contact accordingly. As described herein, the analytics server may then identify that a contact is related to another node that may represent a file and/or a workflow component within an organization. The node 340e respond to one or more messages generated and transmitted among users, such as emails or any other messages (chat applications).

As depicted, the analytics server may not differentiate between files stored on data repositories accessible to one or more users and workflow components generated/accessible to the users. The analytics server may execute various analytical protocols described herein to identify related nodes and may use edges to link or merge the related nodes. For instance, the analytics server may use edges 350a-c to connect related work component nodes. The analytics server may also use age 360 two connect node 340c (workflow component) to the node 310d, and indirectly connect node 340d to nodes 310a, 310b, 310e, 310c, 310h, and 310i.

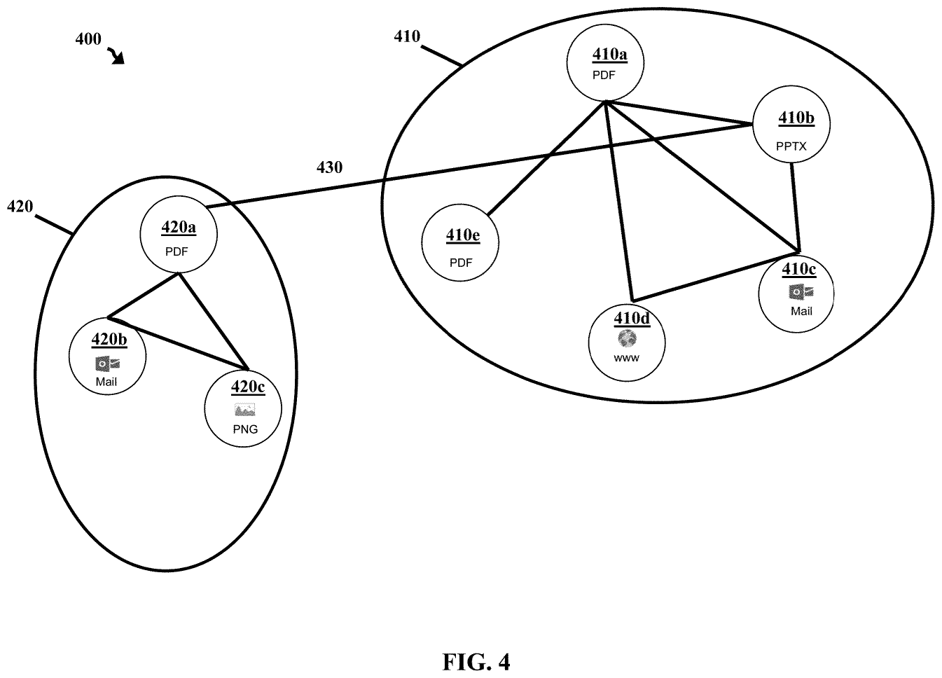

Referring now to FIG. 4, another illustration of a nodal data structure is illustrated. Nodal data structure 400 represents a clustered nodal data structure where the analytics server clusters related files into data clusters 410 and 420. As described above, each node within the nodal data structure 400 represents an identified file. Each node within the nodal data structure 400 may include metadata associated with each respective file (e.g., indicating the location, type, historical data, and context data associated with the file). Upon identifying relationships between files, the analytics server may generate a cluster that represents all related nodes/files. For instance, the analytics server may determine that a unique identifier of a first pdf file on a first computer (represented by node 410a) matches the unique identifier of a second pdf file stored on a cloud storage accessible by a second computer (represented by node 410e). In response to identifying this relationship, the analytics server may link nodes 410a and 410e. Subsequently, the analytics server identifies that a PowerPoint file (represented by 410b) and a web link (represented by node 410d) were transmitted via an email message (represented by node 410c) that also includes the pdf file represented by node 410a. In response, the analytics server may link node 410a to each of nodes 410b, 410c, and 410d. The analytics server may further link node 410b and node 410d to node 410c because files represented by nodes 410b and 410d may be related. As seen in FIG. 4, the analytics server creates data cluster 410 that includes all the above-mentioned nodes.

The analytics server may execute similar protocols as described above to identify interrelated files and generate multiple clusters. For example, the analytics server may cluster nodes 420a-c into cluster 420. Furthermore, one or more nodes within different clusters may also be linked, as represented by edge 430. As described above, data cluster 410 and 420 each represent a related family of files. Different clusters may be stored into different shards to optimize storage and efficiency when identifying nodes (e.g., step 260).

In some configurations, the analytics server may consolidate all metadata associated with each identified file to identify all related users and content. In a non-limiting example, the analytics server may identify that user 1 sent File A in an email (along with File B) to user 2; user 2 downloaded File A and stored File A in a folder with File C. As a result, the analytics server may connects nodes representing files A, B, and C. When a user accesses any of the files A, B, or C, the analytics server notifies the user regarding the relationship between these files. As described herein, the analytics server may only customize the notifications in accordance with each user's access permissions. For instance, if a user is not authorized to access (or view) File B, the analytics server may only display notifications regarding Files A and C to the user.

Referring back to FIG. 2, at step 240, the analytics server may periodically scan the plurality of electronic data repositories, to monitor the first file and the second file. The analytics server may periodically scan the electronic repository as discussed above. In some configurations, the frequency of data scanning may be predetermined or may be adjusted by an administrator in accordance with an entity's needs. For instance, an administrator may require the analytics server to scan the electronic data repositories every week, day, or multiple times per day depending on their unique needs and data sensitivity.

In some configurations, the analytics server may only scan the electronic data repositories in response to receiving a notification or a trigger from another server, such as an email message, a third party API or a data management server operationally in communication with a data repository. The analytics server may use application-programming interfaces and/or web hooks to achieve the above-described results. For instance, as described above, the analytics server may utilize various APIs to monitor the identified files. Therefore, the analytics server may receive a notification, from an API, that a file has been revised. In some embodiments, the API may transmit details of the revisions (e.g., user name, timestamp, and the like). In some other embodiments, the API may not be configured or authorized to transmit such detailed data. In those embodiments, in response to receiving the notification from the API indicating that a file has been revised, the analytics server may further scan the electronic repository (or other repositories, such as email, third-party applications, and other repositories) on which the file is stored. As a result, the analytics server may retrieve revision details associated with the revised file.

At step 250, the analytics server may, for each instance of the server detecting a related file to the first file, merge the first node where the merged first node corresponds to a context data of related files (e.g., storage location and a timestamp of the related file to the first file and context data of the first file). In response to identifying a revision or a modification to a file, the analytics server may revise the nodal data structure accordingly. For instance, as described above, the analytics server may identify that a file has been revised or modified by a user within the network. The analytics server may then update the metadata associated with the node and the respective edge representing the revised file with revision/modification data. For instance, the analytics server may update the node metadata with a user identifier, timestamp, content of the revision, and other historical data. When the analytics server identifies a revision of the file, the revised file is no longer a “copy” of the original file. Therefore, the analytics server updates the metadata of the revised file from “copy” of the original file to a “version” of the original file.

In some configurations, the analytics server identifies related files based on their context data stored onto one or more nodes representing each respective file. For instance, in some embodiments, the analytics server may update or revise the nodal data structure by generating new nodes and/or edges. For instance, when the analytics server discovers that a user has attached a file in an email communication, the analytics server may generate a node that represents the email communication. The analytics server may then update the node's metadata with information associated with the email communication (e.g., timestamp, email body, email address, sender user identification, receiver's user identification, and other context data described herein).

In some configurations, if the email communication includes other files or web links, the analytics server may create individual nodes for other related files. For instance, and referring to FIG. 3, node 310d represents email communication between two users where one user attached a pdf file represented by node 310b. Furthermore, in the email represented by node 310d, the user also attached a document represented by node 310e. As depicted in nodal data structure 300, the analytics server may also link the above-described nodes using edges 330b and 330e. As a result, the analytics server may continuously and iteratively update the nodal data structure. Therefore, the nodal data structure is a dynamic computer model, which adapts to user interactions.

In some configurations, the analytics server may combine metadata from multiple related nodes into a single metadata file. Instead of each node having a separate metadata file, the analytic server may create a single metadata file associated with a file where the metadata file contains all metadata associated with all (or a given subset of) related nodes. For instance, if File A is related to Files B-F, the analytics server may create a single metadata file and combine metadata associated with Files A-F. Upon identifying additional related files (or other related data, such as tasks, messages, and the like), the analytics server may update the metadata file accordingly.

In some configurations, the analytics server may augment the metadata file using public data. For instance, in addition to scanning the electronic repositories described herein, the analytics server may also scan publicly accessible repositories (e.g., public websites or other publicly accessible data). When the analytics server identifies a public file related to an identified file, the analytics server may augment the identified file's metadata file. For instance, the analytics server may identify a video file stored locally onto a user's computer. The analytics data may then determine that the identified video is similar to a video publicly shared on a website (e.g., YouTube®). Consequently, the analytics server may augment the identified video's metadata file using data associated with the publicly share video (e.g., URL of the video).

As described above, the analytics server may use two methods to merge two nodes where the two nodes represent two related files (e.g., copies of the same file, and/or files that have been determined to be related). First, the analytics server may create a new node for the newly discovered related file and may link the nodes together. Second, the analytics server may combine the metadata of the newly discovered file with the original file (e.g., create a single metadata file and combine all metadata corresponding to context information of the related file to the original file). The analytics server may also use one or both of the above-described methods when merging two nodes.

In a non-limiting example, the analytics server may identify two copies of the same file where the first file is stored on a local database and the analytics server identifies the second file as an attachment in an email sent from a first user (or when the file path is transmitted through the email) to a second user. The analytics server may then combine the metadata associated with the email (e.g., email message, sender identifier, receiver identifier, content data, mailbox identifier, and the like) with the metadata associated with the first file (e.g., name of the local system, size, data modified, folder, and the like). For instance, the analytics server may generate a single metadata file that contains metadata associated with the first file and the second file. The analytics server may then use the combined metadata file to identify related files, build, and suggest relationships between the first/second file and other files identified. In another example, the analytics server may generate a node that represents a file. When the file is attached in a task, the analytics server may generate a new node for the task. Therefore, the analytics server may operate in two ways: 1) creating a new node for a related file; and/or combining the context into a single metadata file for a file. In some configurations, the analytics server may use a combination of the above-described methods.

At step 260, the analytics server, in response to receiving from an electronic client device, a request to access the first file or the second file, may identify all or some of the related files to the first file or the second file in accordance with a latest timestamp of the first node or the second node. The analytics server may receive a request to access a file. For instance, a user may click or otherwise interact with a file and transmit a request to access the file (e.g., view, edit the content, revise the name, send, or otherwise interact with the file). In some embodiments, the user may access a shared third-party application and transmit a request to access the file. In response to determining that the user has requested to access a file, the analytics server may identify a node within the nodal data structure that represents the requested file.

Upon retrieving the identified node, the analytics server may retrieve all related nodes and metadata associated with the identified nodes and/or the related nodes within the nodal data structure. The analytics server may analyze the metadata retrieved and identify all related files (including a latest version of the requested file). For instance, the analytics server may retrieve all timestamps for all nodes related to a node representing the requested file. The analytics server may then compare all timestamps to identify a latest version of the requested file. The analytics server may also identify relationships between files by determining relationships between different nodes representing those files. These relationships (identified related nodes) may be displayed on the GUI viewed by the user. For instance, when a user accesses a file, the analytics server may identify the original file, different copies, versions, derivative, shared tasks, shared comments, shared emails, shared tags, and shared folders that are associated with the file. The analytics server may also display these related items on the GUI, as depicted in FIGS. 5-7.

At step 270, the analytics server may retrieve all files related to the requested file-in accordance with the storage location of the latest version of the requested file identified based on the updated first node—and may transmit the retrieved latest version to the electronic client device. As described above, the analytics server may identify a node that represents a latest version of the requested file. Subsequently, the analytics server may use the path stored within the metadata of the identified node to retrieve a latest version of the requested file and transmit the retrieved latest version to the electronic client device. The analytics server may populate a graphical user interface that displays various information associated with the requested file. As described herein, the analytics server may directly display graphical user interface on the user's computer or may incorporate the graphical user interface into a third-party application, such as a third-party email application. In some embodiments, the analytics server may display all versions of the requested file. For instance, in addition to displaying the latest version, the analytics server may display an option for the user to access an older version or a related version (e.g., a version of the requested file that was shared in an email). Using the above-described options, the user may access and interact with an older version of the request file.

Using the methods and systems described herein, the analytics server also allows users to interact with files stored onto disparate electronic data repositories using the same web-based application (e.g., browser). For instance, the analytics server may identify a node representing the requested file stored onto a first electronic data repository, a first related node representing an email stored onto a second electronic data repository that included the requested file as an attachment, and a related file stored onto a third electronic data repository. The user may access all the above-mentioned files (requested file, related file, and related email) from the same browser even though the above-mentioned files are stored onto different electronic repositories.

To retrieve all related data (e.g., all related files including the latest version of a file), the analytics server may utilize the Apache Lucene project's open source enterprise search platform, Solr®, for full-text indexing and searching. As described above, the analytics server may index every node within the nodal data structure, which allows the nodes to be searchable by their associated metadata. Furthermore, executing the above-described indexing and searching protocol on the nodal data structure, as opposed to all files stored in a central data repository, allows the analytics server to identify nodes and retrieve related metadata in real-time or near real-time.

Referring now to FIG. 5, an example of a graphical user interface displaying file context information is illustrated. In some configurations, the analytics server may display GUI 500 directly on a user's computer. For instance, when a user interacts with a file (e.g., clicks on a file and request the file to be opened), the analytics server may display the GUI 500 on the user's computer. In the depicted embodiment, a user requests File XYZ to be opened. As a result, the analytics server displays the GUI 500. In some other embodiments, the analytics server displays an indicator associated with File XYZ and displays the GUI 500 in response to the user interacting with the indicator.

The GUI 500 may display filename and file types of the requested file in the graphical component 510. For instance, graphical component 510 indicates File XYZ (file name) and further indicates that File XYZ is a PDF file (file type). The GUI 500 may also comprise an interactive graphical component 520. When the user interacts with the interactive graphical component 520 (e.g., by clicking), the analytics server may display content of File XYZ. Another interactive graphical component 560 may allow the user to share File XYZ with other users. For instance, when the user interacts with the interactive graphical component 560, the analytics server may generate an interactive link configured to direct the recipient to the File XYZ (e.g., a URL or other paths indicating a storage location of the File XYZ).

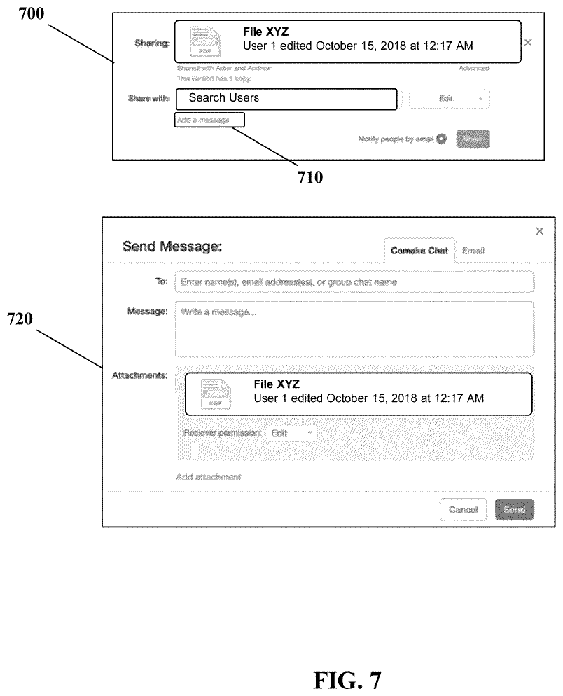

In some configurations, the analytics server uses a messaging application to transmit the requested file to other users. When a user interacts with the graphical component 560, the analytics server may direct the user to the messaging application (or otherwise referred to as the sharing panel). Referring now to FIG. 7, an internal messaging application is illustrated, in accordance with an embodiment. The internal messaging application may include a graphical component 700, where the user can search for other users/employees/contacts, identify one or more recipients, and share the file with the identified recipients. When the user interacts with the graphical component 710 (“add message), the analytics server may display a graphical component 720 where the user can add customized messages and other attachments.

In some embodiments, an organization may use an internal (or third party) software solution to aggregate and consolidate all tasks, messages, and contacts across all connected tools (e.g., software applications used by users/employees). The analytics server may use that software solutions to transmit he requested file to the users. Additionally or alternatively, the analytics server may integrate its services into other software application. For instance, the methods and systems described herein can be implemented into other applications, such that users no longer need to use multiple applications.

The internal messaging application may also provide the user with the option to transmit the file via any third-party email or messaging system previously connected to the analytics server. As a result, the user may draft an email using the internal messaging application provided by the analytics server (e.g., while interacting with the file) and the analytics server may transmit the email by communicating with the third-party email application. The above-described method creates a significant positive user experience because the user is no longer required to interact with multiple interfaces and applications.

As described above, the analytics server/messaging application may also provide users with the option to transmit other workflow components. For instance, users may be able to share tasks, contacts, messages, and the like. For any unit of work, a user can easily share and embed the unit of work within a message. For example, conventionally, users may share emails with other users by forwarding the emails. However, using methods, systems, and software solutions described herein, a sender can share an email with a recipient else not included in the email message, without forwarding the email.

The GUI 500 may also comprise interactive component 530 comprising a status indicators illustrating a status of File XYZ. For instance, the interactive status indicators may indicate whether File XYZ is muted or “watchlisted.” A file can be muted, followed, or watchlisted. If a user has never interacted with a file, the user may never get any updates or notifications regarding that file. If a user has interacted with a file (e.g., modify a file, send a file, received a file, create a file, change permissions of a file), the user may get key updates regarding that activity around that file. In some embodiments, the updates/notifications may be transmitted to each user via a feed, such as an RSS feed delivered to each user, or via daily email overviews of all relevant updates. Users can also choose to manually follow or watchlist a file. When a user watchlists a file, the user may receive notifications, regarding all activity related to that file, including all of its copies and versions.

Through advanced settings, the user may determine to “hide” or “ignore” a file, meaning that the analytics server may not compare the file to other files stored within other electronic data repositories. Additionally or alternatively, the analytics server may not monitor a hidden or ignored file. However, when a file is watchlisted, the analytics server periodically monitors the file, as described above. The GUI 500 provides the user with the option to change the status of File XYZ by interacting with the interactive indicators.

The GUI 500 may also comprise a graphical component 540, which displays context information associated with File XYZ. Data displayed in the graphical component 540 may be retrieved from metadata stored within the nodal data structure and may include type, size, timestamp of creation, owner, an indicator of storage location, and different tags associated with file XYZ. Graphical component 540 may provide the user with the option to delete, add, and/or revise different tags. In some implementations, users can add custom metadata fields. In some configurations, the analytics server may further identify suggested tags for file XYZ based on related files and their respective tags. The analytics server may also suggest tags based on file content, file relationship, a user identifier, tags gleaned through user activity, and more.

The GUI 500 may further comprise a graphical component 550, which displays all the versions and copies (including the latest version) of the requested file permitted to be viewed by the user. For instance, the graphical component 550a displays that user 1 uploaded File XYZ one on Jun. 26, 2018. The graphical component 550b displays that the analytics server has identified a related file (e.g., a file with a matching unique identifier, as described above). As depicted in graphical component 550b, the related file name is File XYX, which is also a PDF file. The graphical component 550b displays that File XYX was identified in an email communication between user 1 and user 2 on Apr. 12, 2018. Furthermore, graphical components 550c-e indicate where File XYZ and File XYX are stored respectively. Even though the embodiment described here uses a related file that is the same file type as the requested file, in some configurations, a related file may not be the same file type. For instance, a PDF file stored in a first electronic repository may be stored in a second electronic repository as a document file.

As depicted in 550d, sometimes a file (or other workflow data) can be stored in a third-party data repository where the analytics server identifies the file by integrating with the third party. For instance, the file indicated in the graphical component 550d may be associated with third-party CRM and/or ATS software. The analytics server may provide additional metadata by integrating with these third-party software solutions, which can help contextualize files/workflow. For instance, if a file corresponds to a resume, the file may be referenced in an ATS software solution, which may be internal/native to an organization or may be a third party ATS solution. If a user interacts with the resume and his/her email, the analytics server may display context data associated with the resume, such as whether the resume is associated with a new hire in an ATS software (e.g., whether the resume is being considered for a first round or a second round of interviews), whether the analytics server has identified any additional nodes or files associated with the resume, and the like. In some embodiments, the analytics server may direct the user to the ATS software solution where the user can obtain more information and review related files/data.

In some configurations, each graphical component shown may be interactive. For instance, the user may click on any of the above-described graphical components and the analytics server may direct the user to the file represented by each respective graphical component. For example, if the user clicks on the graphical component 550c, the analytics server may retrieve a location of the email communication between user 2 and user 1 and may change component 540 to display details regarding the graphical component 550c. The analytics server may also open the message tab of GUI 500 and display the email communication on the GUI 500.

The graphical component 550 may also display a suggested related file (e.g., a version). As described above, the analytics server may periodically monitor all files accessible by all computers within a network (e.g., all computers within an entity or all registered users) to identify related files/content. When the analytics server identifies the related file/content, the analytics server may display the identified related file/content in the GUI 500. For instance, graphical component 500f indicates that the analytics server has identified File XYP, which is also a PDF file and is identified as related to the file XYZ by the analytics server. The graphical component 500f also indicates that file XYP was received in an email correspondence from user 3 user on Oct. 1, 2018. This is possible because the analytics server determines that file XYP may, for example, share an email thread with file XYZ and due to other similar metadata, it establishes that they are likely versions of each other. Alternatively, user 3 could have been working on file XYZ before (e.g., satisfying a predetermined time threshold) saving file XYP and therefore, by closeness of activity along with other considerations, the analytics server suggests file XYZ and XYP as versions of each other.

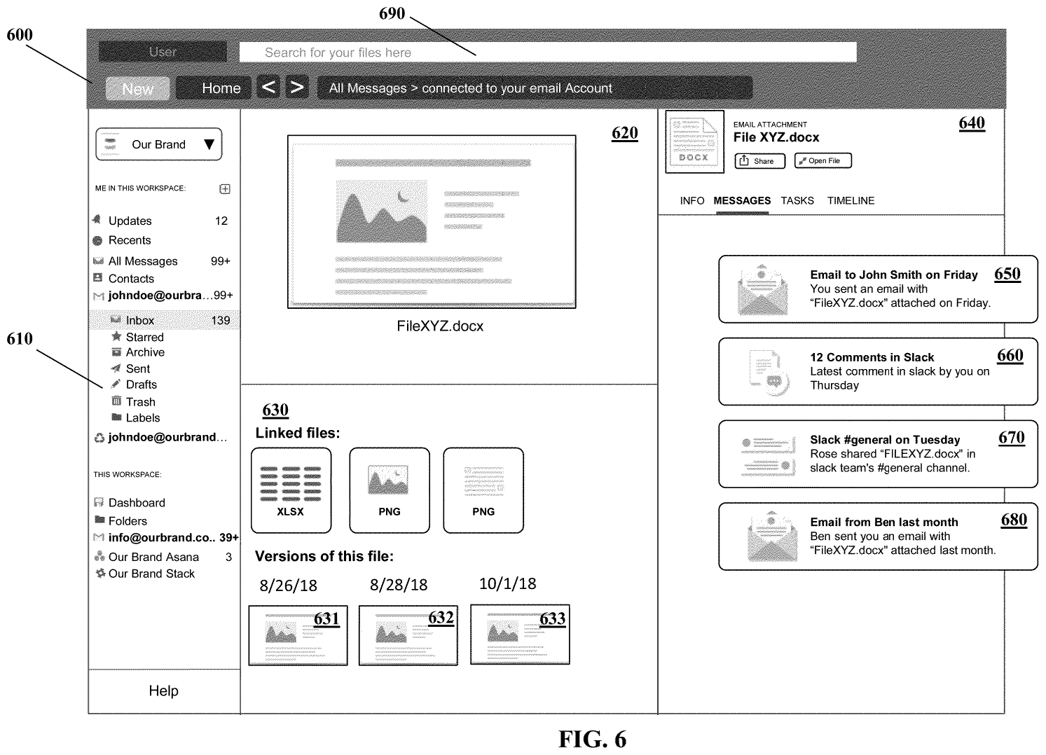

Referring now to FIG. 6, another example of a graphical user interface displaying file context information is illustrated. As described above, the analytics server may incorporate a graphical user interface displaying file previews and context information into a third-party application, such as a third-party email application, a third-party file sharing application, or a third-party project management tool. Additionally or alternatively, the analytics server may generate a web-based application (e.g., a website) and/or native desktop and mobile application where registered users can login to access and/or manage different files. The web-based application may incorporate other third-party applications, such as email applications.

GUI 600 represents a graphical user interface generated and operatively controlled by the analytics server. In the depicted embodiment, the analytics server incorporates data from third-party email, messaging, and other collaborative applications into the GUI 600. For instance, GUI 600 corresponds to a user who has previously registered and connected his or her third-party email, Slack® account, and Asana® account. As a result, the analytics server updates the graphical component 610 in real time by continuously querying the third-party email, messaging, project management, and cloud storage applications and populating the graphical component 610. As described above, the analytics server may utilize various web hooks and/or APIs instead of continuously scanning data repositories.

The GUI 600 depicts an example where a registered user has requested to access File XYZ by searching for the File XYZ using the search bar 690. As described above, the analytics server may perform the search using a search platform (e.g., Solr®), which maintains an index of all files, messages, tasks, and more across all of the data repositories including all third-party data sources. In some embodiments, the analytics server may augment the search results through an understanding of the interconnected nature of the nodes (e.g., how interconnected are the nodes). For example, the analytics server may execute a predetermined ranking algorithm and display the search results accordingly. Upon identifying File XYZ (by identifying a node that represents File XYZ within a nodal data structure), the analytics server populates the graphical component 620 that displays a “quick view” of the file XYZ.

The GUI 600 may also comprise a graphical component 640 that includes interactive hyperlinks/components where a user can open File XYZ or change the file's user permission and share a link directing recipients to access File XYZ. In this illustrative user interface, the graphical component 640 includes hyperlinks for info, messages, tasks, and timeline. Activating the info hyperlink can display information such as timestamp, author, version number, or the like. Activating the messages hyperlink, as shown in FIG. 6, can display messages containing File XYZ. Activating the tasks hyperlink can display tasks that contain or are related to File XYZ. Activating the timeline hyperlink can display a listing of chronological events and related projects associated with File XYZ.

Activating the deals hyperlink can display a list of all the deals a file is related to in CRM or other sales software (e.g., third party software), as well as other related data (e.g., what stage it is in, the people involved in those deals). Similarly, other hyperlinks could be added, such as project that correspond to the different data sources that might be connected to the analytics server. The GUI 600, including graphical component 640, thereby allows a user to consolidate and manage all updates, notifications, contacts, messages, tasks, and content on a single user interface in a more user-friendly manner.

The GUI 600 further includes a graphical component 630, which indicates suggested related files. In some configurations, the analytics server may display the suggested and/or related files, as shown in graphical component 630. The suggested (e.g., using soft factors) and/or related (e.g., using hard factors) files may be grouped and/or sorted based on different customizable categories. For instance, other files that are attached in the same email thread as File XYZ and other files that are a part of the same deal as File XYZ in a CRM could be grouped together. Furthermore, related files may be sorted based on file type. The graphical component 630 may also include “quick view” access to different versions of File XYZ. For instance, graphical component 630 comprises version 631 from Oct. 26, 2018, version 632 from Oct. 28, 2018, and version 633 from Oct. 1, 2018.

The GUI 600 further includes a message history of File XYZ, as illustrated by the graphical component 650-680. As described above, each graphical component within the GUI 600 may comprise an interactive component configured to direct the user to a file, a message, a task, or a person related to File XYZ. The timeline tab includes a history of all user activity events related to File XYZ and all of its versions, including but not limited to email messages, edits, downloads, and views.

For instance, the graphical component 660 indicates that File XYZ is associated with 12 comments on a third-party project management application. When the user clicks or otherwise interacts with the graphical component 660, the analytics server displays each comment on the GUI 600. The user can easily respond to comments from any third party system (e.g., a task management application) in which the file was uploaded to, or used in a chat conversation. In another example, when the user interacts with the graphical component 650, the analytics server displays the email communication between the user and John Smith.

In a non-limiting example, the analytics server scans data accessible to all computers within a company where the data is stored onto multiple electronic repositories. Upon identifying all files stored onto different electronic repositories, the analytics server executes a hashing protocol for each identified file to generate a unique identifier for each file. For references to files or websites (e.g., links shared in email messages, website bookmarks, file shortcuts, etc.), the analytics server identifies different unique identifiers such as file path, a URL, or a third-party party system's unique ID. The analytics server further creates a nodal data structure where each node represents an identified file and contains metadata indicating data associated with each file. The analytics server further compares the unique identifiers for all the identified files. When two files have matching unique identifiers, the analytics server updates the nodal data structure by linking the nodes representing the two files as copies of one another.

The analytics server may further scan other data sources with varied metadata, such as messaging systems, task management tools, and the like. The analytics server may also update the nodal structure to relate (e.g., link/merge) multiple files that share emails, messages, tasks, and activity events for example. Similarly, the analytics server can generate unique identifiers for other types of data/units of work, including but not limited to messages, tasks, contacts, calendar events, and notifications in order to link/de-duplicate units of work that are the same across different systems. For example, a URL that points to a task within a project management tool can be found within an email message and that same task could be otherwise indexed by the analytics server directly from the project management tool (e.g., via the project management tool's API), such that the analytics server links the unique URL for that task with the indexed task in the database.

The analytics server periodically scans (or receives updates via API or web hooks) the electronic repositories and iteratively updates/revises the nodal data structure based on comparing unique identifiers of all the units of work and linking appropriate nodes. When a user operating a computer within the company requests to access a unit of work, the analytics server retrieves the nodal data structure and identifies a node representing the requested unit of work. The analytics server also identifies related nodes and context data stored on the node's metadata (representing the requested unit of work). The analytics server then displays detailed information associated with the requested unit of work. For instance, the analytics server displays all the versions (including a latest version) of a requested file, related files, related tasks, related people, email communication related to the requested file, and the like.

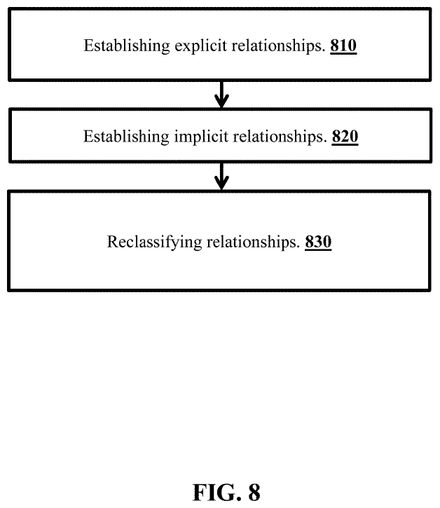

In addition to identifying related files and workflow components using explicit relationships (hard factors) described in FIG. 2, the analytics server may also use a variety of methods to identify related files and workflow components using implicit relationships (soft factors). FIGS. 8-12 describe a variety of methods utilized by the analytics server to identify related content (e.g., files and workflow components) using data associated with each file. The analytics server may monitor context data associated with files and workflow components. For instance, the analytics server may monitor how various files were shared among users and/or edited/accessed by each user. The monitored context data is sometimes referred to herein as the soft factors or implicit data. How users interact with files and workflow components may indicate whether they are related to each other or to a particular project.

As will be described herein, the analytics server may use artificial intelligence (AI) and machine learning (ML) modeling techniques to identify related content. For instance, the analytics server may calculate a likelihood of relatedness for different files based on implicit data (e.g., user interactions). If the analytics server identifies, within a reasonable degree of certainty, that a node corresponding to a file or workflow component is related another node, the analytics server may link the related nodes.

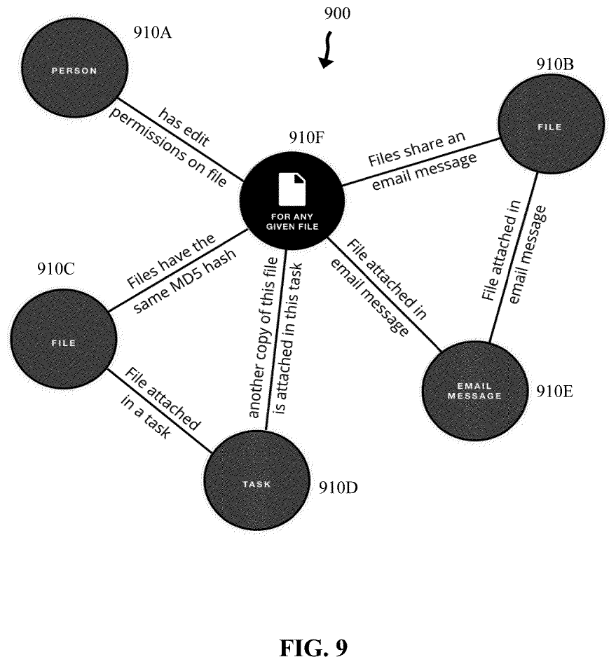

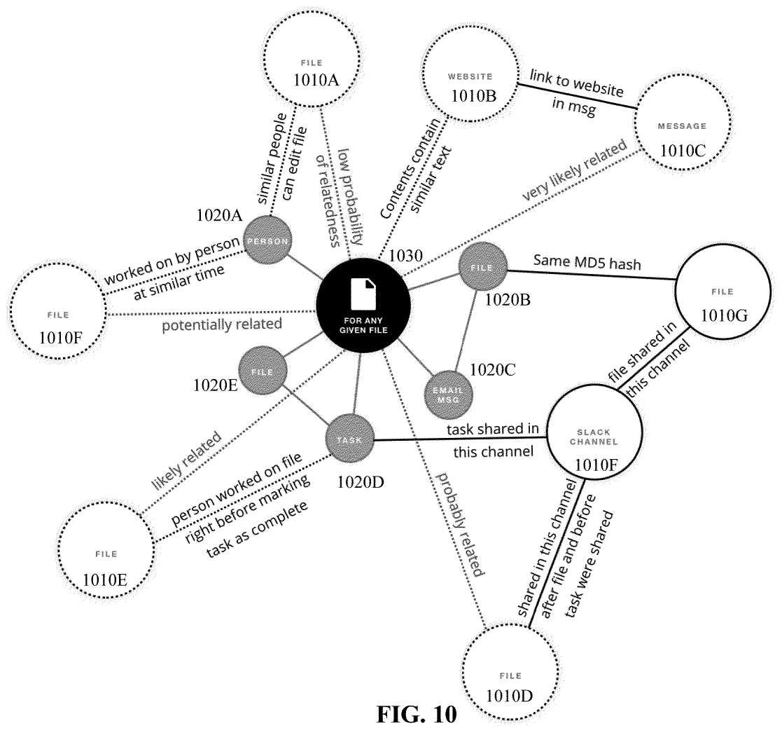

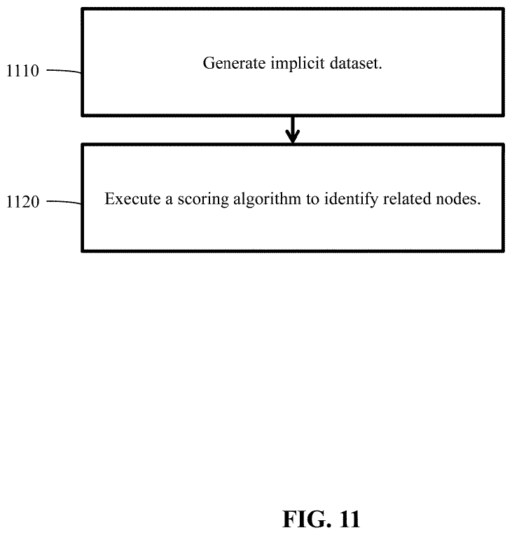

As illustrated in FIG. 8, the analytics server may use a three-step process to identify related content and to establish relationships between related nodes within the nodal data structure. At step 810 (as illustrated in FIG. 9), the analytics server establishes explicit (e.g., known data or hard factor) relationships between nodes. At step 820, (illustrated in FIG. 10) the analytics server establishes relationships between nodes based on implicit data (e.g., soft factors) by calculating a relative distance/measure between nodes. At step 830, (illustrated in FIG. 11, the analytics server reclassifies types of relationships between nodes that are close to one another according to user needs/use cases. The reclassification can put more abstract labels that might better align with user needs/use cases.

Upon identifying related nodes, the analytics server may append the identified relationships as metadata to each node. For instance, the analytics server may identify related information (e.g., electronic messages, files, other users, tasks, calendar events, and notes) for each node. The analytics server may then generate metadata for each node that corresponds to the identified relationships. In some configurations, the analytics server may also de-duplicate nodes by comparing unique identifiers, such as email addresses for contacts to generate a more efficient graph (nodal data structure).

Although examples and embodiments described herein relate to files and workflow components, the methods and systems described herein can be configured, such that the analytics server identifies related nodes that correspond to a person, user, contact, message, task, etc.

At step 810, the analytics server may use a variety of methods to establish a connection between nodes based on explicit and known context data associated with different nodes. For instance, the analytics server may use method 200 described in FIG. 2 to retrieve relevant data associated with each node (corresponding to different files and/or workflow components) and may establish proper connection within the nodal data structure accordingly.

At step 810 (e.g., explicit relationships or hard factors), the analytics server connects different nodes corresponding to related files through explicit relationships. The most basic relationship considers the MD5 hash fingerprints of each file to identify all copies of one file across different systems (e.g., data repository and/or software applications). If the hashes of the two files match, the analytics server assumes that they correspond to the same file. Other types of relationships are built between files that are attached in the same email or email thread, files that are attached in the same task, files that are referenced in another's comments, and so forth. Activity and relationships from different copies of the same file are consolidated to enable more relationships to be created.

Referring now to FIG. 9 a visual representation of connected nodes is illustrated. FIG. 9 illustrates a set of nodes where the analytics server identifies as related based on known factors, such as being attached in a monitored electronic communication or having a matching unique identifier. As depicted, the analytics server may establish known links between nodes in the graph 900. Each node may represent a file, user, or a workflow component. For instance, the node 910A represents a user, nodes 910B/C/F represent different files, node 910D represents a task, and node 910E represents an email message.

Using methods and systems described herein, such as method 200, the analytics server retrieves context data associated with each node. The analytics server uses MD5 hashing methods to identify that node 910F is related to node 910C. The analytics server then connects nodes 910D to 910F because a copy of the file corresponding to the node 910F has been attached to the task corresponding to the node 910D. The analytics server also connects nodes 910E and 910B to the node 910F because an email attached the same file as 910F. Finally, the analytics server connects the node 910A to the node 910F because a person corresponding to the node 910A edited the file corresponding to the node 910F.

Referring back to FIG. 8, at step 820, the analytics server may connect various nodes using implicit relationships among files, users, and workflow components. This process is also referred to herein as implicit relationships or soft factors. In this step, the analytics server gathers and stores all user activity across systems and services. The methods and systems described herein leverage this monitored and collected user activity data to deduce implicit feedback, which is then used to expose unknown relationships between files. As a result, the analytics server does not have to rely on known relationships (hard factors) or user input to link different nodes. Implicit feedback can also augment explicit feedback/relationships. Moreover, the analytics server is also able to find relationships between nodes that are unknown to users.

As will be described herein, the analytics server may use various scoring algorithms to identify a likelihood that a pair of nodes are related. If the likelihood of relatedness satisfies a threshold (e.g., two nodes are highly likely related, such as 80% possibility that the nodes are related), the analytics server may revise the nodal data structure by linking and/or merging the corresponding nodes. If the likelihood of relatedness does not satisfy the threshold (e.g., there is a 50% possibility that the nodes are related), the analytics server may suggest the nodes as related or may not link the nodes.

As described above, the analytics server periodically monitors files and user activity within a network. The analytics server periodically collects user data (e.g., edit histories, communication histories, files revisions, time of revision, electronic communications, location/device metadata, current open window (e.g., analytics server windows/smart windows) and generates a nodal network that represents relationships between files, messages, tasks, people, websites, and other types of information.

The analytics server may then consolidate timelines of activity around each user. Consolidating timelines may be technically challenging. For instance, a third party data repository application (e.g., GOOGLE DRIVE) may not currently give third party applications (e.g., analytics server) information related to what a given event represents. Instead, the third party data repository application indicates to third party applications that there was a change to some file, without any information about what that change was or who performed the action. Therefore, in order to discern the details around who performed what action, the analytics server needs to execute comparisons protocols and data correlations.

In a non-limiting example, the analytics server has previously indexed File A, and in that record, File A is shown as a private file without any shared permissions. Therefore, if the analytics server identifies that a “change” was made to File A as described above, it is able to compare the previous version of File A with the new version of File A and determine that the permissions were changed and that the original owner shared the File A with a new “person X.” Furthermore, the analytics server may compare other fields in the index, such as a hash of the file's contents to determine if the file was revised.

In some configurations, the analytics server may not be able to discern the actor or the action simply by comparing the old index record with the new information from the third party data repository application. For example, if the “file A” was previously shared with multiple people, it may not be possible to know which of those people truly shared the file with person X. The analytics server may coordinate partial information from different systems, for example, by analyzing email messages to identify if there was an email notification indicating “person Y shared file A with you (person X)” or by tracking activity on local systems and identifying that a given user edited a file. The analytics server may augment the database/index of consolidated activity by tracking and/or scraping information from user's web views/screens/computers/applications as they work normally within those systems.

In order to identify whether two nodes are related, the analytics server may first generate an initial label that includes data indicating that two files may be related (also referred to herein as implicit dataset or implicit feedback dataset). The analytics server may then use a file correlation algorithm and/or scoring algorithm to generate a score that represents a distance between two nodes. In order to achieve this, the analytics server may execute various scoring algorithms and or AI/ML models.

As described herein, the analytics server may execute various analytical protocols to identify whether two nodes are related. The analytics server may only link two nodes when the analytics server has determined a likelihood of the two nodes being related that satisfies a threshold. For instance, the analytics server may execute various analytical protocols described herein to identify whether two nodes are related. If the likelihood of two nodes being related satisfies a predetermined threshold (e.g., the analytics server can confidently determine that the two nodes relate to each other), the analytics server may link the corresponding notes.

The predetermined threshold may correspond to a confidence score generated by the analytics server that identifies a likelihood of the two nodes being related. The system administrator or an end user can revise the predetermined threshold. When the predetermined threshold is increased, the analytics server may only link nodes when the confidence score is higher. For instance, a predetermined threshold of 80% may require the analytics server to only link nodes if the analytics server identifies (with an 80% confidence) that the two nodes are related.

For possible related nodes that do not satisfy the predetermined threshold, the analytics server may link the nodes, such that the nodes are “suggested” as related. As will be described herein, the analytics server may suggest related files/workflow components to the end user. If two files are merged, the analytics server has determined that the two files are related. However, if the analytics server determines that two files are likely to be related, instead of merging/linking their corresponding nodes, the analytics server may link the nodes. When displaying results, the analytics server may then suggest the nodes as related, whereby the end user is informed that the two files may be (but not guaranteed to be) related.

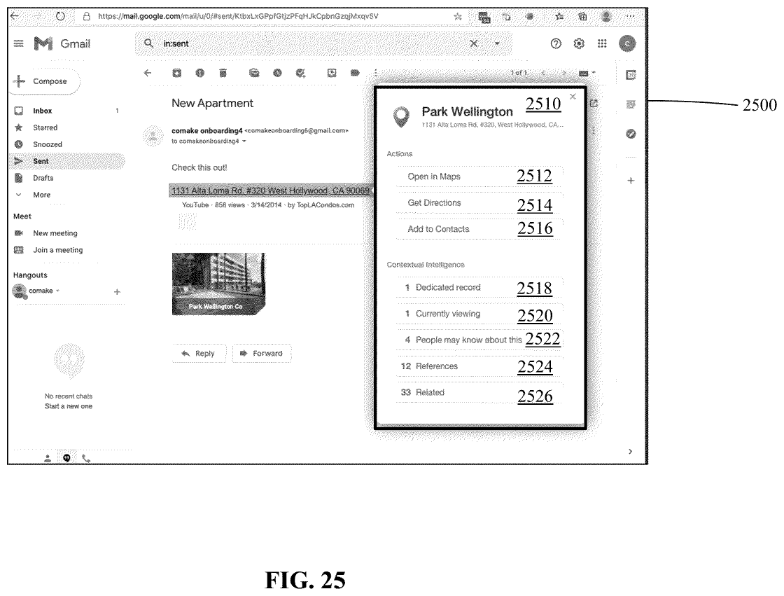

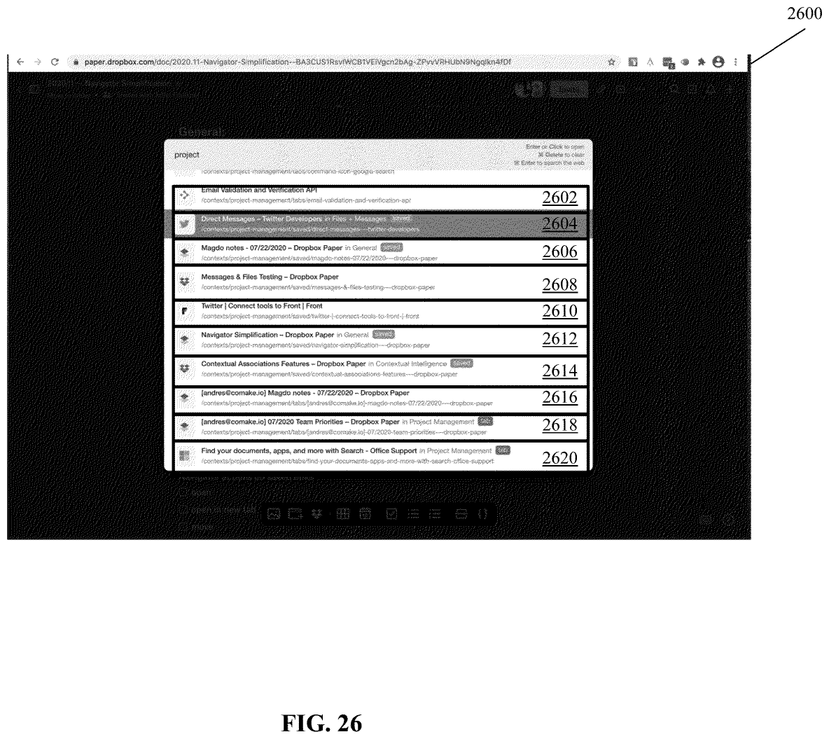

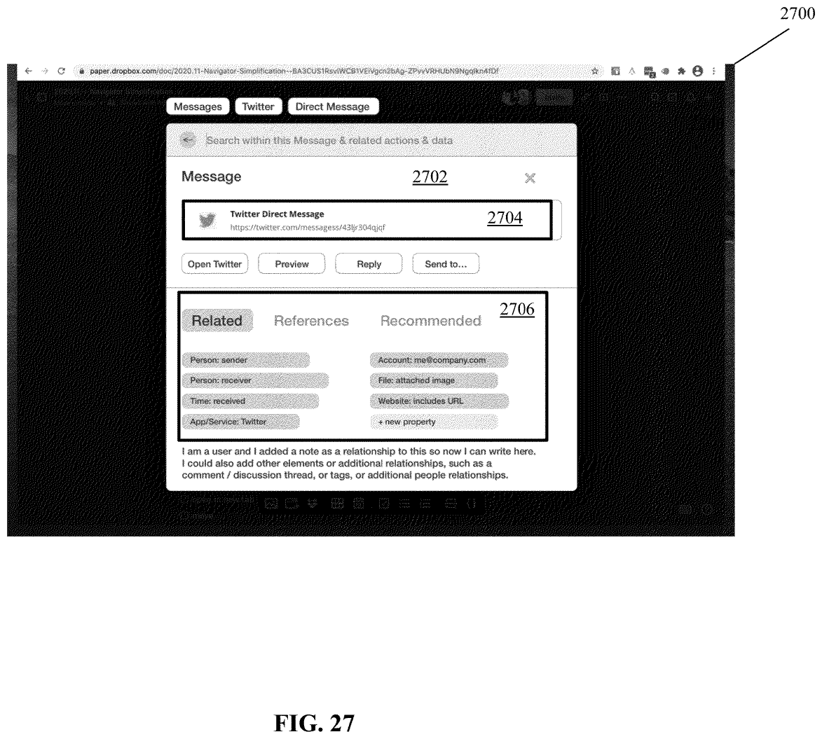

For instance, as illustrated in FIGS. 26-27, the analytics server may display a software platform with a user's existing software applications and accounts (e.g., email accounts or a homegrown file management software). The displayed interface may show related files grouped by context or project (FIGS. 25-26). The platform provided by the analytics server also allows users to consolidate all relevant files such that users can easily work across accounts. For instance, even if different files are stored within different platforms, a user may access them (if they are designated as related) using the same platform (FIG. 27).

The information that the analytics server indexes, correlates, and contextualizes can also be queried and accessed via API by any number of third party software products and tools. In this way, the data augmentation can be used to enrich workflows within, for example, a user's favorite email client or task manager.

### Initial Labeling

The analytics server may generate a set of predetermined features/indicators that indicate whether to nodes may be related. This initial labeling may create a weaker/noisier signal that the analytics server may improve using ML and reinforced learning. The type of nodes (files, messages, users, tasks, notes, etc.) may have some impact on how the analytics server generates the initial labeling. The analytics server may generate an implicit feedback dataset. The analytics server may execute various analytical protocols (e.g., scoring and AI/ML models) using the implicit feedback dataset to identify whether two nodes are related.

The implicit feedback dataset is based on gathering observations that indicate possible relationships between nodes. When a user performs an action using a software tool connected to the analytics server, an event is added to the analytics server graph and passed to the file correlation algorithm, or corresponding algorithm if dealing with non-file/other types of nodes. In a non-limiting example, the analytics server may group events together by a heuristic the analytics server call “session groups,” which can be easily understood as a session. All the files and units of work that are worked on by a given individual within the same session are grouped together into a “session group.” An assumption is that files that appear in the same “session group” more often have a higher chance of being related. File pairs with a high chance of being related may receive a higher “relationship score” than files that do not. The output is a data frame with a preliminary relationship score for every file-file pair.

Session grouping allows the analytics server to identify different files and units of work as possibly related. As discussed herein, the analytics server may monitor different interactions by a user and group them together within the same session. For instance, a user may initiate a chat session with a second user, generate a document file, attach the file in an email, send the email to a third user, and interact with a billing software. As a result, the analytics server may group the generated document, the chat session, information associated with the first, second, and third users, content of the email, and file associated with the user's interaction with the billing software together in a session group.

The analytics server may also provide explicit suggestions for files in addition to the implicitly generated suggestions. These may include the linked nodes of a particular nodes' other linked nodes that might have been shared with a user immediately before and/or afterwards by the same person. In another example, files that might have been shared immediately before and afterwards in a chat session may also be designated as related. Lastly, the analytics server takes this pool of implicit and explicit suggestions and linked files, and compares the metadata such as names, file snippet, file contents, and/or mime types to determine whether to suggest files as versions.

In an example, the analytics server generates an initial labeling (e.g., implicit feedback dataset) indicating that two nodes are related based on idle time. An idle time may refer to a scenario where two nodes have successive activity events by the same person within a predetermined amount of time (e.g., less than 45 minutes). Time logging data entered or confirmed by a user can be used to influence a relative score between two nodes.

In an example, the analytics server generates an initial labeling indicating that two nodes are related based on open or used applications on a user device. Users can open locations, files, nodes, contacts, applications, etc. within analytics server's software tools or windows (or sometimes third party application monitored the analytics server). Having these elements listed above open in the same analytics server window (or external window, third party browser window) can influence a relative score between them.

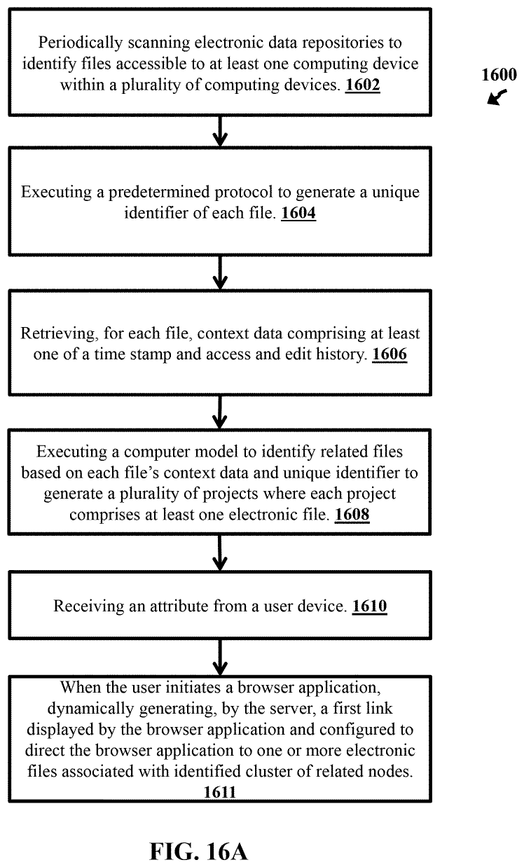

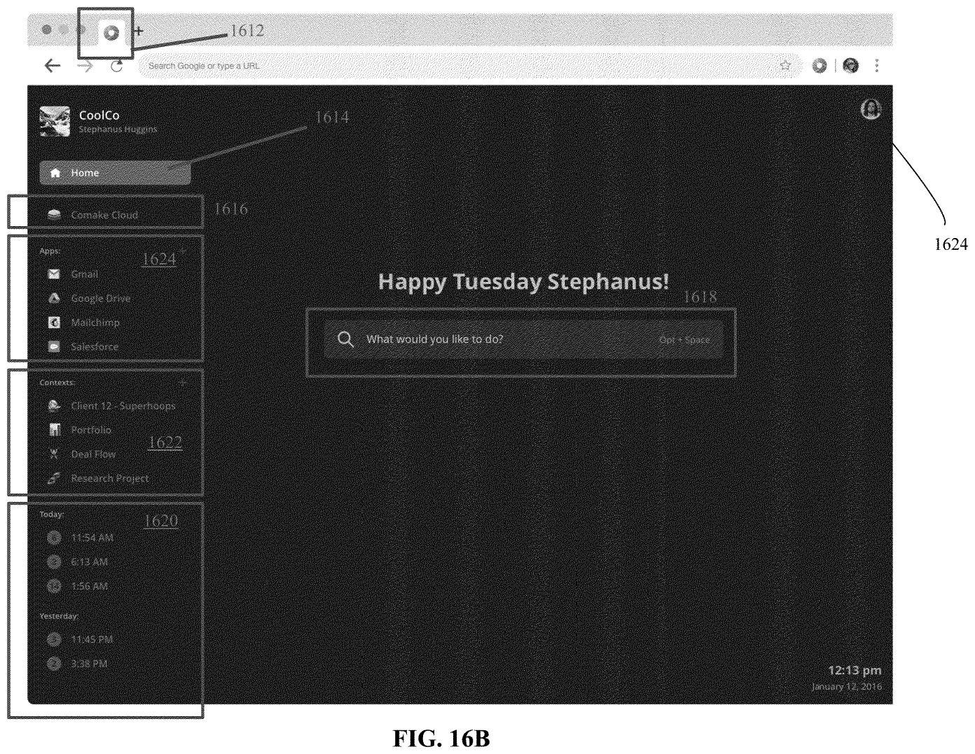

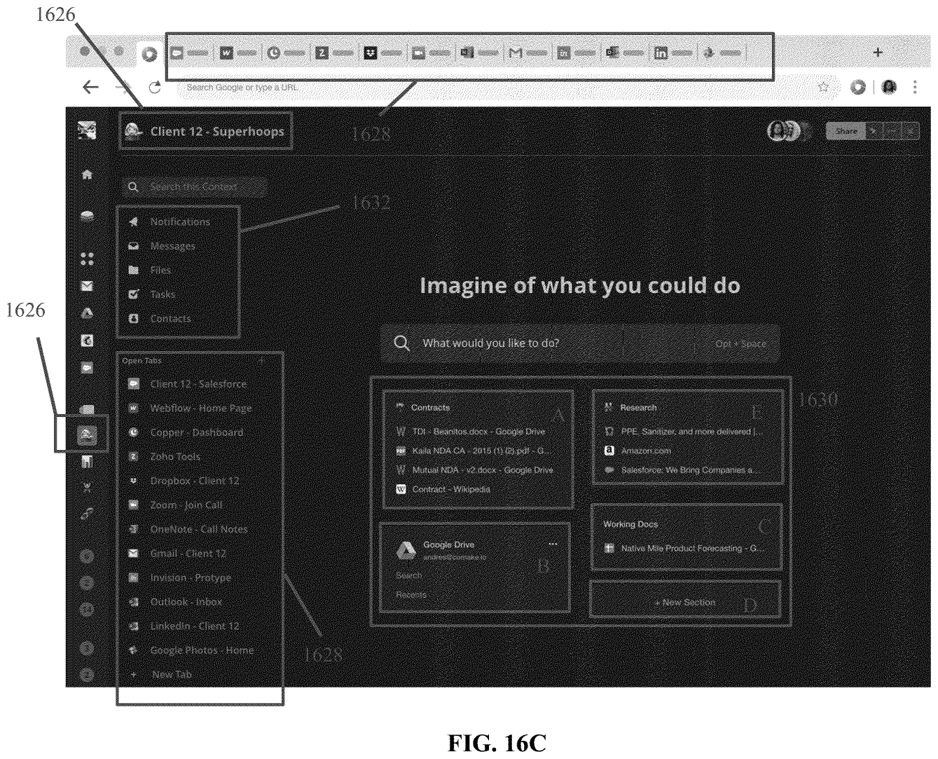

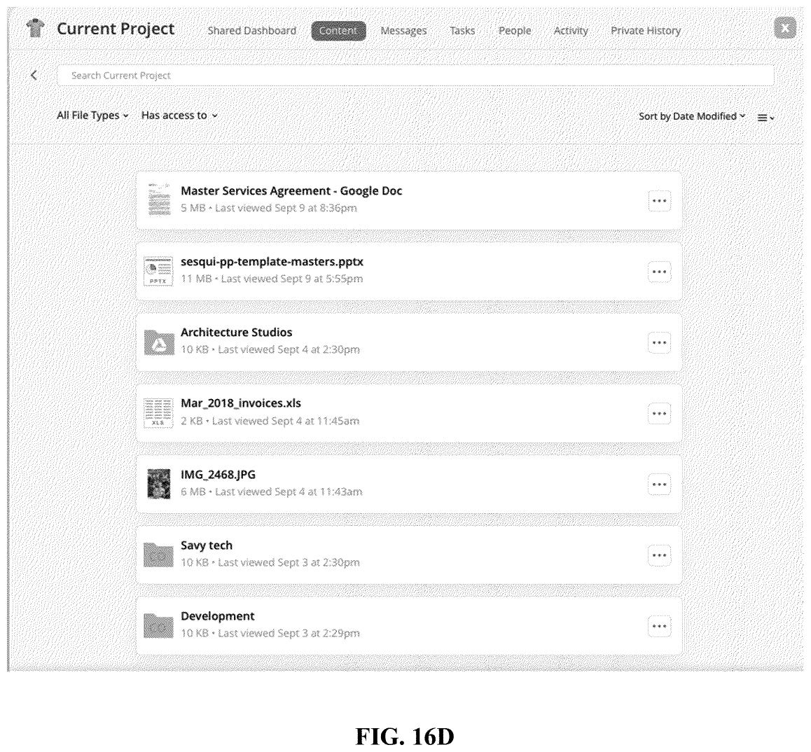

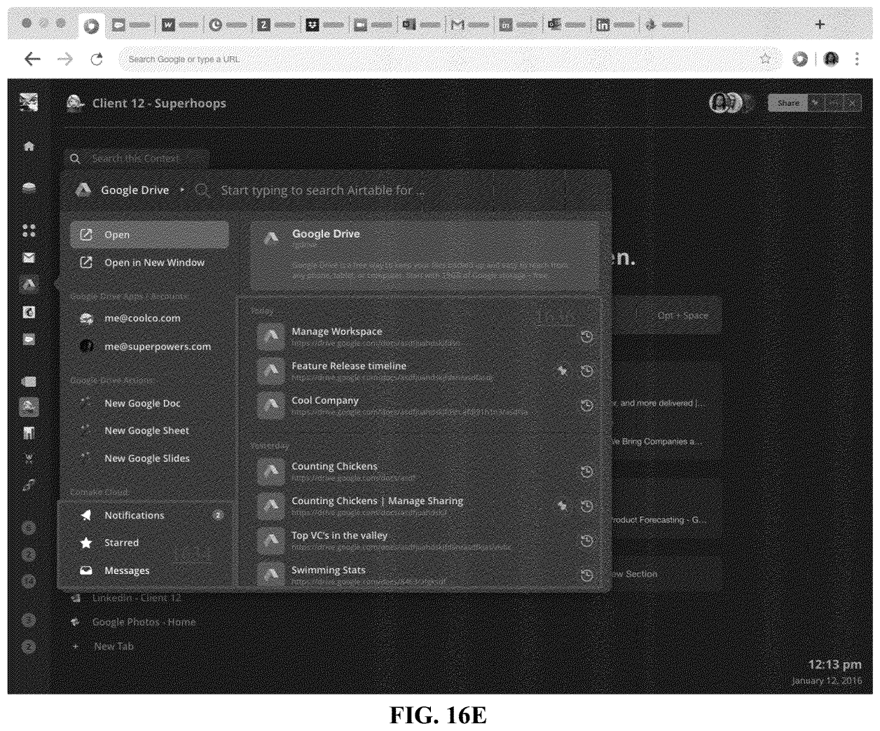

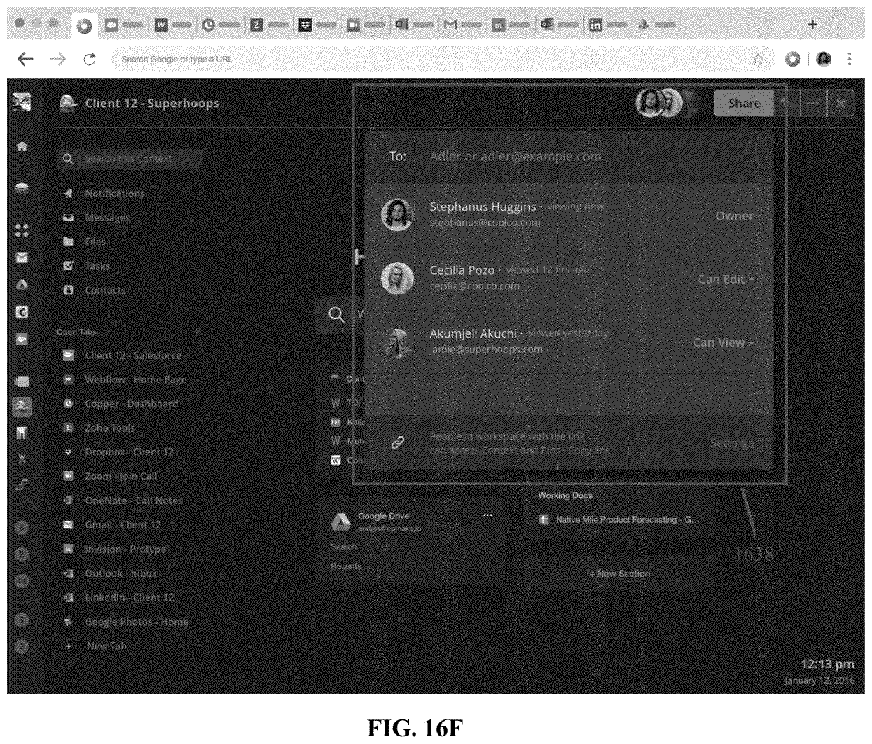

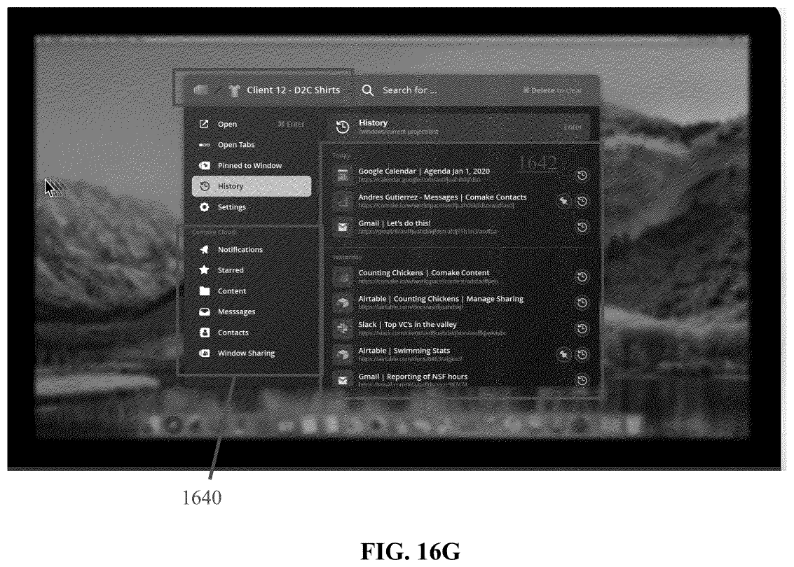

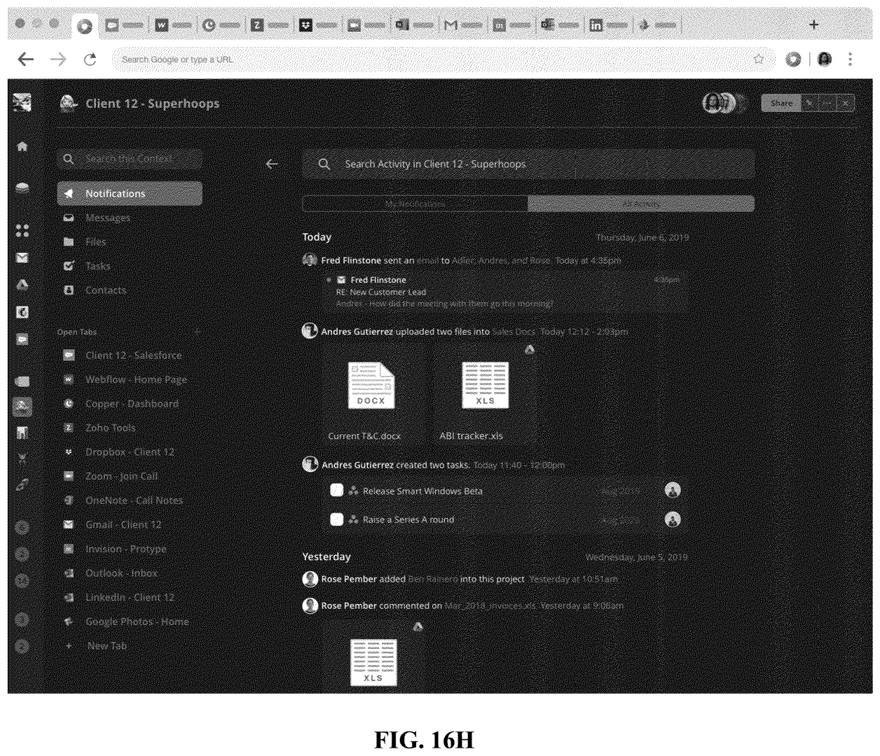

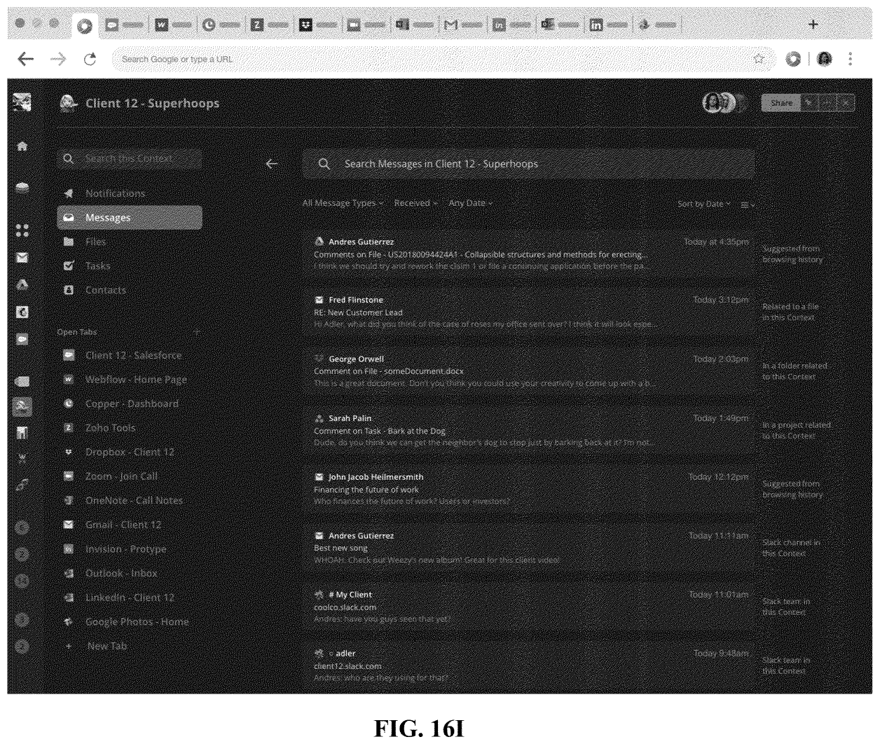

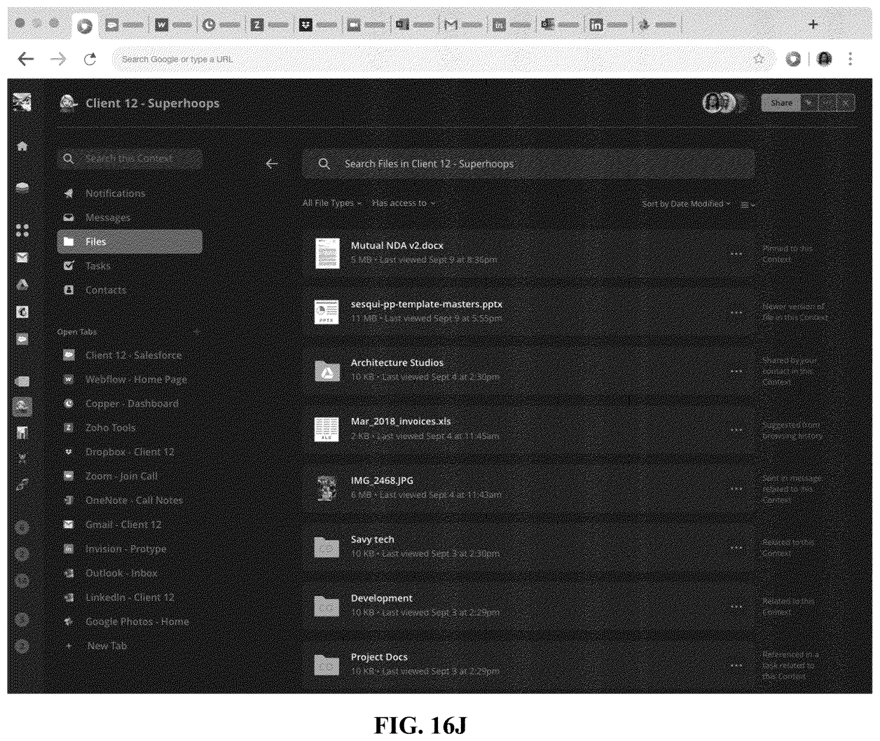

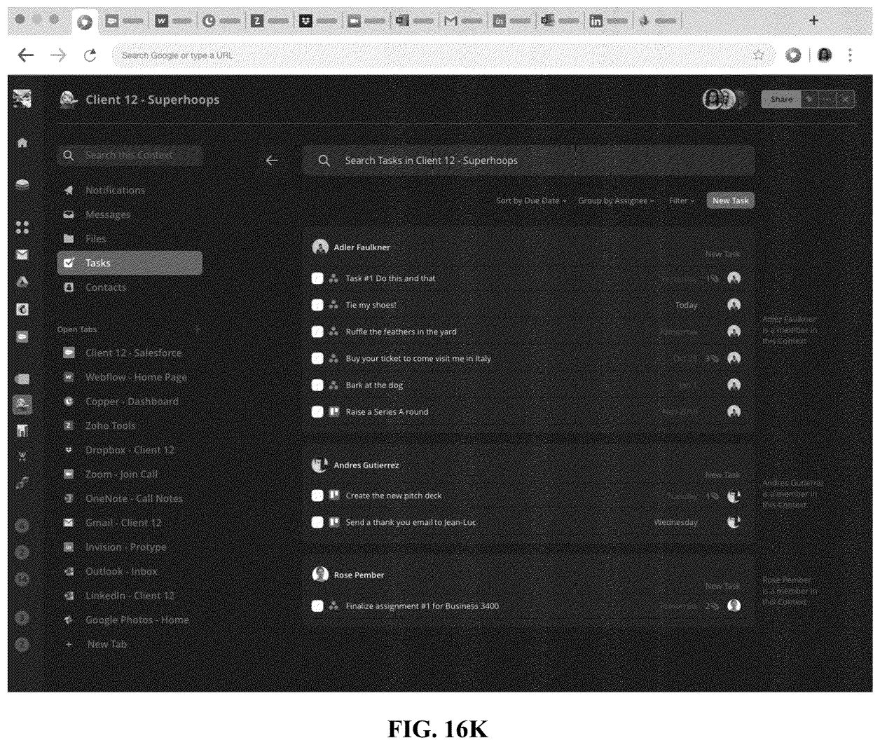

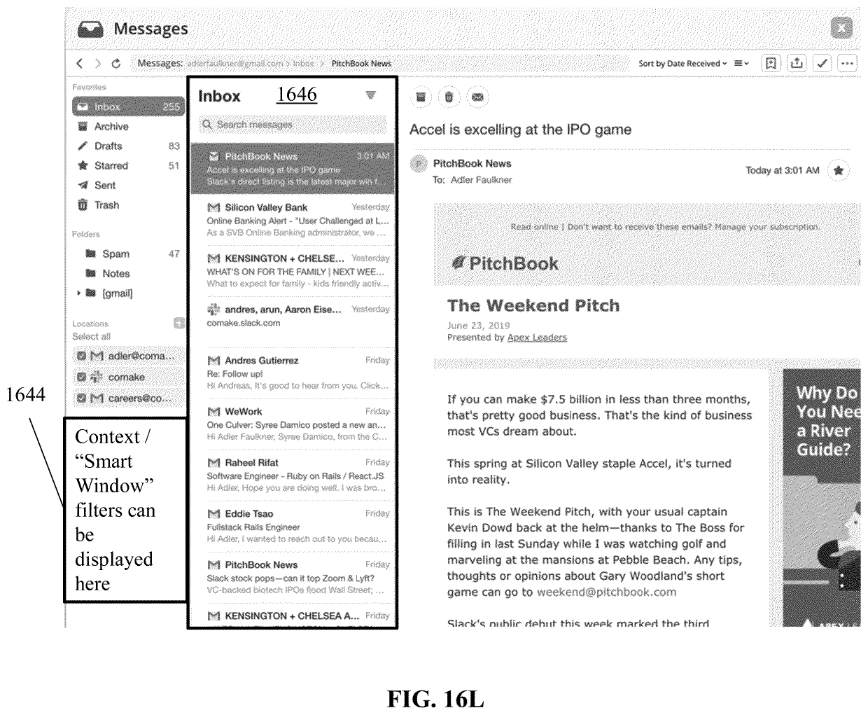

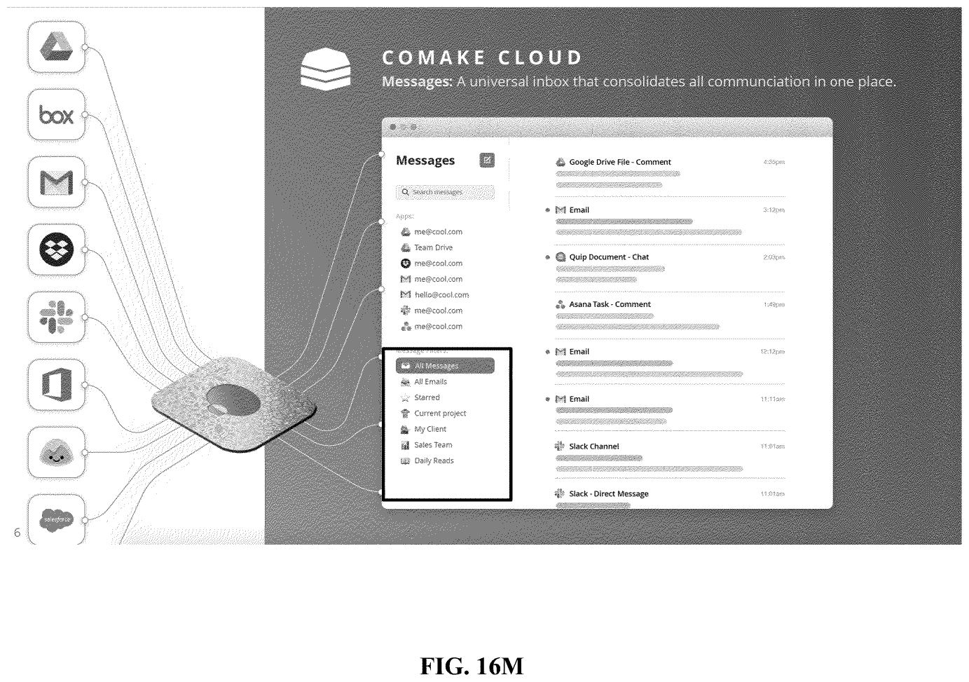

In another example, the analytics server generates an initial labeling indicating that two nodes may be related based user associations. Users can associate locations, files, nodes, contacts, applications, a given account for an application, etc. with graphical user interfaces provided by the analytics server (e.g., smart windows described in FIGS. 16A-M). If both elements have a hard relationship (e.g., pinned to the window, added as a source for the window, etc.) with an analytics server window, then they are more likely to have a higher relative score (e.g., closer distance) between them.

If elements A and B are recommended to the same smart window C (e.g., based on soft factors) then the analytics server generates a relative score between A and B indicating that they may be related. Other soft/implicit factors may include being viewed in the same window/application.

The analytics server may also retrieve additional data associated with each node. Non-limiting examples of data retrieved may include existing relationships between nodes (e.g., other connected nodes). The analytics server may also retrieve location information, IP address, device, ID, and other data associated with different electronic devices that accessed the files/data.

The analytics server may also consolidate activity for a given user and may create relative scores between units of work because of closeness of a user's activity around them (e.g., file edit history). The types of activity events performed by users may also influence the relative score between nodes. For instance, if a user edits File A, reads File B, edits File A, reads File B, the analytics server may create a higher relative score indicating a higher likelihood of relatedness than if the user reads file A, reads file B, and reads file C.

The analytics server may also use various scoring algorithms (that can be revised and tuned by a system administrator) to generate a score indicating whether two nodes are similar. For instance, the analytics server may use the score to identify users who may know information related to a file (e.g., workflow component). When a user accesses a file, the analytics server may recommend a user who is associated with the file (“other users who may know about this”). The analytics server may rank users based on their respective scores and may recommend a top portion of the ranked users (e.g., top 5 users). To generate the score, the analytics server may attribute 1.5 points per collaboration on messages that user has sent; 1 point per collaboration on messages that user was in “To” field/sent slack message; and 0.5 points per collaboration on messages that user was in “CC” field/was recipient in a slack direct message. To identify and score related content, the analytics server may assign 0.75 points per collaboration on copies/versions that user has activity on; and 0.5 points per collaboration on copies/versions that user has no activity on.

The analytics server may automatically link nodes that correspond to files and workflow components in accordance with the following rules:

Shared email message: if file A and file B share an email message;

Shared email thread: if file A and file C share are in two emails within the same thread;

Shared chat message: if file A and link B share a chat message;

Shared message thread: if file A and file C are in two messages within the same thread; and

Shared task: if files A and B are attached or referenced in the same task.

### File Relationship Algorithm

The analytics server may execute a file relationship algorithm to identify/recommend relationships among nodes. The analytics server may leverage the history of relationships stored within your connected locations to build newly suggested relationships. As used herein, a connected location may refer to an application that is integrated into the methods and systems implemented using the analytics server. For instance, a third party messaging application, desktop folders, cloud server, an organizations internal and/or external CRM software tools, may all be considered as connected locations.

Furthermore, consolidating user activity allows the analytics server to loosely suggest implicit relationships between files that are worked on at similar times. The analytics server then uses these explicit and implicit relationships between files as a starting point over which a collaborative filtering model is executed to provide recommendations (e.g., identify related nodes).

The observational data gathered from implicit feedback may not be used directly to provide sophisticated recommendations, and is therefore used primarily as preliminary data. This is because implicit feedback may have certain characteristics that must be accounted for to get meaningful suggestions. For instance, implicit datasets may not provide negative feedback without additional processing (e.g., if there is no registered interaction between files, then the “missing data,” or the lack of a relationship between file pairs is not addressed without further processing). In another example, implicit feedback may be noisy. In another example, the relationship score between two files may only indicate the system's “confidence” over the existence or non-existence of a relationship, and may not provide the actual strength of the relationship.

A visual representation of possibly related nodes is illustrated in FIG. 10. In the nodal data structure 1000, the analytics server identifies some nodes as related using explicit factors. These relationships are illustrated using solid lines. For instance, nodes 1020A-E are related to the node 1030. The nodes 1020A-E may represent similar nodes as the nodes 910A-E illustrated in FIG. 9. The analytics server may identify other related nodes using explicit relationships. For instance, the node 1010G is relate to node 1020B because of a similar MD5 hash value. The node 1010F is also related to the nodes 1010G, 1010E, and 1020D. Similarly, the nodes 1010C and 1010B are related.

The analytics server also identifies that some nodes are possibly related due to implicit relationships. These relationships are illustrated using dashed lines. For instance, the analytics server identifies that the node 1010A-E may be related to the node 1030. The analytics server may also designate a likelihood of the nodes being related based on the type of implicit data. For instance, the node 1010A has a low likelihood of being related to the node 1030 because similar people can edit the file that corresponds to the node 1010A. In contrast, the file that corresponds to the node 1010D is likely related to the node 1030 because the file has a solid line (e.g., hard factor) relationship with the node 1010F, which has a solid line relationship with the node 1020D, which has another solid line relationship with the node 1030.

### Scoring/Imputing

After initial labeling, the analytics server may calculate a compiled relative score between nodes (e.g., between files and other files, between users and other users, and items to identify whether they are related). As described above, the analytics server may generate an implicit feedback dataset that includes all retrieved context/session data (step 1110 in FIG. 11). The analytics server may then execute a scoring algorithm to identify whether the nodes are related (step 1110 in FIG. 11). The analytics server may also execute one or more computer models configured to identify whether the nodes are related. The models may employ artificial intelligence and machine learning algorithms to determine a likelihood of relatedness for each pair of nodes using the implicit data previously retrieved.

The AI/ML models may be trained using training datasets (e.g., ground truth datasets) that represent known related nodes. Once trained, the models can be executed to identify whether two nodes are related. The analytics server may also periodically monitor the model's outcome to retrain the models based on identifying false positive and revising various algorithms utilized by the models.

The analytics server may generate a score matrix based on the implicit dataset. For instance, the analytics server may generate an element-element co-occurrence matrix by aggregating over all sessions and calculating: X_ij:=(Count of distinct sessions where both element i and element j had events).

In this sparse symmetric matrix, X is factored into UV′ using an appropriate numerical method, such as Alternating Least Squares provided by implicit package, although other algorithms may also be used. The number of columns for U may correspond to a tuning parameter chosen by k-fold cross validation. The analytics server may then apply a Regularization algorithm (e.g., alpha is also chosen by k-fold cross validation). The number of iterations is a nuisance parameter. In some configurations, the analytics server will warm start the factorization updates.

The analytics server may employ the following method to achieve the above-described results:

Step 1: Related files are determined by scoring an element;

Step 2: File Detail view makes request to recommender micro service;

Step 3: Identify element i for a given file;

Step 4: Calculate predicted scores of X_i* by multiplying U_i×U;

Step 5: Filter out all element pairs, which are explicitly linked elsewhere in the graph;

Step 6: Take top 20 remaining elements;

Step 7: Filter out all elements scoring below threshold \tau (where \tau determined via cross-validation);

Step 8: Return elements that remain as JSON;

Step 9: Mapped back to files by Web server.

In that embodiment, the analytics server may generate groupings of files that were worked on by the same individual during similar times. These groupings are called “session groups” (e.g., context data associated with the event) and are created by querying the database and/or the nodal data structure for activity events recorded in timelines for each file. Different types of events over files can have different relative weights corresponding to how important they might be within a given “session groups.” For example, receiving a file during a given work session will have less impact to an “session groups”, than viewing a file during that same session, which in turn has less impact than editing a file during a given session. The matrix is then factored into X=UV′, where U and V are n by k matrices and k and λ factors are selected via cross validation methodologies. When the analytics server generates a score for file i, scores are calculated (e.g., UiV), sorted descending, and filtered based on a threshold.

As previously described, the implicit dataset may be noisy, which may lead to incorrect results. To address this issue, the analytics server may various curve-smoothing methods. For instance, the analytics server may use the collaborative filtering technique described in the paper “Collaborative Filtering for Implicit Feedback” (Hu et al., 2008). This technique relies on using Alternating Least Squares to minimize a loss function. Alternating Least Squares method exploits the algebraic properties of the loss function to minimize it in linear time. Smoothing in this way generates recommendations that are more accurate given the nature of implicit feedback datasets. In some other embodiments, the analytics server may utilize a stochastic gradient descent method.

To improve the scoring process, the analytics server may also include explicit relationships among nodes into the model before smoothing the data points. In some configurations, the analytics server may execute the model to generate two sets of recommendations, based on two different scores (one from explicit suggestions, and the other from smoothed implicit data points). The analytics server may combine these scores and generate only one set of recommendations that take both implicit and explicit data into account.

In some configurations, additional factors can be taken into consideration in scoring the relationships between nodes. For example, the analytics server may add weights to different types of events that are used in creating implicit relationships between nodes. This assumes that certain activities are stronger indicators of relationships than others are. The analytics server could also use types of events between nodes to suggest types of relationships. For instance, the analytics server can adapt an approach that also analyzes other metadata, such as email content surrounding the files, common collaborators between files, common folders that contain both files, and the like. The analytics server may compare text-related files using low-dimensional vector representations of them. Similarly, the analytics server may calculate semantic similarity between units of work (e.g., documents, files, messages, tasks, etc.) to find text-based similarities, which may indicate that two components or work are similar and/or related.

### Labels and Scores Change Over Time

Referring back to FIG. 8, at step 830, the analytics server may periodically reclassify and relabel nodes to achieve better results. The analytics server improves the quality of initial labeling and the AI/ML powered scoring by considering user behavior. For example, the analytics server may provide an option for users to accept and/or reject recommendations and have their actions influence the earlier labels and models described herein. For instance, as a user is interacting with a file/workflow component, the analytics server may generate a list of possibly related files/workflow components. The analytics server may then prompt the user to identify whether the suggested files/workflow components are indeed related to the user's project/files. Users may be able easily verify whether a suggestion is a good suggestion by either accepting it or dismissing the suggestion. These user responses will update the score between the two nodes. A naive implementation that could be used as a starting point would divide the current score between the two files in half. Furthermore, validations and/or rejections of suggestions should be used as a training set to improve recommendation generated by the analytics server.

In some configurations, if a user dismisses a recommendation, the analytics server does not revert the score identifying the relationship between the two corresponding nodes to zero. Instead, the analytics server may adjust the score, such that other considerations are taken into effect. For instance, user 1 and user 2 have local access to file A and file B. They are not shared files, so both users each have 1 private copy of each file. If user 1 accepts a relationship between file A and file B, and user B rejects the relationship between file A and file B, the analytics server could use both inputs in calculating a new score. The factors that could potentially influence a relationship between files A and B do not have to result in a binary output of options. Furthermore, having an understanding of all of the factors and metadata surrounding a conscious acceptance/rejection, a passively browsing click to view the file, the context in which a file was viewed, by whom, in what location, on what device, etc. . . . can help personalize recommendations contextually by user or by project. There does not need to be a single score between nodes (e.g., there can be a single score between nodes per user).

The analytics server may also identify subsequent and/or previous versions of the same file/workflow component. For instance, the analytics server may identify closest nodes to any given node and process the information again with new/alternate algorithms that can establish particular types of relationships between the nodes. For example, analytics server may compare the text in the contents of this subset of nodes (e.g., nodes that are more similar or closer in distance) more easily than comparing text in all of the existing nodes. This method also requires less computing power because fewer nodes are analyzed. If text is similar enough (e.g., likelihood of similarity satisfies a threshold), the analytics server suggest two nodes as versions of each other. Specific types of actions and relationships can also start to inform classifications. For instance, two files with similar names that share an email thread may likely be versions of each other.

In order to increase efficiency and execute more detailed analysis, the analytics server may identify a subset of the nodes and execute various additional analytical protocols. The additional protocols may include protocols that extract and identify similarities between content corresponding to the subset of the nodes. For instance, where in some embodiments, the analytics server compares metadata corresponding to a file or node, in some other embodiments, if there is only a subset of nodes, the analytics server could do deeper (more detailed) processing and comparison of the contents of the nodes. The analytics server may execute additional models/algorithms that may be too costly or inefficient to run on all possible combinations/permutations of all nodes within the nodal data structure.

In some configurations, the analytics server may allow users to define their own types of relationships, association, and other pertinent information. In this way, the analytics server may provide users with the freedom to label relationships with any label they choose. As the amount of user-defined, implicit, and other explicit relationships increases, the analytics server (using recommendation algorithms) will be able to provide better suggestions that could include specific relationships types. Non-limiting examples of these relationships may include, files that are derivatives of other files (e.g., working files or parent-child relationships between files), files that are outputs or exported from other files (e.g., a pdf file and the associated word document that generated the pdf), files that are previews of other files (e.g., an image of a 3D model and the associate CAD file), emails that are related to the same deal, etc.

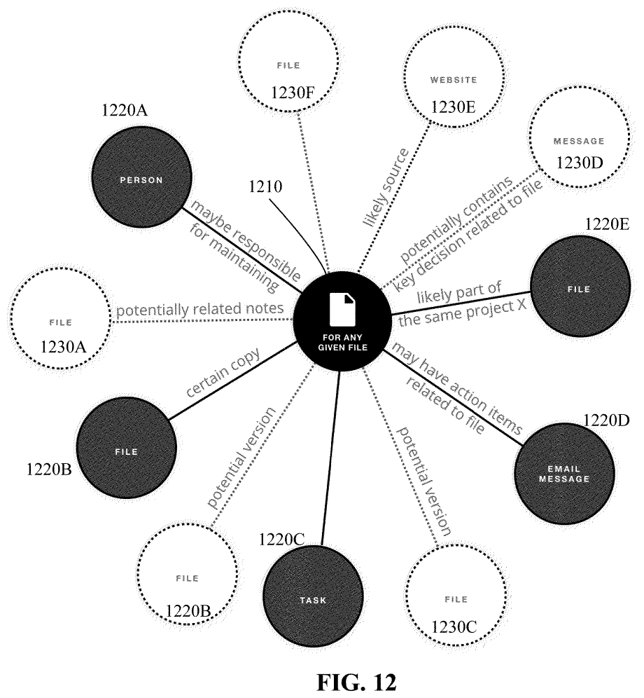

Referring now to FIG. 12, a nodal data structure linking nodes based on the methods/systems described herein is illustrated, in accordance with an embodiment. The node 1210 is linked with various other nodes using hard/soft factors and the methods/systems described herein. The analytics server links the nodes 1220A-E to the node 1210 based on explicit data, illustrated as solid lines. The analytics server then links the nodes 1230A-F to the node 1210 as related nodes identified using implicit data, illustrated in dashed nodes.

The methods and system described herein can be used for an information mapping business that helps users improve their access to relevant and understanding of fragmented work data. The methods and systems described herein can be used in conjunction with a variety of software tools. The value of these methods and systems, regardless of how the technology is packaged, lies in helping users automatically and/or manually interrelate units of work, while also contextualizing them within the larger objectives/contexts, such as, teams, projects, clients, classes, etc.

The analytics server allows users to increase their ability to work contextually without being required to provide the analytics server access to any of their underlying data. However, users must share some context data with the analytics server in order allow the analytics server to map data and identify related nodes. As a result, the methods and systems described herein can be implemented on any data repository without requiring a change within the existing infrastructure. For instance, the analytics server may be utilized within an organization where the analytics server can work in conjunction with existing infrastructure and software tools to contextualize data.

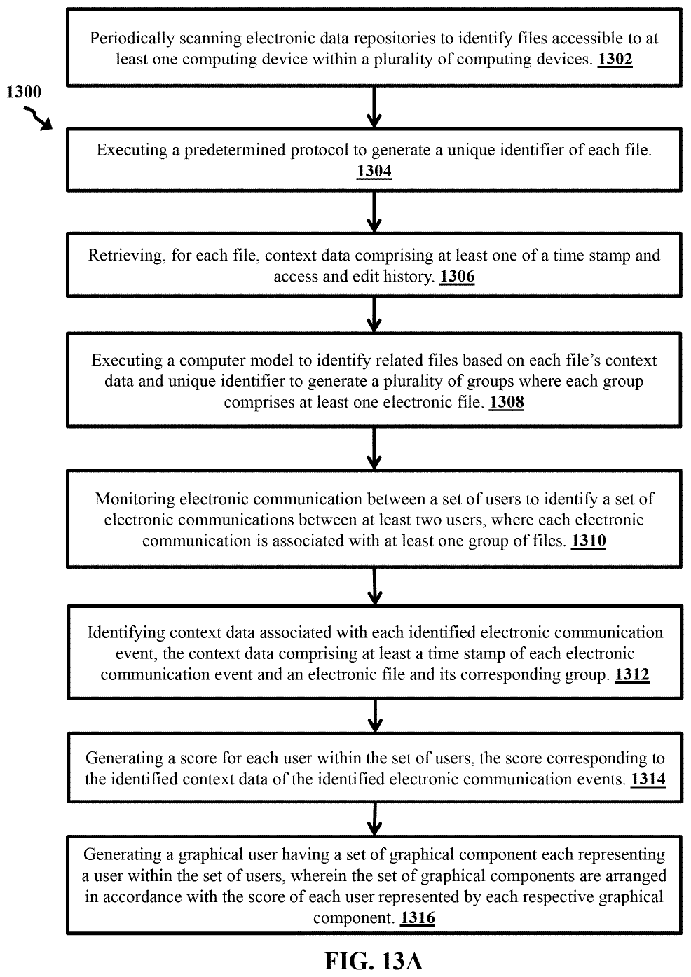

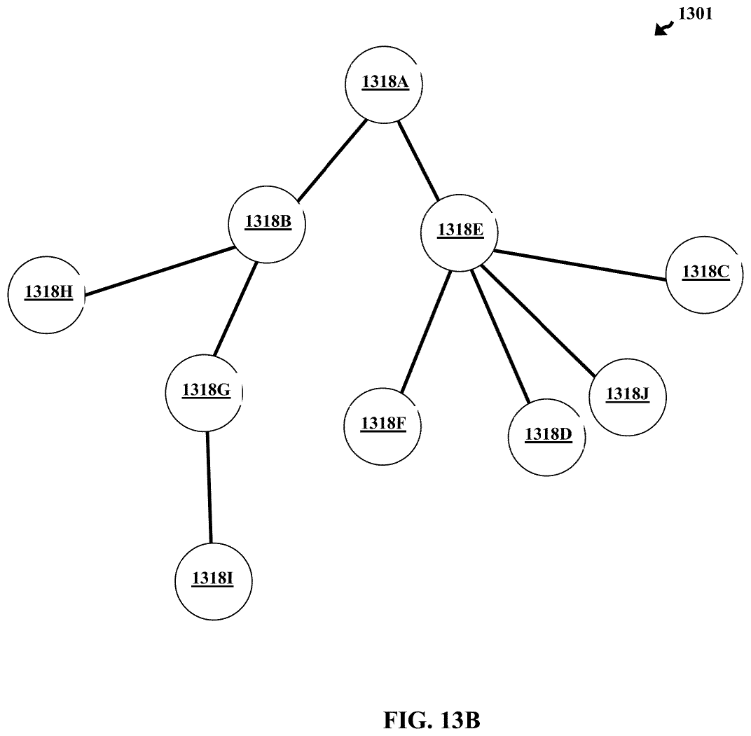

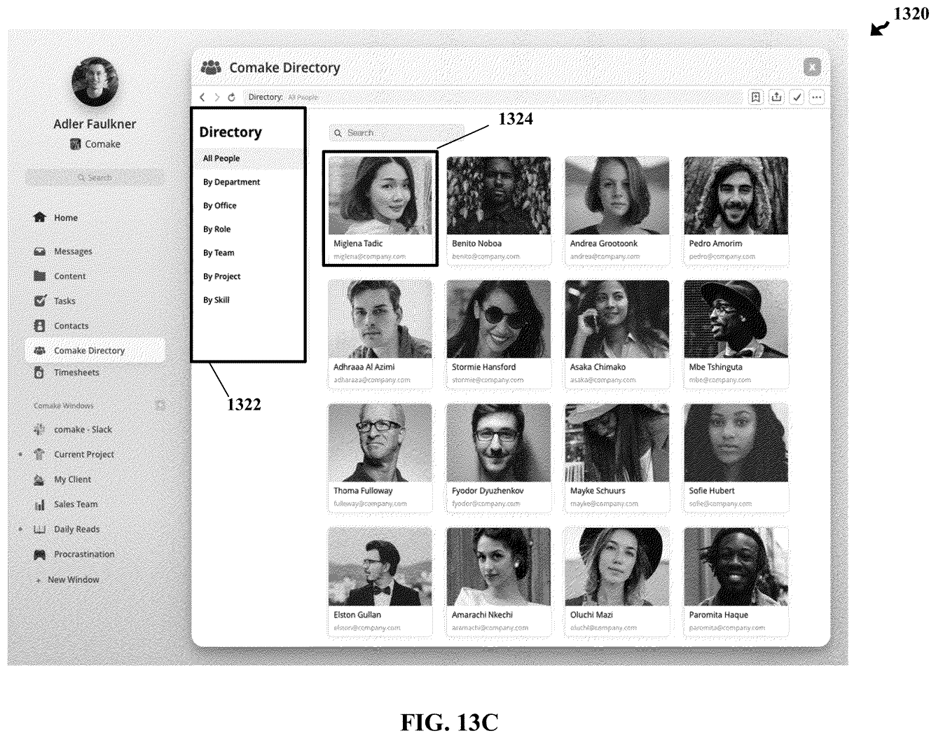

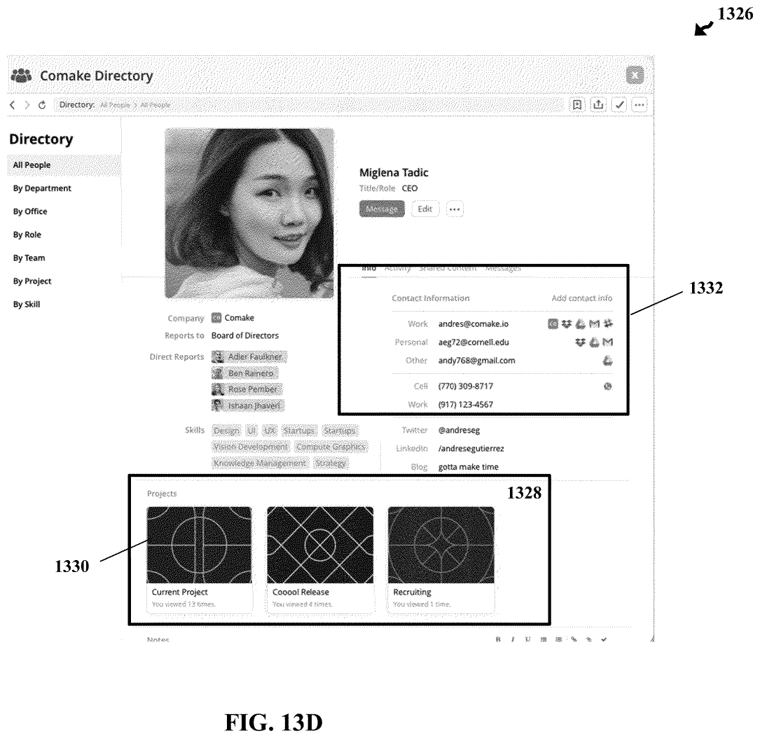

FIG. 13A illustrates a flow diagram of a process executed in an electronic workflow management system, in accordance with an embodiment. The method 1300 includes steps 1302-1314. However, other embodiments may include additional or alternative execution steps, or may omit one or more steps altogether. In some embodiments, the method 1300 may be executed on various other workflow components, such as tasks, messages, notification, and the like.

In addition, the method 1300 is described as being executed by a server, similar to the analytics server described throughout this disclosure. However, the described steps may be executed by any number of computing devices operating in the distributed computing system described in FIG. 1. For instance, part or all the steps described in FIG. 13A, may be locally performed by one or more user computing devices or an administrator-computing device. Furthermore, even though some aspects of the method 1300 is described in the context of a web-based application, in other configurations, the analytics server may display related data in a mobile application or an application native to the user's desktop.

At step 1302, the analytics server may periodically scan a plurality of electronic data repositories accessible to a plurality of computing devices to identify a plurality of files stored onto the plurality of electronic data repositories where each file is accessible to at least one computing device within the plurality of computing devices. As describe above, the analytics server may use various protocols to identify various files stored onto data repositories accessible (or accessed) by one or more computers within a network. Furthermore, as described above the analytics server may use various APIs, web books, and the like to identify the files accessible and/or accessed by the users within the network.

At step 1304, the analytics server may execute a predetermined protocol to generate at least one unique identifier of each file within the plurality of files. At step 1306, the analytics server retrieves for each file, context data comprising at least one of a time stamp and access/edit history. At step 1308, the analytics server executes a computer model to identify related files based on each file's context data and unique identifier to generate a plurality of groups where each group comprises at least one electronic file.

As described above, the analytics server may use one or more analytical protocols to identify related data. For instance, in some embodiments, the analytics server may use the unique identifier generation method (also referred to herein as the hard factors) to identify whether two files are related. Additionally or alternatively, the analytics server may execute various analytical protocols and/or artificial intelligence modeling techniques (also referred to herein as the soft factors) to identify whether one or more files are related. In some configurations, the analytics server may use a combination of the hard and soft factors to identify related files and workflow components.

As described above, analytics may generate and periodically update a nodal data structure where each node represents a unit of workflow, such as a file, message, a user, or any other content related to workflow. The nodal data structure may include interrelated nodes that are identified as related, using methods and systems described herein.

The analytics server may also generate various groups/clusters of nodes where each node within a group/cluster is related to other nodes. For instance, a group of nodes may correspond to nodes associated with a project or a client. The analytics server may group nodes based on various attributes. Therefore, a group of nodes may represent any group of nodes that correspond to workflow components that share at least one attribute.

At step 1310, the analytics server monitors electronic communication between a set of users to identify a set of electronic communications between at least two users, where each electronic communication is associated with at least one group of files. The analytics server may monitor all electronic communication between users where they electronic communication involves at least one node within at least one group. Electronic communications may involve any identifiable communication using organization servers and/or the analytics server.

At step 1312, the analytics server identifies context data associated with each identified electronic communication event, the context data comprising at least a time stamp of each electronic communication event and an electronic file and its corresponding group. The analytics server may monitor timestamps associated with each communication event. For instance, the analytics server may monitor a “response time” associated with each communication event. The response time may correspond to a time period between when an electronic message was received (or seen) and when a response was sent back.

The analytics server may consider other data associated with the users/nodes to identify relationships among users. Things considered by the analytics server may include number of shared files, messages, tasks, calendar events, and the like within two users within a predetermined time. In another example, the analytics server may consider activity events across software tools. For instance, the analytics server may consider the type of activity events (e.g., view or edit). If events are one sided, it could inform type and direction of relationship (e.g., someone is always assigning tasks to someone else)—it could also inform who else reports to the same manager and therefore can create ‘sibling’ relationships between people. In another example, if one user always edits the other users work product, defense may indicate that the editing user may have a higher score within the employee organization chart. In some embodiments, deviations in patterns/relationships can come from changes not between two people, but changes between a group. Where if a manager stops assigning tasks to one user in the “family,” the whole family might need to be re-evaluated.

The analytics server may also consider data retrieved from third party tools in order to generate relationships between users. For instance, the analytics server may initially retrieve relationships from an existing organizational chart from an internal and/or external HR system.

The analytics may also consider information and manual inputs from users. For instance, the analytics server may retrieve labels manually entered by different users (e.g., on their social media or other websites) and/or confirmation/rejection of previous recommendations. If the analytics server identifies a possibly new relationship, the analytics server may prompt the user to enter the user's relationship with one or more other users within an organization. The analytics server may retrieve roles, titles, job description, and other relevant information as indicators of a user's position within an organizational chart.

The analytics server may also consider Contexts/smart windows that may be centered on teams and that have information relating to team dynamics in them. As will be described below, the electronic platform provided by the analytics server may include various contexts specific windows that are customized based upon users and/or projects. The analytics server may use data customized by each user to identify relationships among users. For instance, if a user generates smart windows for other users, the analytics server may assume that the user who has generated the smart windows is a manager of the other users.

The context data may also refer to the language used within the electronic communication. For instance, the analytics server may use various natural language processing protocols to identify sentiment associated with each electronic medication. Sentiment, as used herein, may include tone of the electronic communication event. For instance, the analytics server may execute a sentiment analysis protocol that uses artificial intelligence and/or machine learning to identify sentiment of electronic communications between two users based on the vocabulary used in those electronic communication sessions. Understanding the sentiment of an electronic communication session may allow the analytics server to identify a relationship between the users.

At step 1314, the analytics server may generate a score for each user within the set of users, the score corresponding to the identified context data of the identified electronic communication events. The analytics server may generate a score for each user based on predetermined rules. The score may correspond to an importance level, a hierarchical relationship, or otherwise labeled/classified relationship (e.g., client < > consultant, friends, secret lovers, etc.) between the users. For instance, in some configurations, the score may correspond to a response time between two users. Additionally or alternatively, the score may also correspond to the identified sentiment value.

In a non-limiting example, the analytics server monitors employee A and his electronic correspondence with other employees. The analytics server identifies that employee A predominantly receives electronic communications (e.g., emails) from employee B, C, and D. The analytics server identifies that employee A's response time to employee C is 4 minutes. In contrast, employee A's response time to employee B and D is 18 minutes. Similarly, the analytics server identifies that employee A's communications with employee B and D correspond to a much friendlier sentiment than his communications with employee C. Using the above described information, the analytics server may generate a higher score for employee C than employee B or D. Using the above described information, the analytics server may conclude that employee A may report to employee C. Therefore, employee C may be higher in an organization chart than employee A, B, or D.

In some embodiments, the analytics server may generate a second nodal data structure comprising a set of nodes where each node corresponds to an employee and their respective score. The analytics server may then arrange the nodal data structure according to each employee's score. In a non-limiting example, as depicted in FIG. 13B, the analytics server may arrange different employees based on their score. The depicted nodal data structure 1301 may correspond to a hierarchy among the depicted employee 1318A-J. For instance, employee 1318A has a higher score than all other employees. Similarly, employees 1318B and 1318E have higher scores than employees 1318C-D and 1318F-J.

Using the methods/systems described herein, the analytics server can also establish patterns in the relationships between two given employees and recognize any potential changes in the interaction patterns, regardless of how unique the relationship between two individuals might be. The analytics server may generate insightful graphs representing an organization, including but not limited to, generating and/or automatically maintaining a de facto organizational chart. For instance, employee A may be a manager of employee B. The employees AB usually meet at 8 am on Monday. The two employees are have a lot of regular communication, overlapping calendar events, files, etc. However, employee B then changes projects and therefore his/her manager might change.

In another example, employee A may be officially designated to be reporting to employee B. However, based on their communications (e.g., how fast employee A responds to employee B and other employees), shared projects, and working on different files that are related, the analytics server may identify that employee A reports to employee C instead. The analytics server may continuously/periodically revise the dynamic organizational chart as more relationships are identified or new employee relationships are created (e.g., employee A is now assigned to a new team overseen by employee D). The analytics server may also provide searching capabilities to efficiently search for employees/resources based on this dynamic chart.

Conventionally, manual revisions of the organization chart is required. However, if an administrator has not updated the organization chart, the analytics server (or anyone else within the organization) will be notified on this change. The analytics server can automatically identify that employee B and employee A's relationship has changed: both got access to different files and content, started working in different folders, no longer have regular meetings, there is fewer communication event, and the like. The analytics server may then prompt each user (or a system administrator) to update the information and even begin to suggest whom the new manager-employee relationship might be. The analytics server will continuously revise the dynamic organizational chart as more relationships are identified or new employee relationships are created (e.g., employee A is now assigned to a new team overseen by employee D).

At step 1380, the analytics server may generate a graphical user interface having a set of graphical component each representing a user within the set of users, wherein the set of graphical components are arranged in accordance relationship between each user represented by each respective graphical component.

The analytics server may generate a graphical user interface that displays a hierarchy of the employees within an organization. The analytics server may use the nodal data structure 1301 to arrange the employees in accordance with its identified hierarchy.

Referring now to FIG. 13C, a non-limiting example of a graphical user interface illustrating an organizational hierarchy is shown, in accordance with an embodiment. GUI 1320 includes a list of all employees and their corresponding image and contact information. A user interacting with the GUI 1320 may filter the employees based on various provided filters, depicted in the graphical element 1322. For instance, the user may arrange the employees by department, office, role, team, project, and/or skill. When prompted by the user to rearrange the employees based on an attribute, the analytics server may identify a relationship among users' nodes within the nodal data structure (based on various analytical protocols described herein) and may arrange the visualization of employees accordingly.

When a user interacting with the GUI 1320 interacts with an employee displayed on the GUI 1320, the analytics server may display detailed data regarding that employee. For instance, when a user interacts with the graphical component 1324, the analytics server directs the user to GUI 1326 (FIG. 13D) where more detailed data associated with the selected employee is displayed. GUI 1326 may include graphical components 1328 where the analytics server may display various results of the analytical protocols described herein. For instance, when a user interacts with the graphical element 1330, the analytics server may identify nodes related Miglena Tadic (using the nodal data structure) and may direct the user to any related project/workflow. The analytics server may display data associated with nodes related to a node that corresponds to Miglena.

The analytics server may automatically generate profiles for each users/colleagues/collaborators by consolidating profile information from any integrated third party tools. For example, the depicted user may have various third party software tools that are depicted in the graphical component 1332. The analytics server may consolidate information from all of these tools around a profile that is automatically generated and updated.

The analytics server may display a logo for a variety of third party services used by each employee, contact, or colleague. Therefore, either the user viewing the GUI 1326, Miglena Tadic, and/or a third party have connected/integrated the illustrated accounts and that the analytics server has identified shared content between an email that the viewer has confirmed/verified as his/her and an email that has been recognized (using the methods and systems described herein) as being related to Miglena Tadic. As depicted, the analytics server may also display other employees to whom Miglena reports.

The analytics server may use the method 1300 to generate and maintain organizational charts for human resources; to document project teams; to provide other human capital analytics/classifiers (early bird, late owl, social connector, and flag communication breakdowns), and the like. Even though, embodiments describing the method 1300 focus on a specific use of this process around people and organizational charts, the underlying principles are very similar regardless of whether the method 1300 is applied to files, employees, or any other workflow component (e.g., tasks). For example, the method 1300 can be applied to other workflow components and/or files to identify a hierarchy between the workflow components and/or files.

Using the method 1300, the analytics server can also classify or recommend classification types between the relationships. For example, the analytics server can analyze known relationships between two files (e.g., shared email message, shared email thread, shared task, similar file contents, and/or files with similar activity by a user) and infer/recommend relationships that may be more useful to users (e.g., versions of each other, one is a derivate of the other, and/or related to a particular deal or project). As stated throughout, the method 1300 may also be applicable to any other workflow component, such as nodes corresponding to people and their contact.

In other related embodiments, the analytics server may identify and rank employee contacts as well. Employees' contacts typically fall out of date and lack contextual information. Employee directories require dedicated people to maintain, and even then, they fall out of date. Organizational charts require dedicated people to maintain, and even then, they fall out of date. Employees usually struggle to quickly receive and respond to the most important contact updates (e.g., information, updates and action items) they receive across the many tools and accounts they work with. The analytics server can rank different contacts.

The analytics server can retrieve a list of email addresses associated with the users. Each email address may have a list of related integrations (on which it has permissions); consolidated list of activity events from the email address' related integrations; consolidated list of files the email address' integrations have permissions on; consolidated list of messages the email address' integrations have permissions on; and consolidated list of tasks the email address' integrations have permissions on.

The analytics server can also retrieve and display a list of users where each user has a list of related integrations (e.g., applications and/or workflow components on which he/she has permissions), consolidated list of activity events from the user's related integrations and from the user, consolidated list of files the user's integrations have permissions on, consolidated list of messages the user's integrations have permissions on, and consolidated list of tasks that have been have been created by or assigned to the user's integrations. The analytics server can retrieve and display a list of contacts associated with each user. Each retrieved contact may have a list of related email addresses, and through those integrations, the analytics server may identify new connections.

The analytics server may also consolidate profile information from the contact's related integrations. This is sometimes referred to as deduping (or de-duplicating) nodes. For instance, the analytics server may de-duplicate files with similar MD5 identifies and merge their respective metadata from different sources. The analytics server may then execute various analytical protocols described herein to establish relationships between users and label those relationships.

The analytics server may also use various profile data to integrate and identify relationships among users. For instance, each user profile may have special fields, such as person to person relationships (e.g., Slack profiles can have the following fields: mentor (user), birthday (date), title (string), etc. and a different company can have different fields), consolidated list of activity events from the contact's related integrations, consolidated list of files the contact's integrations have permissions on (e.g., the files, messages, etc. need to be able to be accessed by the logins/integrations of both the 1st person user and that user's contact), consolidated list of messages the contact's integrations have permissions on, and consolidated list of tasks the contact's integrations have permissions on. Each contact can also have other related units of work, including files, messages, tasks, notes, etc. that can be established in much the same way as relationships and labels between files are established. Similarly, contacts are able to have relationships with other contacts and/or users.

The analytics server may allow users to share accounts for given integrations (e.g., multiple people can access a central email such as info@company.com). In this embodiment, not all activity from shared integrations may pollute the activity timelines for contacts that have access to a shared account/integration. In other words, contact's profile does not show all activity from shared integrations, but it can show activity that is identified as originated from user within shared integrations.

Using the methods and systems described herein, the analytics server can create a relative score between a user and all of his/her contacts (e.g., create a measure of relative distance between a user and contact). Analytics server may provide a list, which allows users to focus information around the people/contacts that matter most to them. The analytics server may establish labels between users (e.g., manager and manage and/or a user and a contact). Using the methods and systems described herein, analytics server may identify when an organizational chart needs to be updated.

The analytics server may send a notification to multiple users to suggest/recommend relationships and labels for the relationships (e.g., manager, mentor, client, etc.) between different employees and/or employees and their contacts. For instance, if the analytics server identifies that users A and B have high scores in relation to user C, the analytics server may recommend contacting user B when user C is contacting user A. In a non-limiting example, when user C is drafting an email to user B, the analytics server displays a prompt on user C's computer that recommends drafting a similar email to user A or including user A in the email as a recipient.

The relationships generated by the analytics server are dynamic and the analytics server may revise them based on monitored user activity and behavior. For instance, a change in a user's activity may indicate that a label (or lack of label) may have changed between a user and contact (or a cluster of contacts). The analytics server may revise these relationship (e.g., relative score) based on monitored user behavior of the user, related users, and/or the contacts.

The analytics server may also augment suggesting relationships by identifying a behavior pattern of the contact, such as the contact's department, related teams, and related projects. The analytics server may also recommend when users/contacts are working (e.g., early bird, late owl, and prefers slack to email) or add labels to contacts to improve collaboration.

Using the methods and systems described herein, the analytics server may use communication and activity patterns to also identify a relationship between two users/employees. The relationships may not be limited to identifying organizational hierarchy. For instance, the analytics server may also identify social relationships among employees. The analytics server may create paradigms of relationships that it can try to match between users, such as manager-employee, close friends, social conflict, etc. This can be used to improve operational performance, staffing, organizational transparency and lateral communication, etc.

The analytics server may also provide searching capabilities to efficiently search for employees/resources based on the dynamic organizational chart. Using the nodal data structure representing the organizational chart, the analytics server may receive a query (e.g., “show me employees who work on project X”) and traverse the nodal data structure accordingly to identify related nodes. For instance, even if employee A has not been officially designated as working on project X, the analytics server may identify employee A as a possibly working on project X using the methods and systems described herein.

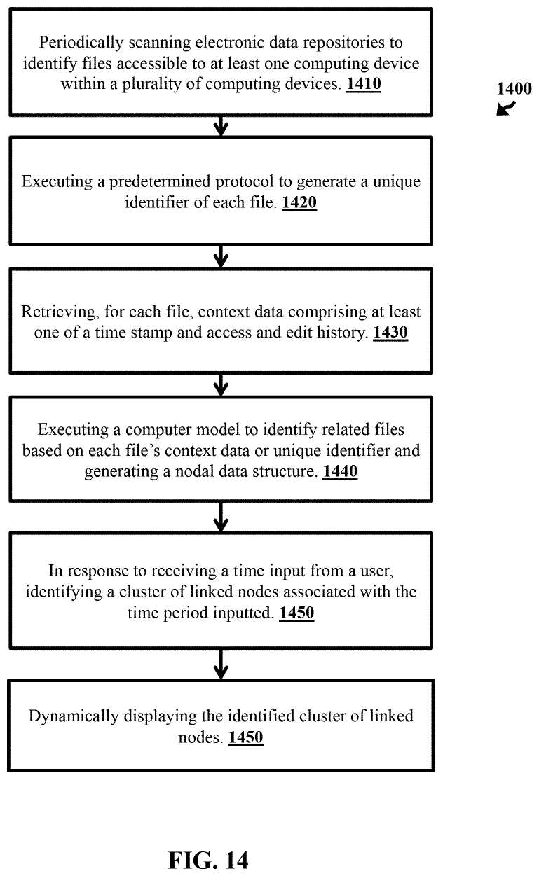

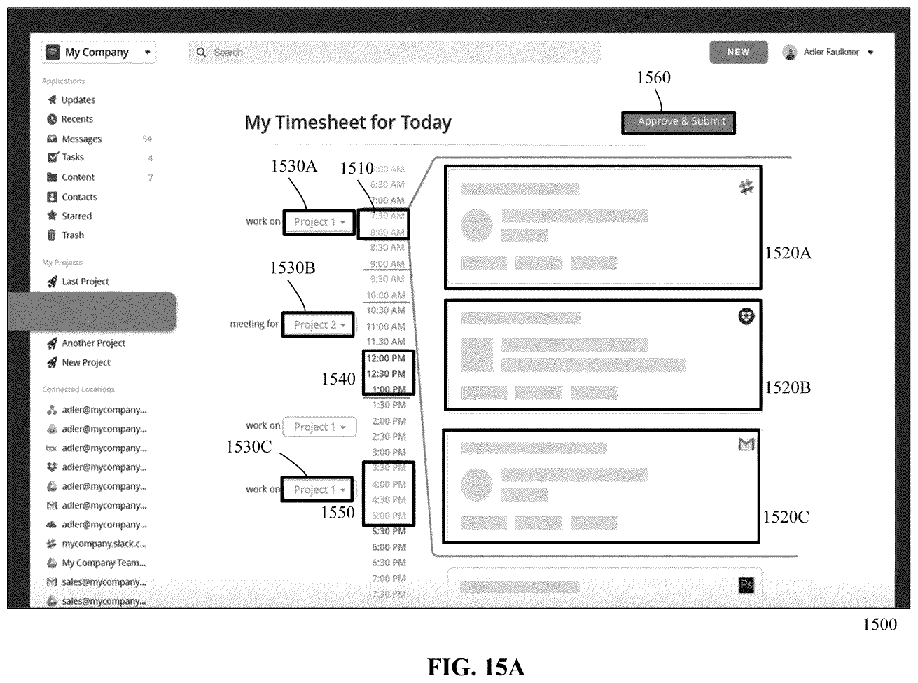

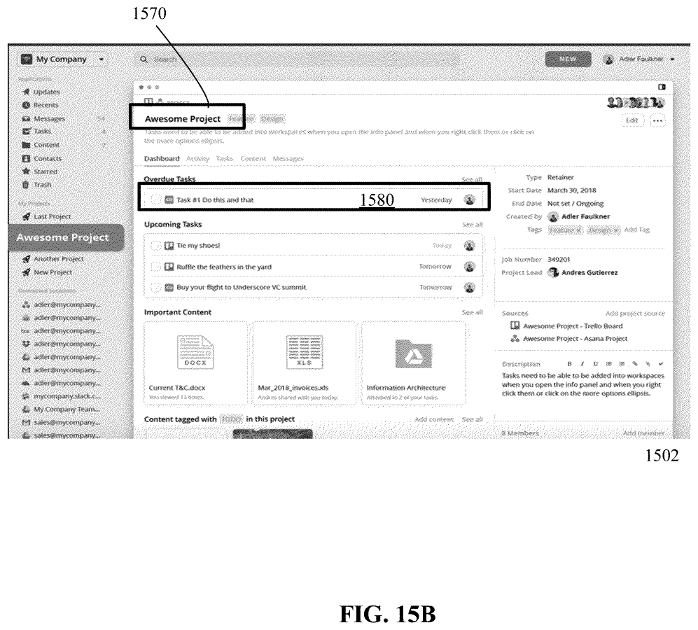

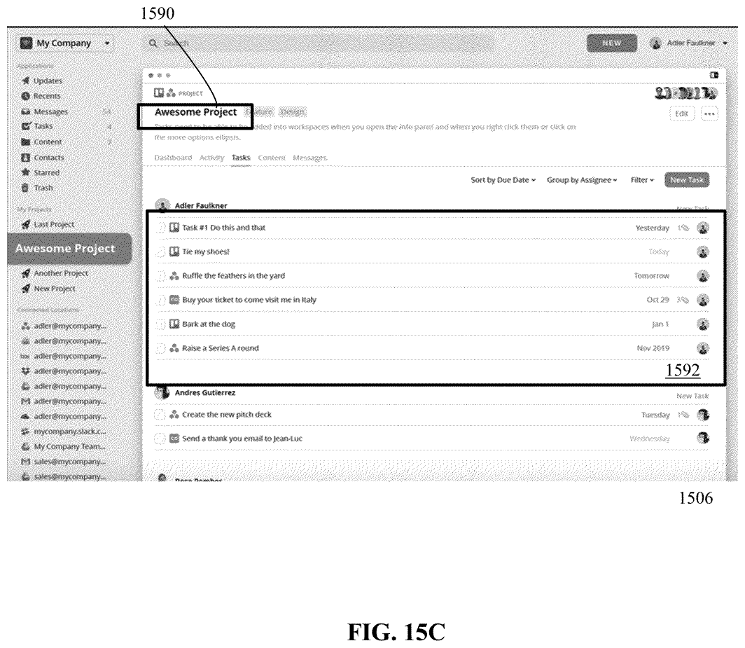

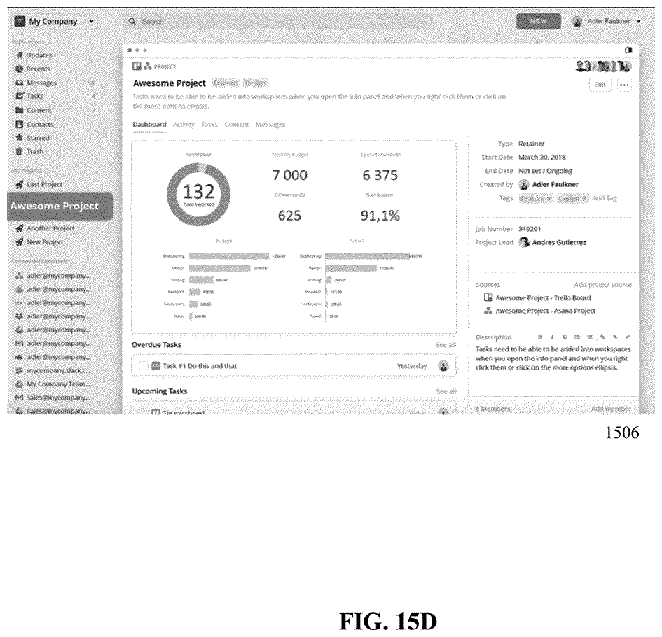

Conventionally, information shown in project profiles may not typically exist in one place. As a result, information associated with a particular project may not be easily accessible to employees. The analytics server utilizes the nodal data structure (e.g., disclosed system of pointers that is building/presenting known and suggested relationships between components/nodes of information that reside within different (sometimes third party tools) to identify a project associated with an employee's worked hours. End users are able to navigate their activity timelines and see relevant activity events automatically correlated with different suggested projects. Ultimately, as users accept or submit their timesheets, they are increasing the analytics server's confidence that a given activity event and therefore related units of work may be related to a given project. This helps the analytics server populate project profiles with relevant information. As described and depicted in FIGS. 14-15A-D, the analytics server may utilize the methods and systems described herein (e.g., nodal data structure) to automatically recommend certain projects or clients for blocks of time depending on the underlying relationships between files/units of work, and certain projects.

The method 1400 uses the relationship-building methods described herein to augment time entry applications. For instance, the analytics server can use related files and users (e.g., how other users working on a related file have documented their time spent on a project) to recommend a best option for time worked by users. In a non-limiting example, analytics server can recommend how much time a user should bill to a project. The analytics server can also consolidate user timelines and time spent on different projects. By consolidating the data, analytics server can also allow structured and unstructured searching (e.g., e-discovery). For instance, when instructed, the analytics server may retrieve all times billed to a particular project and identify corresponding nodes within the nodal data structure. As a result, the analytics server may retrieve all relevant files to a project (e.g., all files accessed by employees while working on a project).

Using the method 1400, the analytics server can provide time tracking suggestions that attribute (or suggest) a user consolidated timeline of activity events to a particular project.

The analytics server may retrieve data from the existing graph (e.g., nodal data structure) and relationship recommendations to suggest what events are related to which projects. The analytics server may also use other users/employees activities to identify a related project. For instance, if multiple users are related to the same activity or event (e.g., email sent/received, and calendar event) and one user classifies his/her time as related to one project, the analytics server may conclude with a certain level of confidence that other users (working on related material) were also working on that particular project during the same time. Using this method, the analytics server may improve the recommendation for what project that time slot is associated with for the second user. This method may use information from third party time tracking tools to help increase/decrease the relative recommendation score between activity events and their related files, messages, tasks, etc. to projects.

The analytics server may also provide users the option to classify certain times and groups of activity/events as different projects and/or increase/decrease the relative recommendation score between the underlying information to the respective projects. The analytics server's recommendations may improve depending on a number of users who have mapped (e.g., classified) different events. For instance, when a predetermined number of users map the same event as related to a project, the analytics server can identify that the event and the project are related with a high degree of confidence. Therefore, the analytics server's recommendation improves with each mapping of events inputted by each user.

FIG. 14 illustrates operational steps for identifying a time period associated with one or more electronic files. At step 1410, the analytics server may periodically scan a plurality of electronic data repositories accessible to a plurality of computing devices to identify a plurality of files stored onto the plurality of electronic data repositories where each file is accessible to at least one computing device within the plurality of computing devices. At step 1420, the analytics server may execute a predetermined protocol to generate at least one unique identifier of each file within the plurality of files. At step 1430, the analytics server may retrieve, for each file, context data comprising at least one of a time stamp and access/edit history. At step 1440, the analytics server may execute a computer model to identify related files based on each file's context data and unique identifier to generate a plurality of groups where each group comprises at least one electronic file.

At step 1450, the analytics server may, in response to receiving a time input from a user, identify a group associated with the user during the time period inputted. The analytics server may receive a request from a user device to identify a group associated with an inputted time. In a non-limiting example, a user may select a timeframe representing a time period of work hours. For instance, the user may access an electronic time entry form/software tool and may select a time. As described herein, the analytics server may periodically scan (or use other software tools described herein) to identify files/workflow components accessible and/or accessed by each user within a network. The analytics server may then generate a nodal data structure and identify interrelated nodes using the methods/systems used herein.

As described herein, the analytics server may use various analytical protocols to identify and link related nodes. Therefore, the analytics server may generate clusters/groups of nodes within the nodal data structure. The analytics server may cluster nodes based on one or more attributes. For instance, each cluster of nodes may represent a project defined by a system administrator.

After receiving a request from a user along with an identified time period, the analytics server may first identify units of work accessed by the user operating the user device within the selected/inputted time. For instance, if the user indicates that the user is interested in a time window corresponding to 3-5 PM on Wednesday, June 23, the analytics server may first identify all user activity (e.g., files accessed, messages sent, workflow components revised, and any other activity implemented on the user device or otherwise associated with the user even if performed from a different user device) within the inputted time.

The analytics server may then identify nodes within the nodal data structure that correspond to the user's activity within the identified time window. For instance, if a user has access to file A during the selected time, the analytics server may identify file A and may identify a corresponding cluster of linked nodes to which file A belongs. In essence, the analytics server may identify a project that corresponds to the identified nodes, which will likely identify a project associated with the inputted time. For instance, the analytics server may identify (using metadata associated with the related nodes) a project name that all the related nodes have in common. As a result, the analytics server may conclude that the related nodes correspond to a particular project. As a result, the analytics server concludes that the user's activity during the identify time window is related to the identify project.

At step 1410, the analytics server may dynamically display the identified linked clusters. The analytics server may display an indicator associated with the identified project (e.g., length clusters of nodes). FIG. 15A is a non-limiting example of the indicators displayed by the analytics server. As depicted in GUI 1500, a user may select various time periods. For instance, the user selects time windows 1510, 1540, and 1550. The analytics server first identifies the user's activities during the identified time windows. The analytics server may also identify a cluster of linked nodes that include the identified nodes accessed by the user within the time windows. For instance, the analytics server displays indications of what files were accessed in the graphical elements 1520A-C (corresponding to time windows 1510, 1540, and 1550 respectively). Using the methods/system described herein, the analytics server identifies corresponding projects worked by the user in the corresponding time window.

The analytics server may also display an indication of a suggested project via graphical elements 1530A/C. For instance, graphical element 1530A indicates that (based on the user's activity in that time), the user was working on project 1. Graphical indicator 1530B suggests that the user worked on project 2 from 10:30 AM to 1:00 PM.

The suggested projects and/or time windows may include visually distinct elements. The visually distinct elements (e.g., different colors) may correspond to a degree of certainty associated with the suggested project. For instance, if the analytics server determines that a time window is associated with a project with a high degree of certainty, the analytics server may display the time window and/or the project name using green colors. Similarly, the analytics server may use red coloring for the time window 1540 because the analytics server identifies project 2 with a low degree of certainty.

To achieve the above-described visual distinction, the analytics server may generate a likelihood that the identified cluster is associated with a particular time window. The likelihood may correspond to a number of nodes accessed by the user within the time window that are also associated with a particular project. For instance, if a user accesses 10 files that are all associated with a project within a time window, the analytics server assigns a higher likelihood that the time window should be attributed to that particular project than another user who accesses one file that is associated with that particular project.

In some embodiments, the analytics server may identify the cluster of nodes associated with a first user's work hours based on projects worked on by other users. For instance, as described above, the analytics server may generate an organizational chart for an organization. If the analytics server identifies that multiple coworkers have attributed their work time (that corresponds to a particular node) to project A, the analytics server may suggest project A for all users who have accessed same, similar, and/or related nodes. In this way, the analytics server may predict a project based on a user's coworkers who are working on the same project or have similar job descriptions and responsibilities.

The analytics server may also provide users with the option of approving and submitting the suggested projects. The user may, upon selecting the correct suggested project, approve and submit the timesheet. If approved, the analytics server may use the user's approval to revise the nodal data structure accordingly. For instance, if the user approves that the content displayed in the graphical element 1520A are indeed related to project 1, the analytics server revises the nodal data structure, such that nodes corresponding to the content displayed in the graphical element 1520A are connected to nodes corresponding to project 1.

In some configurations, the analytics server may use the revised nodal data structure to display related information when displaying data associated with a project. As depicted in GUI 1502, when the analytics server displays information related to the project 1570, the analytics server may display tasks (and a corresponding time) performed by the user.

In some configurations, the analytics server may allow a user to designate a project when creating new tasks or other workflow components. The analytics server may use the designated task to identify a project when prompted. As depicted in FIG. 15C (GUI 1504), a user may generate various tasks displayed in the graphical component 1592 and may designate the tasks to the project 1590. When prompted (e.g., when the user accomplishes the tasks and requests the analytics server to identify a corresponding project), the analytics server uses this designation to suggest the project 1590.

In some configurations, the analytics server may use the methods/systems described herein to provide metrics associated with each project. As depicted in FIG. 15D (GUI 1506).

The analytics server may also use associated time entered by users/employees to revise the nodal data structure. For instance, when a user submits his/her timesheets (even if the user is using third party, not generated by the analytics server, software or systems to log time, and so long as the analytics server can integrate with/ingest the data), the analytics server may revise the nodal data structure accordingly by building relationships between the nodes corresponding to related activity events, files, emails, and/or tasks and a given project/client. In an example, when a user identifies his/her worked time period as associated with a project, the analytics server may identify a cluster of nodes associated with the user, which the user has interacted with during that particular time period, and associate the nodes within the identified cluster with one or more nodes of the project. That is, the analytics server may revise the nodal data structure and the relative scores and labels between nodes in accordance with the project associations identified by users. The analytics server may also link nodes corresponding to different employees based on their identified projects. For instance, the analytics server may link nodes associated with employees who are working on the same and/or related projects.

The methods/systems described herein can be used to generate user behavior patterns. For instance, the analytics server may continuously/periodically monitor how a user accesses various files, tasks, and other workflow components. Consequently, the analytics server may generate a model that represents the patterns of behavior associated with each user. The analytics server may use the generated behavior model to predict whether a user's account or device has been compromised, as well as flag potentially dangerous intentional actions by the user. The methods/systems described herein can be utilized to generate news alerts, customized for users based on each user's unique working patterns and relationships to other users.

Most modern knowledge workers are involved with multiple projects, which requires them to access multiple files hosted on multiple (internal or external) applications and software tools. Currently, for simultaneous access to files (and other workflow components, such as tasks, notifications, and the like) related different projects, users must access multiple software tools, which has created negative user experiences and created inefficiencies. For instance, a typical employee may have multiple browsers, software applications, task organization applications, and other project related software applications open at the same time. Managing multiple applications decreases efficiencies.

Using the methods and systems described herein, the analytics server may provide a browser extension that provides all relevant data associated with a particular context. The context may represent any category of data selected by the user. For instance, the context may correspond to a project, a particular aspect of a project, or any other category of data described herein (e.g., all data associated with a particular employee). Using the methods and systems described herein, the analytics server may traverse the nodal data structure, identify relevant nodes, analyzed identified nodes, and provide context-specific data.

In a non-limiting example, a user may generate multiple browser tabs where each tab corresponds to a particular project or any other attribute of his/her workflow. When the user accesses a browser tab, the analytics server only displays data associated with that particular project. Therefore, the user may access all software tools, files, notifications, messages, and any other workflow component from the project's browser tab. This eliminates the need to execute and initiate multiple software applications. The browser tabs are customizable, such that users may customize notifications messages or any other workflow components according to their needs. Various applications (internal or external) and software tools can be loaded onto each browser tab to provide easy access. These applications and software tools could be desktop applications, web applications, and/or other websites. The analytics server enables users to relate different accounts to each application, such that a user can be simultaneously logged into multiple accounts for the same type of application (e.g., two social media accounts).

As will be described throughout, the methods and systems described herein can be implemented within a browser extension. However, in other embodiments, the methods and systems described herein can be implemented into any software application.

The graphical user interfaces and browser extensions/tabs described herein (e.g., FIGS. 16A-O) are also referred to herein at “smart windows.” The disclosed platform that utilizes the methods and systems described herein offers software products that allow users to group data into these contexts so that they can have a holistic view (and access) without being required to execute multiple browsers and applications. The disclosed platform improves focus and productivity, while helping manage content organization across different applications. Using the methods and systems described herein, the analytics server allows users to load websites into their browser as native applications, and then group websites and resources into context.

The methods and systems described herein can be implemented as a browser extension that transforms browsers into collaborative and smart workstations where users can access information from websites at the browser level (e.g., without loading the webpages), as well as load and offload work sessions (and tabs) contextually. While some embodiments described herein are described in the context of a web-based application, such as a web browser, the method 1600 can be implemented on any application (e.g., desktop applications, databases, and/or cloud-based applications).

The analytics server may also provide a keyboard navigable version of the same concepts, where users can use keyboard shortcuts and basic commands to search through, access, and otherwise interact with information within the nodal data structure.

Because the analytics server identifies and aggregates relevant data, e.g., by generating the nodal data structure, users can organize their activities more efficiently. For instance, users can search data, generate messages and tasks, identify contacts, and receive alerts using one workflow browser application (or a single browser tab).

FIG. 16A illustrates operational steps of displaying customize browser tabs based on identified projects associated with each user, in accordance with an embodiment. At step 1602, the analytics server may periodically scan a plurality of electronic data repositories accessible to a plurality of computing devices to identify a plurality of files stored onto the plurality of electronic data repositories where each file is accessible to at least one computing device within the plurality of computing devices. At step 1604, the analytics server may execute a predetermined protocol to generate at least one unique identifier of each file within the plurality of files (or any other workflow component). At step 1606, the analytics server may retrieve, for each file, context data comprising at least one of a time stamp, access, and edit history. At step 1608, the analytics server may execute a computer model to identify related files based on each file's context data and unique identifier to generate a plurality of projects where each project comprises at least one electronic file.

Using the method 1600, a user can create his/her own contexts through a GUI or API. The analytics server creates filters and/or models to map nodes to a given context. As used herein, context may refer to any attribute or classification designated by the user. For instance, the context may refer to a GUI specific to a project, team, client, portfolio, or any other classification desired by the user. For instance, the user can instruct the analytics server to generate the customize GUI that displays information relevant to one or more attributes. The analytics server may use the attributes received two identified nodes that are associated with that attribute (e.g., nodes associated with a project, client, employee subgroup, and/or a particular department).

The context (the customized GUI) can be shared with others, so that the shared content of each customized (e.g., a shared project, team, and client) does not have to be created multiple times by different people. Each user may then accordingly further customize the GUIs by adding/removing files, applications, and other content from each customized GUI (context). New users can login and already have relevant applications and context associated with their profile/workspace. As information reaches analytics server from integrated systems, data is processed and may be associated with a given context. The analytics server may then dynamically update each context according to the new data received. Therefore, each user may use his/her context as a one-stop shop to access his/her relevant data.

Additionally or alternatively, when a user opens a context via GUI or (or other user/system accesses Context via API), the analytics server can perform a search based on certain attributes and return units of work as well as recommendations. Recommendations can come from browsing history, activity, notifications, saved tabs, pinned resources, etc. The context is an “app-like” experience because it is easy to open, easy to search, provides notifications control, and screen-time/time-tracking, anther relevant features.

In steps 1602-1608, the analytics server may monitor user interactions and may generate a nodal data structure corresponding to file accessible and/or accessed by various users and user devices within the network. The generation of the nodal data structure is described in detail throughout disclosure. The nodal data structure may correspond to related files and/or workflow components within a network (e.g., organization).

At step 1610, the analytics server may receive one or more attributes from a user device. The analytics server will use this attribute to identify relevant nodes, group electronic content, and display the GUIs described herein. In some embodiments, the analytics server may display a prompt to receive the attribute from the user. The attribute may include a classification of data or context selected by the user. Non-limiting examples of the attribute may include projects, clients, portfolio, team, team hierarchy, and the like. By selecting an attribute, the user instructs the analytics server to generate a GUI (e.g., browser tab) that displays data associated with that attribute. For instance, a user may instruct analytics server to generate a browser tab that displays data (e.g., files, notification, messages, and/or tasks) associated with a particular project, objective, or other context. The grouping of nodes from the nodal structure around an attribute and the graphical user interface that represents it is also referred to herein as a context.

If no attribute is received, the analytic server may identify the user's working patterns (e.g., the user's hierarchy within the organization chart and projects associated with the user). The analytics server may use the user's working pattern as the default attribute. For instance, if a user has not identified a desire to generate a context browser, the analytic server may automatically consolidate and suggest workflow components associated with different projects in which the users is involved.

Upon receiving the attribute, the analytics server may use the methods and systems described herein to identify a cluster of nodes that correspond to the attribute. For instance, if the attribute corresponds to a project name, the analytics server may identify all nodes within the nodal data structure that are related to that particular project. That is, the analytics server identifies a cluster of nodes that are related to the attribute. The analytics server may traverse the nodal data structure and use the identified cluster of related nodes to display data as described herein.

At step 1611, the analytics server may dynamically generate a first link displayed by the browser and configured to direct the browser application to one or more electronic files associated with identified cluster of related nodes when the user initiates a browser application. For clarity and brevity, the embodiments described herein depict a browser tab that displays data grouped based on projects (sometimes referred to herein as context). However, it is expressly understood that data within the nodal data structure can be grouped based on any other attribute. For instance, the method 1600 may be used to generate a browser tab that groups data for different clients, portfolios, and the like.

Using the methods and systems described herein, the analytics server may identify files and workflow components related to different projects. The analytics server may search for and retrieve nodes that correspond to different files and workflow components that are relevant to the attribute received from the user. In other words, the analytics server may use the nodal data structure to identify nodes that are associated with and relevant to the received attribute. The analytics server may then generate various GUIs that display graphical elements that correspond to files and other workflow components corresponding to the retrieve nodes.

The analytics server may generate customized browser tabs where each tab is specific to one or more projects associated with the user. When the user interacts with a browser tab, the analytics server then displays project-specific information for the user including multiple links (e.g., graphical components) providing the user with the option to efficiently access data organized based on different projects to which they relate. In this way, users can minimize the number of browser tabs and active applications, which creates a better user experience.

Referring now to FIGS. 16B-P a non-limiting example of a browser extension displaying a browser tab that groups/clusters data based on an attribute is depicted, in accordance with an embodiment. The browser extension can be installed and implemented on any browser, such that the information can be displayed by the analytics server. FIG. 16B illustrates a typical web browser equipped with a browser extension provided by analytics server.

To start, a user may interact with the graphical indicator 1612 and the analytics server displays the GUI 1624. In some configurations, this tab (graphical indicator 1612) will always be visible to the user. The graphical indicator 1612 is comparable to a computer's “desktop” for users' browser. The graphical indicator 1612 may represent the home space for cloud/web-based workflows, which the user can always access by interacting with the graphical indicator 1612 and/or 1614. By interacting with these graphical indicators, a user can launch any application he/she might want from “Home,” pin any application to the dock (graphical elements 1616) for easy access, search for anything using the search bar 1618, and view his/her recent working history over the past several days (graphical elements 1620).

A user can also choose to keep certain contexts in their dock (graphical element 1622), such that the applications are easily accessible from the “Home” screen displayed in GUI 1624. The user can always access all pinned and unpinned applications and contexts from search bar 1618, such that she/he does not have to keep all of the contexts within his workspace always pinned to the Home screen. Also, similar to applications, notifications, recently visited pages, integrated search, and more is easily accessible without having to open others applications or other software tool itself, (e.g., FIG. 16E). The analytics server also allows users to easily search and see units of work (notifications, files, messages, notes, etc.) relevant to that context without opening/loading any of the related webpages or applications. In this way, the analytics server provides an “app-like experience” for contextual workflows (e.g., objectives, clients, classes, teams, projects, etc.) where information and accessibility is greatly improved in contrast with a traditional website or fragmented workflows across applications.

When a user initiates a context, the user is able to continue working from where the users last terminated his/her work (e.g., left off work last time). This solution greatly improves an individual's workflow where she/he can log off or try to keep all the applications active on his/her computer. The analytics server provides a way for the user to easily maintain visibility and control into relevant activity across applications/accounts by context (e.g., project and/or objectives), while maintaining a clean and organized workstation without an overwhelming number of open windows. This improves both the user's performance as well as his computer's performance.

When a user chooses to continue working on a given context, the analytics server can retrieve the user's last known state of work for that given context, and allow the user continue working with the same window and tabs open as previously accessed. This can include logging the user into the corresponding application and accounts. For instance, if the user decided to include a third party email application, the analytics server can integrate the third party application in the GUIs described herein. The analytics server can also keep the user logged into the third party email account, such that the user is no longer required to initiate that third party application to check his/her emails. An alternate embodiment would allow multiple windows per context and could include both online and offline work.

Additionally or alternatively, the analytics server may provide users to have a context open as multiple windows in a “desktop,” which comprises contextual files (files arranged based on their context data retrieved from the nodal data structure), notifications, messages, tasks, contacts, questions & answer forum, calendar, and the like.

FIG. 16C illustrates an embodiment where a user opens a context by either clicking on that particular context it from the dock or searching for it. When opened, the analytics server searches for the user's or the context's previous state, retrieves all pertinent data, and loads in all the necessary websites, tabs, logins, and components to match that previous state. Graphical indicator 1626 indicates to the user what context is currently open (the project corresponding to the GUI depicted in FIG. 16C). The graphical indicator 1628 illustrates all the workflow components (e.g., applications, task, and third-party items) to which the use has access (e.g., the user has open). In some embodiments, open tabs, illustrated in the graphical component 1628, maybe stated, such that the user can always access them. For instance, the analytics server may display icons associated with the workflow components, such that the user can view/access them as a browser tab.

When the user closes a workflow component, such as an application, changes tabs, visit the website, or performs any action, the analytics server saves/stores the state/status of the user, such that the user can terminate any or all parts of the graphical user interface shown here. In that way, when the user re-initiates the workflow component, the analytics server can display a latest status of the workflow component.

The graphical components 1630B-M illustrate sections where a user can pin (e.g., permanently pin) resources to the GUIs described herein. Graphical user interfaces provided by the analytics server provide easy methods for a user to link key websites, documents, contacts, messages, applications, and other resources to a given context so that users can easily access the content. The analytics server allows the users to access the pinned content, even after the user has terminated the application itself. For instance, graphical component 1630C illustrates that a user has previously pinned a working document titled “native mile product forecasting.” Even if the underlying document is no longer active (e.g., the user has terminated or closed the document or the application that hosts the document), the analytics server provides the user the opportunity to have access the document using the graphical component 1630C. For instance, the user can re-initiate and view this document by interacting with the document's icon.

The graphical component 1630B shows a given application and account that is also pinned. The user can choose to show different things for a given application. FIG. 15D (or 16D) illustrates alternate embodiments of these pinned sections where user is able to pin various workflow component (e.g., tasks, files, and messages) to a browser provided by the analytics server (e.g., a native application provided by the analytics server). Alternate embodiments of these sections include being able to pin sections showing live data embedded within units of work and widgets that show live data within applications and systems as illustrated in FIG. 15/8D.

Referring back to FIG. 16C, the user is able to have certain shortcuts associated with that given application, or can change the view to see recently viewed, starred units of work, activity, notifications for that application, and the like. The graphical component 1632 illustrates how the analytics server may organize various categories of files and/or workflow components.

In some embodiments, the workflow components may include content that is shared with other projects or context. For instance, the graphical component 1630A/E illustrates pinned resources that may correspond to more than one contexts. In essence, the content pinned and illustrated in the graphical component 1630A/E represent links shared between two different contexts. This may be similar to the links between files or other nodes within the neural data structure. Similarly, the analytics server can recommend these associations. However, links between contexts may be different in that they can be shared metadata tags for resources or units of work relevant to both sections. Therefore when linking two contexts together, users may create a shared section both contexts, which essentially represents an intersection between the contexts. In the depicted example, the user has a context for “Contracts” (1630A) and a context for “Research” (1630E). In an embodiment, interacting with the “contracts” context would cause the analytics server to show a number of other sections for a variety of clients, one of which is “Client 12-Superhoops.” Similarly when looking at each client's context, the analytics server would show a contracts section in each.

The graphical user interfaces described herein help users view pertinent data associated with each project. The users can simultaneously work across multiple applications, platforms, and the like. The graphical user interfaces described herein provide sharing features to onboard collaborators to different projects, across all different applications and accounts. The analytics server can also augment users' web browsing with useful data related to various contexts using the nodal data structure described herein.

As depicted in FIG. 16E, the analytics server may display various notifications and messages specific to a project/context. For instance, the graphical component 1634 illustrates that the analytics server indexes all files, messages, tasks, notifications, starred items, and the like for every integrated application and/or context. The analytics server may index workflow components and organize all relevant workflow components as they relate to a specific application, contacts, project, or any other category selected by the user (e.g., graphical component 1636).

As depicted in FIG. 16F, the analytics server allows the user to transmit and share any workflow component (e.g., file, context, and the like) with other users. The analytics server provides the user an option to select a workflow component and further select a user where the analytics server shares the selected content with the recipient (e.g., graphical component 1638). The analytics server may also allow the user (sender) to select editing permissions for the recipient of the content.

As depicted in FIG. 16G, the analytics server provides a search functionality where the searching is limited by a category, context, or any other attribute selected by the user (e.g., attribute received from the user). For instance, a user may select a project (as depicted, project “client 12—D2C shirts”). The user may then use the search bar provided by the analytics server and input a query. Upon receiving a text string entered by the user, the analytics server may identify, within the nodal structure, relevant data that correspond to the query inputted by the user and the project selected by the user. The analytics server may display the results in the graphical component 1642. As depicted, the analytics server may also populate the graphical element 1640 where notifications, starred workflow components, content, messages, contacts, and shared content associated with the inputted query and the selected project are displayed. The user may access all the information mapped and filter the information using categories described in the graphical element 1640. Using the methods and systems described herein, the analytics server may search for and display content related to local browsing history; open tabs and last used state of context; websites, applications, and resources pinned to context; sharing settings; and units of work mapped to a particular project/context.

FIGS. 16H-M illustrate how the analytics server can display units of work like notifications, messages, files, tasks, and contacts associated with a particular context. The graphical user interfaces described herein provide an app-like experience where data is arranged based on respective context (e.g., arranged based on various attributes), easy to access, and easy to search. In some embodiments, the analytics server may monitor user's interactions with various features displayed on these graphical user interfaces. For instance, the analytics server may track how long a user interacts with file accessed through a context (customized GUI). The analytics server may then use the track time to attribute the users worked hours to a particular project as described herein.

For instance, a user can search for data associated with the “Client 12—Superhoops” project. The analytics server may first identify a cluster of nodes within the nodal data structures described herein. The analytics server may then conduct a search for the inputted query within the identified cluster of nodes.

By limiting the search to the cluster of relevant nodes, the analytics server may increase efficiencies and provide better and more relevant results (FIGS. 16H-M). As depicted in FIG. 16H, the analytics server may display all relevant notifications. As depicted in FIG. 16I, the analytics server may display all relevant messages. The retrieved messages may belong to different (internal or external) applications and messaging protocols. However, all the retrieve messages are relevant messages to the selected project. As shown in the right-hand side of FIG. 16I, the reasons for why certain messages are displayed is described, including but not limited to, messages accessed in that context, comments on files related to that context, suggestions based on other user's activity, etc. As depicted in FIG. 16J, the analytics server may display all relevant files. An alternate embodiment of the relevant files is shown in FIG. 16D. Finally, as depicted in FIG. 16K, the analytics server may display all relevant tasks, which may or may not belong to the same application. The analytics server may also provide the users with the option of sorting and/or filtering the retrieve content based on various attributes selected by the user.

In some embodiments, graphical user interfaces or at least parts of the described GUI features may be integrated into third-party application. For instance, features described herein can be integrated into a third party (or sometimes internal) messaging application as depicted in FIGS. 16L and 16M. For instance, one or more features described herein can be displayed as a part of the depicted messaging application (e.g., graphical element 1644). Moreover, the analytics server may use the methods and systems described herein to sort/filter messages based on various attributes received from the user. For instance, messages displayed in the graphical element 1646 belong to different messaging applications. However, the analytics server displays the messages, such that they are sorted based on context (e.g., project) not time or the sender.

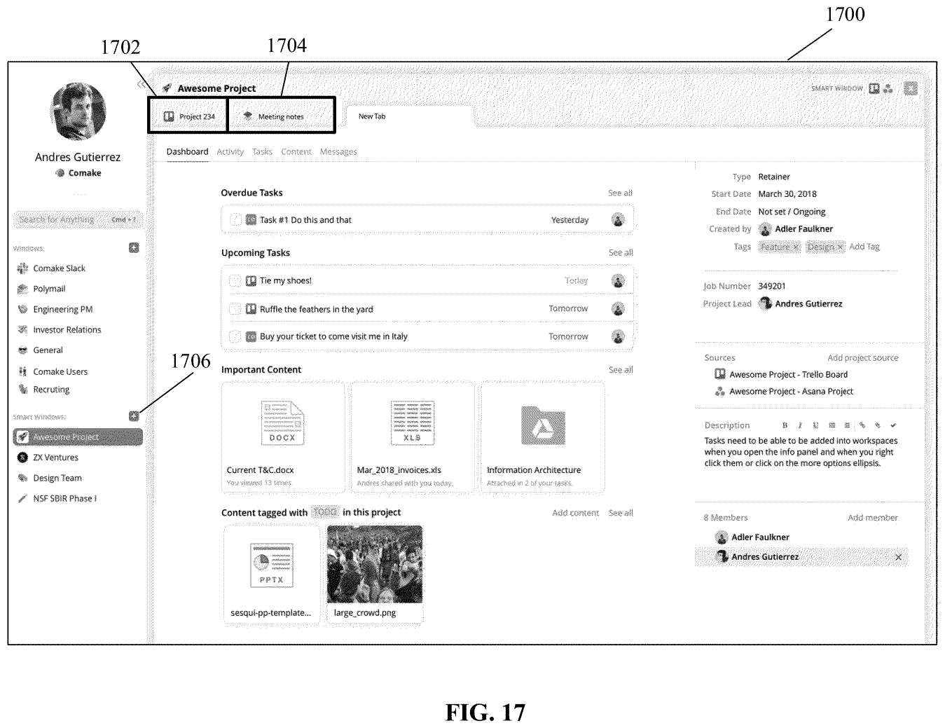

In some configurations, a user may generate multiple “smart windows” and customize graphical user interfaces where each customize graphical user interface corresponds to an attribute. As described in GUI 1700 (FIG. 17) a user may generate different dashboards that correspond to different contexts. For instance, browser tab 1702 and 1704 are applications opened by the user that may correspond to “Awesome Project”. The user may use the graphical element 1706 to create new contexts or smart window, such that each new tab within the window shows a contextual dashboard in the new tab page. This contextual dashboard can show all relevant units of work as described herein. Contexts can be embedded within one another such that one context can be experienced by the user as hierarchically nested within a different context. Similarly, users can pin and relate applications, accounts, systems, resources, and units of work with a given context. For instance, “Project 234” may be a project in Trello® that is a part of “Awesome Project.” The user is easily able to open Project 234 in its native Trello® interface, as well as view the relevant tasks without opening Trello® by looking at the dashboards.

Using the methods and systems described herein, the analytics server may display various workflow components (e.g., files, messages, tasks, and other related content) within each smart window. The user may dictate how various data is displayed within each smart window. For instance, the analytics server may sort the content chronologically. In another example, the analytics server may use multiple attributes to sort the content (e.g., sort by due date, creator, and assignee).

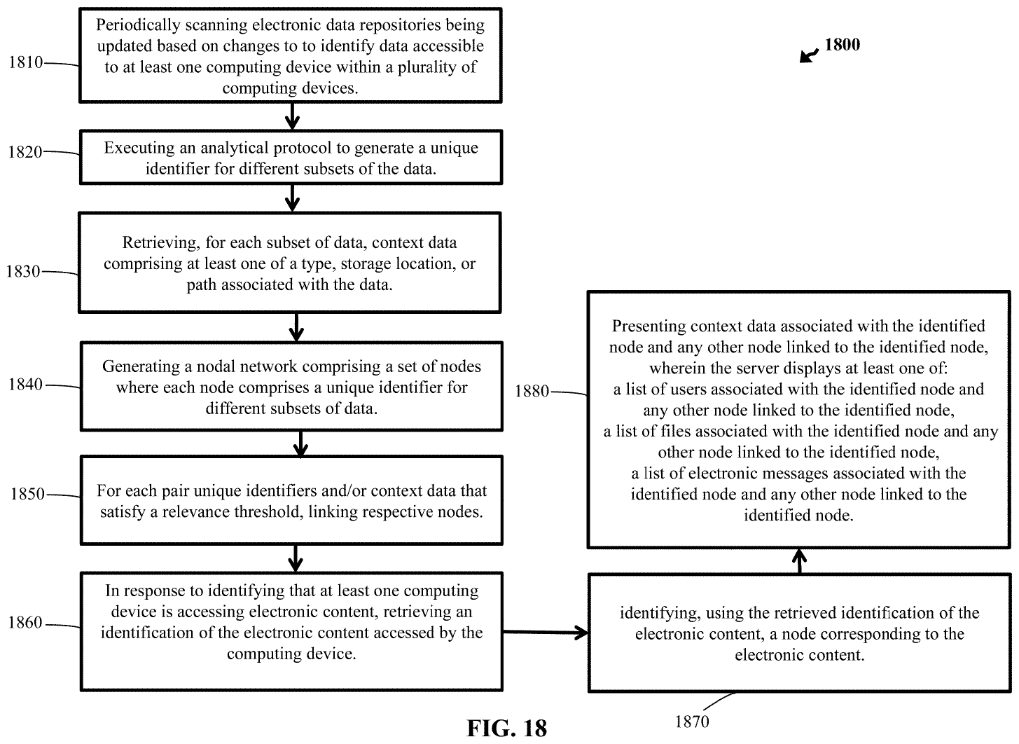

FIG. 18 is a flow diagram of a process executed in a work (or workflow) management system, according to an embodiment. In steps 1810-1850, the analytics server may generate a nodal data structure representing related workflow components or units of work (e.g., files, web-browser history, etc.), as described above. For instance, the analytics server may periodically monitor various files accessible to a network of computers and may generate a representative nodal data structure. The analytics server may also monitor user interactions with those files.

The analytics server may then use one or more of the analytical protocols described above to identify whether two nodes (representing two different files) are related. For example, the analytics server may use the hashing algorithms to identify whether the two nodes represent the same file (e.g., are copies of the same file). In some configurations the analytics server may generate contextually aware unique identifiers for two different units of work that might not be immediately adjacent nodes in the nodal data structure, but that are regardless related to the same topic. For example, two different text string references to the same project articulated using different vocabulary in two different mediums (e.g., a local file and an email) might be understood to be related by the analytics server through an analysis of the known data points and units of work associated with each text string. In an alternate embodiment, a user could manually link both text strings as being related to the same topic. Once the analytics server establishes, through analytical means (e.g., topic modeling) or otherwise, that both text strings are related, and referencing the same topic in this example, the analytics server might generate a unique identifier linking both units of work together.

Even though aspects of the methods and systems described herein may be described in the context of files or units of work, it is expressly understood that these methods and systems are applicable to any data, such as data that may represent units of workflow (also referred to herein as a unit of work). For example, a “file” or “unit of work” may also include any data that is generated as a result of a user interacting with his/her computer that can be contextualized (e.g., file, message, email, thread, contact, task, activity event such as a create or a read event, date and time stamp, physical location, software application, project, class, deal, product, brand, story, client, website, phone number, user-generated tag, machine-generated topic, and the like).

A unit of work for an action performed can be represented by a file, data record, and/or any instance representing the data record. For instance, a unit of work may refer to data created as a result of a user performing an action (e.g., creating a task or transmitting a message to another user). In some embodiments, the data created (and/or the unit of work) may itself be a file (e.g., document file).

Also, as described herein, “electronic content” refers to the content/data being accessed (e.g., displayed or otherwise outputted) by a user. A non-limiting example of electronic content may include a website, and email, and/or a task. Using the methods and systems described herein, the analytics server may identify and display units of work (stored within the nodal data structure) that are relevant to the electronic content being accessed by the user. For instance, when a user is viewing a website (electronic content), the analytics server may display a chat message and a document (examples of units of work) that are relevant to the website using various GUIs described herein.

The electronic content may also include a series of layered/nested contextual information about the content being presented (e.g., viewed on the user's device). For instance, a user may be logged in as an employee of company X and is accessing a smart window (or any other browser application). The user may be viewing a web application (on website) within the smart window or the browser application. Specifically, the user has opened a word file within the web application. The word file includes an image. In this example, electronic content include all data corresponding to the web application, website, the word document, and the image itself. Specifically, the electronic content may include information about that image and all that context about how, where, and in what context the user has accessed the image.

In some configurations, the electronic content may be the same as the unit of work. In those embodiments, the electronic content being accessed by the user is a unit work that corresponds to information within the nodal data structure. For instance, the user may be viewing a document file (unit of work) and the analytics server may display relevant software applications and contextual actions associated with them, a relevant email and contextual actions associated with it, or other document files (unit of work) and contextual actions associated with them using various GUIs described herein.

Moreover, the analytics server's presentation of data is not limited to displaying the content using GUIs. In other configurations, the analytic server may present the data using CLIs (command line interface), NLUI (natural language user interface), API, Brain-computer interface (BCI/NCI), other sensory measurements that can be used as interfaces/inputs for the analytics server, etc.

The analytics server may use artificial intelligence modeling (e.g., machine learning) techniques described above to determine whether two nodes (corresponding to two units of work, such as an email and a chat session, electronic file, and/or online browsing session) are related. In some configurations, the analytics server may execute one or more AI models using context data retrieved for each file to identify whether two or more files/nodes are related. For instance, the analytics server may identify two nodes/files as being related to each other (and ultimately to a project) because they are accessed by team members working on the same project and that the two nodes/files have been attached to an email between the two team members where the email contained content related to a particular project.

The analytics server may continuously monitor the computers and revise the nodal data structure accordingly. The analytics server may continuously or periodically monitor each computing device within one or more networks of computers. For instance, the analytics server may monitor every computer operated by users (e.g., employees of a company). The analytics server may monitor a unit of work such as a web application displayed on an electronic user device via a software (e.g., a browser extension, a desktop background process) that executes on any computing device operated by a user (e.g., computer, tablet, and/or phone). The analytics server may monitor multiple electronic devices and various applications executing on the electronic devices. The analytics server may also subscribe to or otherwise be notified of relevant activity from electronic devices rather than or in addition to continuously monitoring. The analytics server may communicate with various electronic devices and monitor the communications between the electronic devices and the various servers executing applications on the electronic devices. The analytics server may also monitor one or more units of work via software that executes on a computing device (e.g., a remote server) that is providing data to a computing device operated by a user. As a result, the analytics server may periodically revise the nodal data structure when new relationships and association are identified.

At step 1860, the analytics server may, in response to identifying that at least one computing device is accessing electronic content, retrieve identification of the electronic content accessed by the computing device. Additionally or alternatively, in response to identifying that at least one computing device is accessing at least one unit of work in a “working session”, retrieve identification of any unit of work accessed by the computing device.

When the analytics server identifies that a user is accessing electronic content on his/her computer, the analytics server may analyze the electronic content to identify one or more nodes that are relevant to the electronic content. For instance, the analytics server may parse the words within a website being viewed by a user or analyze the website using its URL. The analytics server may use this data to search within the nodal data structure and to identify relevant nodes that correspond to different units of work (e.g., files, chat messages, and emails).

Additionally or alternatively, the analytics server may augment the analysis described above by also analyzing other content accessed by the user/computer. For instance, the analytics server may also analyze data associated with different applications being used by the user (e.g., if the user is also accessing a billing software while viewing a website, the analytics server may analyze the user's interactions with the billing software). The analytics server may also analyze other units of work that are accessed by the user and their context data. For instance, if a user is viewing a website and a file at the same time, the analytics server may analyze the file (e.g., identify a node associated with the file) and its context data (e.g., what the folder file is in, a project associated with the file, data embedded in the file, timestamp indicating how the user has interacted with the file, and the like).

Using the identified data, the analytics server may identify relevant data stored onto the nodal data structure and may present the relevant data to the user or to other software applications, such that the user/software can choose to focus information around any of these nodes as they see fit. Given that the analytics server may identify many relevant nodes to the electronic content being displayed on the user's computer, the analytics server may use the above-described analysis to only show relevant data to the user.

In a non-limiting example, the user is accessing a website that is identified to be relevant to ten nodes associated with five projects. Because the user also has a file open that is identified to be associated with one of the five projects, the analytics server prioritizes the nodes relevant to the identified project.

In another non-limiting example, the user is accessing a website that is identified to be relevant to ten nodes. The analytics server also analyzes the user's “working session” and identifies that the website the user is viewing includes an email that has an attachment with an embedded image of an invoice that is associated with a particular project. As a result, the analytics server prioritizes nodes that are relevant to the website being viewed by the user that are also relevant to the identified project. For example, the analytics server may present and prioritize: relevant data and actions associated with the general navigation of web pages; relevant data and actions associated with the general navigation of email messages and webpages, as well as general context data and actions associated with the specific email app being used; contextual data and actions associated with of the identified email message and related data, including message thread, people, message content, attached files, etc.; and/or contextual data and actions associated with to the identified project and its associated nodes such as contributors, key files, dates, and more.

In some configurations, the analytics server may generate contextually aware unique identifiers for two different units of work that might not be immediately adjacent nodes in the nodal data structure, but that are regardless related to the same topic. For example, two different text string references to the same project articulated using different vocabulary in two different mediums (e.g., a local file and an email) might be understood to be related by the analytics server through an analysis of the known data points and units of work associated with each text string. In an alternate embodiment, a user could manually link both text strings as being related to the same topic. Once the analytics server establishes, through analytical means (e.g., topic modeling) or otherwise, that both text strings are related, and referencing the same topic in this example, the analytics server might generate a unique identifier linking both units of work together.

The analytics server may continuously or periodically monitor and/or subscribe to or be notified of relevant activity from each computing device within one or more networks of computers. For instance, the analytics server may monitor every computer operated by each user (e.g., employees of a company). The analytics server may monitor a web application displayed on an electronic user device via a browser extension executing on any computing device operated by a user (e.g., computer, tablet, and/or phone). For example, a user may be accessing an online document that has a task embedded within it through a document editing application (e.g., Dropbox Paper) within a smart window in a web browser during a time in which said user is in a meeting registered through a calendar event. In this scenario the user's working session has several units of work that may be identified, including the application being used, the document being worked on, the task within the document, the smart window in which this is all open, and the calendar event that lines up with the current time.

The analytics server may also monitor multiple electronic devices and various applications executing on the electronic devices. The analytics server may also communicate with various electronic devices and monitor the communications between the electronic devices and the various servers executing applications on the electronic devices. For instance, the analytics server may monitor data packages received and sent by each electronic device to monitor the content of what is displayed/executed on each electronic device. The communication may take any suitable form. For example, the electronic device may execute a browser application having an application and/or an executable file that enables a user to navigate to the webpage. The analytics server may monitor all applications causing the electronic devices to perform an action, such as display a document, print a webpage, edit a spreadsheet, share or record the user's screen, render a mobile version of a website, or another form of electronic content to which a user may navigate/access online or offline.

The embodiments of the present disclosure are not limited to webpages/websites accessible via a browser application. The analytics server may monitor electronic devices operated by users to identify any electronic content accessed by the users. For instance, disclosed methods and systems are also applicable to end users accessing local files (files stored locally or on a private network, such as a company network), local tasks or reminders, local contacts, strings of text representing physical addresses or email addresses on locally stored files, etc. For clarity, certain embodiments disclosed herein use a website as a non-limiting example of electronic content accessed/viewed by a user.

When the user performs an activity on a browser application of the electronic device, the analytics server may track the user's activity and current “working session” in order to determine relevant units of work that may be present, such as the application that is open, the electronic content open within said application, any potentially embedded electronic content, and any other contextual information related to who is working on what, how, when, where, and why on the electronic device. The analytics server may use several techniques to track the user's activities on the electronic device, such as by tracking browser cookies, IP addresses, screen-scraping protocols, and information embedded in the URL address. In one example, the analytics server may track the user's activity using IP address. In another example, the analytics server may track the user activity by storing user's web browser cookies. The analytics server may store the cookies as text strings on the user's electronic device local drive, and the cookies may be sent to a system server by the analytics server for user session tracking.

In yet another example, the analytics server may track a user's activities using information embedded in a URL string on a browser application of the electronic device. The analytics server may implement the tracking process by communicating with a webserver (in communication with the electronic device) appending a tracking or query string onto the URL string at the electronic device prior to sending the URL string to a browser. When a web browser accesses the content using the URL embedded with tracking information, the web browser sends the URL string back to a webserver. By monitoring the embedded information, the analytics server may track user activities and then identify a webpage the user is accessing.

In some configurations, the analytics server may locally install a software application (e.g., a web browser extension) onto each user's electronic device. The software application may continuously/periodically track the user's activity and identify which websites have been accessed by the user. The software application (executable file) may be executing as a background process of the electronic device. For instance, the software application may be transparent to the user operating the electronic device. In this way, the analytics server is able to monitor the user's activities and “working session” without disturbing the user and/or disturbing the display screen of the electronic device. The software application may remain in the background (e.g., transparent to the user) until and unless the analytics server displays a pop-up window (or other GUIs) displaying relevant information in the foreground. This pop-up window (or other GUI or GUIs) may be initiated automatically by the analytics server or by the user manually requesting contextual information and/or actions.

The methods and systems described herein may apply to any electronic content accessed by the user, regardless of the platform on which the content is presented. For instance, the electronic content, as described herein, may apply to text viewed by the user (e.g., on a website, on an application executing on the user's computer, such as an email application) and/or images viewed by the user (e.g., an image embedded in a file, such as a PowerPoint file) or an image viewed in an email, or another file attached to an email.

The analytics server may collect the content viewed or accessed by the user's computer and execute various parsing protocols to parse the data. For instance, the analytics server may parse the words and execute natural language processing protocols to identify the words displayed within a website. In another example, the analytics server may capture a video displayed on a user's computer and may execute a facial/object recognition protocol to identify the people and objects within the video.

At step 1870, the analytics server may identify, using the retrieved identification(s) of the unit(s) of work, any node(s) corresponding to the electronic content being accessed on the user on the computer. In some configurations, the analytics server may determine an identification of the electronic content (e.g., webpage) presented or otherwise selected or accessed on or through the electronic device, as well as the identification of the software application through which the electronic content is being accessed (e.g., browser), the identification of the smart window that is open or project/context being worked on/in, the identification of the user accessing the electronic content, and so on. The analytics server may obtain the identity of the unit(s) of work and electronic content using a stored profile, cookies, IP address, request for input of an identification, domain, URL, operating system SDKs, APIs, recording the screen or user interactions and discerning identifiers through analytical protocol(s) (e.g., computer vision process to recognize a website URL as text on screen that can be matched with a unique identifier) or any other identification method. If the electronic device has accessed a local file, the analytics server may identify an application being used to access the local file a file path associated with the local file.

The analytics server may then determine if the unit(s) of work is/are associated with at least one node within the nodal data structure, and the analytics server may present information relevant to the node. In some embodiments, the analytics server may generate a unique identifier (e.g., hash value) for the electronic content and/or unit(s) of work presented on the electronic user device. The analytics server may then query the nodal data structure to identify whether the unique identifier of the electronic content and/or unit(s) of work matches any unique identifier stored within the nodal data structure.

In some configurations, the analytics server may query a table to identify whether the identified unit(s) of work (e.g., URL of the website displayed on the electronic device, the application through which the website is being displayed, and the “smart window” currently open within the operating system and/or application) is/are associated with any context data of any nodes within the nodal data structure. For instance, when the analytics server identifies that an electronic device has accessed XYZ.com, the analytics server may query all context data to identify whether XYZ.com is relevant to any nodes, or is itself a node, within the nodal data structure. The analytics server may use hard factors and/or soft factors to identify relevant nodes to the units of work, including electronic content, presented on or through the electronic device.

In some configurations, the analytics server may capture various data fields associated with a unit work traditionally understood as “metadata” (e.g., dates, permissions, tags, and folders/folder paths). As a result, the nodal data structure can be generated and periodically revised, such that different clusters of nodes (each representing one aspect of a unit of work) can correspond to a project or any other segmentation of the data. For instance, a cluster of nodes may correspond to a file and another cluster of data may correspond to a department within an organization.

The analytics server may generate a unique identifier associated with the units of work collected and/or content parsed or otherwise understood by the analytics server (step 1860) and use various analytical protocols to generate at least one unique identifier associated with the units of work collected and/or parsed content. In a non-limiting example, the analytics server may use MD5 hashing or the AI models discussed herein. The analytics server may then use the unique ID to identify related nodes. For instance, the analytics server may compare the unique ID of the contextually-understood-content and units of work accessed by the user to information associated with people, files (and other units of work), messages, tasks, data/time, physical locations stored within the nodal data structure.

In order to identify relevant people, the analytics server may evaluate the unique ID (generated based on the content being accessed by the user) with data corresponding to the following attributes of users whose data is stored within the nodal data structure: email address, phone number, address, social profile data, website, names, birthday, ID number, social security numbers, and Other metadata/properties (e.g., associated application/service provider where data may have originated, date profile was created, people who edited profile, etc.).

In order to identify relevant files, the analytics server may evaluate the unique ID (generated based on the content being accessed by the user) with data corresponding to the following attributes of files within the nodal data structure: file contents; file ID, Website, and/or URL; file title and other file metadata and properties (e.g., associated application/service provider, folder, size, date modified, tags, time stamps, etc.). The analytics server may also analyze the content of the data/metadata associated with the files or other filed embedded within the files (e.g., unique combinations of keywords, locations, time stamps, etc.).

In order to identify relevant messages, the analytics server may evaluate the unique ID (generated based on the content being accessed by the user) with data corresponding to the following attributes of messages within the nodal data structure: message contents; message ID, thread ID, Website/URL embedded within the message, message subject; other metadata/properties (e.g., associated channel/application, sender/receiver, time stamps, etc.); analysis of data/metadata (e.g., unique combinations of keywords, addresses, time stamps, etc.); and MD5 Hash/some other analysis or preprocessing of message (including contents and/or metadata) that result in unique ID or other metric that allows for identification of identical (or comparison of similar) messages.

Non-limiting examples of messages, as used herein, may include text messages, chat messages, email messages, comments, and threads.

In order to identify relevant tasks, the analytics server may evaluate the unique ID (generated based on the content being accessed by the user) with data corresponding to the following attributes of tasks within the nodal data structure: task contents, task ID, Website, URL; task title; other metadata/properties (e.g., assigned to, due date, date modified, project, edit history, comments, subtasks, etc.); Analysis of data/metadata (e.g., unique combinations of keywords, people, time stamps, etc.); and MD5 Hash/some other analysis or preprocessing of tasks (including contents and/or metadata) that result in unique ID or other metric that allows for identification of identical (or comparison of similar) tasks.

The analytics server may also identify related content based on timelines accessed by the user. For instance, a user may be viewing an email that includes a particular date and time. The analytics server may use the methods and systems described herein to identify whether the identified time is related to any content stored within the nodal data structure. For instance, the time being viewed may be related to an ongoing project (e.g., deadline for deliverables).

At step 1880, the analytics server may present context data associated with at least one of the identified node and any other node linked to the identified node, wherein the context data comprises at least one of a list of users (e.g., people, collaborators, and/or other employees), a list of files, or a list of electronic messages associated with the at least one of the identified node and any other node linked to the identified node. The analytics server may present searchable contextual data and contextual actions associated with the identified node(s) and any other node linked to the identified node(s), wherein the server presents at least one of a list of users associated with the identified node and any other node linked to the identified node, a list of files associated with the identified node and any other node linked to the identified node, a list of electronic messages associated with the identified node and any other node linked to the identified node.

In response to identifying one or more nodes associated with the presented electronic content, the analytics server may present an indication corresponding to the file associated with the identified node. The analytics server may also present indications associated with any other files (and nodes) related/associated with the identified node. Furthermore, the analytics server may also present all context data associated with the identified nodes.

The displayed GUI (or CLI or non-visual interface) may present related units of work and actions grouped by context or project. The GUI (or CLI or non-visual interface) presented by the analytics server may also allow users to consolidate all relevant files, such that users can easily work across accounts and navigate through various types of electronic content, units of work/context data. For instance, even if different files are stored within different platforms, a user may access them (if they are designated as related) using the same platform via the displayed GUI (or CLI or non-visual interface).

In a non-limiting example, when a computer operated by a user within a network, for instance, a team member or an employee, accesses a website, the analytics server may display a helpful pop-up window to display relevant information for the user. For instance, if a webpage associated with XYZ.com is displayed on a computer of an employee, the analytics server queries all context data of all nodes within the nodal data structure. The analytics server then identifies whether any node includes data related to XYZ.com and displays a graphical user interface with information relevant to XYZ.com.

The pop-up window (or any other visual or non-visual representation of the related context data and actions) can also be shared with other users. For instance, the user accessing the contextual data and actions (e.g., through a pop-up window) can share any or all data and actions with another user (e.g., via sending an electronic message to the user that links to or attaches the content).

In some embodiments, the analytics server may present the identified data and actions based on a type or category (or one or more attributes within the “working session” associated with the electronic content) of the electronic content accessed by the user. For instance, if the electronic content is a name (e.g., employee name or a client name), then the analytics server may analyze the nodal data structure to identify people. Furthermore, if the electronic content includes any awareness regarding when, where, how, and who (including identified and unidentified units of work) may be accessing the electronic content, it might analyze several nodes together in order to determine the identity of or probability that certain nodes are related to the electronic content. The analytics server may also use this awareness of the broader electronic content/context to prioritize the presentation of contextual data and actions.

When selecting the data to be displayed, the analytics server may weigh the data to be displayed, such that “more important” data is displayed. Therefore, the data to be displayed may be weighted. In an example, the analytics server may weigh certain the contextual data and actions corresponding one unit of work (e.g., the file being viewed may be ranked higher than the application in which the file is being viewed) within the electronic content higher than others. In another example, the analytics server may weigh the identified people based on their respective position (e.g., lead, client, patient, team, applicant (to job, program, etc.), or student) relative to the electronic content being viewed, which may potentially include data about an active user and/or an active project.

The methods and systems described herein may also apply to any electronic content or units of work accessed through non-visual interfaces, such as an application programming interface or a natural language user interface. In a non-limiting example, a software application, system, or service may execute the method 1800 as the user accessing or otherwise retrieving a given unit of work and being provided with contextual data from the analytics server. In other embodiments, a software application, system, or service may take the role of a user and directly query the analytics server by providing some or all known data and/or metadata about the electronic content and/or unit(s) of work to the analytics server through an API. In yet other embodiments a user may verbally (or non-verbally) ask an intelligent personal “assistant” a natural language question about a colleague or a project, and the “assistant” could provide an electronic content and/or identify one or more unit(s) of work, and query the analytics server or otherwise be provided, by the analytics server, with contextual data relating to the electronic content and/or identified unit(s) of work. In some configurations, a simple response to a natural language question could be ascertained with some degree of certainty by reviewing the contextual data related to the electronic content and/or identified unit(s) of work. For example a user may ask the “assistant” a natural language question such as “how long have I known this colleague” and the assistant could ascertain that information by the units of work (e.g., which includes history of communication and activity across accounts) related to the identified unit of work (e.g., this colleague).

In addition to the context data discussed herein, the analytics server may present a list of including at least one contact/user associated with the identified node and any other node (and/or actions) linked to the identified node. For instance, the analytics server may identify one or more coworkers (users) who are related to the identified node.

In addition to the context data discussed herein, the analytics server may present a list of files, documents, notes, and other units of work associated with the identified node and any other node (and/or actions) linked to the identified node. Additionally or alternatively, the analytics server may present an electronic message associated with the identified node and any other node (and/or actions) linked to the identified node. Additionally or alternatively, the analytics server may display a task associated with the identified node and any other node (and/or actions) linked to the identified node.

FIGS. 39A-32 illustrate non-limiting examples of how the analytics server can present relevant information and actions on a user's electronic device, according to various embodiments. FIG. 39A-C illustrate how the analytics server presents relevant context data when a user is browsing the web. In FIG. 39A, an electronic device operated by an employee uses a browser application to access GUI 1900. In the depicted embodiment, GUI 1900 represents a webpage having a URL address 1901. The analytics server may monitor the user's activity and identify the URL 1901 associated with the webpage (GUI 1900). The analytics server may accomplish this task using a browser extension and via a background process, such that the analytics server does not obfuscate any part of the GUI 1900.

The analytics server may also accomplish this task by recording the what the user is viewing on the screen or otherwise capturing the communication provided by the computing device to the user and identifying, using certain analytical processes (e.g., computer vision to process the image output by the computing device to a screen) to recognize applications, file paths, and other units of work in the current “working session”. In some configurations, the process of monitoring the user's activity, through back-end (e.g., API) and/or front-end (e.g., computer vision) processes, is completely transparent to the end user.

If the URL 1901 does not match any data stored within the nodal data structure, the analytics server may not display any GUIs (or CLI or non-visual interfaces in other embodiments) and the user may not receive any context data. However, in some embodiments, when the analytics server does find a match for URL 1901 within the nodal data structure, the analytics server may create a node associated with URL 1901 in order to relate it to other identifiable units of work such as the open application, the smart window, the user, etc. When the URL 1901 does match data stored within the nodal data structure, the analytics server may display the pop-up window 1910. The pop-up window 1910 may include various graphical components 1911-1915 where each component represents context data grouped together in accordance with predetermined rules and/or the user's preferences. For instance, the graphical component 1911 may display an indication of the unit of work (e.g., webpage) displayed on the electronic device that corresponds to the URL 1901.

The graphical components 1912A may display data associated with any nodes associated with the URL 1901 and/or any nodes that otherwise reference a node for which the URL 1401 is a unique identifier. In a non-limiting example, the analytics server may display relevant electronic files (e.g., documents, notes, audio files, and video files) and messages (e.g., emails, chats, comments) that include the URL 1401 as text or a hyperlink within their contents. The users can customize these graphical components, such that they display customized categories of data and/or actions. For instance, a user may customize the graphical component 1913A to only display audio files or documents.

The graphical components 1912A may display several different types of units of work (e.g., files, messages, other websites, voice notes, video call recording, activity event, calendar invite, etc.) which include within them a “reference” to the same URL as the URL 1901, or a reference to a node for which the URL 1901 is a unique identifier. The analytics server may identify all units of work associated with the URL 1901 (e.g., embedded content, metadata, associated application, associated smart window, etc.). In some configurations, the analytics server may also display webpages from a user's browsing history that reference a given unit of work (e.g., URL 1901). In other configurations, the analytics server may also display any electronic content that has previously been presented to the user through a computing device (e.g., shown on an electronic device's display that is monitored by the analytics server, read out loud to the user by an intelligent artificial assistant, and/or presented to the user through some computing device that is not directly monitored by analytics server such that the presentation is recorded by a second computing device that is monitored by analytics server such as a camera) and that references a given unit of work (e.g., URL 1901).

The graphical components 1913A may display any units of work which may be considered content by the user and/or analytics server, such as files and/or websites, and that are related to any units of work (such as files and/or messages) which reference the URL 1901 or a node for which the URL 1901 is a unique identifier. The analytics server may present any unit of work that might be understood or classified as “content” by the user and/or analytics server (e.g., file, note, website, story, video, etc.) and that is associated with the identified node.

Files/links related to referencing files may include any files/links normally associated with each other through syncing/indexing process (e.g., MD5, files that share emails, files that share email threads, files that share slack threads, files that share tasks, and embedded files/links). Files/links related to referencing messages may include any files/links normally associated with each other through syncing/indexing process (e.g., files attached in messages, and/or links embedded in messages).

In a non-limiting example, the analytics server may present, within the related content section 1913B, suggested “content” (e.g., files, websites, notes) that is/are related to node(s)/unit(s) of work (e.g., versions, time stamps, smart window, etc.) within or otherwise associated with related content 1913A-B, and/or related messages 1914A-B. In some configurations, the analytics server may rank the suggested content using a predetermined attribute (e.g., relevance factor, closeness in nodal graph, timestamps). In some configurations, AI and machine learning methods described above can also be used to improve related and suggested content.

The graphical components 1914A may display any units of work which may be considered messages by the user and/or analytics server (e.g., emails, comments, instant messages, call transcripts, voice notes, etc. using internal or third-party messaging applications) and that are related to any units of work (such as files and/or messages) which reference the URL 1901 or a node for which the URL 1901 is a unique identifier. The graphical component 1915A may display other users who may be related to the identified nodes/unit of works (e.g., the URL 1901). For instance, the analytics server may provide a list of all the people (e.g., contacts or users) most closely associated with the nodes/units of work (e.g., the URL 1901, the news app associated with URL 1901, the context/smart window in which the news app is open, etc.) identified within the current “working session” and within the nodal data structure.

In the graphical component 1914A, the analytics server may present any unit of work that might be understood or classified as “message” by the user and/or analytics server (e.g., email, thread, chat message, comment, etc.) and that is associated with the identified node (e.g., any “message” related to any “reference”). “Messages” related to “references” may include any “messages” normally associated with each other through syncing/indexing process (e.g., MD5, messages that share attachments like files, messages that share embedded links, messages that are referenced in the same tasks, messages that are linked to the same project, etc.).

In a non-limiting example, the analytics server may present, within the related content section 1914B, suggested “messages” (e.g., emails, chats, comments) that is/are related to node(s)/unit(s) of work (e.g., files, time stamps, project, tag, smart window, etc.) within or otherwise associated with related content 1914A-B, and/or related messages 1914A-B. In some configurations, the analytics server may rank the suggested messages using a predetermined attribute (e.g., relevance factor, closeness in nodal graph, timestamps). In some configurations, AI and machine learning methods described above can also be used to improve related and suggested messages.

The analytics server may present messages related to any referencing messages. The following are non-limiting examples of a message that is related to a referencing message:

Shared file between two messages: if copies of same file exist in contents of message A and message B.

Shared web-link between two messages: if copies of the same web-link exist in contents of messages A and B.

Shared task between two messages: if the same tasks reference messages A and B.

The graphical components 1915A-B may display people associated with the units of work described above (e.g., collaborators from the “references,” “related content,” and “related messages”). The analytics server may rank users by number of occurrences across these units of work. In some configurations, the analytics server may only show a limited number of users related to the identified node/electronic content.

In some configurations, the analytics server may generate a score for each user associated with the identified node, electronic content, and/or the working session. The analytics server may then select a predetermined number of users (with the highest scores) and display an indicator (e.g., name or nickname) each user accordingly. The following is a non-limiting example of how the analytics server may generate a score for each user associated with electronic content and/or nodes:

In this example, the analytics server may assign 1.5 points per collaboration on copies/versions to each user. For instance, when the analytics server identifies that a user has a known activity associated with a file (e.g., edited the file), the analytics server may assign 1.5 to that particular user. The analytics server may also assign 1 point per collaboration on copies/versions that user has no activity on (e.g., only accessed the file but not edited the file or received a file in an electronic message from another user).

For related content, the analytics server may assign 0.75 points per collaboration on copies/versions of a file/node on which the user has a known activity (e.g., editing or reviewing). The analytics server may assign 0.5 points per collaboration on copies/versions of files/nodes with which the user has no known activity.

For related messages, the analytics server may assign 1.5 points per collaboration on messages that the user has generated and sent. The analytics server may assign 1 point per collaboration on messages that user was mentioned in the “To” field and/or sent slack message. The analytics server may assign 0.5 points per collaboration on messages that user was mentioned in the “CC” field and/or was recipient in a slack direct message.

Using the predetermined set of rules described above, the analytics server may identify the most relevant users to electronic content. The analytics server may then rank the users based on their respective scores. The analytics server may then only display (e.g., suggest) the top five users or any other predetermined number of users. As discussed above, the analytics server may also execute various machine learning and/or artificial intelligence modeling techniques to improve the score and identify users that are most relevant to the electronic content and/or each identified node.

When the user clicks on a name of a contact or a collaborator displayed in the graphical component 1915B, the analytics server may display context data and actions for the selected contact, including a history of communication and collaboration between the user and the selected contact. The analytics server may also identify and display all the files (or other electronic content) shared between the user and the selected contact/collaborator.

Each graphical component may include at least one interactive element that, when interacted with by the user, may display action and links allowing the end user to access relevant files or other content. For instance, when the user interacts with the graphical component 1912A, the analytics server displays the graphical component 1912B that include interactive links to related units of work (e.g., a link to an email with the subject line of “have you read this?!”). When the user interacts with the graphical component 1913A, the analytics server displays the graphical component 1913B that contains interactive links that could direct the user to the identified units of work (e.g., files associated with the identified node).

The analytics server may also display suggested content. For instance, the analytics server may display an indication within the graphical component 1913B informing the user that the analytics server may have a file that may be related to the electronic content displayed on the user's electronic device. As described above, the analytics server may use a variety of techniques (e.g., artificial intelligence, machine learning, and/or hard factors) to identify whether a unit of work (e.g., a file) is related to the electronic content. For instance, the analytics server may retrieve all context data/units of work associated with one or more “reference”, “related content”, and/or “related message” (e.g., timestamp of access, users who have permission to access). The analytic server may then execute predetermined protocols (e.g., AI model) to identify whether a unit of work (e.g., a file) can meet the necessary threshold to be suggested as related to the electronic content.

In a non-limiting example, the analytics server (e.g., executing as local machine or in the cloud) indexes a user's work data (e.g., messages, emails, notes, files, tasks, projects, intranet posts, ERP data, and/or CRM data). The analytics server may index the work data at a predetermined granularity level (e.g., individual level, team level, or all company level). The analytics server then finds, or generates via an analytical process, all “unique identifiers” referenced or embedded within the work data. Non-limiting example of unique identifiers may include URLs (e.g., https://nytimes.com and/or nytimes.com), file paths (c:/my documents/file), email addresses, addresses, phone numbers, people's names, project codes, etc.

In some configurations, the analytics server may generate “unique IDs” from normal/unstructured data (e.g., text and/or images) using AI/machine learning-based clustering algorithms (e.g., topic modeling) to generate potential topics. The analytics server may also generate “unique IDs” from normal/human-readable/unstructured data (e.g., a recording of a screen, an audio or video recording of a meeting, a recording of central nervous system activity or other biological activity, etc.) using AI/machine learning-based algorithms (e.g., computer vision, natural language processing) to isolate units of work and generate unique identifiers that can be matched with or recorded in the nodal data structure.

In some embodiments, the analytics server may use more than generating relationships based on resting data and parsing the contents and metadata of electronic content (e.g., files and messages). Alternative methods of relationship-building/topic-generation could include monitoring a user's working session (including the monitoring of working sessions that are not directly or permanently connected to the analytics server, but that are monitored through sensors, recordings, systems, or other applications that are or can be connected to the analytics server) to understand what is simultaneously open, visible, and/or present in/on a user's workplace, workspace, and electronic device, including what application is in focus, what is open within said application, what are the contents of what is open within said application and if there is anything embedded within said contents, and linking nodes associated with each unit of work (e.g., files) accordingly.

In a non-limiting example, the analytics server may generate a unique ID by identifying whether the user has initiated any applications on his or her electronic device. If the applications executing on the electronic device is/are web applications (e.g., a project management application open in a tab within a web browsing application), the analytics server may retrieve a current URL being viewed on the electronic user device. If the application executing on the electronic device is a desktop application accessing a file, the analytics server may retrieve the file path (e.g., the analytics server mar retrieve a list of open files belonging to a given process executing on the user device).

The analytics server may then use various protocols to scrape content within the file being accessed (e.g., open) on the electronic device. The analytics server may then compare the contents of the file open and being accessed by the electronic user device with context data stored within the nodal data structured (e.g., previously retrieved and indexed based on the user and/or other users' activity) to identify whether the content accessed/open on the electronic user device is related to any other files.

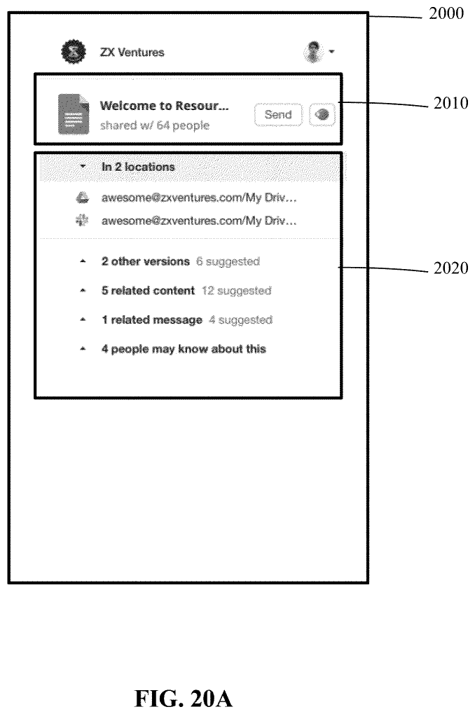

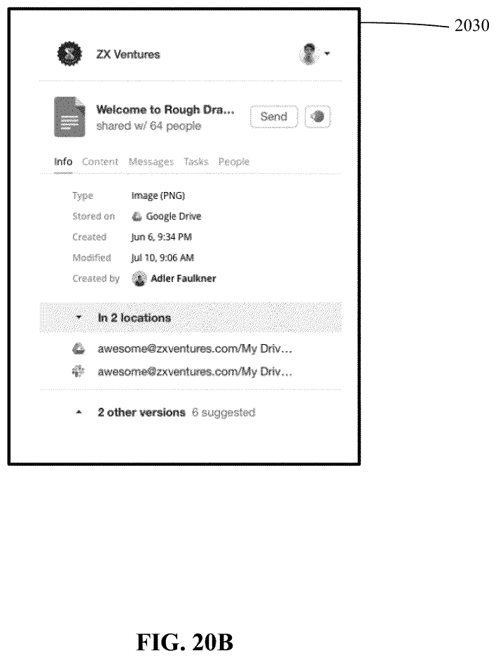

FIGS. 20A-B illustrate a GUI displayed on a user's electronic device when the user has locally accessed electronic content. As a non-limiting example, in this embodiment, the user has locally accessed an electronic file (e.g., an electronic document or a contact) on his/her computer rather than a website.

As described above, the analytics server may monitor the user's activity (e.g., electronic content accessed or viewed on the user's electronic device). The analytics server may then search for or generate unique identifier within the electronic content being accessed and/or viewed on and returns all related associations (e.g., context data associated with related nodes). Rather than utilizing a browser extension, the analytics server may utilize an executable file installed in the operating system that may reside in system tray, for example.

As depicted in FIGS. 20A-B, the analytics server may identify electronic content being viewed as an integrated file or folder (e.g., previously indexed as a “file” or “folder” rather than just a file path, or website URL). The analytics server may then consolidate and show information and metadata specific to that file or type, as well as any other units of work deemed relevant through an analysis of the electronic content (such as the combination of the workspace/company that owns the data, which in this case is “ZX Ventures,” and the user/employee accessing data that together establish the domain of data that the analytics server is able to present in the GUI 2000). For instance, GUI 2000 includes graphical component 2010 that displays an indication of and contextual actions for the electronic file accessed by the user. The GUI 2000 also includes the graphical component 2020 that displays the retrieved context data. For example a GOOGLE DRIVE file can be connected with any references, copies, versions, etc. (as explained above) and the analytics server can recognize a given electronic content as relating to that GOOGLE DRIVE file (e.g., by analyzing the ID in the URL).

The GUI 2000 may display contextual associations (data). The GUI 2000 may include contextual actions (e.g., “open in Comake” button) that allow the user to access, move, copy, send, link, add task, or otherwise interact with the identified file in its native content service or other connected/integrated service (opened by the analytics server), depending on the type of action. For example, the GUI 2000 may include a “send in message button” that may initiate a messaging application and include the file as an attachment to the message. The GUI 2000 may include a “collaborators” tab/section, which may be displayed besides the title of the electronic content accessed (e.g., graphical component 2010) that initiates a collaborators overlay where users can easily access contextual information about people that they collaborate on that file with and/or on related units of work with. The GUI 2000 may include a “locations” component that only displays the copies/locations for the current version of the electronic content displayed (or relevant context data identified).

The GUI 2000 may include a “versions” tab/section, which is a graphical component that illustrates versions of different content (e.g., files) by title and the copies/locations those versions may also be displayed/accessed by the user. The GUI 2000 may include “related and suggested files” tab/section, which may show files and links related to/suggested for this file or folder accessed by the user. The GUI 2000 may include “related and suggested messages” tab/section, which may show messages related to/suggested for this file or folder accessed by the user.

The GUI 2000 may include a “people who may know about this” component or button, which is a section showing collaborators related to the units of work, electronic content identified above, and/or messages above. In some configurations, the analytics server may rank the users based on the number of occurrences across these sources. End users may customize all the above-described features. For instance, an end user may customize this feature and instruct the analytics server not to display more than five users.

The analytics server may also display each identified person individually and may display data related to each individual, as depicted in GUIs 3500-3502 (FIG. 35). The context and contextualized data discussed herein can also be prioritized and/or filtered based on a category of data selected by the end user. For instance, the analytics server may identify data associated with nodes relevant to the electronic content being displayed on a user's computer. When presenting the data the analytics server may filter the data based on a person (e.g., user) or a category of data (e.g., project). As depicted, GUIs 4800-4802 display the context data where they data is only relevant to a particular user.

As described above, interacting with each tab/section described above, may cause the analytics server to display another graphical component that displays detailed data, as depicted in GUI 2030.

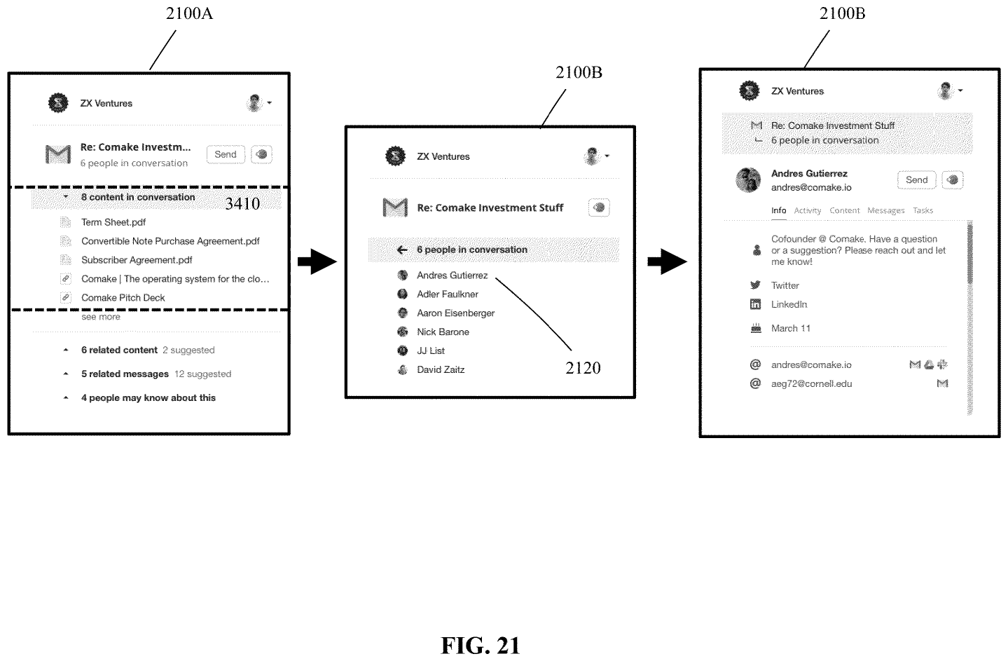

FIG. 21 illustrates a GUI displayed on a user's electronic device when the user has locally accessed electronic content (e.g., the content accessed by the user is also a unit of work). As a non-limiting example, in this embodiment, the user accessed an electronic message that the analytics server has previously indexed as an email.

When the user accesses an email application, the analytics server may monitor the email messages. When the user visits a path (e.g., URL or file path to downloaded messages) that is recognized as an integrated email or email thread (if a path is not available the analytics server can run an analytical process to generate or find a unique identifier for the email message and/or email thread, such as creating an MD5 hash of its contents as described above), the analytics server may display the GUIs 2100A-C. Similar to other GUIs described herein, GUIs 2100A-C can be pop-up windows that display contextual information near the electronic content accessed/displayed (e.g., email displayed on the user's electronic device).

The GUIs 2100A-C may include contextual actions (e.g., an “open in Comake button”) that allows the user to access, move, copy, send, link, add task, or otherwise interact with messages in a messaging application, or other connected/integrated service (opened by analytics server), depending on the type of action. GUIs 2100A-C may include “people in this conversation” tab, which displays all (or a selected portion of) senders/receivers of the email or any email in the thread accessed by the user. In some configurations, the analytics server may not display users who have been “bcc” on email threads.

The GUIs 2100A-C may include “files and links in this email thread” component that displays all files and links attached to or otherwise referenced within this email/thread. The GUIs 2100A-C may include “related & suggested content” component showing units of work determined to be content by the user and/or analytics server (e.g., files and certain websites/links) related to/suggested for this email/thread. The GUIs 2100A-C may include a “related & suggested messages” component that displays messages related to/suggested for this email/thread. The GUIs 2100A-C may also include “people who may know about this” component displaying collaborators from the files and messages above.

In the depicted embodiment, the user accesses an email message and the analytics server displays the GUI 2100A that includes the graphical component 3410 that displays the content attached to (via uploaded file or via hyperlink to cloud-based file) the email displayed (or the email thread). The analytics server may also display people involved in the email displayed on the user's electronic device. For instance, the analytics server may display the GUI 2100B that lists all users involved in the email. In some configurations, the analytics server may not display one or more users based on predetermined rules. For instance, the analytics server may not display all users who have been blind copied on the email thread.

The GUI 2100B may also include an interactive button 2120. Upon the user interacting with the button 2120 (e.g., each user displayed), the analytics server may display the GUI 2100C. The GUI 2100C displays information regarding Andres Gutierrez (interactive button 2120).

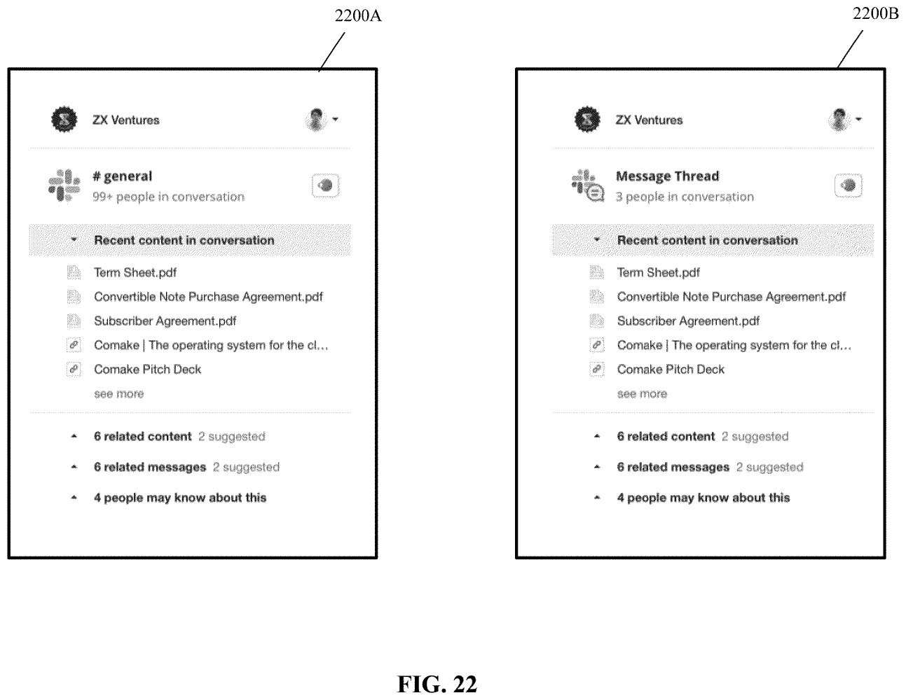

FIG. 22 illustrates GUIs displayed on a user's electronic device when the user has locally accessed electronic content. As a non-limiting example, in this embodiment, the user has accessed is recognized by the analytics server as a group messaging channel that been previously indexed as a group chat/slack channel or direct message.

The GUIs 2200A-B display additional information when a user has accessed a messaging thread. In some configurations, the GUI 2200A displays additional data displayed by the analytics server when the electronic content accessed by the user is recognized as including an integrated slack channel/direct message/thread. In some configurations, the GUI 2200B displays additional data presented by the analytics server when the electronic content accessed by the user is recognized as including an integrated slack thread. The GUIs 2200A-B may include “people in this conversation” component displaying all senders/receivers within the messages displayed in the thread/channel accessed by the user.

The GUIs 2200A-B may include a “recent files and links in this chat” component that displays a few recent files and certain website/links attached to or otherwise referenced within this slack channel or direct message. The GUIs 2200A-B may include “related and suggested content” component that displays files and certain websites/links related to/suggested for this slack channel/chat thread. The GUIs 2200A-B may include “related and suggested messages” displaying messages related to/suggested for this slack channel/chat thread. The GUIs 2200A-B may include a “people who may know about this” component that displays collaborators from the files and messages above.

In some configurations, if the electronic content viewed by the user corresponds to content that is recognized as a message (e.g., comment, reply) that has been previously indexed (by the analytics server) as a thread/comment over a chat message. The analytics server may then display the following components in addition to the above-described components. For instance, the analytics server may display a “related files and messages” that displays related files, links, or messages related to the ones posted in this thread. The analytics server may also display a “suggested files and messages” that displays recent files and messages. The analytics server may also display a “people who may know about this” that displays people (e.g., collaborators) associated with units of work referenced above (e.g., the files and messages above).

Additionally or alternatively, the user can interact with the context data displayed herein (e.g., content displayed within the graphical elements depicted herein) to edit the information identified by the analytics server. The graphical components displaying the context data may be editable (e.g., similar to a live document). As a result, the user may add/edit and/or add other elements/metadata/relationships. The user can also edit (add or remove) any information provided and displayed by the analytics server (e.g., related users, content, and messages). As a result, the analytics server may update the nodal data structure and refine the nodes and their corresponding data using the method, systems, and GUIs described herein.

In some embodiments, the context data may be requested by the user. For instance, the user may be viewing electronic content and may select (e.g., tag) a certain unit of work associated with the electronic content and request the analytics server to display data and actions (from the nodal data structure) that are related to the specific subset of the electronic content. For instance, when a user is viewing an email, the user can highlight a portion of the text (e.g., a name that appears within the email) and instruct the analytics server to display data associated with the selected portion. As a result, the analytics server may use the methods and systems described herein to display related/context data.

The methods and systems described herein allow a user to access data associated with related nodes (e.g., contact information, related files and other workflow information, and other context data associated with the content being viewed by the user) without requiring the user to switch applications. The analytics server may utilize a software application (e.g., a browser extension) to identify and display the data described herein. For instance, the analytics server may highlight/underline/otherwise notify the user that something within the content they are viewing has been identified by the analytics server (e.g., on a browser application, such as checking emails or a native application). When the user interacts with the highlighted content, the analytics server may display searchable contextual/related data and actions as described herein. For instance, the user may hover a cursor over a word within an email displayed on the user's browser and the analytics server may display one or more of the graphical elements and components described above that provide detailed information regarding the word over which the user has hovered.

In another non-limiting example, the user may be viewing an email that contains a physical address. The analytics server may, in real time, search within the nodal data structure. If the physical address is found to be related to a node/unit of work or to be a node/unit of work itself, the analytics server may provide context data associated with the physical address that may be displayed in a pop-up window. The pop-up window or overlay may display emails and other communications that relate to the physical address, calendar events associated with the physical address, other employees associated with units of work (e.g., calendar events) that are associated with the physical address, and information retrieved from other applications, such as accounting software, invoicing software, CRM software, and the like. For instance, the analytics server may indicate that the physical address is associated with a contract and display information related to the contract (e.g., parties associated with the contract, amounts, items sold, services provided, and/or timelines).

The systems and methods described herein can be implemented through/using hardware, operating systems, native software applications, browser extensions, websites, or at the system operator level. For instance, the analytics server may analyze the content that is presented to a human user and that is meant to be easily understood by a user (“human-readable content”) (e.g., image, video, natural language, etc.) in order to try to identify units of work in the working session/electronic content. For example, the analytics server may recognize within a recording or an image of the display screen, on which the “human-readable content” is presented to the user that a web browser is open, and that said web browser is open to a given file within a given web-based application (thereby identifying at least three units of work). Alternatively, the analytics server may recognize that a particular software application (native application, such as an internal CRM application) is open. When implemented at the system operator level, the analytics server may analyze all data accessed/viewed/heard by the user regardless of the application transmitting and/or displaying the data.

The methods and systems described herein can also be integrated with other searching methods, such that the user can query the data within the nodal data structure. For instance, the analytics server may be in communication with a search engine where the analytics server receives query terms, performs the methods described herein to identify appropriate nodes and their corresponding data (query results), and transmits the query results back to the search engine. Additionally or alternatively, the analytics server may display the query results as described herein.

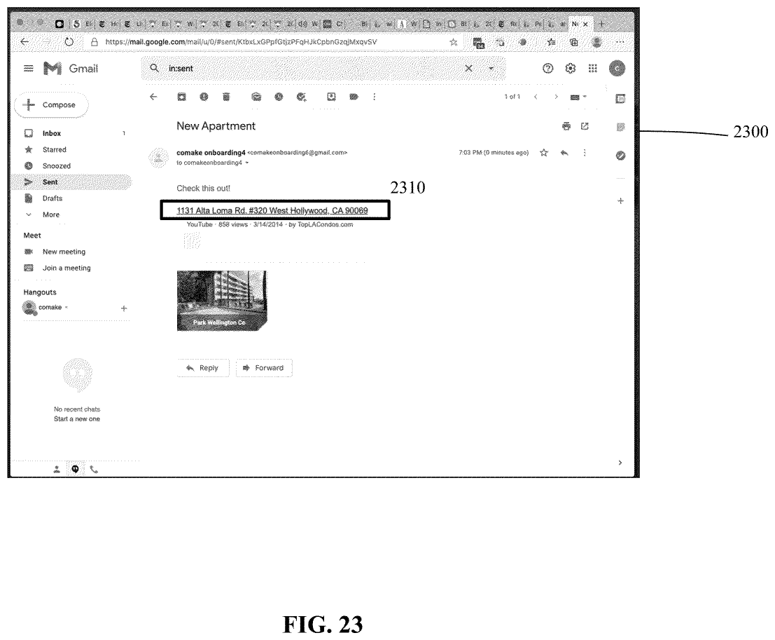

Referring now to FIGS. 23-25, a non-limiting example for displaying/presenting contextual data and actions on units of work that are embedded in the electronic content or that are otherwise identified as being accessible by the user or the screen is shown. In this non-limiting example, a user accesses an email message using a web-based application within using a browser (desktop) application, as depicted in the GUI 2300 (FIG. 23). The contents of the user's email message include a physical address 2310. The analytics server parses the words displayed within the GUI 2300. The analytics server may execute various analytical protocols (e.g., computer vision, natural language processing, regex protocols, etc.) to identify the physical address 2310 as a physical address. The analytics server may then use the physical address as, or generate a new, unique ID for the physical address 2310. The analytics server may then query the nodal data structure to identify context data related to the unique ID corresponding to the physical address 2310. If no node or reference to the physical address 2310 exists in the nodal data structure, the analytics server may create a new record within the nodal data structure.

When the user hovers over or otherwise interacts with the highlighted text 2410 (depicted in GUI 2400), the analytics server displays the GUI 2500 that includes the graphical element 2510. In the graphical element 2510, contextual data and actions associated with the highlighted text 3710 are displayed. Specifically, the analytics server may help direct/provide directions to the user to the location, such as by directing the user to an application or website that displays the map (2512) or displays directions (2514). The analytics server may provide the user with the option of saving the physical address 2410 (e.g., by linking it to a unit of work such as a contact, event, tag, project, or application) (2516). The analytics server may also indicate that it has identified dedicated records such as a record for the address 3710 within a property management system (where the unique ID within that record is also the primary identifier for the user) (2518). The analytics server may also indicate that it has identified one user currently viewing data related to the highlighted text 2410 (2520). The analytics server may also indicate that it has identified four contacts (2522), identified twelve references or documents (2524), and 33 related units of work (e.g., emails and chat messages) that are related to the highlighted text 3710.

When the user hovers over the highlighted text 3710, the analytics server displays the GUI 2500 that includes the graphical element 2510. In the graphical element 2510 displays data associated with the highlighted text 3710. Specifically, the analytics server may direct the user to a third party, such as by directing the user to an application or website that displays the map (2512) or displays directions (2514). The analytics server may provide the user with the option of saving the physical address 3710 as contact and/or linking it to an existing contact (2516). The analytics server may also indicate that it has identified one user currently viewing data related to the highlighted text 3710. The analytics server may also indicate that it has identified four contacts (2522), identified twelve references or documents (2524), and 33 related units of work (e.g., emails and chat messages) that are related to the highlighted text 3710.

In a non-limiting example, the analytics server may be in communication with a search engine that utilizes artificial intelligence assistant to communicate with the user. The search engine may receive a text string from the user. The text string may be a question presented to the search engine in natural language such that the search engine (or the “assistant” or the analytics server) may understand the intention behind the question (e.g., through an artificial intelligence model using natural language processing and/or deep learning models specialized for intelligent search), such as the type (and other properties) of data that the user is looking for as well as what it relates to (e.g., units of work, electronic content, query terms for the analytical server). The analytics server may then use any query terms provided or data provided by the processing of the natural language query to identify one or more units of work within the nodal data structure described herein. The analytics server may identify relevant nodes, retrieve corresponding data, and transmit the retrieved data to the search engine (or a server associated with the search engine, or the “assistant”, or a server associated with the assistant, etc.) for display. The search engine (or the “assistant” or the analytics server) may, in certain configurations, return these answer as links to units of work/other data that contain the answers. The search engine (or the “assistant” or the analytics server) may, in other configurations return a simple answer to the natural language question in a natural language form by using certain analytical processes (e.g., through an artificial intelligence model using natural language processing) suggested answers from the nodal data structure.

Additionally or alternatively, the analytics server may also act as the search engine. Therefore, the search engine, as discussed herein, may be operated by the analytics server or a third party. For instance, the analytics server may display a search engine (e.g., on the user's browser) where the user can input a natural language query. The user can then conversationally ask the analytics server to identify context data related to a unit of work (e.g., email, client, employee, and/or chat sessions). The analytics server may then display the results using the non-limiting examples of the graphical components described herein.

Additionally or alternatively, the analytics server may perform the above-described operation to identify data related to what is being viewed by the user. For instance, when the user views an email, the analytics server may retrieve the sentences displayed within the email. The analytics server may then apply natural language processing algorithms and other analytical protocols (e.g., the artificial intelligence model discussed above that may be operated by the analytics server or a third party) to identify query terms. The analytic server may then query the nodal data structure accordingly. The analytics server may then display the query results using various graphical elements, vernal, or other and components described herein.

For instance, a user may access a search bar generated and/or hosted by the analytics server. The user may input “what were the final deliverables for project X?” While conventional search engines may display a list of deliverables, the analytics server may also display context data relate to project X including employees who worked on the project, address associated with project X, billable hours, and all other data discussed herein using one or more of the GUIs described herein.

Additionally or alternatively, the analytics server may rank the search results based on the data identified within the nodal data structure. For instance, the analytics server may rank the results of the user's search based on an attribute of the nodes identified to be relevant to the user's search. For instance, search results associated a higher number of nodes within the nodal data structure may be ranked higher than another search results. Also, as described herein, certain nodes may be weighted based on their content (e.g., a node associated with a CEO might be weighted more than a node associated with an intern). Therefore, search results may be ranked differently based on the weight of their corresponding weights. As a result, not only the analytics server identifies searchable data, it also ranks them, such that the results are prioritized and tailored based on the end user interacting with the search query.

Referring now to FIGS. 26-27, a non-limiting example of displaying context data in addition to search results is presented. When a user submits a query to the analytics server, the analytics server parses the query and generates query terms. The analytics server then queries the nodal data structure and identifies nodes associated with the query terms. The analytics server then displays the GUI 2600 that displays the search results. Specifically, the GUI 2600 includes graphical components 2602-2620. Each graphical component may correspond to a unit of work (e.g., file, chat sessions, document and/or contact) that is related to the query terms. For instance, the graphical component 2602 indicates that the analytics server has identified an email that is related to the query submitted by the user. Each graphical component may provide a brief description of its corresponding unit of work. For instance, the graphical component 2602 may include the subject of the email, timestamp, recipient(s), and/or other relevant information. Right clicking on the graphical component can reveal contextual data and/or action for the associated unit of work. The user may choose to either open the result in its corresponding application or to see more information about the result in the current search interface.

For instance, when the user selects or otherwise chooses to see more information about the result with a graphical component displayed on the GUI 2600, the analytics server may display the GU 2700 including detailed information, contextual actions, and contextual data regarding the unit of work associated with the selected graphical component. The graphical component 2702 may display context data associated with the search result displayed within the graphical component 2604. For instance, the graphical component 2604 indicates that the analytics server has identified an online chat message that is relevant to the user's query terms. When the user clicks on the graphical component 2604, the analytics server displays the graphical component 2702.

The graphical component 2702 may display an indicator of the chat message 2704. The user may interact with the buttons shown in the graphical component 2702 to perform a series of contextual actions such as open the message (in its original website/service, a message client, and or other service), preview the message without visiting the website, reply to the social medial message, or send a link of the message or the pop-up/overlay with contextual data to another user, and so on.

The graphical component 2702 may also display detailed data associated with the message. For instance, the graphical component 2706 displays data associated with the user who sent the message, time associated with the message, application/platform on which the message was sent, an email address and/or other account information associated with the account sending the message, an attachment associated with the message (e.g., image file), and/or other relevant data.

As described above, the user viewing the graphical component 2702 may interact with the displayed data by adding notes and/or revising, adding, or deleting any of the identified context data. For instance, the user may add customized notes. The analytics server may revise the nodal data structure accordingly. Therefore, the analytics server may, for example, display the user's note when the same message appears in future search results, or when the user is viewing the message elsewhere (e.g., in a message client, in the original service/website, etc.).

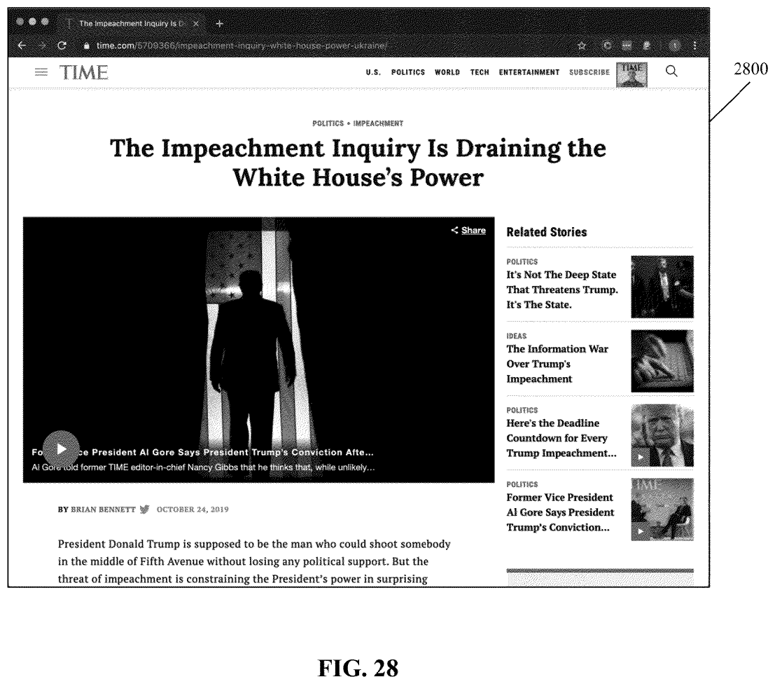

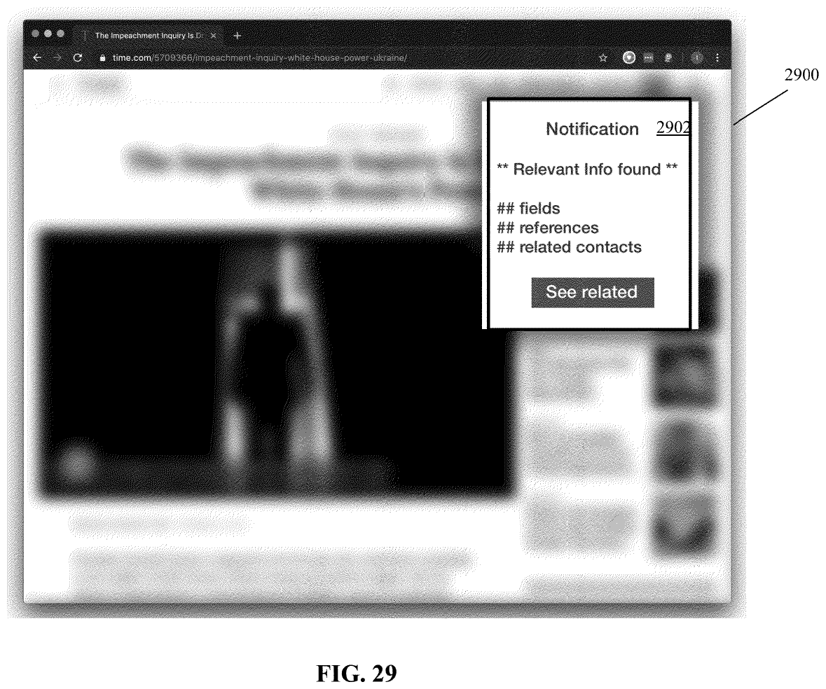

Referring now to FIGS. 28-32, another non-limiting example of displaying context data is depicted. In this non-limiting example, the user accesses a website as depicted in GUI 2800 (FIG. 28). The analytics server identifies the electronic content (website) using the URL associated with the website. The analytics server may then generate or use one or more unique identifiers associated with the website and may search the nodal data structure accordingly. If the analytics server identifies one or more nodes related to the unique identifier of the website, the analytics server may display the graphical component 2902 as depicted in the GUI 2900 (FIG. 29). If the analytics server does not identify one or more nodes related to the unique identifier(s) of the electronic content, the analytics server may generate the nodes in the nodal data structure.

The graphical component 2902 identifies that relevant information has been found. The user can ignore the graphical component 2902 or may interact with the “see related” button to view the related information. If the user does nothing (within a predetermined time threshold) or closes the graphical component 2902, the analytics server stops displaying the graphical component 2902. If the user interacts with the “see related” button, the analytics server displays the GUI 3000 that includes the graphical component 3002 (FIG. 30). Using graphical component 3002, the user can search through the electronic content and any related information, including but not limited to other websites linked within the electronic content, public websites that reference the electronic content, identified named entities (e.g., people, teams, objectives, projects, other Contexts, etc.) in the electronic content, understood meaning of the contents (e.g., using image processing, facial recognition, natural language processing, natural language understanding, etc.), and related information based on implicit or explicit references.

The graphical component 3002 identifies information and context data related to the electronic content displayed and viewed by the user, as described above. In some embodiments, the analytics server may display the graphical component 2102 in GUI 3100 (FIG. 31). The graphical component 3102 includes various placeholders for contextual data that reference the unique ID (e.g., website/news article) or that reference the units of work that can be identified by the unique ID. In this non-limiting example, the user is able to visually scan and/or purposefully search through these “references” and related data. Selecting a reference may direct the user to a different page displaying the chosen/specific unit of work and all understood meaning as well as related/contextual data and actions in the nodal data structure. When the user interacts with any of the buttons, the analytics server may direct the user to a particular page (or a new GUI) that displays more detailed information regarding the unit of work corresponding with the selected button, such as any of the pages displaying context data (e.g., smart windows/Contexts) described herein.

When the user interacts with the one of the references in the list (e.g., the reference found within an email shown by the “email” button/placeholder), the analytics server may direct the user to open the email in its normal webpage, in an email client, or some other service, as well as allow the user to preview any understood meaning (e.g., text and activity summaries, impact or relationship of the asset to a larger objective, potential compliance issues, etc.) as well as all related data and actions associated with that email and the electronic content. When the user interacts with the “project A” button, the analytics server may direct the user to a new page displaying data relevant to project A. As depicted, the analytics server determines that a unique identifier associated with the website being viewed (GUI 2900) is related to nodes that have been identified as corresponding to a particular project (project A). Therefore, the analytics server provides the user with the option of viewing a page associated with project A.

When the user interacts with the “GOOGLE DOC” button, the analytics server may direct the user to a page/GUI showing all related/contextual data and actions related to the GOOGLE DOC, where all relevant units of work (e.g., notes, documents, messages, tasks, projects, clients, people, activity history, etc.) as well as any understood meaning can be previewed, accessed, interacted with, and processed. When the user selects the “Slack Message” button, the analytics server similarly presents a page with all understood meaning as well as contextual data and actions centered around the electronic slack message associated with the viewed website. As described above, the analytics server may identify one or more users associated with the viewed website. When the user interacts with the “contact profile” button, the analytics server may display the profile of a contact that has a reference associated with this particular website, URL, domain, article, and/or activity.

The methods and systems described herein can be integrated into existing windows displayed by a computer's operating system. Moreover, the methods and systems described herein can also be implemented, such that the analytics server can display context/relevant data associated with any selected unit of work (e.g., chat message, email, or file). For instance, instead of analyzing the content displayed (or otherwise outputted) by the user's computer, the analytics server may receive a selection of a unit of work from the user (e.g., the user may right click on a file name or may otherwise select the file). In response, the analytics server may analyze the selected unit of work and display relevant data, actions, and understood meaning as described herein. In some configurations, the user may launch a search interface with contextual data as an overlay/pop-up which will automatically use the electronic content as the selected unit(s) of work described above. In this way the user is able to easily interact (e.g., keyboard shortcut, icon click, voice command, haptic command, etc.) with the electronic device to pull up searchable relevant context and data about the electronic content. When using the search feature, if no results are found to be directly associated with the electronic, the analytics engine can recommend results with implied relationships and/or from elsewhere in the nodal data structure. Importantly, the analytics server may use the electronic content (and the various connections it may have to units of work in nodal structure) to influence the ranking of search results such that nodes that are related to both the search query and the electronic content are ranked higher than nodes with only an association to the search query.

In some configurations, the user may launch a search interface with contextual data as an overlay or pop-up window that will automatically use the electronic content as the selected unit(s) of work described above. In this way the user is able to easily interact (e.g., keyboard shortcut, icon click, voice command, etc.) with the electronic device to pull up searchable relevant context and data about the electronic content. When using the search feature, if no results are found to be directly associated with the electronic, the analytics engine can recommend results with implied relationships and/or from elsewhere in the nodal data structure. Importantly, the analytics server may use the electronic content (and the various connections it may have to units of work in nodal structure) to influence the ranking of search results such that nodes that are related to both the search query and the electronic content are ranked higher than nodes with only an association to the search query.

Additionally or alternatively, the various methods of retrieving, analyzing, and/or displaying data described herein may be combined together. For instance, the search engine described herein can be combined with other methods of data display, such that the user is provided with an intelligent search engine that may be limited to a selected category. Non-limiting examples of these embodiments are depicted in FIGS. 32-33.

In the embodiment depicted in FIG. 32, the user accesses the GUI 3200. The GUI 3200 may be any GUI described herein that is configured to display data corresponding to one or more nodes within the nodal data structure. In an example, GUI 3200 may represent a view of analyses and understood meaning as well as all contextual data and actions related to a unit of work (e.g., a software application like MICROSOFT WORD or EXCEL). In some other configurations, GUI 3200 may represent pages displaying contextual data and actions (e.g., smart windows/Contexts) described herein.

The GUI 3200 may include a graphical component 3202 having various selectable buttons. The user may interact with a selectable button to identify the data displayed within the graphical element 3208 and/or 3206. For instance, the user may limit the data displayed within the graphical elements 3208 and/or 3206, such that the data is only relevant to a specific category (e.g., recently accessed files, favorite documents, notifications related to the selected unit of work, and/or keyboard shortcuts related to the selected unit of work). As depicted, the analytics server may integrate an intelligent search bar within the GUI 3200 (search bar 3204). Instead of browsing through the data, the user may directly enter query terms and/or natural language questions in addition to simple keywords into the search bar 3204. As a result, the analytics server may use the methods and systems described herein to identify relevant data and may dynamically update the graphical elements 3208 and/or 3206. In some configurations, the results displayed may be limited by a category selected by the user (e.g., a category within the graphical component 3202). In other configurations, the results may include suggested answers up front including but not limited to a text snippet, activity summary, a number found in a spreadsheet, and/or the differences between different version of software or file types (e.g., doc vs. docx) in order to help the user avoid looking through the contents of a potentially large number of search results.

In a non-limiting example, the user may access the GUI 3210 by right clicking on a particular file/button/link that represents/references/shortcuts to an application (e.g., Microsoft Word). The user may control the data displayed by the analytics server by dates and time. The user may do this by interacting with the selective button (e.g., “recents”) displayed within the graphical component 3212. As a result, the analytics server may dynamically populate the graphical component 3214 and display recently viewed files associated with the unit of work focused in the “contextual overlay” that may show related contextual data and actions associated with that unit of work (e.g., an application like Microsoft Word). Instead of reviewing all the data displayed within the graphical component 3214, the user may use the search bar 3216 to navigate through the important dates. As described above, the user may input query terms in natural language and receive results from the analytics server.

In another non-limiting example, a variation of the GUI 3200 may represent a smart window displayed by the analytics server that is specific to a project. The user may select a category/property/action associated with that smart window using a variation of the graphical component 3202. The user may access the smart-window-variation of the GUI 3200 by interacting with a shortcut/file/reference that points to the project/smart window. The user may then see all relevant contextual data and actions presented in the “contextual overlay” for that context/smart window/project. The user may use the search bar 3204 and enter “who are some of the people who work on this project?” As a result, the analytics server identifies various users/employees associated with the project and dynamically displays an image and a name of each user within the graphical component 3208. Similarly, a user may ask for “what is the probability that this project will be delivered on time?” The analytics server could then compare the activity patterns of other similar projects, other projects that people with similar roles, and other projects that the people that work on this project have done in order to calculate a probability of “on time delivery” given the existing information within the nodal data structure.

The user might also get to the “contextual overlay” for the project by first right clicking on a file on the user's computing device (or otherwise interacts with the file in a manner that instruct the analytics server to display relevant data), and from that file seeing a shortcut to the aforementioned project/context/window. The user may easily click the project and the analytics server may identify a corresponding project and display the smart-window-variation of the GUI 3200.

In the embodiment depicted in FIG. 33, the analytics server integrates the methods and systems described herein into an operating system of the user's computer. For instance, the user may access the GUI 3300 which is a GUI displaying different files stored on the user's computer (or otherwise accessible to the user, such as stored on the cloud). The analytics server may monitor the user's interactions with the GUI 3300. Upon the user right clicking on the file (or otherwise instructing the analytics server), the analytics server displays the pop-up window 3302 that displays data specific to the selected file.

The pop-up window 3302 may include a search bar 3304 and graphical component 3306. The graphical component 3306 displays data and analyses relevant to the selected file, such as filename, relevant files, version information, content and activity summaries, metadata related to potentially included sensitive information with certain compliance needs, and other data stored within the nodal data structure and described herein. The user may review the data displayed within the graphical component 3306. Additionally or alternatively, the user may interact with the search bar 3304 to input direct queries where the results are specific to the selected file. For instance, the user may input “what is this file about?” As a result, the analytics server may display that the file is associated with a particular project and display project information as well as provide a summary of the file's contents. The analytics server may also display access history and edit history data associated with the selected file as well as a general summary of how the file has been used, where, and by whom.

In the embodiment depicted in FIG. 34, a user is viewing an electronic document 4700. The analytics server continuously analyzes the terms within the electronic document. When the analytics server identifies a term that is related to one or more nodes within the document, the analytics server highlights (or underlines or similarly provides the user with a contextual notification) the term (3402). When the user hovers over the highlighted term, the analytics server displays the GUI 3404 where the graphical element 3406 displays data associated with relevant content and the graphical component 3408 displays other users relevant to the highlighted term (e.g., other users who have included the term in their writing or worked on similar projects or projects that are related to the highlighted term).

In some configurations the analytics server does not automatically highlight the term 3402, however when the user highlights the term, the analytics server can identify present a notification that contextual data and actions exist for the highlighted or selected term/content. The analytics server may provide the user with a prompt to open the “contextual overlay” associated with that term, or otherwise automatically open it on behalf of the user. The analytics server may also use the term as a search query as described in other embodiments above.

In the embodiment depicted in FIG. 36, the user is viewing electronic content 3600 on a browser. Upon the user transmitting an instruction to the analytics server (e.g., by pressing Ctrl+Space or any other customizable combination of keys), the analytics server displays the overlay 3202 that displays contextual information and actions relevant to electronic content, which includes the webpage/tab open in the browser application being viewed by the user, the application associated with that webpage (e.g., Paper by Dropbox), the project/smart window/context associated with current browsing session (e.g., actions like share this “context”/smart window), and any relevant other units of work (e.g., some actions, some relationships, and/or options to see more information and context, as described herein).

Additionally, the analytics server may display data associated with a project and/or client associated with the content being viewed by the user. Additionally, the analytics server may display the user's saved agenda and tasks within the overlay 3602. The agenda and tasks presented could be determined by the analytic server's understanding of the current user, the time, the location, and the date potentially present within the electronic content. The user and/or analytics server could determine to filter down the presented agenda and tasks such that is relevant to other elements of the electronic content, such as the website being viewed, the project/smart window/context/client that it is associated with, etc.

Additionally, the analytics server may display data associated with a project and/or client associated with the content being viewed by the user. Additionally, the analytics server may display the user's saved agenda and tasks within the overlay 3602 (filtered, such that is relevant to the content being displayed).

If the user desires to access a file (or any other unit of work), the user may interact with the graphical component 3604 to view related files and select the desired file. The user may also view other related content (e.g., emails, analyses, activity and content summaries). Alternatively if the user can't find the desired related file, the user may message a coworker who may have relevant information about the project or the content being viewed by the user. The coworker may be identified and presented to the user as a possible person with knowledge using the methods and systems described herein.

The analytics server may then monitor the communication between the user and his/her coworker. For instance, the analytics server may generate a node within the nodal data structure that corresponds to the message. If a file is shared between the parties, the analytics server may revise the nodal data structure by linking the message(s) and the desired file to the content being viewed on the user's browser. In the alternative, the user may interact with the search bar 3606 to enter queries and identify the desired file.

FIG. 37 is a flow diagram of a process/method 3700 executed in an electronic work (or workflow) management system, according to an embodiment. As described herein, the analytics server may generate a nodal data structure representing related workflow components or units of work (e.g., files, web-browser history, etc.). For instance, the analytics server may periodically monitor various files (or any other units of work) accessible to a network of computers and may generate a representative nodal data structure. The analytics server may also monitor user interactions with those files and revise the nodal data structure accordingly.

The methods and systems described herein allow a back-end server(s), a local computer(s) (a computer operated by the end-user), and/or a distributed computing protocol(s), such as Ethereum®, (e.g., each of which and/or combinations which can comprise an analytics server) to identify content being displayed or accessed by a user based on the user's overall activity. The term analytics server should be understood as a processor that can exist within and across various environments. The server may generate an intent summary for the user's activities to identify contextual information surrounding the content being accessed by the user. For instance, the server may identify that the user is logged in and working on project A because the user is also accessing other units of work associated with project A. As a result, the analytics server can group and/or recommend relationships between the relevant data and use the user's activity to further revise the nodal data structure. The server may also provide various GUIs that allow the user to navigate the grouped and/or related units of work, e.g., by using a search bar or by clicking on various displayed options.

As used herein, electronic content and electronic context may refer to different concepts. For instance, the electronic content may refer to the content accessed by a user. In contrast, electronic context may refer to data associated with the expected and actual activity of the user as well as the expected and actual content being accessed by the user. For instance, electronic content (or simply referred to herein as content) may refer to a website being viewed by the user. However, using the methods described herein, the analytics server may identify data associated with the website, such as a project associated with the website, other employees associated with the website, or any other data described herein.

The analytics server may also recommend information based on an understanding of the expected and/or actual activity of the user at a given point in time. For instance, the analytics server may identify data that the user may want or need to access such as the link to a video conference on a calendar event that is about to start, the file that is associated with a task that is due today, and that email that was snoozed until a time that is five minutes away, and so on. The analytics server could also leverage machine learning processes that consider activity events consolidated from multiple sources to find patterns and provide recommendations based on those patterns. For example, the analytics server might recommend to a user opening her computer in the morning a list of the most recent email newsletters in her inbox if she tends to read those when she first opens her computer in the morning. The analytics server may also generate and recommend a video conferencing link to a group of users if they tend to have a “standup meeting” every day at the same time regardless of whether there is a related calendar event.

Beyond pattern recognition, the analytics server may also use natural language processing and/or natural language understanding techniques to recognize that the user sent a message to someone saying that she will do a certain task today, or that she told someone in a meeting she will follow up with additional information after the meeting, and therefore remind the user at the right data and time of what she said as well as other data that the analytics server identified as being related to her intent and the electronic content. Similarly, the analytics server can track what the user is actually doing and compare that to, for example, historical activity patterns or models associated with the user, or activity events that are expected based on events that the analytics server expects from the user at a given date and time (e.g., assigned task that is due, upcoming meeting, user said she would meet someone somewhere), in order to identify what the user may be trying to do. This data, which is the result of the analytics server analyzing the users activity and any related data as well as the content viewed (or otherwise interacted with) by the user, is referred to herein as the electronic context data or context data. The context may also refer to data behind a smart window, which represents a collection of the units of work related to a certain category or attribute and which can include its own consolidated activity from multiple users and sources. In this way electronic context for a given smart window or context can consider expected activity, actions, and other data from multiple users. For instance, a smart window may refer to various units of work that are related to a particular project.

The analytics server may analyze the content being viewed by the user (and other content that are similar) to create analyses (e.g., summaries) for all units of work independently. The analytics server may then create the summary of a context by summarizing all of the summaries for units of work and activity related to that context. The analytics server may also search, retrieve, and/or create information to populate key metadata fields/relationships of that Context (Smart Window) from units of work related to that context.

In a non-limiting example, if a user asks another user for approval via email, and that email is associated with the context, then the system can relate the person being asked for approval as a “decision maker” on the context. The analytics server may create the summary for a contact by summarizing all the units of work and activity related to a given contact. The analytics server can analyze times, roles, projects, contexts that both users were involved in and can extract data from emails (e.g., email signatures, to populate contact profiles) and other related applications.

Using the methods and systems described herein, the analytics server can generate summary for a person's role (similar to intent) within a given context specific to a project, client, matter by classifying (and summarizing) the activity that the person had for units of work related to a given project and/or context. For instance, if the analytics server determines that a user is setting a lot of tasks for others or writing specifications, the analytics server may determine that the user may be project manager. If the analytics server determines that a user is communicating via email a lot (more than a threshold as may be determined by historical activity patterns across one or more users), the analytics server may determine that the user may be account manager. If the analytics server determines that a user is writing patent drafts, the analytics server may give a particular designation to the user that indicates an intimate familiarly patents. In this way, the analytics server can be recommending metadata and relationships to and/or between a given user, team, project, and/or other context.

The analytics server may establish relationships between a given context or contact and key resources (more than just a person as described above). For example a contact could always have a CV/resume field associated with it, so whenever (or wherever) the analytics server encounters a CV, it can add the resume file to that contacts field. Similarly a patent can always have an assignee field, so whenever the analytics server encounters a patent file accessible to a user, regardless of the source where the patent is stored or originates from (e.g., private database, USPTO database, GOOGLE PATENTS database, etc.), the analytics server may look for the embedded assignee reference and associate it with a given contact/profile. As described above, a project or context could have “decision makers,” but they could also have “key deliverables,” which might be able to be gleaned based on when it was shared, the way it was shared, who it was shared with. It could also have fields such as active dates, contributors, budget, client, etc. that can all be gleaned and recommended in a similar way to the above.

The analytics server may generate summaries and/or descriptions of roles (e.g., a partner at a law firm) or other types of data (e.g., a standard workflow process, the expected format of a given deliverable). The analytics server may use various method to achieve this, such as by evaluating the metadata (e.g., skills) and activity as well as other “lower-level” summaries or analyses (e.g., usage amounts for certain types of software).

The analytics server may use the above-described data to identify attributes for various users that were previously unknown (even to the users themselves). For instance, the analytics server may generate “labels” for common functional types which can replace people's job title being based on hierarchy or manager/subordinate relationships (e.g., employees' job title or role could be functional based). For instance, account managers, sales development representatives, and other titles may all fit into some “Communication and objectives Coordinator” grouping based on their workflow and usage of computers. The analytics server may analyze data accessed and usage of each employee to identify a de-facto job title for the employees. Similarly the analytics server could establish a variable level of influence that a given user has within a grouping of other users, projects, and data within the nodal data structure.

The analytics server may suggest workflow improvements to different users who indicate that they have (or that are otherwise are understood by the analytics server to) have similar roles within a given context (e.g., a company, a team, a project, etc.). The analytics server may use various machine learning and AI models to create clusters of people based on characteristics of their workflow. The analytics server may then label the clusters accordingly and learn to identify/predict job titles for new users/employees. Similarly, the analytics server can evaluate other contexts besides people to identify potential patterns, similarities, relationships, levels of importance, and more.

Using the method and systems described herein, the analytics server may understand data related to a given person, account, project, application, and the like. As a result, the analytics server may identify the data that might have been accessed through a breach. Using the methods and systems described herein, the analytics server may have the ability to estimate intent, and a role of a bad actor (e.g., a compromised employee account). As a result, the analytics server can potentially flag “intents” that are not in line with that person's role or expected activity for closer review. The analytics server may implement the same method for analysis of accounts, applications, and the like. As a result, the analytics server may identify accounts/applications/contexts that are trying to go beyond their designated “role” in a way that may be considered dangerous from a data access, data sharing, compliance, or other standpoint. When mal-intent is identified, the analytics server may require a higher security level (e.g., second factor authentication or ask users to clarify their intent or reason for accessing content or performing an action and transmit the responses to compliance team for manual review, etc.).

The analytics server may use electronic content, context, and intent to present relevant information contextually, as depicted in various figures presented herein. For instance, the analytics server may display relevant information passively. The analytics server may use the query found within electronic content/context to show related data and search results. It could use electronic context and intent to augment the query or otherwise rank the results. The analytics server may use electronic context to choose and/or rank the groupings (results or the displayed units of work) themselves (e.g., the apps, the contexts, the people, and whatever might be shown on the left side of the GUI). For example, the analytics server could prioritize the selection of groupings (in the sidebar) that are relevant to the identified data type (a.k.a., type of unit of work) over where that data type originates from (e.g., Google Drive® and/or Dropbox®). In other words, the analytics server could determine the structure of the interface based on an understanding that the electronic content is a news article rather than primarily focusing on the fact that it may be a news article from the New York Times® or from other news agencies (FIG. 29-34). The analytics server can also use the larger understanding of what a person is trying to do to identify “smart answers” as shown in FIG. 44. The analytics server can also modify the interface for the search engine and add additional tabs units or work or relevant results. The analytics server can also add cards from the nodal data structure to other interfaces, knowledge graphs, and/or nodal data structures (FIG. 72 or FIG. 73). For instance, the analytics server may augment the depicted search engine by displaying the depicted graphical components respectively.

For example, the analytics server may use the hashing algorithms to identify whether the two nodes represent the same file (e.g., are copies of the same file). Similarly, the analytics server may identify whether two nodes represent the same data if other unique identifiers can be established (e.g., the same social security number is associated to two different contacts). This method is also referred to as using “hard factors.”

In addition to using hard factors to identify whether two units of work are similar and/or related, the analytics server may also use contextual data associated with each node to identify relationships among different nodes. For instance, the analytics server may generate contextually aware unique identifiers for two different units of work that might not correspond to immediately adjacent nodes in the nodal data structure (e.g., the nodes may not be identified as related using hard factors) but that are regardless related to the same topic. For example, two different text string references to the same project articulated using different vocabulary in two different mediums (e.g., a local file and an email) might be understood to be related by the analytics server through an analysis of the known data points and units of work associated with each text string.

In addition to the analytics server automatically identifying related nodes, a user could manually link two nodes together and identify them as related to a particular topic (e.g., a document file and a chat session can be designated as related to a project by a user, for example, when saving the file). Once the analytics server establishes, through various analytical means (e.g., hard factors, soft factors, user inputs, and/or topic modeling), that both text strings are related, and referencing the same topic in this example, the analytics server uses various method to link nodes corresponding to the units of work.

Even though aspects of the methods and systems described herein may be described in the context of files or units of work, it is expressly understood that these methods and systems are applicable to any data, such as data that may represent units of workflow (also referred to herein as a unit of work). For example, a “file” or “unit of work” may also include any data that is generated as a result of a user interacting with his/her computer that can be contextualized (e.g., file, message, email, thread, contact, task, activity event such as a create or a read event, date and time stamp, physical location, software application, project, class, deal, product, brand, story, client, website, phone number, user-generated tag, machine-generated topic, deals, clients, employees, notifications, online articles, videos, songs, applications, addresses, and the like).

A unit of work for an action performed can be represented by a file, data record, and/or any instance representing the data record. For instance, a unit of work may refer to data created as a result of a user performing an action (e.g., creating a task or transmitting a message to another user). In some embodiments, the data created (and/or the unit of work) may itself be a file (e.g., document file).

The analytics server may use the methods and systems described herein for simultaneous presentation of contextual information and actions related to multiple elements that are identified as related to an action being performed by the user, such as electronic content being accessed by the user (e.g., website being viewed by the user). For example, the analytics server may present information related to a user's current selection, currently open file, currently open application, and/or currently open context all at the same time. The analytics server can further rank this subset of data and actions based on some criteria, such as how relevant they are to a user or category or any other identified attribute.

The analytics server may use the methods and systems described herein to automatically index and categorize a user's browser history and allow its access, presentation, interaction, and more by type of data across websites, applications, and data sources: file, message, task, article, recipe, etc.

The analytics server may, through processing, indexing, translating, and/or otherwise adding data into or editing data within the nodal data structure (regardless of whether the data originates from one or more different data sources), classify data with standardized data types or types of units of work. In other words, the analytics server may identify that data found on a local computer system, data within Google Drive®, and data within Dropbox® can all be classified as standard data type “File”. Therefore, the analytics server can offer standard actions that a user might want to do over a file in a standard way (e.g., rename, delete, save, share, send in message, add or create a related task, associate with a calendar event, add a note, create or link a new file version, otherwise relate to another unit of work, “summarize file,” open with a given interface, etc.).

The environment and the source of the file can determine (e.g., in a parametric way) which standard actions the user can perform over said File. For example, a File stored on a local computer might not be able to be “shared” in the same way as a File stored in the cloud where the user can choose to let other users access said File with certain permissions. The analytics server may classify any data as being associated with or having multiple standard data types (e.g., a “File” could also be an “Image” and simultaneously a “PNG”). Similarly, the analytics server may identify multiple data types and nodes within a given piece of data. For example, a “Document” (which is also a “File) may have an Image embedded within it as well as text-based reference to a “Person”. In this scenario, the analytics server may create one separate node (if none already exists in the nodal data structure) for the Image and one for the Person identified within the Document, on top of the node for the Document. The analytics server may then evaluate the Image and identify that it is an image of Bill Gates (a Person) at Microsoft Headquarters (a Place) and associate it to (or create) the corresponding nodes in the nodal data structure, each with their own sets of standard actions and potential interfaces.

The analytics server may use the methods and systems described herein to generate summaries of projects, teams, objectives, and recent activity for one or more users (e.g., individual users or a group of users). The analytics server may use the methods and systems described herein to create summaries of user activity (which can give insight into a user's intent) and/or create summaries of units of work (e.g., files, messages, etc.). The analytics server can then summarize the relevant summaries for activity or work related to a given project, team, class, time period, and the like. The analytics server may then analyze the data using these summaries and can help answer questions like: what has X team member worked on in the past week? Or what has changed with objective Y?

The analytics server may use the system and methods described herein to scrape/acquire data and metadata through a user's normal computing use and web-browsing. Furthermore, the analytics server may associate the retrieved/scraped data and metadata to nodes within the nodal data structure. For example, a user could establish rules that any time he/she is reading an article that references an existing contact, add that article to the referenced contact's profile. Similarly, a user could implement data/knowledge acquisition rules that anytime he/she is reading a patent, create/find the corresponding node for it in the nodal data structure, and automatically add data from the website or file to the nodal data structure, including: inventor, assignee, title, priority date, etc. This would establish a rich nodal structure of every patent the user interacts with (as well as establishing relationships between them and other elements) and then let the user search across and interact with all patents he/she has viewed by any of these associations (e.g., inventor, priority date, version, office action, related email, etc.) well as other metadata including where the user accessed the patent from, what they were doing, what contexts or files it is likely associated with, and so on. Furthermore, the analytics server/processor could automatically present the user with a clean timeline of all the research that has been done according to access dates or priority dates.

Identifying Related Content within the Nodal Data Structure

The analytics server may use a variety of methods to determine if two nodes are related to each other.

Using the methods and systems discussed herein, the analytics server can for example utilize behavioral data, proprietary data-correlation methods, and machine learning to establish relationships and recommendations between related nodes representing units of work (e.g., files, messages, people, and other data) so that nodes are identified as related and so that institutional knowledge can be preserved and leveraged.

In some embodiments, the analytics server may parameterize the backend and/or frontend syncing (and other) processes and build a universal syncing module to easily sync standardized structures of metadata coming from different APIs of integrated systems and services. The analytics server may store this information as standardized data types within the nodal data structure and provide a variety of interfaces, processes, and actions from a multitude of sources that can be used with any given standardized data type. Similarly, the standardized data types may be stored using one or more different database technologies to make up the nodal data structure. This method of abstracting the representation, access, and interaction of information through standardized data formats can improve the maintainability of data ingestion, syncing, and other forms of processing data within the nodal data structures. In other words, the syncing logic of data may be built over standardized data types rather than uniquely per data source. This simplifies the integration of new data sources that contain data types with existing syncing logic.

For instance, to add a new integration, a developer can reuse “File” and “Folder” syncing code and processes across multiple services that host files and folders (e.g., Dropbox®, SharePoint®, etc.). More specifically, a developer must implement a predefined set of methods and/or mappings in one or more service translation files (or databases), which may reside within or be used by code executed by the analytics server (e.g., Ruby on Rails application hosted on AWS). These methods and/or mappings may be accessible via NPM modules, Ruby Gems, REST APIs, and in other ways. The content in these service translation files and/or service translation API(s) may define (1) how the syncing (or other) processes can be authenticated with data source(s) while being executed by the analytics server (e.g., system or service) and (2) a mapping from the inputs and outputs of API endpoints of various data sources into the standardized data types to be inserted or updated into the nodal data structures. Once the service translation file(s) and/or API(s) is/are created, a universal syncer may then, via the analytics server, periodically sync the data from any authenticated/integrated data sources with data residing in the nodal data structure for each user who adds and authenticates it.

The analytics server may be configured to run processes (e.g., syncing processes) in a variety of different ways. For example, the user may configure the analytics server to run on specific time frames or based on certain triggers. The analytics server may also, depending on the configuration and the triggers, choose to run additional processes such as virus scanning of files, choose whether or not (or to what level) to deduplicate data, choose to summarize text base content, and so on. Additionally and alternatively, the analytics server may receive notifications that may prompt certain processes and/or configurations of processes to run.

One or more universal syncers may be used to ingest every data type available from an integrated system or service (data source) according to the methods or mappings defined in the service translation file(s) and/or service translation API. For example, a social media platform may be a data source that can contain “conversations,” “messages,” “people,” and more while a file sharing platform may be a data source which contains “files,” “folders,” “people,” “comments” (another form of a message), etc. Both integrations supply data of standardized data type “message” to the nodal data structures, but the file sharing platform may be more likely to supply data of standardized data type “document” and “folder” vs. the social media platform (e.g., people can and do share certain files via social media).

In addition to defining how nodal data structures can ingest data from an integrated system or service (data source), the service translation file(s) and/or database(s)/API(s) may also define details on how the analytics server can perform actions and edit data on behalf of a user within a given system or service (which may be specified parametrically). This allows one or more knowledge application interfaces to provide actions to the user to manage their data. For example, in a “Files” knowledge application, a user has the ability to rename, copy, move, or delete files and folders on a file sharing platform without opening the platform itself (e.g., accessing the platform on their browser or initiating a platform application). The service translation file(s) and/or API(s) may define how an action performed in a knowledge application uses a system or service's API(s) to affect the underlying data.

In some embodiments, the analytics server may utilize a local-first data storage strategy, enabling a user's nodal data structure to be entirely offline, private and controlled by the user. For instance, a user may install a browser extension that either includes or is in communication with the analytics server. The browser extension may access via the browser's API the user's browsing history and use it contribute to the user's nodal data structures. In other words, the extension (via a local and/or remote analytics server) may process historical archives of browsing history from the user's browser. The extension (via the analytics server) may process and index the browsing history with classifiers for different data types and may create relationships with other components/units of work within the nodal data structures (e.g., applications and contexts). The extension may use technologies, such as IndexedDB to store this information in a relational manner (or as a key value store, etc.) and may use indices for fast querying. In addition, the extension may store a local cache in IndexedDB of the user's preferences, applications, contexts, and histories of recent browser tabs, which it keeps synchronized with the cloud when either end is updated. Similarly, the user could install an application on a computer that includes an analytics server and that stores the entire nodal data structures locally, allowing a user to leverage the knowledge extracted and managed by the analytics server without storing data in the cloud.

Using the methods and systems discussed herein, the analytics server has the ability to improve access to information while also providing meaningful and useful contextual information. The analytics server may achieve this by leveraging raw metadata and behavioral data to connect information across third party applications and systems, which is achieved via using one or more data correlation algorithms. These algorithms may estimate relatedness between data to (1) empower a page-rank style algorithm for search and (2) provide users with suggestions of related data (e.g., summaries, analyses, and/or related person, project, message, etc.) whenever they are viewing/accessing electronic content (e.g., a file). Accordingly, the analytics server provides users the ability to make easy lateral jumps across systems, hierarchies, processes, and other barriers between data from different applications/systems that may be also managed by a variety of people and teams over time.

To relate data, the analytics server may combine explicit and implicit relationships into a single score and a single list of suggested data. The algorithm(s) may first ingest data and their metadata from a plurality of systems and services. During ingestion, the analytics server may for example parse the contents of hundreds of common text-based file types. The analytics server may also, for example use hashing algorithms to determine a unique fingerprint for each file's contents. This allows the analytics server to isolate and combine all activity and metadata from copies of the same file so that suggestions of similar files can be more effectively derived regardless of and across data sources. The analytics server may also, for example deduplicate other data types such as people, projects, teams, clients, patents, objectives, etc. in order to consolidate metadata from various sources and establish (within the nodal data structure) more relationships between deduplicated data than may exist in any one isolated instance of the data across data source.

In a non-limiting example, the analytics server may then, as users interact with nodal data structures or any connected system or service, group their resulting activity events (e.g., copy, edit, rename, move, etc.) into an approximation of “sessions” or periods of time in which a user is working on a specific task across systems and services. The assumption is that files often found related to activity events in the same session have a higher chance of being related than files that are not. Each pair of files is given a relationship score in an adjacency matrix X where Xᵢⱼ equals the count of Sessions file i and file j were both found in. The adjacency matrix is factored using the alternating least squares method into X=UV′ where U and V are n by n matrices. This approach exploits the algebraic properties of the loss function to minimize a cost function in linear time. This smoothing provides more accurate recommendations given the nature of implicit feedback datasets.

To obtain suggestions for files similar to file i, the analytics server may calculate scores UᵢV sorted in descending order and filtered by a threshold (e.g., 0.75). The analytics server may use the Alternating Least Squares method to achieve this result. In some embodiments, the observational data gathered from implicit feedback cannot be used directly to make sophisticated recommendations and therefore may be used primarily as preliminary data. To rectify this problem, the analytics server may incorporate more information into the file correlation model to give it the necessary sophistication to produce meaningful suggestions. A new matrix is formed: X=X₁+X₂+X₃+X₄, where,
X₁ is the original implicit feedback adjacency matrix
X₂ uses the triangle function |4 hours−|tᵢ−tⱼ∥/4 to create a score between each pair of files based on how similar the creation times of those files. This estimate assumes that two files' likelihood to be related linearly diminishes with increased time between their creation and that files created more than 4 hours apart are not related. This augments our implicit feedback from X₁ by relating files which were created by a user for the same work task but may not have been interacted with in a way that would produce an activity event picked up by X₁.
X₃ is the number of explicit relationships between two files. These include both automatically-recognized (e.g., two files are attached in same email) as well as users-defined relationships. Users can manually specify relationships between files such as parent/child, input/output, etc. These relationships add explicit feedback into the model.
X₄ is a measurement of how similar key metadata between a pair of files are. This includes file titles, activity and creation timestamps, as well as other similarities in files' metadata into the model. Many people increasingly use strict naming conventions for files based on date, contents, project, source, etc. for more systematic and potentially easier retrieval. This may make titles particularly important pieces of metadata within the available metadata. The analytics server may use the formula min(8, p)/16 where p is equal to the length of the longest prefix between the titles of two files.

The four matrices may be added together and factorized for smoothing. Transitioning to this new model seems to have increased the number of suggested files that exceed the filtering threshold. This is especially true for files that have no implicit relationships through activity event history. It is worth noting that although this new model incorporates 4 factors, for each user, as the amount of activity events (Session data) increases, the model may re-converge. This is because X₁ will grow while X₂, X₃, and X₄ stay relatively constant for each file-to-file pair.

To provide better recommendations, the analytics server may create a framework for validating the quality of recommendations. In one example, the analytics server may inquire users to rate how meaningful the suggested files are to their work. Another example may include gathering implicit feedback by tracking the number of clicks that the suggested files garner, implying their usefulness to the user.

The analytics server may also improve the correlation detection by incorporating more standardized and useful behavioral data. Activity events may be predominantly based on the explicit activity events obtained from integrated systems and services (data sources), which in some cases may be other nodal data structures. These events, however, may be only a small picture of a user's behavioral data concerning their files. To rectify this, the analytics server may create a specification of a more comprehensive activity tracking system based on the CRUD (create, read, update, delete) architectural style. In addition to this standardization, the analytics server may relate activity events in a parent-child relationship. This would allow the analytics server to have a more complete picture of a user's behavior and of the relationship between their files. For example, activity events denoting edits of two files might share the same parent event denoting the time in which a specific browser window was opened on the user's computer. Identifying grouped bookmarks and open tabs in a user's web-browser or “context page” or “smart window” (and eventually also desktop applications) or identifying a user-defined label (e.g., Client 1, Project 2, Objective 3) may provide a meaningful label to the relationship between the two files edited. The analytics server may use a distributed tracing standard to standardize the relationships between activity events. The analytics server may create a framework that allows for collecting activity and behavioral data across applications and data sources without complicated and custom integrations for each source as described herein. This framework may enable the analytics server to refine the correlation algorithms and approach identifying correlations.

The correlation algorithms can be used for more than identifying related files. Indeed, the correlation algorithm can be used to identify any unit of work that is related to other units of work. For instance, the correlation algorithm or model can be used for (1) a contact recommendation system that established the closeness of two people based on communication and collaboration activity (e.g., email, messaging, calls, meetings, etc.), (2) a method of classifying relationships between people based on communication data from messaging systems, and (3) providing contextual associations via URL(s).

Contact Identification and Recommendation

The objective of the contact recommendation algorithm may be to ascertain which email addresses are likely to communicate with each other, and in which direction. Example use cases of such an algorithm may include: contextual auto-completion of email headers, (e.g., “would you like to also cc X person”), contextual suggestions of task assignments or file shares, filtering activity feeds or email inboxes to prioritize or hide activity or messages from contacts based on a score that determines how important a given contact is to the user, ordering contacts into a list of top friends or colleagues, building and maintaining people graphs for organizations to analyze team breakdowns, internal influencers, and the like. A non-limiting and simple example of a solution to solving these problems may be to rank contacts by the sum of emails sent to and from two email addresses.

To generate more sophisticated rankings, the analytics server may perform the following series of steps. First, like the file correlation algorithm, the analytics server may create an email address to email address (or phone number to phone number) adjacency matrix X where Xᵢⱼ is the count of emails sent from email address i to email address j. This matrix is n by n, where n is the number of email addresses in the system. X may then be factored into a low rank representation, X=UV′ where U and V are n by k matrices. In a usual subspace clustering algorithm, U would often be interpreted as cluster assignments, and V as cluster centers, however, because U may drop below zero, it is more accurate to interpret V as major and minor axes (e.g., in a dense subspace of X). Because the dimensions of our matrix are email addresses, one can also interpret U as a sender-space and V as a receiver space. The analytics server may use a protocol that provides two tuning parameters, k and λ (lambda) where k is the number of inner dimensions of the system, and lambda is a penalty on the norm of U and V.

A large variety of flexibility may exist in how the problem was set up before using an optimizer to factor the email matrix. An example of this is splitting X into symmetric and antisymmetric parts such as:

Z₁=(X+X′)/2 and

Z₂=(X−X′)/2

Here, Z₁ᵢⱼ represents the average number of emails sent between two email addresses, and Z₂ᵢⱼ represents how balanced or unbalanced the relationship is. This variation could help if there were pairs of emails that were very directional (many more sent from one side than the other) and pairs that were very nearly balanced. This splitting heavily affects the sparseness pattern (gives the matrix many more nonzero values compared to X), and thus produces very different fits and tends to be slower computationally. To preserve the sparsity pattern while splitting, the following variant can be used:

Z₁=min(Xᵢⱼ,Xⱼᵢ) and

Z₂=Xᵢⱼ−min(Xᵢⱼ,Xⱼᵢ)

Here Z₁ᵢⱼ represents the quantity of messages sent from the email address which sent less than the other and Z₂ᵢⱼ represents how unbalanced the relationship is. The skeleton of each component Z₁ and Z₂ is a subset of the original, which is somewhat faster than the previous variant and produces a more similar fit to the original data. A log transformation could also help in theory if the distribution of emails was over dispersed. The analytics server may filter out automated emails and bots whose send rate would likely far exceed that of any human. However, there could still be some variance in the number of emails which would signify a strong connection simply based on the workflow of a user. For instance, one user may have frequent 3-5 email communications with their closest collaborators, while another may commonly have 15-20 email communications.

Z=log₁ₚ(Xᵢⱼ)

The matrix could also be split based on time where:

Zᵢ=Xᵢⱼ if i messaged j in the last t time period

Z₂=Xᵢⱼ*I(Zᵢⱼ=0) where Z is the log transformation above.

Where Z₁ would factor in a time sensitivity to our ranking of contacts, a necessity to produce results relevant to the user at that moment in time. For example, an employee may have 200 emails from a person who was their boss 3 years ago but with whom they have not communicated since and have 100 emails with a person who has been their boss for the last 2 years. Ideally, their new boss can be ranked and do not include their old boss in the suggestions. An improvement on this time sensitivity would be to multiply Xᵢⱼ by an exponential decay based on the date the most recent email was sent from i to j so that instead of a cut off constant, t, the possibility for a high volume past communication to still have a ranking can be ignored or preserved. Z₂ is a rudimentary spam filter. Lots of email spam comes from email addresses who only ever email you once. This could be improved by also filtering out any email address whom a user has not responded to.

The analytics server may not directly compare the fit from Z₁ to X because of a difference in units. Instead, the analytics server may transform back to predicted(X)=predicted(Z₁)+predicted(Z₂) and compare that to the equivalent fit from factoring X directly, controlling for the number of parameters. There may not be any large advantage to splitting compared to modeling X directly in terms of model error nor qualitatively.

The analytics server may also incorporate communication data from more integrated systems and services than just emails. For example, incorporating data from other sources like internal project management systems, human resource systems, instant messaging platforms may likely add the ability for the algorithms to more effectively classify and help manage various types of relationships between contacts such as co-workers versus clients, managers versus collaborators, and the like.

Classifying User Relationships:

The institutional knowledge and contextual information around work and data (such as who worked on what, what role they played, who they worked with, etc.) may be distributed across a variety of systems and services or otherwise be only practically accessible through individual people's living memory. This institutional knowledge may be spread in pieces across a few isolated (e.g., in silos) applications and may often not match an existing schema or be simply missing. To help identify this contextual information and to help establish and/or manage the relationships between people, projects, objectives, and more, the analytics server may analyze communication and collaboration data and activity alongside organizational chart data, billing information, timesheets, and more to learn from and to help maintain a completed and correct organizational chart and record of who may have been responsible for what.

In a non-limiting example, the analytics server may extract this knowledge in two parts. For instance, the analytics server may first extract the existing manager-reportee data from metadata associated with electronic communications between users, from professional social networks (e.g., LinkedIn), from human resource systems, etc. By recursively calculating the ‘manager depth’ of a report, the analytics server may arrive at a primitive view of the organization's structure. Referring now to FIG. 38A, a chart 3810 represents how the analytics server may process data from a company's internal messaging system to create and connect nodes for and between each employee based on a “manager-reportee” field within their user profile within the internal messaging tool. The chart 3810 illustrates that the predominant issue in the data set is not only that individuals may not generally have their manager field properly set in their internal communication tool, but rather that middle managers also do not, which leads to several disconnected subgraphs. This graph highlights how manager-reportee information that may exist in a human resources system (that is rarely accessed by employees) is also not available within the internal communication system the employees use most often. In other words, the data is not immediately accessible to employees when they want in the context in which they might want it.

The chart 3800 illustrates a graph of channels vs employees where the color of each point represents the number of messages an employee sent in a specific communication channel (e.g., SLACK). The darker an area, the more messages. As depicted, certain users send more messages, and certain channels receive more messages.

Using this data, the analytics server may perform an initial unsupervised modeling by running the user-channel bipartite graph through hierarchical clustering. The model may be restricted to users that have made at least one post (on a communication channel). This clustering provides a high level view of the relative co-occurrence of users in channels, as depicted in a chart 3820 in FIG. 38B.

The chart 3820 illustrates 4-5 outlying groups, and a very large central cluster. These groups likely denote a few semi-distinct business units or departments from the larger general employee base. This clustering provides a rough overview of the social dynamic and the structure and overlap of business units in a company analyzed. This could potentially be a simple way to classify organizational structure from a higher level, but may not help identify an employee-to-employee relationship level. For instance, managers may not be clustered separately from non-managers in any meaningful way nor may they be especially close to their reports. In order to produce more meaningful results for the manager-reportee problem, the analytics server may utilize a supervised model.

The generalized linear model (GLM) is a standard statistical method for modeling a response variable as a function of several predictors. As used herein, the outcome variable Yᵢⱼ may represent a binary outcome indicating whether person i is managed by person j. Several predictors can be generated and screened including:
Xᵢⱼ=euclidean distance between channel messaging: Σ(Mᵢₖ−Mⱼₖ)² where M is the user-channel matrix with Mᵢₖ representing the number of messages i sent in channel k.
Xᵢⱼ=euclidean log distance between channel messaging: Σ(log 1p(Mᵢₖ)−log 1p(Mⱼₖ))²
Xᵢⱼ=euclidean distance between channel messaging with a time adjustment: Σ(Mᵢₖ−Mⱼₖ) for messages in between max(time i joined k, time j joined k) and the present time.
Xᵢⱼ=five point b-spline on the euclidean distance between channel messaging: B(Σ(Mᵢₖ−Mⱼₖ)²)
Xᵢⱼ=1 if the domain of user i and user j's email addresses match, 0 otherwise
Sᵢ=1 if sender is i (the predicted report)
Rⱼ=1 if receiver is j (the predicted manager)

During initial efforts using the various distance measures (e.g., first 3 listed predictors), the model may not track the data associated with managers efficiently. This may be because most managers are a “medium” Euclidean distance from their reportees, which indicates that their messaging may not be equally balanced with their reports yet not extremely unbalanced compared to other possible relationships. To improve the results, the fourth predictor, a five point b-spline can be applied to the data as well.

Due to the high collinearity between predictors, the model may have to apply regularization to reduce variances. This can be achieved via an elastic net method. The two tuning parameters provided by elastic net, α (alpha—controls the split between hard and soft regularization) and λ (lambda—the amount of regularization to apply) can be chosen by grid search over alpha, thus the optimal lambda can be determined efficiently conditional on alpha.

In addition to elastic net regularization, a regularization protocol based on sender and receiver predictors can also be applied. These predictors may help skew the results towards irregular or special relationships. If the model assumes that most employees participate in the majority of communal communication (e.g., SLACK) channels with their business unit (design, sales, etc.) or the entire company (general, announcements, random, etc.), the first 4 predictors may not produce much difference between manager-reportee relationships as other types of relationships because in most cases either the majority of employees contribute to these communal channels, or only a few executives or higher level managers post in a controlled manner. To differentiate specifically between types of relationships, one can hypothesize that there is a correlation between how much a reportee sends or receives messages to or from their manager. This is based on the assumption that managers and their reportees frequently communicate in direct messages (private, non-communal channels) with a different pattern than other relationship types.

When tested, sender effects tended to zero out the whole block of parameters. This was with the unique exception of one employee in the data set that had five managers and therefore was 5 times more likely to be someone's reportee. Regularizing applied to receiver effects tended to lift managers as expected. However, because this is a main effect, it may cause all managers to be scored higher, proportional to their number of reportees. This would likely be caused by managers frequently being asked questions or being provided with updates from their reportees. For example, the ego node of the data set may have over 20 people scoring highly.

The analytics server may use a post-hoc filtering protocol to account for false positives. As depicted in FIG. 38C, the analytics server may apply the maximum spanning tree algorithm to the imputed graph, removed isolates, and shown managers in a different color than the rest of the nodes. As depicted, most of the managers are at the edge. This may be an artifact of the ego-centric data collection. Because each dyad is modeled independently, fitting the model to data may be represented as O(n²p³). In other words, each additional observation bears a cost of O(np³) and each additional predictor bears a cost of O(n²p²). In order to moderate this increase as the number of users increases, the analytics server can hard-condition the model by the communication channel workspace. This complexity also implies that the model should avoid adding high-cardinality predictors in the future.

In order to improve the results, one embodiment can analyze the data using an exponential random graph model (ERGM). ERGM is a statistical method for modeling a network as a whole, and so can also incorporate network-level covariates, such as the distribution of in and out degrees of nodes. The main advantage of incorporating degree effects would be to match up the predicted edges with what is known about an existing organizational chart/tree. The basis used by the model can be set as follows:
Out degree should be [1,k], where k is a small number representing a “reasonable number” of managers. Empirically, 5 may be the maximum, for example.
Out degree equaling 0 is very unlikely (person with no manager).
In-degree should be a mixture of zero for non-managers, and 3-8 for managers.

A drawback to ERGM software is that regularization may not be implemented, meaning that selecting between various distance metrics would need to be done iteratively (e.g., using Bayesian info criteria) rather than in one shot. The computational complexity for fitting this model may be higher than a GLM. This may not be an issue for batch reporting use cases, but may be prohibitive to integrating with live services for fast updating.

In another embodiment, the analytics server may use a support-vector machine (SVM) protocol. Instead of optimizing a probability model, SVM optimizes the hinge loss function which would be used to categorize relationships as either manager-reportee or not. Because of the kernel trick, the analytics server can incorporate a high dimension feature space or high-cardinality features directly. For example, the analytics server could test every unique channel or direct message joined by employees, instead of aggregating over the channels dimension as done previously. The optimal set of support nodes selected should map to the managers. This method could help in identifying changes over time. If the model identifies the specific patterns within a manager-reportee relationship, the model (and ultimately the analytics server) could suggest updates to relationships which fall into or out of the pattern over time.

In yet another embodiment, the analytics server may use a semi-supervised model that utilizes a non-negative matrix factorization (NNMF). NNMF is a standard technique in the recommender systems. It is based around factoring a non-negative matrix A=UV′ such that U and V are lower rank, but also subject to the constraints that they are non-negative and csparse. U is often interpreted as cluster assignment, and V is often interpreted as cluster centers. As in the alternating least squares applications for files and emails (and other types of data), the main tuning parameter is k, which can be selected via cross-validation.

In the present application of the model to the data, the model may encounter two sets of data. Accordingly, the model may construct the block matrix, A=[MC], where M is the directed adjacency matrix of reports to managers, and C is the number of messages sent by a reportee to each communication channel. Ranging k from 13 to 93 shows a high amount of agreement between the various fits, with the largest change being whether ˜10 nodes are grouped into the central cluster (rectangle on bottom right of silhouette plots (rectangles 3830 depicted in FIG. 38D)). Plotting one of the fits (k=8) using igraph, it can illustrated that the model may be over connecting (many grey lines between nodes), and with many managers being located spatially further away from their reportees than other nodes (red lines).

To identify user-to-user relationships, the analytics server may utilize a method that can scale to include channel activity as a predictor directly, such as the SVM model. Accordingly, the analytics server may have to resort to feature hashing. Also, as an improvement to the SVM model, the analytics server may also account for directionality of a manager-reportee relationship.

The model and tuning parameters used by the analytics server may work for the respective size, social dynamic, and communication structure of all companies/entities involved. These differences might be too great to allow for a generalized model based on communication channel information alone. Therefore, the models may also analyze email data, like that used for the contact recommendation system, and other behavioral and activity data.

The model may identify recognizable patterns in the interplay between how often and in which direction managers and their reportees choose to send emails versus more informal and potentially time sensitive communal communication messages (e.g., forums, texts, and SLACK messages). The model could benefit from the inclusion of more specific predictors to distinguish managers-reportee from other types of relationships. For example, it is likely that managers often message their reportees asking for updates, or timelines detailing when something will be done, or why something did not get done. This is in contrast with, for example, two engineers collaborating on code, asking each other technical questions. The analytics server may also use natural language processing for such semantic, text-based predictors. As an improvement, and a possible solution to add directionality to the SVM model, the analytics server could incorporate the “role” field communal communication channel users often add to their profile metadata, roughly denoting their position within the company. Another possible improved predictor could be how quickly people respond to messages. The model may assume/hypothesize that reportees often respond quickest to messages from their managers in order to appear intelligent and responsive in their work. Inversely, a manager may reply more slowly, to ensure they've thought out the best way to phrase something to a reportee and because they have the leisure as the traditionally more powerful side of the relationship.

In addition, the analytics server may take into consideration information from other data sources like calendars, project management tools, CRMs, and more. For example, managers often have scheduled “one-on-one” meetings with their reportees in a somewhat regular basis. Data related to this meeting typically exists in a calendar event, and could therefore be used to help validate data or be otherwise incorporated into some of the methods described herein.

Identifying Relationships Through URLs and URIs

The analytics server may use URLs to identify relationship between nodes of the nodal data structure. Most of the electronic content a user views or accesses on the internet is represented by a URL. Most web-based file storage systems have a unique URL for each file, most web-based email clients and instant messaging tools have a unique URL per email, thread, or other communication channel. Employees often spend hours each day searching for work information in the browser from websites and web-apps. The analytics server may help this process by providing contextually related information to users about their current webpage directly in their browser. URLs are valuable identifiers as they can be used to make connections across many facets of a user's workflow rather than just files. Additionally, protocols like the Linked Data Platform also provide a unique URL for a specific node of data within a nodal data structure and could be easily ingested by the analytics server.

To relate units of work based on URL, the analytics server may, for example, create two tables in a relational database, links and link_associations. The links table may have a URL string field and may store a JSON object with each unit of the URL (e.g., protocol, host, path, query, etc.) for easier querying at runtime. Records in the links table may be unique based on their URL. The link_associations table may be a join between links and any unit of work (file, message, contact, etc.). Due to the parameterization and scalability protocols discussed herein, the analytics server may insert a call to a link parser module to create relationships between units of work and links as part of the processing. The link parser module may take as input any text content related to a unit of work. The text content could be plain or structured, such as the subject or body of an email, the contents of a text-based file, or profile information about a contact. The module then may use a standard library (e.g., Ruby's URI library) to parse the text for URLs. The module may then find existing links in the database (nodal data structure) with those URLs or creates new links for them. Lastly, the module may create link_associations between the links and each unit of work being processed.

The analytics server may utilize an API to return all units of work related to a provided URL parameter. The API may return several different classifications of related data: (1) units of work containing the exact URL, (2) units of work containing links with only the same host and path, (3) units of work that are second degree connections to the provided URL. For example, if a certain URL was sent in the body of an email to a user and the user visits that URL, the API will return the email along with any files which were included as attachments in that email or other attachments sent in other messages in the email thread, and (4) the API may add content related to links only matching the domain of the provided URL. This may help users quickly jump to a different recently viewed document on the same service (e.g., file sharing services) without having to search or navigate a separate interface or folder structure.

Upon every page navigation a user makes, the analytics server may query this API (e.g., the nodal data structure) with the user's current URL (a.k.a., a unique identifier) and display the associated units of work and analyses (e.g., files, emails, contacts, etc.) related to what the user is viewing as described further herein. All of these results may be, for example, displayed in a drop down, which the user can open or close with a single click in the header of their browser.

This correlation identification may be performed locally on users' computers, remotely on a server, using a decentralized computer system, or otherwise. Doing so may require the nodal data structure and syncing processes to be stored and run locally (or in the corresponding environment(s)). The analytics server may encounter a non-trivial amount of “noise” in the related content returned by the API (e.g., from the nodal data structure). For instance, emails may commonly contain attachments for calendar events, branding or social media icons, and tracking links. Some of the files and links tend not to be content that the user cares about and need to be filtered out by de-noising algorithms to maintain the quality of relationships maintained by the nodal data structure.

The analytics server may also consider/analyze data gathered from the APIs of integrated systems and services, as well as usage of user-facing GUIs provided by the analytics server to create new and meaningful relationships among units of work.

The analytics server may consider “legacy” user experiences, such as interactions with file browsers, email clients, and the like. Various third party applications and software solutions may provide collaborative and organizational features and create an “all-in-one” solution. The analytics server may use data collected from these tools to create additional relationships. For instance, a single tool, like a file browser, may not be able to provide enough data and interactions across an organization to produce meaningful insights about users' workflows because it may not encompass an organization's or a user's whole “world of work.” in contrast, the information that is available across user interactions within the above-mentioned tools can be used by the data correlation algorithms to identify context around users and their activities.

The amount of data retrieved from some the backend systems and services interacted with may be limited. For instance, some services, like file sharing applications, may not provide comprehensive activity details via their APIs. Instead, they may only provide data informing that a change happened to a given file (not who did the action, or what was changed). To rectify this problem, the analytics server may generate a system to identify, infer, and impute data gaps by monitoring changes to the data stored within various databases (e.g., nodal data structure) through periodic data monitoring and syncing of new files, interactions, and content.

In another embodiment, the analytics server may include a component(s) which acts as a meta-layer that resides over user's existing and varied tools, such that additional interaction data is detected. This allows the analytics server to (a) not be limited by other tools' back-end APIs, (b) not require users to work through one interface, and (c) be able to access more and a different variety of behavioral data than would be possible using each software tool's APIs to improve the knowledge generated via the nodal data structure. To create a meta-layer that achieves these criteria, the methods and systems discussed herein can be implemented in at least three different ways: an operating system level solution, an application level solution, and/or as an extension to an application or operating system. Embodiments of these approaches may include: (a) having the analytics server is natively embedded into an operating system, a web browser, a file browser, a project management tool, or some other tool; (b) having the analytics server built into an application that tracks network traffic such as web requests or JavaScript events and messages, (c) having the analytics server be built into a browser extension or some other application; (d) and more. Additionally, the methods and systems can be deployed and combined in a variety of ways across various environments while contributing information into the same nodal data structure(s) (e.g., the analytics server(s) may be simultaneously built into a augmented reality device's operating system, be built into an application that runs on a desktop, be built into a browser extension that runs on a phone, and be built as an application that runs on a remote server).

Operating systems have among the most comprehensive access to a single user's interactions on a given device, at times even allowing the analytics server to overlay information on top of software and tools a user may interact with. Building the meta-layer as an application or background process running at the operating system level would allow the analytics server to access a significant amount of data including: insight into what applications a user has open, what files are opened or modified, visibility into network requests and lots of other operating system APIs such as location data, contacts, the file system, audio/video, and much more.

An OS-based or web-based development and implementation of the methods discussed herein can provide ease of development and existence of an active developer community, as well as use and reliance on these technologies for the users and customers. The web as a platform is in many ways a sort of operating system, though of course it also comes with its own limitations.

Referring back to FIG. 37, at step 3710, the analytics server may determine that a computing device has accessed electronic content. The analytics server may monitor one or more computing devices (e.g., employee computers) and may determine that a computing device accessing electronic context that can be analyzed by the analytics server. The analytics server may use various monitoring protocols (e.g., screen scraping, cookie analysis, JavaScript tracking) and/or may receive a notification from a third-party system or server (e.g., external server) that the computing device is accessing the electronic content. For instance, a third-party file sharing website may notify the analytics server that an employee is accessing a file.

As described herein, “electronic content” refers to the content/data being accessed (e.g., displayed or otherwise outputted) by a user using a computing device. A non-limiting example of electronic content may include any unit of work (e.g., a website, an email, and/or a task). Using the methods and systems described herein, the analytics server may identify the electronic content and units of work related to the identified electronic content. The analytics server may then display the units of work (stored within the nodal data structure) that are relevant to the electronic content being accessed by the user. For instance, when a user is viewing a website (electronic content), the analytics server may display a chat message and a document (examples of units of work) that are relevant to the website using various GUIs and overlays described herein.

To identify the electronic content, the analytics server may use any of the methods described herein, such as using (e.g., website URL) or generating a unique identifier (e.g., the hash of a file's contents, correlation algorithms, or other models discussed herein). In addition to identifying the electronic content itself, the analytics server may infer the user's intent behind accessing the electronic content. Using this inferred or predicted intent, the analytics server can identify other data (e.g., units of work) that are related to the outputted electronic content. The analytics server may also use the user's intent to select the results displayed to the user. For instance, the analytics server may rank the results in accordance with their respective relevance to the user's intent.

When the analytics server identifies that a user is accessing electronic content on his/her computing device, the analytics server may analyze the electronic content to identify one or more nodes that are relevant to the electronic content. The analytics server may analyze the electronic content outputted to identify one or more attributes of the electronic content. For example, the analytics server may gather the metadata (e.g., a website might have header information that includes a title and description as well as schema.org information that might include the electronic content's data type and data source) surrounding the electronic content and process the electronic content to understand its contents (e.g., using natural language understanding, facial recognition, etc.), identify any potential named entities in its contents, identify the data types associated with and/or embedded within the contents.

Using the identified attributes, the analytics server may search within the nodal data structure and identify nodes that (at least partially) correspond to the identified attribute(s). For instance, the analytics server may analyze an identifier of the electronic content (e.g., URL of a website) and/or parse the words within the electronic content (e.g., file name or the content of a chat session, content of a website being viewed by a user, and/or the text within an image).

Additionally or alternatively, the analytics server may analyze the user's working session to identify contextual data associated with the electronic content outputted (also referred to herein as identifying the intent of the user). A working session, as used herein, refers to data associated with a user's activity within a time period. The analytics server may monitor a user's activity and may analyze/contextualize the data produced as a result of the user's activity within the time window. For instance, the analytics server may monitor the user's activity for the day and determine various projects or topics associated with the employee's activity. The analytics server may then use this determination in consideration with its analysis of the user's intent and the electronic content being accessed by the user. In a non-limiting example, the analytics server may determine that because the user has been working on a particular project throughout a given period of time (a.k.a., working session), any electronic content accessed by the user during that time may have a higher probability of relatedness to the given project. It may therefore increase a relative potential relatedness score between the electronic content accessed during that working session and the project. As the same electronic content is interacted with across multiple working sessions, by one or more users, the analytics server can increase or decrease the potential relatedness score with the project as described in the systems and methods herein.

In a non-limiting example, the analytics server may use machine learning methods to group activity events throughout the day into various working sessions. For instance, the analytics server could access (from the nodal data structure) the activity events done by the user (across data sources) within a given timeframe (e.g., a day, 5 minutes, etc.) and identify all the contexts (e.g., projects) that are related to all the units of work (e.g., electronic content) that the user interacted with throughout the day. The analytics server may identify the contexts (e.g., projects) that have the highest relatedness score for electronic content associated with each activity event (or timespan during which the user was engaging with or interacting with a given electronic content). If multiple potential contexts (e.g., projects) are identified for a given activity event or timespan, multiple contexts can be taken into consideration as the analytics server calculates the overall potential relatedness score between a given working session and a context (e.g., project). The analytics sever may calculate and rank the potential relatedness score between a given working session and any associated context (e.g., project) by, for example, adding up all the potential relatedness scores between activity events and/or timespan(s) in a working session and all the contexts that are related and ordering them by most related. The analytics server may then use one or more of the most related contexts (e.g., projects) for a given timespan to recommend classifications of the user spent his/her time, as well as to influence the relative relatedness scores between the identified contexts (e.g., projects) and any electronic content within the timespan. The analytics server could use machine learning techniques to identify time spans and potential working sessions based on clusters of activity events that share relationships with the same contexts. In other words, the analytics window could suggest working sessions based on its understanding of the relationships between activity events/time spans and contexts (e.g., projects, objectives).

The time window associated with the working session may be as granular as needed to analyze the data and infer related contexts, the intent of the user during a given working session, and/or other analysis of activity. For instance, the analytics server may access working session data associated with the user's activity during the previous hour or login session. In another example, the analytics server may analyze the working session of the user for the day, week, or a month.

In a non-limiting example, the analytics server may analyze data associated with different applications being used by the user (e.g., if the user is also accessing a billing software while viewing a website, the analytics server may analyze the user's interactions with the billing software). The analytics server may also analyze other units of work that are accessed by the user and their related context data as well as any analysis stored (e.g., classification of time by productive vs. not productive) in the nodal data structure. For instance, if a user is viewing a website and a file at the same time, the analytics server may analyze the file (e.g., identify a node associated with the file) and its context data (e.g., what the folder file is in, a project associated with the file, data embedded in the file, timestamp indicating how the user has interacted with the file, and the like). The analytics server may do the same for the website.

Using the identified data, the analytics server may determine one or more attributes associated with the electronic content, search the nodal data structure, and may present the relevant data to the user or to other software applications, such that the user/software can choose to focus information around any of these nodes as they see fit. Given that the analytics server may identify many relevant nodes to the electronic content being displayed on the user's computer, the analytics server may use, for example, any of the above-described analysis to only show most relevant data to the user.

In a non-limiting example, the user is accessing a website that is identified to be relevant to ten nodes associated with five projects. Because the user also has a file open that is identified to be closely associated with one of the five projects, the analytics server prioritizes the nodes relevant to the identified project. Therefore, when the user submits a query to the analytics server, the analytics server ranks the results, such that data corresponding to the identified project is ranked higher.

In another non-limiting example, the user is accessing a website that is identified to be relevant to ten nodes. The analytics server also analyzes the user's “working session” and identifies that the website the user is viewing includes an email that has an attachment with an embedded image of an invoice that is associated with a particular project. As a result, the analytics server prioritizes nodes that are relevant to the website being viewed by the user that are also relevant to the identified project. For example, the analytics server may present and prioritize: relevant data and actions associated with the general navigation of web pages; relevant data and actions associated with the general navigation of email messages and webpages, as well as general context data and actions associated with the specific email app being used; contextual data and actions associated with of the identified email message and related data, including message thread, people, message content, attached files, etc.; and/or contextual data and actions associated with to the identified project and its associated nodes such as contributors, key files, dates, and more.

In some configurations the analytics server may generate contextually aware unique identifiers for two different units of work that might not be immediately adjacent nodes in the nodal data structure, but that are regardless related to the same topic. For example, two different text string references to the same project articulated using different vocabulary in two different mediums (e.g., a local file and an email) might be understood to be related by the analytics server through an analysis of the known data points and units of work associated with each text string. In an alternate embodiment, a user could manually link both text strings as being related to the same topic. Once the analytics server establishes, through analytical means (e.g., topic modeling) or otherwise, that both text strings are related, and referencing the same topic in this example, the analytics server might generate a unique identifier linking both units of work together.

The analytics server may continuously or periodically monitor and/or subscribe to or be notified of relevant activity from each computing device within one or more networks of computers. For instance, the analytics server may monitor every computer operated by each user (e.g., employees of a company). The analytics server may monitor a web application displayed on an electronic user device via a browser extension executing on any computing device operated by a user (e.g., computer, tablet, and/or phone). For example, a user may be accessing an online document that has a task embedded within it through a document editing application (e.g., Dropbox Paper) within a smart window in a web browser during a time in which said user is in a meeting registered through a calendar event. In this scenario the user's working session has several units of work that may be identified, including the application being used, the document being worked on, the task within the document, the smart window in which this is all open, and the calendar event that lines up with the current time.

The analytics server (one or more) may also monitor multiple electronic devices and various applications executing on the electronic devices. The analytics server may also communicate with various electronic devices and monitor the communications between the electronic devices and the various servers executing applications on the electronic devices. For instance, the analytics server may monitor data packages received and sent by each electronic device to monitor the content of what is displayed/executed on each electronic device. The communication may take any suitable form. For example, the electronic device may execute a browser application having an application and/or an executable file that enables a user to navigate to the webpage. The analytics server may monitor all applications causing the electronic devices to perform an action, such as display a document, print a webpage, edit a spreadsheet, share or record the user's screen, render a mobile version of a website, or another form of electronic content to which a user may navigate/access online or offline.

The embodiments of the present disclosure are not limited to webpages/websites accessible via a browser application. The analytics server may monitor electronic devices operated by users to identify any electronic content accessed by the users. For instance, disclosed methods and systems are also applicable to end users accessing local files (files stored locally or on a private network, such as a company network), local tasks or reminders, local contacts, strings of text representing physical addresses or email addresses on locally stored files, etc. For clarity, certain embodiments disclosed herein use a website as a non-limiting example of electronic content accessed/viewed by a user.

When the user performs an activity on a browser application of the electronic device, the analytics server may track the user's activity and current “working session” in order to determine relevant units of work that may be present, such as the application that is open, the electronic content open within said application, any potentially embedded electronic content, and any other contextual information related to who is working on what, how, when, where, and why on the electronic device. The analytics server may use several techniques to track the user's activities on the electronic device, such as by tracking browser cookies, IP addresses, screen-scraping protocols, and information embedded in the URL address. In one example, the analytics server may track the user's activity using IP address. In another example, the analytics server may track the user activity by storing user's web browser cookies. The analytics server may store the cookies as text strings on the user's electronic device local drive, and the cookies may be sent to a system server by the analytics server for user session tracking.

In yet another example, the analytics server may track a user's activities using information embedded in a URL string on a browser application of the electronic device. The analytics server may implement the tracking process by communicating with a webserver (in communication with the electronic device) appending a tracking or query string onto the URL string at the electronic device prior to sending the URL string to a browser. When a web browser accesses the content using the URL embedded with tracking information, the web browser sends the URL string back to a webserver. By monitoring the embedded information, the analytics server may track user activities and then identify a webpage the user is accessing.

In some configurations, the analytics server may locally install a software application (e.g., a web browser extension) onto each user's electronic device. The software application may continuously/periodically track the user's activity and identify which websites have been accessed by the user. The software application (executable file) may be executing as a background process of the electronic device. For instance, the software application may be transparent to the user operating the electronic device. In this way, the analytics server is able to monitor the user's activities and “working session” without disturbing the user and/or disturbing the display screen of the electronic device. The software application may remain in the background (e.g., transparent to the user) until and unless the analytics server, for example, displays a pop-up window (or other GUIs) displaying relevant information in the foreground. This pop-up window (or other GUI or GUIs) may be initiated automatically by the analytics server or by the user manually requesting contextual information and/or actions. The analytics server could also augment the interfaces of websites viewed by the user with relevant contextual information, actions, and/or analyses.

The methods and systems described herein apply to any electronic content accessed by the user, regardless of the platform on which the content is presented. For instance, the electronic content, as described herein, may apply to text viewed by the user (e.g., on a website, on an application executing on the user's computer, such as an email application) and/or images viewed by the user (e.g., an image embedded in a file, such as a PowerPoint file) or an image viewed in an email, or another file attached to an email. The analytics server could also augment speech-based interfaces, virtual/augmented/mixed reality environments, and more.

The analytics server may collect the content viewed or accessed by the user's computer and execute various parsing protocols to parse the data. For instance, the analytics server may parse the words and execute natural language processing or understanding protocols to identify the words displayed within a website. In another example, the analytics server may capture a video displayed on a user's computer and may execute a facial/object recognition protocol to identify the people and objects within the video. Similarly, the analytics server may capture everything the user is doing on the screen and perform image recognition techniques to identify and index everything the user is doing within the nodal data structure.

As used herein, everything on user's screen may be considered as the “electronic content.” In contrast, all data associated with the user's “working session” may be fall within the definition of “electronic context.” Additionally, “electronic context” may also refer to all the data that is not identified as the primary node (aka “electronic content”) that a given user is accessing.

In some configurations “smart windows” or contexts (e.g., projects) may save the last working state, as well as the history of working states, (e.g., any open windows, tabs, and other aspects of a working state that may be associated with a given project) and let the user close everything and reopen it with ease at any future point in time. More than just restoring tabs within a browser, this can help the user close all the Microsoft Word windows and files, Photoshop windows, browser windows, MacOS Finder® windows, and more that the user had open when he/she was last working on a given context (e.g., project). In other words, the analytics server may record parts of a user electronic context and relate those units of work to a given context such that the user can restore that electronic context. In this way a “smart window” can also be considered a “smart desktop screen” with multiple windows, tabs, and/or applications that may be open at a given time on the same computing device.

The electronic content may also include a series of layered/nested contextual information about the content being presented (e.g., viewed on the user's device). For instance, a user may be logged in as an employee of company X and is working within a smart window that has a series of tabs and applications open within it. The user may be viewing a web application (on website) that is identified as part of the “working state” for a given smart window (e.g., project). Specifically, the user has opened a Word® file within the web application. The Word® file includes an image. In this example, electronic content include all data corresponding to what the user is engaging with on the screen including the web application, the website, the word document, and the image itself. Specifically, the electronic content may include information about that image and all that context about how, where, and in what context the user has accessed the image. In this way multiple nodes can be simultaneously considered electronic content.

In some configurations, the electronic content being accessed by the user is a unit work that corresponds to information within the nodal data structure. For instance, the user may be viewing a document file (unit of work) and the analytics server may display relevant software applications and contextual actions associated with them, a relevant email and contextual actions associated with it, or other document files (unit of work) and contextual actions associated with them using various GUIs described herein.

Moreover, the analytics server's presentation of data is not limited to displaying the content using GUIs. In other configurations, the analytic server may present the data using CLIs (command line interface), NLUI (natural language user interface), API, Brain-computer interface (BCI/NCI), other sensory measurements that can be used as interfaces/inputs for the analytics server, etc.

The analytics server may use artificial intelligence modeling (e.g., machine learning) techniques described above to determine whether two nodes (corresponding to two units of work, such as an email and a chat session, electronic file, and/or online browsing session) are related. In some configurations, the analytics server may execute one or more AI models using context data retrieved for each file to identify whether two or more files/nodes are related. For instance, the analytics server may identify two nodes/files as being related to each other (and ultimately to a project) because they are accessed by team members working on the same project and that the two nodes/files have been attached to an email between the two team members where the email contained content related to a particular project.

The analytics server may continuously monitor the computers and revise the nodal data structure accordingly. The analytics server may continuously or periodically monitor each computing device within one or more networks of computers. For instance, the analytics server may monitor every computer operated by multiple users (e.g., employees of a company). The analytics server may monitor a unit of work such as a web application displayed on an electronic user device via a software (e.g., a browser extension, a desktop background process) that executes on any computing device operated by a user (e.g., computer, tablet, and/or phone). The analytics server may monitor multiple electronic devices and various applications executing on the electronic devices. The analytics server may also subscribe to or otherwise be notified of relevant activity from electronic devices rather than or in addition to periodically scanning the data sources. The analytics server may communicate with various electronic devices and monitor the communications between the electronic devices and the various servers executing applications on the electronic devices. The analytics server may also monitor one or more units of work via software that executes on a computing device (e.g., a remote server) that is providing data to a computing device operated by a user. As a result, the analytics server may periodically revise the nodal data structure when new relationships and associations are identified.

At step 3720, the analytics server may present data associated with the outputted electronic content. The analytics server may identify one or more nodes (and any other node linked to the identified node) that are related to the electronic content. The analytics server may then present (e.g., for display) data associated with the identified node.

As detailed above, the analytics server may determine the electronic content being accessed by a user to display relevant information (e.g., from the nodal data structure). In addition to identifying the electronic content being accessed by the user using the methods and systems described above, the analytics server may determine or identify the user's intent when accessing the electronic content.

The analytics server may use the various methods to match and identify electronic content. For instance, the analytics server may monitor browsing history of each user and analyze the URLs associated with each user (e.g., tile, date, number of visits, file paths). The analytics server may utilize a parser(s) (e.g., regexes) to analyze the URLs and browsing activity of each user without having to open the websites. The analytics server may also utilize machine learning models to identify the content accessed by the users.

To match the electronic content accessed by the user, the analytics server may match the websites by analyzing HTML, source of the content with different known applications, IP addressed, Context pages, workspaces, and the like. The analytics server may also utilize a listening device to monitor data packets transmitted (sent or received) via the user's computer. For instance, by analyzing what data was sent and/or received (e.g., JavaScript events and messages), the analytics server may identify what content is being accessed by the user and/or what the user may be doing.

As depicted in FIG. 39, the analytics server may generate a timeline of activity for a user and analyze the activity of the user to identify the intent of the user accessing the electronic content. For instance, the analytics server may generate a timeline 3900 based on a user's activity. As used herein, activity refers to any actions conducted by the user using one or more electronic devices. The analytics server may monitor any activity (e.g., any interactions with any website, third party applications, native applications, etc.) associated with a user's account.

FIG. 39 is a visualization of the consolidated activities for a user within a predetermined window of time. The analytics server may monitor and record the user's activities. The depicted timeline 3900 can correspond to any time window. For instance, the user may zoom out of the depicted view, such that the overall time window is increased. When the user increases the time window, various attributes (blocks of time) may be less detailed (because the blocks of time are now indicating a larger time window).

The analytics server may generate the depicted hierarchy or otherwise identify relationships between various actions performed by the user. For instance, as depicted, the analytics server can identify actions that are simultaneously (or near simultaneously) performed and then identify whether they are related. The relationships of the actions depicted in the timeline can have certain weights between them or certain associations that can be used to identify the user's intent.

Through time and event tracking, the analytics server can correlate all of the user's activity. In a non-limiting example, the user may be operating his phone and his computer simultaneously. Section 3902 indicates activities received by the analytics server via backend connections and section 3904 indicates the activities tracked via a client-side system installed on the user's computer. In addition to monitoring the user's activities using the methods and systems described above, the analytics server may communicate with one or more applications executing on the user's computer and receive a timeline of activity and events associated with the user and/or with the websites, applications, and services the user is interacting with.

FIG. 40 shows the ability of a standard web browser (e.g., Chrome®) to track and provide a timeline of processes and tasks that the browser may perform while rendering a given website. The timeline 4000 shows how the browser can provide user generated events, tasks, processes, etc. that could be similarly tracked by the analytics server to create or modify aspects of the nodal data structure. The analytics server, could processes this information, along with other data (e.g., from multiple data sources) as described herein, to establish its own timeline of user activity and related events. Certain activity events in timeline 3904 may be nested, such that multiple dependent events, timespans, and/or units of work are interacted with in a contextually relevant manner.

The analytics server may use this information to generate the aggregated timeline 3900 depicted in FIG. 39. Therefore, the timeline 3900 depicted FIG. 39 may illustrate all user events and activity by a user organized by device and by time 3904 (e.g., actions performed, applications opened), timespans for electronic content and electronic context nested by their dependencies (e.g., user X is logged in from the office for a period of time, and while he/she is logged in, he has a browser open for a subset of that time, and within that subset of time he/she has a certain website open for a subset of that subset of time), events identified through backend connections 3902 (e.g., Asana API updates the analytics server that a task was completed), timespans expected via backend connections 3902 (e.g., user has a meeting scheduled in Outlook® calendar between 2 and 3 pm).

As depicted, the span of active Google Maps® directions between 13:30 to 14:15 indicates that the user used a map/direction application and was traveling from point A to point B. This may have been done on a device that doesn't have a client-side tracking application installed, but since the directions were done with the user's Google account, the analytics server may have received the information that the user was using Google Maps to get directions from point A to point B between 13:30 and 14:15. Around the same time, the timeline 3904 shows that the user was actively using his/her phone between 15:35 and 14:29. More specifically it indicates that the user transmitted a text message around 13:45 and made a phone call at 14:00.

In contrast to the Google Maps® directions, these events and timespans may have been tracked by software installed on the user's phone. The analytics server may also retrieve calendar information associated with the user's mobile device and determine that the user was scheduled to be in a meeting associated with project A starting from 14:00 to 15:00. Further processing this information, the analytics server could determine that the text message the user sent at 13:45 was to a participant of the meeting scheduled to start at 14:00, perhaps indicating that he/she was running late. Furthermore, the analytics server may determine call the user made at 14:00 was to dial into the phone number listed on the calendar event, therefore the call was related to the calendar event, even though the user was not at this computer or dialing in via the ZOOM application. This processing allows the analytics server to relate and/or recommend that the text message and the call therefore be related to the calendar event and any other relevant context and/or node. Similarly, it enabled the analytics server to understand that the user was working at 14:00, and it can use that to mark the entire timespan from 14:00 to 14:30 as likely 100% billable as described further below 3906.

In some configurations, the user may also have access to a time tracking application (e.g., billing software solutions) where the user may record and attribute all his/her time to a particular project or a billable matter. Using this time tracking application, the analytics server may generate a relationship between the actions performed. For instance, the user may use the time tracking application to indicate that his activity from 14:20 to 15:10 should be attributed to project B (time tracking indicator 3908). As a result, the analytics server may increase the relatedness score between all the user's activity between the identified time period (cluster of activities 3910) and project B. As a result, the analytics server may contextualize each block of time for the user by analyzing the user's activity and attributing the user's activity to one or more nodes within the nodal data structure. Therefore, the analytics server may generate analyses of the user's screen time and activity.

As an example, the analytics server determines that the user has accessed a “smart desktop screen” (also referred to herein in various embodiments as smart window, context page, or context) that is related to called “Context 3—Cool Project”. The analytics server determines that the user has initiated a Chrome window 3912 within the “Context 3—Cool Project” smart desktop screen. In the depicted embodiment, the cluster of activities 3914 indicates that the user accessed a series of applications within Chrome window 3912. In this scenario, the user could ZOOM into the interface to understand more effectively what those activities are. The timeline 3904 also depicts the user opening the ZOOM application 3920 around 14:25 and closing it at around 15:05, and within that time it also shows that the user had a messaging application and the Figma application open.

Therefore, the timeline 3900 depicts a mixture of information captured via both backend and frontend processes. As a result, the analytics server may have the ability to infer things from the combination of those monitored activities. So in the depicted embodiment, the analytics server may not directly identify any user activity at 15:50 because that time has not yet happened (a.k.a. the current time is roughly 15:50 in this example). It therefore makes sense that the user has no activity during this time period (after 15:50). However, the analytics server has identified some back-end information that can start to suggest the user's expected activity (e.g., scheduled meeting with client A) retrieved from the user's calendar (activity 3916).

As the user continues to interact and perform actions on his/her computer, the analytics server may build and infer new relationships. For instance, and as described above, the analytics server determines that the user is currently on a virtual meeting/call (3918), such as a ZOOM call. That virtual meeting/call 3918 is probably related to the scheduled meeting 3916. Upon further analysis, the analytics server may determine that the virtual meeting/call 3918 is referenced in the details or metadata for that scheduled meeting. Furthermore, the user's time-tracking tool logged that the user was doing work for Project B during that scheduled meeting 3916. Therefore, anything within this time window has a high chance of being related to Project B, including the virtual meeting/call 3918. The analytics server may also identify that Context 3 was opened the entire time that the user logged his/her time to Project B. Therefore, the analytics server may infer that Context 3 is probably related to Project B.

The cluster of activities 3910 may represent the actions and activities performed while the user was working on Context 3 (e.g., open applications). As a result, the analytics sever may associate the data generated during this time period as a result of the user interacting with the applications and units of work within the cluster of activities 3910 to Context 3 (and ultimately to project B). For instance, the tasks performed by the user, the files the user was editing, the files and messages that were being sent within the virtual meeting/call 3920 (e.g., presentations or files that were shared via the chat and/or the website that was presented while the user was screen sharing during the virtual meeting/call 3920) may be attributed to the Context 3 and/or Project B.

Using this method the data associated with each unit of work depicted in the timeline 3900 can start to be related together because the user is working on it at a similar time. Additionally or alternatively, the analytics server may generate/infer new relationships because of other associations or relationships that might be available within the nodal data structure. In another example, the cluster of activity 3922 may also be related to Project B. As depicted, Project B may correlate to Context 3, therefore increasing the probability that they're related. The probability of Context 3 and Project B being related may also increase when the analytics server identifies another user who has interacted with Context 3 also logged his/her time as working on Project B.

The analytics server can start to classify information not just by what it's related to, but also by determining type of action that was performed by a user. For instance, the analytics server determines that the user was reading New York Times and interacting with some other applications (cluster 3922) as well as working within a file sharing platform (e.g., GOOGLE DOC). Therefore, some of those activities can be considered productive (e.g., related to Project B) and some of the activities may be irrelevant, such as reading the news. The analytics server can infer or suggest that 25% of the time within the block of time corresponding to the cluster 3922 is billable. Similarly the activities that are related to Context 3 or Project B may be considered as billable work by the analytics server. Therefore, the analytics server can start to infer that some activities were billable within the cluster 3922 at some percentage, and you can start to understand what amount of the user's time is potentially billable.

The analytics server may also generate summaries for various time windows or time blocks. For instance, the analytics server can create summaries in blocks, as depicted in the section 306. The analytics server can try to infer what users are doing within the depicted 30-minute blocks. The analytics server can understand that a user is reading a recipe for the majority of time block corresponding to 14:00-14:30. Therefore, the analytics server may determine that user was reviewing recipes for making a birthday cake, as illustrated in the summary 3924.

Additionally or alternatively, the analytics server can use NLP, natural language processing or natural language understanding, and/or texts summarization techniques to start to build summaries over the document 3926 within the context of the cluster 3922. The analytics server may generate a summary for each unit of work. For instance, Context 3 has a summary associated with it. Each application within the cluster 3922 may have a summary associated with it. The “MyCompany” Workspace may also have a summary associated with it.

The summaries may be generated by the analytics server, or can be manually established by users. Therefore, as the user is working across various applications and electronic content, the analytics server may generate the associations described above as well as summarize what each unit of work is as well as summaries of what the user is doing with that unit of work over a given period of time (e.g., potential intent of the user). The analytics server may then use the summaries of lower lever units of work (e.g., the cluster of activities 3914) to generate summaries of the higher lever units of work they make up (e.g., Context 3). In other words, the analytics server may generate summaries of summaries. The summaries may also be aggregated, such that the summaries correspond to larger blocks of time. For instance, rather than getting a summary every 30 minutes, the analytics server may generate a summary for the day (e.g., this is a summary of what the user generally did this day). These larger summaries could also be generated by creating summaries of summaries.

As the analytics server generates the summaries, the analytics server may also identify and record intent or purpose or actual work done as opposed to summarize individual actions. The analytics server may glean the meaning out of the actions performed by the user and the content within those actions to identify and provide users with easy access to information to what the users were doing as they were looking through things.

The summaries can be used to generate or modify relationships within the nodal data structure and/or can be used to help with searching the nodal data structure. For instance, if the user searches for something that's associated with a summary at a given point in time, then the analytics server can present the results based on the summarizations and the relationships discussed above.

The analytics server may also display the timeline 3900, such that the user can view the identified relationships or summarizations. The analytics server may also provide the user with the opportunity to delete, add, or revise (correct) any relationships, associations, and/or summaries depicted within the timeline 3900. This could help further improve the analytics server ability to create analyses and/or summarize information. By tracking the user's activity, the analytics server may generate a digital footprint.

The timeline 3900 may also be revised and customized by the user. For instance, the user may revise the timeline 3900, such that it is centered around a specific information. For instance, the user may click on Context 3 and the analytics server can refocus the timeline 3900 around Context 3. Therefore, rather than just looking at the general timeline for everything, the user can filter the data that is relevant to Context 3. As a result, the user will not see items related to Project A or Context 2 (unless they are also related to Context 3). As a result, the user may only see the history associated with Context 3, what user was doing within Context 3, other things (e.g., applications, websites, or any other units of work) that were open within Context 3 that the user was (or wasn't) actively working on, such as tabs, other applications, and other activity associated with Context 3 that might have even been initiated by the user or someone else (e.g., the user received an email that's associated with Context 3 but the user never opened it; the analytics server may include the email within the timeline 3900 if the timeline 3900 us focused around Context 3).

The user can zoom in and out of the timeline 3900 and as the user re-centers the timeline 300, the analytics server may show different aspects of the nodal data structure in varying levels of detail within the timeline view.

The analytics server may also display the graph 4100 (FIG. 41) where each node can visually represent each node and its related/linked nodes. The graph 4100 may show the entire nodal data structure or it may be focused around Context 3. The analytics server may display all the associations of relationships that might be relevant for Context 3. For instance, if the user is reading a news article, then the user can see all the associations and relationships that might be relevant to that news article in a graph type view. The user can also start to organize the graph 4100 in a more structured way, such as grid or via a grid or a more easily legible free form graph 4200 (FIG. 42).

The analytics server may use the above-described and depicted graphs to allow users to navigate, search, understand, and retrieve data. In some configurations, the search conducted by the users may be limited by a specific attribute (e.g., search can be limited to data associated with a project or a Smart Window). The analytics server may display the overlay 4300 (FIG. 43) to allow the user to use search by, for example, keyword, association, and/or natural language to retrieve desired data. As depicted, the user can refocus the search around different applications, tags, context, or any other desired attribute.

Overlay 4400 (FIG. 44) is another example of a search bar provided by the analytics server. The user may enter a query in natural language (e.g., who was the last person to work on this project). The analytics server may then understand that the user looking for a person, the user is looking for the last activity and the user looking for the last activity from a person associated with a particular project, which is identified as a named node. The analytics server also identifies what project is referred to by the user when the user enters “this project.” Upon identifying the user's intent, the analytics server may display potential results that might be relevant to what the user is looking for. For instance, the analytics server may display the response 4410.

Additionally or alternatively, as depicted in FIG. 45, the user may request (in natural language) for “all the articles I have read last week.” As a result, the analytics server displays a list of articles viewed by the user in the identified time period (4500). The user may then interact with the input elements 4510 to filter the articles. The analytics server may then use the relationships built and summaries generated to identify and display the relevant articles. For instance, the analytics server may use the user's digital footprint to filter the articles by their source, geographic locations in which the articles were accessed, and/or a client or project associated with the article.

When a user reads an article within a given context, (e.g., a user reads it while a Context page associated with client 1 was opened), then the analytics server can display the article when the user requests a list of articles associated with client 1. In another example, the user may choose Context 1 and the analytics server may display all the articles that have been read through Context 1 or that are otherwise related to Context 1. Additionally or alternatively, the analytics server may display an article that was embedded in a message that's associated with Context 1.

The analytics server may also use the user's digital footprint to recommend new associations. For instance, the user may be viewing the website 4600 (FIG. 46). The user may then interact with an input element (e.g., input element 4610) to view the overlay 4620. When the user interacts with the overlay 4620 and indicates a desire to save the content being currently viewed, the analytics server may display the overlay 4700 (FIG. 47). The overlay 4700 may display various information that are inferred to be associated with the website being viewed by the user. For instance, the overlay 4700 may suggest the context that the user is currently in (e.g., things related to the store).

The user may also be directed to an overview page of the suggested Context (e.g., a context called “Comake Store”), as depicted in FIG. 48. The user can view all his/her browsing open tabs, as well as history and activity sectioned off based on their respective relationships. The GUI 4800 may also include various groupings allowing the user to choose a category (or customize the categories) of data to be displayed. For instance, the GUI 4800 may display the files or applications that are currently open (indicator 4802). When the user clicks on the indicator 4802, the analytics server displays all the files that are related to the “Comake Store” Context, from all the user's currently open tabs and recent history.

Referring back to FIG. 48, when the user interacts with messages tab 4804, the analytics server displays all the messages that the user has viewed through this context (FIG. 50A and FIG. 50B). The tabs displayed on the GUI 4800 prioritizing “Files,” “Messages,” “Tasks,” and “People,” could be customized based on the user's (the user viewing the GUI 4800) role. For instance, a software developer might see tabs that say “tasks,” “specs,” “pull requests,” and “bugs.” A patent lawyer might see “Files,” “Messages,” “Prior Art,” “Figures,” “Calendar.” An advertiser might see “Messages,” “Specs,” “Campaigns,” “Creative.”

When the user interacts with the tasks tab 4806, the analytics server may display all the tasks that the user has viewed through this context (FIG. 51). When the user interacts with people tab 4808, the analytics server may display all the people that that the user has viewed through or that are otherwise related to this context (FIG. 52).

The user may also browse through various files, using the graphical components depicted in FIG. 49. For instance, when the user interacts with the “files” tab, the analytics server may direct the user to the GUI 4900 where the graphical component 4902 allows the user to explore various files corresponding to the data stored within the nodal data structure. In some embodiments, the presentation of the files may correspond to the electronic content being displayed on the user's computer and/or their relevance to the user's intent (e.g., the relevance to the project being viewed by the user).

The analytics server may map and build relationships through the user's general usage and activity. The user may interact with various input elements to identify what the content being saved is and what it relates to. In essence, the user may identify how the analytics server should tag and relate the saved content within the nodal data structure. The analytics server may then revise the nodal data structure accordingly.

Referring now to FIG. 53, in a non-limiting embodiment, a user is viewing a patent on a website provided by the United States Patent and Trademark Office. The user desires to save a patent displayed by the USPTO and the analytics server displays the overlay 5300. The overlay 5300 illustrates that the patent has already been pre-classified as a patent and a PDF and it may have prefilled a variety of different fields and metadata associated with the PDF. Using the overlay 5300, the user may choose to give the patent a different name or just keep the normal name from the USPTO website, as depicted. The user may then continue adding or changing more details if the user desires (using the input element to input customized the information being saved within and related to the nodal data structure). The overlay 5300 may be keyboard-navigable, so the user can push tab to jump into this input field. The overlay 5300 may also suggest a workspace (e.g., the company associated with the user). In alternative embodiments, the user can choose another workspace, such as the user's personal workspace.

The overlay 5300 may also suggest a Context (Smart Window). The user can choose to add a Context or Smart Window as associated with the patent to be saved. Using this input element, the user can add the saved patent to a specific Context or Smart window. The analytics server may pull information from the page to build and/or suggest more relationships within the nodal data structure. In some cases, the analytics server may generate the relationships as the user is browsing and not necessarily as a result of the user confirming or saving any content. FIG. 54 illustrates another example of an extended overlay that is similar to the overlay 5300.

As depicted in the overlay 5400, the analytics server prefill or recommend a wide range of information that it may automatically gather from the electronic content being saved. It may generate summaries or find summaries on the page or within the content being saved (summary 5402). For instance, the analytics server may analyze the HTML header of the website to generate the summary. In another example, the analytics server may analyze the website and identify the abstract section of the patent. The analytics server may then plug the abstract of the patent into the different fields within the overlay 5400. The analytics server may also suggest other fields using the data within the patent being saved, such as the assignee, a patent number, inventor's priority date. Some of this information can also be retrieved from related documents or the related context via the existing information within the nodal data structure.

The overlay 5400 may also include other related files using the nodal data structure. The overlay 5400 may also include a location of the user when saving the patent (and other data associated with the user saving the patent). The overlay 5400 may also include section 5404 that identifies a hierarchical view of how the user is accessing the file being saved (e.g., similar to the nested dependencies in the timeline 3900 (FIG. 39). In addition to suggesting data from the electronic content and the nodal graph structure, the analytics server may also retrieve data from the identified electronic context depicted in the section 5404. Additionally or alternatively, the analytics server may identify data associated with the saved patent using its URL (which can be independently used to classify the document with one or more data types) or the HTML structure.

The metadata and input fields of the overlays 5400 or 5300 correspond to the content being saved/viewed (e.g., the patent on the USPTO website). For instance, the overlay 5400 includes an assignee input field because the analytics server may automatically identify the content being saved as data type “patent” and therefore it can suggest certain standard fields that are expected of a “patent”. These metadata and input fields may change depending on the content being saved. For instance, if the user is saving content using a LinkedIn profile, the metadata and input fields of the respective overlay may be different. For instance, the second overlay may include tags that correspond to person, current role, company, skills, people who have recommended those skills, and the like.

Identifying relevant information and/or prepopulating input fields are not limited to saving or to the depicted sections. For instance, the analytics server may use the methods and systems described herein to identify and/or generate information associated with any of the metadata fields or features depicted in FIG. 54 (not just the summary section 5402). The analytics server can automatically collect data associated with a variety of fields, such as the ones shown in the overlay 5400. As described herein, the analytics server can automatically generate and revise (update and/or recommend) the nodal data structure using data captured as one or more users are accessing or otherwise interacting with data (e.g., working or browsing the internet), through, for example, manual saving, general browsing, or through predetermined rules that only record certain types of data while working normally (e.g., to processing overhead down and/or avoid the nodal data structure growing in size too much).

While the user is operating his/her computer to access data (e.g., writing emails, working on files, browsing the Internet, etc.), the analytics server can continuously or periodically monitor and/or analyze the user's computer and related electronic context to revise the nodal data structure. The analytics server can also retroactively review recordings of user activity, screen recordings, network traffic recordings, or other historical data. For instance, the analytics server may retrieve the user's recorded history and any corresponding metadata according to the user's configured settings, and augment or modify it as specified (e.g., with standard metadata about the user's location, device, and other attributes discussed herein). The analytics server may also classify what type of data is being monitored/retrieved. Based on the collected data, the analytics server may also search for additional metadata for a given historical record from third-party sources (e.g., find a URL in a user's browsing history and access that website remotely to gather additional metadata). The analytics server may then interrelate the collected data to other related data within the nodal data structure. As a result, the analytics server may generate/revise relationships between what the user has historically done (e.g., electronic content accessed by the user) and other content within the nodal data structure.

FIG. 55 visually depicts the scope of data that can be retrieved from a social media post limited to 140 text characters (e.g., a TWEET). In this way, the analytics server may can use an identifier for a tweet (e.g., a URL) to independently access and enrich information via backend and frontend processes. As depicted, the data can indicate various attributes associated with the TWEET such as the related user, the user's account, user's associations on the platform (e.g., “friends”), and the like. Using this data, the analytics server may revise the nodal data structure and improve the established relationships between nodes.

Referring now to FIG. 56-57, visually depicts data that can be retrieved from a website. The analytics server may identify the data type of the content displayed by the website by looking at the metadata embedded in the HTML. FIG. 56 shows that the website is showing information about a specific data-type: Person, with a specific name: Bill Gates, along with other metadata including social profiles, job titles, images, social profiles, and more. FIG. 57 shows another example of a website that details out, in the page's HTML, that the website's content includes an audio object, with a specific name, details about the people who created it, a summary or description, as well as other information. Using this data, the analytics server may add all of this metadata into a nodal graph structure in an automated way with minimal processing. By improving the nodal data structure, the analytics is able to more effectively perform its various analyses as described herein, including identifying the user's intent at any given point in time.

The analytics server may use a series of algorithms that disparate historical archives of information and interconnect the isolated components within each archive into a nodal data structure. These algorithms build associations by looking at the activity, past and present, of the users within the data archives and within the systems used to access the data. By generating, maintaining, and understanding the context around data (a.k.a. work), the analytics server may maintain the nodal data structure as a living memory of the user's work, intent, and context as a private or shared Knowledge Base. Therefore, the nodal data structure is more than a simple index of projects, files, communication, and people. The nodal data structure becomes a living memory of all a user or group of users digital work, and can be queried and/or analyzed in much more sophisticated ways as described herein.

Users have varied habits, preferences, and ways of working that lead them to use different tools and organize data differently. Users' work habits also change over time as new technologies emerge and circumstances change. They save knowledge and information in different structures, in different systems, and with different limitations. File and folder systems, for example, remain largely hierarchical and non-associative, leading to difficulties managing versions, sources, decisions, etc.

The methods and systems described herein can be used to build and maintain relationships between data and thereby empower individuals and teams to build and maintain a shared memory and consciousness across tools, systems, and time. This in turn enables the users to better access the right information, understand it more completely, and ultimately work better with each other without requiring every party to fully overlap on schedule or software preferences. As people communicate and collaborate in various systems and services, the analytics server may utilize various algorithms to gather, structure, and maintain contextual information and “knowledge” within the nodal data structure. This knowledge is accessible to and shareable by users contextually around their existing workflows.

The analytics server may, for example, leverage the nodal data structure to (1) enable knowledge workers to easily find information with personalized search results based on their workflows, to (2) share and leverage institutional knowledge, empower asynchronous work, and avoid rework by revealing all of the context around each “unit of work” (e.g., project, file, team, objective, KPI, task, etc.), to (3) better understand the characteristics that lead to successful outcomes including people, workflows, team dynamics, etc., to (4) mitigate security/compliance risks associated with inconsistencies and incompatibilities across systems (e.g., by improving identity and access management through contextual awareness of a user's Graph), and to (5) improve operational performance through data-driven business insights.

As shown in FIG. 22, the analytics server may contextually and un-intrusively present everything that's relevant to a file, message chat or other digital data including any messages, people, tasks, and other types of data. In this way, users can easily access the process, reasoning, and best practices behind each unit of their work. This history and context associated with their work is currently distributed across a variety of systems and services and is typically only accessible through individual people's living memory. The analytics server may, via the nodal data structure, build and maintain a digital memory for each user that can be shared, and includes a knowledge graph, activity logs, and tables of relationships for specific types of data like files, messages, and contacts across everything a user does online (and offline). Every file, message, contact, etc. indexed by the analytics server may have a GUI (e.g., a profile) that presents all its associations with other files, messages, people, and higher-level conceptual understandings like projects, objectives, and goals.

The methods and systems described herein may also be used to save a given unit of work embedded within a file, website, message, etc. (e.g., a selection of text) as depicted in FIG. 59. As depicted, the user highlights a portion of a website. As a result, the analytics server displays the overlay 5900. As depicted, the top portion identifying the electronic content and context changes when compared to overlay 5300. Specifically, the top portion of the overlay 5900 displays the Context, “client patent,” open tabs, patent number, and then displays what is being saved (section 5910).

Overlay 6000 (FIG. 60) depicts an embodiment of what the user might see when he/she first opens the standard contextual overlay prior to choosing to save the blurb of text. Notice the GUI 6000 shows a section for “current selection” along with custom actions that may pertain to the data type that is selected. For example, the user may also copy and/or send the content to another user (which would ultimately cause the analytics server to identify new relationships and revise the nodal data structure accordingly). The user may also view related data associated to the user's selection. The user can search anything within the nodal data structure based on and/or using the user's selection. The user can also search third party sources (e.g., search platforms and/or other applications could such a CRM software). Similarly, the user may be able to choose from various third-party digital processes that can work with data type “text”, such as a text summarization service from AWS, a sentence restructuring service from WORDTUNE, and so on.

FIG. 61 depicts an embodiment of the extended overlay 6100 (same overlay 6000 as FIG. 60) showing how it may include additional suggestions and features. For instance, the overlay 6100 may also include contextual actions and data from other items recognized in the electronic content such as the “current tab” (e.g., move, copy, send, see related data for the current tab features), the “current app” (e.g., lets the user switch between multiple USPTO accounts, view data that the user has saved that is also related to USPTO, search USPTO, etc.), and so on.

Using the overlay 6100, the user may access or create custom shortcuts or actions that might be particular to USPTO or the content being saved. The user may for instance choose to use a shortcut that starts a video conference or call with everyone associated with current context. The user may also see activity or notifications associated with current context. The user can see who else might be working on that current context right now (or any other inputted time, such as last week). The user can also use the overlay 6100 to see other content that is saved, see related messages, see related files, and share this context with other people.

As depicted, the analytics server may simultaneously display actions and context from multiple recognized elements in the electronic context.

Using the overlay 5900, the user can save the highlighted portion and classify it as a “key concept” within the nodal data structure. The analytics server may then create a node for “key concepts” within the nodal data structures and start to establish, suggest, and maintain relationships with “key concepts” as discussed herein. Using the overlay 5900, the user may also add (a.k.a., establish and/or relate) comments (and other units work like tasks, people, and more) to the text string being saved.

Contexts are groupings of data related within the nodal data structure. How that data is organized and presented can vary. For example, Contexts can help organize information across people, applications, time, and more. Contexts may work with different human computer interaction methods and form factors. FIG. 62 shows a graphical user interface of a “Contexts Browser” that lets users search for, browse, modify, and work within Contexts. In this embodiment, a user is working on a Context titled “Super awesome hospital” which can be nested under or otherwise related to other Contexts (6200). Contexts can have a series of custom classifications and properties that may be customized by users to help them more easily work with that Context and/or organize data within that Context. This embodiment shows the current Context is of type “project” 6202. Each type of Context can have different standard templates or otherwise prioritize different data. For instance, a Context of type “Team” can prioritize the mapping and presentation of related people, whereas a Context of type “Project” can prioritize the mapping and presentation of key decisions, tasks, and deliverables.

The virtual office, as used herein, may refer to a virtual environment, similar to the infinite canvas experiences that are common in design software, where permitted users are able to work independently or collaboratively within a virtual space that isn't bounded by the size of a paper or a screen. The virtual office or the infinite canvass may range from a blank canvas to a representation of a virtual version of a physical office where users can enter virtual collaborative spaces. For instance, users 6204, 6206, and 6208 have entered the virtual office and the analytics server may display an avatar or an image or live video icon for each user along with an indication that they are speaking. User 6206 for instance can be identified as the current speaker by changing the status icon as well as adding additional graphical elements. The virtual office can also include an indication 6210 of all the users in the virtual office or room, regardless of whether they are visible on the screen or not. “Users” within the virtual office could include people as well as be considered to include other applications or services, such as an automatic transcription service to record meeting notes. Similar to many contemporary calling systems today, users are able to share voice, share video, screen share, and more. Within this virtual office, users may also choose to enter private spaces or rooms. The users can embed data within the virtual office such that the data is accessible to other users within the virtual office. In a similar way to how users can open windows or applications on their computing devices and traditional operating systems, they are able to open applications and windows as needed. The virtual office may also have a shared calendar (or data repository) where users can share their activities with each other.

In environments like this, additional electronic context data may be gathered and taken into consideration by the analytics server in order to establish relationships and/or otherwise modify the nodal data structure. Non-limiting examples of these additional contextual considerations may include the proximity of users to one another within the virtual office, the rooms that people are in, the “shared” vs. “private” ways in which users work or share information within the virtual office, and more.

Virtual and Augmented Reality Presentation

In an alternate embodiment, the virtual office may have virtual, augmented, or mixed reality experiences as well as an infinite canvas (or environment). Similar to the aforementioned virtual office concept (and/or the “smart desktop screens” described above), Contexts could be used to, for example, open a series of applications, data, and actions within a “space” that can be easily swamped out. This would help users more easily context switch. Importantly for this patent, this could also be used to determine intent. With this new medium there are additional indicators that can be taken into higher consideration when creating electronic content/context analyses or operations such as (a) establishing relationships between units of work/data or (b) determining intent. The indicators might be more prevalent in this medium include a better understanding of a user's field of view, of even focus (e.g., foveated rendering). data/apps/items that are following a user's field of view around the virtual office,

The methods and systems described herein can be used to search through files and users. Specifically, the analytics server may rank the results based on the intent of the user and/or based on other factors/features identified from the user's electronic context and/or nodal data structure. For instance, as depicted in FIG. 63, the user may use the search bar to search for users (e.g., other employees) and the analytics server may rank the users based on whether they are associated with a particular project, such as the project that is currently being accessed by the user submitting the query. For instance, the analytics server may first identify a project currently being worked on by the user who has entered the search command (target project). The analytics server may then search the nodal data structure based on the search command and rank the identified users based on whether they satisfy the search criteria inputted by the user and whether the other users have spent most of his/her work hours on the project identified as the target project. Additional or alternatively, the analytics server may rank the user's contacts by how close they may work with him/her, or whether they are currently online/offline.

The analytics server may apply the same concept to any query instruction received form a user. For instance, the analytics server may rank the files in accordance with whether they are associated with a project that the user is currently working on, as depicted in FIG. 64.

FIG. 58 illustrates non-limiting examples of GUIs that can be displayed by the analytics server. As depicted, the GUI 5800 illustrates a user accessing a file online. The GUI 5802 shows an example of a notification that the analytics server can present to the user informing him/her that it has identified knowledge that may be relevant for the work he/she is doing. The GUI 5804 shows an overview of the related knowledge. In the depicted example, the analytics server is taking several inputs into consideration when presenting related knowledge. These inputs include the current file, the current application (GOOGLE DOCS), the current Context, the role of the user, and inferred intent of the user (which can be collectively understood as electronic context). The analytics server is able to therefore prioritize information that might be relevant to a project manager working on a final report. Other related documents, people who worked on the project, key decisions, outcomes, and more from multiple sources could easily be accessed in this way.

In some configurations, the methods and systems descried herein can be utilized as a browser extension, as depicted in FIGS. 65-69. For instance, as depicted in FIG. 65, the analytics server displays various icons in the section 6500 of the Smart Window accessed by the user (e.g., Salmon Smart Window). The Salmon Smart Window may be shared with various users, as depicted in graphical component 6510.

When the user interacts with the files icon 6520, the analytics server may display the overlay 6600 (FIG. 66). The analytics server then provides the features described herein via the overlay 6600, such as intelligent searching capabilities. Referring back to FIG. 65, when the user clicks on the icon 6530, the analytics server then may display the overlay 6700 (FIG. 67) where the user can search the nodal data structure by “People” (e.g., centered around nodes of type “Person”). For instance, the user may identify people that are relevant to the Salmon Smart window (e.g., other users who are working on a project that is related to the Salmon Smart Window). When the user clicks on “recently viewed,” the analytics server displays other people recently viewed by the user. This list may be ranked by time, based on the user's intent (e.g., Salmon Smart Window), alphabetically, or in other ways.

Displaying the icons described herein may not be limited to display of smart windows. For instance, the same or similar icons may appear, as depicted in graphical component 6800 in FIG. 68 (also known as the dock) even if the user is browsing a website that is not hosted or controlled by the analytics server. In other words, the analytics server may modify the GUIs of the 3^{rd} party websites (or apps, services, etc.) to present information from the nodal data structure. When the user clicks on the file icon 6810, the analytics server may display an overlay 6900 (FIG. 69), which provides the same functionality as the overlay 6900.

The analytics server may use the methods and systems described herein to provide intelligent searching capabilities. For instance, as depicted in FIG. 70, the user starts typing USPTO in search bar and the analytics server may display the depicted tabs that are open in the user's current context before other results that may have weaker relationships with the electronic context (partially displayed above search bar). The analytics server may display the “Search Dropbox Paper for . . . ” that is offered because it is an action associated with an application that is being accessed by the user. This search could also rank in results from the user's current tab's webpage, domain, or other related content if there was a match with the query.

Referring now to FIG. 71, the analytics server may also use the methods and systems described herein to display relevant data within Smart Windows. For instance, the Smart Window 7100 may include various graphical components (e.g., widgets) that filter and present information relevant to some attribute of the Smart Window 7100 identified using the methods and systems described herein. For instance, when the analytic server identifies new employees who are associated with the Smart Window 7100, the analytics server updates the “Related People” section. As discussed above, users may customize Smart Windows with custom properties, categories and more. Similarly, users may create templates that include custom summaries, filters, actions, interfaces, and more for any given Context/Smart Window.

Using the nodal data structure, the analytics server can reveal all related information across applications, people, and time for a given project or other type of higher-level concept. These are higher-level groupings are called “Contexts.” Each Context can have an Overview allows users to view a “quick sense of a given project.” Powerful contextual search helps users navigate all the related information in whatever level of detail he/she wants.

The methods and systems described herein are applicable to any unit of work. The analytics server may display electronic messages and rank them in accordance with how relevant they are to a user. For instance, the analytics server may display various messages (from different platform and via different modalities) for the user. Using the methods and systems discussed herein, the analytics server may display relevant data within a user's browser to augment the user's activities. For instance, as depicted in FIG. 72, the analytics server may display the component 7200 that can augment the user's search. For instance, if the user is searching for a cancellation policy for a particular airline, the analytics server may provide the user to access relevant data (other users, files, emails, and the like from the nodal data structure) associated with the user's search. For instance, the analytics server may direct the user to an email (within the user's inbox) that includes a response to the user's query.

In another example, as depicted in FIG. 73, the analytics server may display the component 7300 that has similar functionality as the component 7200 when the user is detected to be searching for “Bill Gates.” Moreover, the analytics server may display the component 7310 that displays relevant information associated with the searched term (from the nodal data structure), such as projects, teams, components, documents, or other units of work that is relevant to Bill Gates.

Generating Knowledge

As described herein, the analytics server may identify the user's intent and may display the results accordingly. For instance, once a search attribute is received, the analytics server may analyze the user's working session and identify an intent of the user. The analytics server may then search the nodal data structure for any node having data associated with the received search attribute. The analytics server may then identify a subset of the nodes that also correspond to at least one attribute of the user's intent and display the subset of the nodes as the results. In some configurations, the analytics server may display data corresponding to all the nodes but rank the results in accordance with the user's intent.

However, in some embodiments, the analytics server may not identify any nodes within the user's nodal data structure. For instance, a user may request to view employees who are associated with project X. The analytics server may first identify a nodal data structure that belongs to the user. The analytics server may then search the nodal data structure to identify all employees whose nodes (within the user's nodal data structure) are associated with project X. If the analytics server identifies the requested employees, the analytics server displays the results as described herein. However, if the analytics server does not identify the requested employees, the analytics server may, for example, query a different nodal data structure to identify the results. The analytics server may also query one or more nodal data structures, regardless of whether it was able to retrieve relevant results from one or not.

Specifically, the analytics server may identify one or more related and authorized nodal data structures. The analytics server may first determine a nodal data structure that includes at least one node that corresponds to the search criteria received from the user. For instance, the analytics server may search multiple nodal data structures to see if at least one nodal data structure includes at least one node that corresponds to an employee and has at least one association (e.g., in its metadata) with project X. As a result, the analytics server may identify that five nodal data structures. The analytics server may then analyze the identified nodes within each nodal data structure to determine whether those nodes are authorized to be accessed by/for the user. That is, the analytics server identifies whether the data within any of the five identified nodal data structures are permitted to be accessed by or shared with the user.

To identify the authorized nodal data structure, the analytics server may analyze a predetermined list (e.g., access-control list) to determine whether a given unit of work may be accessed by the user. The predetermined lists may be used to determine whether the user can access any relevant node within across the five identified nodal data structures.

Additionally or alternatively, the analytics server may retrieve a set of rules indicating whether the user can access any other nodal data structure. A non-limiting example of a rule may include a hierarchy of the users where certain tier of users are able to access nodal data structure of other tiers of users. For instance, a user within the executive tier (e.g., CTO of a company) may access nodal data structure of all users within a regional manager tier but not vice versa.

Using the methods and systems described herein, the analytics server may generate a series of nodal data structures (as depicted in FIG. 74) where each nodal data structure corresponds to one user and is updated in accordance with each respective user's activities and contextualized data. Using this method, the analytics server may continuously update and revise collective knowledge of a group of users, such that each user is contributing to the collective knowledge without sharing detailed data. For instance, a contact associated with a project may be identified based on a first user's email to a second user that discussed the contact's information.

Methods and systems described herein may sync, transfer, share, and de-duplicate data across different relational and/or graph databases as part of the nodal data structure. For example, a user might have her own private nodal data structure on her computer, and might work for a company that has an enterprise nodal data structure. That user might want to contribute certain information from her private and personal nodal data structure to the shared enterprise nodal data structure. Similarly that user might want to access data certain from the enterprise nodal data structure, such as projects and clients. For example, a user is researching patents and stumbles upon a patent that exists within the enterprise nodal data structure. The analytics server can therefore contextually present related information to the user from the enterprise nodal data structure. If there is also additional information found in her personal nodal data structure, then that data can also be simultaneously presented. If the patent she is viewing doesn't exist in either nodal data structure, she can create or adopt rules that allow that patent to be created in either her personal or the enterprise nodal data structure (or both). She can also choose to contribute aspect of her personal nodal data structure to the enterprise nodal data structure, such as all of her work associated with the Contexts (e.g., projects, clients) that exist within the enterprise nodal data structure. The analytics server may use URIs as unique identifiers to help deduplicate data across nodal data structures. Additionally or alternatively, the analytics server may create an additional nodal data structure (that is controlled by neither the enterprise nor the individual) to consolidate, deduplicate and correlate the information between both.

In a non-limiting example, the analytics server may allow people to contribute aspects and features of various data sources (e.g., 3^{rd} party apps), processors (a.k.a., actions, syncers, data correlation services, other data processing services), interfaces, data types (a.k.a., ontologies, vocabularies, and data shapes), Content templates, Knowledge Apps (a.k.a., bundles of the aforementioned components) to a collective store of composable software components. The analytics server may also allow users to contribute translations between data sources, processors, interfaces, and data types in order to maximize the translability of data and thereby the composability of the software components. Furthermore, the system also allows for different versions of these “App Stores” of composable components to exist across different nodal data structures and operating environments.

Using the methods and systems described herein allows the analytics server to “push” and “pull” data from different nodal data structures. For instance, when contextual information surrounding a first user's activity is not known, the server may access a knowledge graph of a second user to generate new connections and link relevant data. In another example, users can “push” their knowledge into one or more nodal data structures by identifying relationships or contextual data to improve the nodal data structure.

Using the methods and systems described herein, the analytics server may move data between various nodal data structures (which can be either or a mix of databases and knowledge graphs and other nodal data structures of various sizes and modalities). That is, a user may contribute to the collective knowledge. Therefore, transmitting the data doesn't have to be from one user to a different user. The data to be contributed to the collective knowledge, can be stored onto various modalities, such as a user's local computer, a blockchain, in a hosted/remote database, and/or in/across a distributed database system (e.g., Solid Pods®), or elsewhere. The shared knowledge bases could also be stored locally or on a collective data repository (e.g., cloud accessible to multiple users). Therefore, data can be pushed or pulled from different nodal data structures regardless of where that data is stored. Similarly, the analytics server can process data in a variety of different environments, such as via a local computer's processor, a phone's GPU, a remote server's processor, a distributed computing platform like Ethereum, a quantum computer's processor, and/or any combination therein.

As described herein, the analytics server may analyze the data being accessed (used) by the users while the users are browsing (or otherwise accessing the data). As a result, the analytics server may continuously improve the nodal data structure and ultimately the collective knowledge (e.g., the collective data structure).

As depicted, the analytics server 7400 may be connected to different autonomous nodal data structures (7402-7412). As depicted, some of the nodal data structures may include more data than others. Moreover, the nodal data structures may be autonomous and may not be directly in communication with other nodal data structures. They may only access data within other nodal data structures through the analytics server 7400.

Each nodal data structure may correspond to a user (e.g., an employee of a company). The analytics server 7400 may individually update each nodal data structure in accordance with each user's activities. Each user may also indicate whether his/her nodal data structure can be shared with other users and/or used for the collective knowledge. For instance, a user may designate certain part of his/her activity as private. As a result, the private activity of the user may not be shared with other users.

Users can “opt in” to contribute to the collective knowledge using various ways (e.g., manually, automatic contribution of manual review, or using a fully automatic method). The analytics server may use the collective data to provide value back to users. Users can contribute manually, via backend integrations, or by simply contributing their browsing to enrich their company's/community's/etc. knowledge base.

The analytics server can leverage the collective data to further provide value to user. For example, a user may contribute translations between data sources and data types (manually, automatically, or some mixture of automatic and manual contributions) to a “public” knowledge base that may allow additional or more sophisticated service to be provided by the analytics server (e.g., via the composable app store). In another non-limiting example, instead of a group of administrators reviewing being responsible for creating all the metadata for data sources, translation mappings, and more, the analytics server may request permission to monitor different users' activities in order to automatically capture some of this information via users browsing as described above. In another example, employees at a company can decide to contribute data from their browsing of a given website such as LinkedIn to a shared nodal data structure (e.g., for their company), such that all the LinkedIn profiles that any employee views gets automatically added to or updated in the shared nodal data structure and can enrich their CRM.

In alternate embodiments, there could be more than one analytics server across various computing environments.

User interactions are inherently fragmented. For instance, people have varied habits, preferences, and ways of working that lead them to use different tools and organize data differently. People's work habits also change over time as new technologies emerge and circumstances change. They save knowledge and information in different structures, in different systems, and with different limitations. The resulting fragmentation and difficulty accessing and managing information ultimately contribute to a lack of clarity at the operational level, which in turn makes it harder for employees to get up to speed on a new team or project, effectively document processes and outcomes on projects and initiatives, and/or leverage previous knowledge to make the best decisions and improve innovation capability.

As depicted in FIG. 75, the analytics server can use the methods and systems described herein to build and maintain relationships between data across tools, systems, and time. As users communicate and collaborate in various systems and services, the analytics server may gather, structure, and maintain contextual information and “knowledge” within the nodal data structure. This knowledge may be accessible to and shareable by users contextually around their existing workflows. This empowers individuals and teams to build and maintain a shared memory and consciousness and enables users to better access the right information, understand it more completely, and ultimately work better with each other without requiring every party to fully overlap on schedule or software preferences.

The analytics server may leverage the methods and systems described herein to enable knowledge workers to easily find information with personalized search results based on their workflows, to share and leverage institutional knowledge, empower asynchronous work, and/or avoid rework by revealing the context around each “unit of work” (e.g., project, file, team, objective, KPI, task), to better understand the characteristics that lead to successful outcomes including people, workflows, team dynamics, and the like, to mitigate security/compliance risks associated with inconsistencies and incompatibilities across systems (e.g., by improving identity and access management through contextual awareness of a user's nodal data structure), and/or to improve operational performance and business outcomes through data-driven insights.

Using the methods discussed herein, the analytics server can contextually and un-intrusively present additional data (e.g., knowledge) relevant to a file, message, contact, or other digital data (e.g., versions and related files, notes, messages, emails, etc.). In this way, users can access the process, reasoning, and best practices behind each unit of their work. This history and context associated with their work is currently distributed across a variety of systems and services and is typically only accessible through individual people's living memory. The analytics server may build and maintain a digital memory for each user (e.g., the individual nodal data structure for each user) that can be shared, and includes activity logs, summaries, and tables of relationships for specific types of data like files, messages, and contacts across everything a user does online (and, in some embodiments, eventually offline). The analytics server may build and connect these information graphs (individual nodal data structures) regardless of where the underlying data is stored, e.g., across any website and competing ecosystems.

The analytics server may provide users with all the pieces of information and prior work that might be relevant to the task they are currently working on. In some embodiments, as a user opens a file to work on a project, the analytics server may compile and display all the versions, related files, sources, websites, emails, tasks, and other relevant information for the user. As they write an email to a colleague, the analytics server may automatically compile and present the timeline of relevant work and communication across all their tools and services. As they are trying to understand a given project and why certain key decisions were made, the analytics server may display an overview of the project across various applications and provide more detailed information regarding various assets and activities as needed.

Ultimately, by displaying relevant information, the analytics server may save hours of wasted effort for each individual by automatically providing all the relevant materials for his or her work contextually, and is a force multiplier for innovation capability by helping users avoid repeating mistakes, identify synergies, and connect with other users and information at the right time and in the right context.

The analytics server may establish a software category that is focused on automatically organizing, classifying, and interrelating data to better document knowledge on behalf of users regardless of the source (the app, service, or ecosystem) of the data. As specialized tools are developed (e.g., file storage and sharing, email clients, or project management tools) and companies continue to use or otherwise change out more tools, people, and services over time, there needs to be a lasting way for individuals, employees, and other services to easily access the relevant knowledge. The methods and systems discussed herein are agnostic of hardware, ecosystem, and platform and can help users organize, maintain, and manage their knowledge through these changes.

Using various methods, the analytics server may augment the knowledge and provide the person, the company, and broader society the capabilities, control, and confidence to access and leverage knowledge in a way that was not previously accessible to them to make the best decisions starting with productivity and innovation capabilities.

Furthermore, employees are utilizing more digital resources and working on cloud-based applications, which means more data, across more tools, with fewer people that were around when the work, the thinking, the lessons, and the outcomes were properly understood. Beyond fragmentation, users have experienced more and more problems that can be partially attributed to data overload.

Modern knowledge workers find themselves moving between different applications every day as they work on any given deliverable or project. Most users' digital workflows are fragmented by function, where external communication typically happens over email, internal communication over chat/messaging, different storage systems and locations are used for different projects and teams, and so forth. As a result, all the information relevant to any deliverable or project is fragmented across these tools and systems. Organizations continue to increasingly rely on these fragmented information archives to store, share, and repurpose knowledge. Given that all the work and communication within these archives tend to be disconnected across local file directories, storage clouds, email accounts, chat systems, project management tools, and other specialized applications, it is easy to understand why individuals struggle to find and work with the right information.

For example, as depicted in the methods and systems discussed herein may be used in a process of creation of a single document like a research proposal, contract, financial model, or presentation. These efforts typically go through a series of versions and have several stakeholders (i.e., lawyer, designer, consultant, manager, etc.) who provide feedback along the way. The information within this document also tends to be related to other information sources like file templates, research papers, business presentations, etc. To create a single document, one might end up having 10 different file versions for the same deliverable, with duplicate copies of each version stored in both the “downloads” folder and on the email server. Manually organizing all this data is tedious, impractical, and prone to human error.

The combination of individual needs and preferences along with the mass proliferation of specialized apps has created a scenario where knowledge workers use a wide range and a combination of tools and systems for daily work. Using the methods and systems discussed herein, the analytics server unlocks the information and knowledge that is “filed away” by tracking work across fragmented systems, building and maintaining relationships between people, work, and communication, and ultimately presenting all the relevant information contextually around the work one might be currently engaging with.

The analytics server may, for example, extract knowledge using the following three steps. First, the analytics server may aggregate and maintain synced data from multiple sources (e.g., a series of linked relational and graph databases, as discussed herein) into standard representations of the data (e.g., data types). Second, the analytics server may use various algorithms to build a relationship graph out of this aggregated and tracked data. Third, the analytics server may provide business insights and empower new processes through this centralized graph. Unlike conventional integration management solutions, pure search, or grouped/shared applications, the analytics server may automatically connect the information from these different systems into a graph as described herein.

After aggregating the information, the analytics server may connect each piece of information into private graphs of users' and/or companies' files, messages, and contacts. This graph can be used for search, knowledge management, human resources, and risk management. As a result, the analytics server may passively build a work graph around users' existing tools and workflows, and in a way that augments these other tools, rather than requiring users to move their entire workflows into a new tool. Therefore, the methods and systems discussed herein can work in conjunction with other data analytics/storage tools. The analytics server may provide a comprehensive graph that works with existing workflows and data across different tools and websites.

In an embodiment, the analytics server may enable companies to leverage their graphs and analyze their data for real-time business and operational insights. For example, the analytics server could help in generating analyses over and summaries of projects, roles, objectives, activity on projects, and more. In other words, the analytics server could use the data in the graphs to automatically generate a summary of a particular role that someone played on a given project and add that to an overview of the project. Similarly, the analytics server could generate a summary of the project itself, and any unseen activity/changes between when someone looked at it last and now. These summaries, of course, could contain information from all the relevant third-party tools and services that work is being done through. Various graphs could also help in: (a) providing early detection of misused confidential information, (b) identifying the common denominators across a company's history of best or worst performing projects, (c) identifying patterns around how employees' workflows change before they leave/quit, and using these patterns to reduce risk and predict/prevent future attrition, and (d) improving identity and access management by leveraging a user's graph to validate behavior and intent.

As described herein, the analytics server may use metadata, behavioral data, and machine learning to establish a knowledge graph with relationships and recommendations between related files, messages, people, and other data so that institutional knowledge can be preserved and leveraged effectively.

The analytics server may allow for syncing of different applications, such that the information from these applications is included within the graphs. The syncing processes can utilize a standardized syncing logic that can be shared across multiple data sources in order to ingest and maintain an accurate index of the data from the various data source in the graph (e.g., nodal data structure). In this way, users and developers can add/customize features, pinpoint bugs, and add new integrations in a much more scalable ways. The analytics server can also generate standardized data representations across all integrations, which make for easier querying.

The analytics server can incorporate explicit feedback and file metadata into the file correlation algorithms to augment the existing implicit feedback. This enables the analytics server to suggest similar files and improve the quality of suggestions. The analytics server may increase access to user interactions and behavioral data from as many places as possible (e.g., meta-layer that assists users contextually wherever they work). The analytics server may provide a UX framework that would may provide value to users without having to optimize for attention or prescribe that all work should happen through a particular interface or software provider. The analytics server may also utilize behavioral data across other tools to build and validate relationships. As a result, the analytics server can infer intent, as well as meaningfully contribute to the production of other useful analyses (e.g., identifying trends and summarizing roles, objectives, & projects). Accordingly, the analytics server can increase the ways that users could leverage knowledge within the nodal data structures within their existing workflows.

The depicted in FIG. 75, GUIs provide users with the (1) ability to easily access and understand key work-product for a given file, person, project, objective, etc., (2) the presentation of relevant knowledge and insights as users work, and (3) the ability to share relevant knowledge with collaborators in a way that respects individual privacy rights.

The analytics server may provide digital knowledge-mapping and knowledge-access services that are based on fundamentally different underlying economics than most other software services. Specifically, the analytics server may not optimize data based on user attention. Accordingly, the analytics server may leverage knowledge to solve problems and build solutions for the knowledge economy in ways that are optimized for the end user's needs rather than an advertiser's or a centralized information broker's bottom line. FIG. 76 illustrates two images of a user working in the word processing software. The image 7610 shows a user highlighting a particular term that he would like more context around to better understand what he is reading/writing. The image 7620 shows users leveraging the services of the analytics server to easily pull up relevant personalized information that can help them access the relevant context and/or dig deeper through actionable connections.

The analytics server may utilize a series of algorithms that passively and actively transform disparate and/or historical archives of information and interaction data into consolidated and interconnected knowledge graphs. The analytics server may use a combination of cloud-based APIs and client-side interaction tracking to build knowledge graphs. The analytics server may generate a nodal data structure composed of nodes and edges (relationships). Nodes can be any file, message, person, task, note, webpage, etc. (herein referred to as units of work). Each data type has varied ontologies of related metadata. A grouping of nodes related to a particular project, team, objective, or higher lever concept is called a “Context,” though a Context itself can also be considered a node with edges to other nodes.

The analytics server may use the nodal data structure to automatically create enriched profiles with metadata, images, and more for all the properties, products, inspiration, etc. that a user may be exploring while acquiring their dream home (e.g., by tracking a user's web browsing history and electronic content). The user may add notes, commentary, and relationships over and between pieces of information from competing for real-estate platforms, and see that Knowledge is contextually presented when they are browsing other applications. For example, a user might later receive an email from someone that includes a reference to an address and immediately be reminded, through contextually presented knowledge GUI, that they were considering it, see their private notes, all the consolidated metadata, and more. Similarly, entering the address into a search engine could inform the user that there is relevant information about the property they are searching within their private nodal data structure. Ultimately, they would be able to easily search their “digital brain” (e.g., nodal data structure) with queries like “all properties I viewed last week that are in Washington D.C. and have a pool.”

This type of consumer use case helps showcase some of the breadth of the potential applications of the methods and systems discussed herein, as well as the potential impact at a broad societal scale. The technology can be used to help many different types of people easily organize, access, and understand commonly “consumed” data types that tend to be accessed by one person across multiple applications; examples include recipes, music, news, travel, shopping, products, etc. Imagine being able to search “show me all the recipes with mushrooms that I've seen in the last year,” “all the classic rock songs that I took notes over while in Hawaii,” or “all the articles related to author X that are referenced in my work” without having to manually organize anything. In other words, the analytics server provides the automatic organization of and contextual access to work knowledge and data across all employees, software, locations, and time.

The analytics server may use the methods and systems discussed herein to build and maintain databases and indexes composed of activity logs, metadata, and relationships for all files, messages, tasks, events, people, projects, objectives, and more across communication channels, storage tools, and project management systems. The analytics server may use various algorithms to (1) build and maintain these nodal data structures regardless of where the relevant data is stored (e.g., across competing ecosystems), (2) build nodal data structures passively during a user's normal and routine course of usage of various application, (3) present relevant information contextually while a user is working on a given task, and (4) more. The analytics server uses (and is helping establish an ecosystem that leverages) standard frameworks and protocols to contribute, access, or otherwise interact with data nodal data structures (e.g., Knowledge graphs).

The analytics server may actively and/or passively enrich the data within the nodal data structure. For instance, as a user browses and interacts with digital information, the analytics server may track and ingest that information and build relationships between nodes in the nodal data structure. For example, currently, when a user reads an article online, their browser usually only saves the URL, the website title, and a timestamp. Using the methods and systems discussed herein, that browsing history and its metadata may be added as related nodes that logically associated and interrelated with other nodes within the nodal data structure. The history entry may first be parsed and classified as data type “article” and relationships may be created to nodes/“profiles” for its author, its publication, and its core subject matter. Finally, the node may be related to the research or project the user is currently working on. All this knowledge can be passively ingested by the analytics server, and potentially prioritized depending on a user's understood role, intent, and/or preferences.

Explained further, the analytics server may automatically classify data, including browsing history, into various “data types” (e.g., article, file, message, task, contact, company, patent, image, video, building material, product, or movie). The analytics server may perform this according to certain methods, rules, and heuristics, including parsing information from websites' HTML, and/or using a set of various URL parsing rules (e.g., prepopulated and inputted by a system administrator). These URL parsing rules help classify URLs for certain websites/apps into the various “types” mentioned above. For instance, any time the analytics server uses a correlation algorithm to analyze data (e.g., when the analytics server encounters a URL), the retrieved data may be parsed and run through a correlation algorithm that relates it to a given “app type” (e.g., an entity called GOOGLE DRIVE to classify all drive.google.com URLs and related information), to a given data type (e.g., a link to a NY TIMES article in the politics section will get classified a political news article), and sometimes additional information embedded in the URL such as file type (e.g., .jpg or .pdf).

The analytics server can build these relationships and leverage the broader context related to what the user is doing without requiring a backend connection. Many websites have a significant amount of embedded information in metatags and embedded schemas for search engine optimization (SEO) and social sharing (e.g., FIGS. 85-86). Additionally, certain URLs may include embedded text-based knowledge that could be accessed by executing an NLP protocol. The analytics server can automatically retrieve this information to build, enrich, and maintain nodal data structure.

In an embodiment, when a user visits an article about Bill Gates (e.g., depicted in FIGS. 85-86), the analytics server may automatically retrieve data from that article's HTML and schemas, and map it to various nodes in the nodal data structure. In the future, that information can be contextually surfaced whenever the user is sending an email mentioning Bill Gates, when he/she is looking at Bill Gates' contact profile, or when searching for information related to the article's author.

In another embodiment, data may also be linked (without adding additional work by the user) by tracking actions the user is doing (e.g., copy and paste functions). For instance, when a user copies an image or a piece of text from a website and pastes it in an email, the analytics server can automatically link the website as a relevant source for that email.

In another embodiment, a third example includes a user working on a file sharing platform and exporting a PDF. The analytics server's syncing processes would recognize that a particular file was created in the Downloads folder and automatically link it to the electronic document that the user had open at the time. The analytics server may automatically correlate the times that a user billed to a project with their related activity across different applications to create categorizations and labeling recommendations for the work done during that time.

The analytics server may provide services in form of downloadable software products and cloud services. The analytics server's service may be a meta-layer that executes in conjunctions of software tools and applications. The interfaces and components that users interact with can be opened as a meta-layer over any application as well as be opened as an application themselves. Though alternative embodiments may include layers over major operating systems.

The GUIs displaying context data may help users organize their online browsing, tabs, and resources by building and managing the contextual relationships between units of work so that people can access relevant information (1) around whatever they are working on and/or (2) around however they are thinking about their work.

The analytics server may provide users with this value immediately upon installation, without any additional work, and without requiring them to authenticate with any applications. For instance, the analytics server may search for locally stored data, such as browsing history, bookmarks, tabs, etc. to automatically classify and interrelate it into the associative nodal data structure using various methods and systems discussed herein. This means that after installing an application in communication with the analytics server, the user can start to query things like showing me all the recipes I have seen in the past week; show me all the real estate properties I've interacted with; show me all the references to a given file; show me all the resources relevant to a given client; and more. Therefore, the analytics server may use a nodal data structure that is specific to the user and/or other nodal data structure (belonging to other users or the organization as a whole).

Users can use different historical archives of information via back-end connections to different nodal data structures. For example, a new user might want to connect his/her email accounts, messaging tools, cloud storage systems, project management tools, and eventually HR systems, time tracking tools, CRMs, and more. The analytics server may then ingest the historical activity and data (files, messages, contacts, etc.) within each connected application, drastically increasing the correlation that can happen across the data, and enrich or modify the users' nodal data structure.

By leveraging the web as a platform, the analytics server may present users useful and relevant context from their nodal data structure (or other nodal data structures) around whatever the user is accessing (e.g., viewing in the browser). Using the methods and system discussed herein, users may be able to highlight or right-click on any email, contact, colleague, file, calendar event, address, etc. on any webpage. As a result, the analytics server may present relevant knowledge about that unit of work (from one or more relevant sources) from the user's nodal data structure. This related data can include associated files, messages, projects, notes, comments, actions, definitions, people who may know more about it, etc.

Depending on the type of data being selected, different actions and types of information may be more or less relevant. For instance, selecting to see contextual data around a file rather than a piece of text may allow the analytics server to prioritize the presentation of other versions, related files, and the sources of any embedded information.

The analytics server may use various methods to present the information discussed herein to the users. For instance, the analytics server may use a file browser 7800 (FIG. 78), a contacts manager, a messaging client, a task manager, a “Contexts” browser (FIG. 71), and/or a search engine (FIGS. 57-59). The analytics server may utilize existing UI typologies (e.g., file browser, message client, or contact manager) so that users can easily understand how to interact with these fundamental types of data. These interfaces can be opened over any webpage or as stand-alone applications. The analytics server may also provide users with “Actions” specific to that data type, for example, a user can read and respond to emails and messages from various sources in the corresponding “messages” tab or section. Similarly, the user can move, share, or rename, their files or folders across storage systems and/or Contexts in the “Files” Knowledge App (FIG. 77).

The analytics server can automatically augment views of files, messages, contacts, events, etc. with data that is most relevant for each data type. For example, viewing an email message a user sent with an attached pdf, will show the user relevant contextual information about the receiver, other related messages, projects, and even the word document that the pdf file originated from.

An example of UX elements offered by the analytics server is depicted in FIG. 77. The element 7700 (also referred to as the dock) may be similar to the MAC OS DOC and the WINDOWS TASKBAR, where users can pin their favorite websites, applications, knowledge applications, and contexts to easily access relevant data and actions for each. The element 7700 may appear as a panel within the browser and can be extensively customized. In alternate embodiments, the analytics server could augment native UI components within existing platforms (e.g., MAC OS or WINDOWS). In other words, the analytics server could integrate the element 7700 in such a way that it is merged (and doesn't compete) with its native counterpart in each of these operating systems, platforms, and/or applications.

Another UX element is the knowledge navigator 7710, a search and keyboard navigation assistant that helps users do many of the standard actions they can normally do in a main interface or a native application in communication with the analytics server. The navigator 7710 may include data and actions from various user applications and can help the user navigate the nodal data structure. Because the knowledge navigator 7710 can open relevant information for anything in a user's nodal data structure, it can also be leveraged as a reinvented “right-click menu.” Right-clicking on an icon (e.g., application, a string of text, file, etc.) may reveal all (or at least a portion of) related data and action via the navigator 7710. Users may be able to search and use their keyboard or mouse to navigate within the related data and actions for what is currently selected.

In another example, the GUI 7800 (FIG. 78) shows an interface that helps users access data and knowledge by “Contexts” that they care about (across apps and sources). In this way, a user can easily see relevant activity, files, messages, tasks, and even an overview and summary for a given Context. This helps people work better together and empowers asynchronous workflows and leads to better outcomes by empowering better decision-making through historical knowledge.

In an embodiment, right-clicking on an app in the dock may automatically show relevant data pulled from browsing history, open tabs, saved resources/bookmarks, as well as specialized actions, automation, and search. Users may also be able to turn any website into a custom app with just a few clicks. For instance, when users upgrade and authenticate backend integrations for each application and/or account, the analytics server can retrieve more information and the functionality for the application expands. For example, applications can gain features like notifications, which can be generated via backend connections; users can access all data within these applications regardless of whether they have locally visited all that data before; and they can easily browse, search, and filter all the data within each application by association (e.g., by data type like contacts, files, messages, etc.). Of course, users can also access all related contexts for a specific unit of data within this application (e.g., file versions).

The analytics server may provide users with capabilities, confidence, control over their data and knowledge. Using the methods and systems described herein the analytics server can build the foundations for a “knowledge operating system” or “KnowledgeOS”, which can improve the overall operational performance of organizations. The analytics server can use the methods and systems described herein to build the framework that will empower organizations to manage and leverage their knowledge with out-of-the-box solutions as well as provide them with the capabilities necessary to customize and tailor their (or their clients') knowledge as they see fit.

The analytics server can establish this framework for building and managing the contextual relationships between units of work (within the nodal data structure) so that people can access relevant information around whatever they are working on and around however they are thinking about their work. KnowledgeOS will create a lasting knowledge graph across an organization's ever-changing software stack and human capital. With comprehensive knowledge across all their tools, users and developers will have a new range of possibilities around accessing and analyzing knowledge.

The analytics server may expand nodal relationships within the nodal data structure beyond recommending data and for specific units of work. For instance, FIG. 58, shows an example of the various inputs that might be considered when recommending data, including what the user has currently open, what the user's role is, what project the user is working on, and analyses on what the user may be wanting to do (e.g., inferred intent). In some embodiments, the user may press a keyboard shortcut to get a list of recommended actions and data that will let him/her get to what he/she wants to do instantly. For example, if a user has an upcoming meeting, those meeting details should be at the top of the recommendations, along with links for the related units of work, including profiles for other contacts in the meeting, the related project, and the like. The data surfaced (e.g., from the project/context profile) could also be further optimized or ranked for a particular role (e.g., developer, designer, project manager) or other workflow or behavioral patterns that may be known about the user.

“Knowledge Apps” refer to applications that are built over the Knowledge Graph (nodal data structure) and that interact with data from several different sources. The knowledge applications not only provide value to users via GUIs but also establish the API and protocols necessary for other developers to access and utilize data within nodal data structures. Over a period of time, the community of users may develop additional services, interfaces, and capabilities (e.g., additional offerings) to present, interact, and analyze knowledge around other data types, business use cases, and/or workflows (or any other data within the nodal data structure).

For example, a developer might create a code manager that helps software developers easily access and manage knowledge related to software repositories, node package manager (NPM) modules, pull requests, etc. across accounts, sources, and environments. This example would need to pull data from the nodal data structure generated by the analytics server about files and webpages classified as “code,” “repositories,” “code packages,” and the like, which the user had recently edited or accessed, has access to, or is publicly available.

Another Knowledge App developer might also create an interface that resembles an advertisement campaign manager and that helps marketing professionals easily manage advertisement campaigns across tools, systems, and time. Other Knowledge Apps could focus on helping business users create automation across workflows, or even on helping various executive roles understand what contributions various applications or services make to institutional knowledge and project outcomes, how much and what types of engagement those applications receive from stakeholders, or how proprietary data is being accessed across various applications and people. The nodal data structure may also hold knowledge regarding security and information governance. For example, the analytics server may leverage an individual's workflow patterns, her role's expected patterns, and/or the expected changes to a project to help with authentication or identify bad actors. The Knowledge OS discussed herein may empower these various Knowledge Apps to stand out from existing solutions by allowing them to access and interact with a user or a company's existing knowledge across all their other applications and history, thereby allowing the knowledge applications to include novel features, present enriched data, and make personalized recommendations.

The analytics server's role can be thought of as generating a platform that allows users to build their own knowledge Apps with composable components as described above.

To provide developers with the capabilities to build knowledge applications the analytics server may: (1) establish standard and scalable ways to ingest, classify, correlate, and manage varied data types from as many sources as possible, (2) construct the architecture for how and where knowledge is stored, and (3) define the protocol for how knowledge is accessed, shared, or queried by other people and applications.

Data Ingestion

The analytics server may parameterize the backend syncing processes and build a universal syncing module to easily sync standardized structures of metadata coming from various APIs of integrated systems and services. This may greatly improve the maintainability of data ingestion and processing into the nodal data structure and may make it easy to add new integrations. In some implementations, the analytics server may make the creation of integrations even more scalable (e.g., able to be crowdsourced from developers outside the network of users (e.g., third-party developers)). Instead of requiring a developer to adhere to the conventions of the backend language used by the analytics server (e.g., RUBY), and require access to the analytics server's core codebase to insert service translation files or otherwise manipulate the code/data, the analytics server may (1) reformat service translation files into a more accessible format, (2) store service translation files separate from application and codebase language used by the analytics server (e.g., outside RUBY ON RAILS), (3) allow service translation files to be automatically generated through forms that users or business can use without writing code, and (4) create publicly accessible documentation for the creation of service translation files. Additionally or alternatively, as mentioned above, the service translation mappings, methods, and processes could also be stored in a database (e.g., in its own nodal data structure) and be provided to developers and software applications via an API.

Reformatting service translation files into a standard configuration-style format like JSON or YAML may create a more human-readable and thus more accessible approach to developers who may not be familiar with programming languages used by the analytics server or system administrators. Likewise, separating these files from the language used by the analytics server (e.g., RUBY ON RAILS application) to an alternate storage system, such as AMAZON S3, may make it easier to allow developers to work independently and allow for an easier review and upload/update process as opposed to being bundled with the rest of the code used by the analytics server. The configuration files (sometimes generated by outside developers) may then be read by an application native to the analytics server to correctly perform the steps it takes in syncing a system or service (or otherwise querying data, processing information, etc.). In addition to the analytics server's “syncers” pulling data from integrated systems and services, the integrations also ingest data pushed to the analytics server (e.g., nodal data structure). The APIs of some systems and services, such as third-party applications and file-sharing platforms, may have webhooks to where developers can subscribe to receive notices about data changes.

Referring now to FIG. 39, the GUI 3900 exemplifies an interface of what comprehensive activity and behavioral data tracking can be like. The items within the graphical element 3904 may be recorded via frontend data ingestion, the items in the graphical element 3902 may be recorded via API-based Data Ingestion, and the items at the top (graphical element 3906) may be analyses of the activity recorded.

Local Data Ingestion

Browsing history may be one or many sources of data to be incorporated in the nodal data structure. A user's browsing may be processed locally by a browser extension in communication with the analytics server and may be stored in an indexed database. Other non-limiting examples of data to be ingested can include (1) metadata, such as information from web pages a user visits from open-source protocols like OPENGRAPH, SCHEMA.org, RDFA, MICRODATA, and JSON-LD, (2) the contents of whatever is on the screen, such as the body HTML the web-pages themselves, if applicable, and (3) the digital context describing the setting of any interaction the user performs.

In capturing digital context describing the setting of any interaction the user performs, the analytics server may utilize different distributed tracing standards. Distributed tracing is a process through which IT and DevOps teams can monitor distributed software architectures. In distributed tracing, “traces” are created which describe the entire life of a request as it moves through the distributed system. “Spans” are named, timed operations representing a piece of a trace. Spans also contain references to other spans, creating a layered parent-child structure, which gives developers a full understanding of what happened during a request. A user's work on the computer can be construed as a series of requests, or objectives. Therefore, each interaction is a descriptive part of the user's objective and can be used to understand the user's intent and create relationships. The analytics server can track activity events across backend integrations with each of a user's authenticated accounts, and track frontend interactions using different products, such as discussed in relation to FIG. 39.

The events may have timestamps and thus be spans, which construct one overlapping timeline used to determine the probability of each unit of work's relationships with others. Over time, if similar sets of units of work are commonly within overlapping or parent-child spans, their perceived relatedness (e.g., likelihood of being related) increases and the analytics server may start displaying one as a recommendation whenever a user views the other. Ultimately, this process of implicit relationship building is can be thought of as one of many data correlation algorithms. This algorithm includes behavioral data and can gradually increase its accuracy by including behavioral data from a multitude of users and recognizing common patterns of behavior among them. Using this algorithm, the analytics server can relate any units of work that can be put into a named and timed span. This process may also be able to be used to uncover intent and run analyses on activity, such as labeling periods of time as productive vs. not productive, billable vs. not billable based on the types of units of work open, and activity recorded during the time frame.

The analytics server may also utilize machine-learning techniques to correlate units of work and/or identify intent. Likewise, NLP techniques may be utilized to analyze the text-based metadata of units of work associated within spans to create summaries of what a user was doing.

Additionally, the analytics server may use various other algorithms to perform in-depth interaction tracking in a distributed way, such as tracking user interactions through browser APIs or certain existing third-party tools built to track application usage in operating systems or obtain any text-based content displayed on a user's computer, regardless of application.

Data Correlation

During and after data ingestion, data from both backend and frontend processes may be run through several de-duplication, correlation, and relationship-building processes within the nodal data structure.

First, the analytics server may de-duplicate units of work by the creation of unique identifiers. For instance, the analytics server determines that two units of work that are copies or versions of each other if a hash of their contents is the same. Likewise, two contacts are the same if they share the same social security number or sometimes email address, and two links are the same if they point to the same URL or path. Many more unique identifiers can be found across the nodal data structure and used for de-duplication across services.

Relationships can be established based on the contents and/or metadata of units of work. For example, two files are related if they are attached in the same email, two emails are related if copies of the same file are attached in both, an email and a task are related if the same unit of work is attached or referenced in both, etc. The correlation algorithms already create many of these explicit connections. The analytics server may also leverage ML-based comparisons of contents and metadata to establish unique IDs between units of work that pass a threshold (patent-pending).

Relationships can be recommended based on the contents and/or metadata of units of work. For example, two units of work may be recommended if they share similarities within their name or contents, even if they are not exactly the same. Specifically, the name of a “Person” entity embedded in the header tag of a web page via a website's specification, could be correlated with a user's contact of a person with a similar name. Because names are not unique, the analytics server may only recommend the relationship.

Relationships can be established based on processing the contents and/or metadata of units of work. For example, units of work can be classified as a particular data type by finding unique URLs or file paths within their text-based contents and metadata using pattern matching regular expressions. Additionally, the analytics server may use and/or create an open-source library of data classification and enrichment rules/methods and corresponding ontologies for data types to enable community contributions to and usage of this system. The analytics server may use this library to identify various relationships. In addition, units of work can be related if there is a bibliography or other reference embedded within the contents of one which references the other. These processing methods could be further enhanced using NLP techniques (e.g., text classification or named-entity recognition) or computer vision methods (e.g., object classification or facial recognition).

Relationships can be recommended based on other known relationships between units of work. For example, two units of work are likely related if they both have an existing relationship(s) within the same third unit of work. Graph traversal and clustering algorithms can be used to evaluate the closeness of nodes.

Recommended relationships can be ranked based on activity and behavioral data. Additionally, activity events from integrated systems and services can be leveraged to improve relationships. Furthermore, recommended relationships could be derived from the span tracking system. For example, a unit of work is likely related to a project if it is shared or referenced during a virtual meeting using a particular software application that has a calendar event associated with that project, an image is related to a webpage if it was saved to the “downloads” folder while the webpage was open.

Recommended relationships can also be validated based on explicit user input. This may include allowing users to create, modify, confirm, and reject associations or recommendations. This feedback, along with tracked user activity, can be used to establish a reinforcement learning model.

Relationships can also be classified through behavioral data. For example, a website can be classified as the source for a unit of work if text or an image is copied from the website to another. In another example, a user can be classified as a “developer” if she has a workflow pattern that passes a comparative threshold for the standard “developer's” workflow.

Relationships can also be classified through additional processing/analyses. For example, classifications (manager-report, file versions, etc.) can be established by processing related or recommended units of work, such as a file being classified as a source for an email if the contents of the file exist in the email and the timestamp on the file is older than the send date of the email.

Multiple of the examples of relationship identifications/determination listed herein can be used in combination to produce more sophisticated rankings of recommendations.

Additionally or alternatively, the analytics server may use a method for data ingestion where other (external) developers can create and upload data correlation rule sets and/or algorithms according to a predefined API. Users or organizations could then decide which of these “parsers” (or other processors) they would like to install (or configure) to have their data correlated in a variety of ways.

Data Storage Architecture

The methods and systems discussed herein may be implemented using standard ways of accessing, linking, and versioning knowledge across different data sources. A user needs to be able to have some level of privacy in maintaining a personal and private knowledge graph (individual nodal data structure), while also having the ability to contribute to and access knowledge in communal knowledge graphs (e.g., her employer's). The user might want to have live data from different sources (e.g., news sources or social media platforms while enriching certain nodes within their nodal data structure. In other words, the totality of an individual user's knowledge likely shouldn't be stored in a single knowledge graph. Additionally, users also can specify which Knowledge Apps have access to and can manage knowledge on their behalf, irrespective of where that knowledge is stored.

In order to achieve these objectives, the analytics server may use an open protocol and architecture for the construction, storage, querying, and interoperability of the nodal data structure. This open or distributed protocol may provide users local control over their knowledge (e.g., separate nodal data structure). In some embodiments, each user may be given full control to move or edit their own data/knowledge.

In some embodiments, knowledge mapped by the analytics server may be separated on individual users' computers making it so that companies, enterprises, and broader society are unable to leverage the knowledge held within the nodal data structures. Some knowledge needs to be able to be shared between people, organizations, and the public. Therefore, the analytics server may construct multiple nodal data structures within the KnowledgeOS. These nodal data structures should fulfill the following requirements.

Knowledge graphs or nodal data structures need to be able to be stored locally or in the cloud. Doing so will let users feel safe knowing they have local control over their private knowledge. When a user needs more storage or processing power, wants to work across devices, or if they want to share aspects of their nodal data structure with collaborators, a company, or the public, they can choose to host some of their knowledge on a data repository provides or otherwise functionally controlled by the analytics server. In some embodiments, users can be able to specify an external cloud-based storage location of their choice to store their knowledge. This means that each storage location must have the capabilities to store knowledge in ways that will implement the same authentication protocol and API.

Each potential storage location of a nodal data structure must implement a standard authentication protocol that will be used to authenticate clients upon each request they make and only allow these authenticated clients to make requests to the nodal data structure's API. This authentication protocol may define some kind of role-based access control wherein authenticated clients may be limited in the level of access they have over the data in the nodal data structure. For example, public knowledge graphs (e.g., a public nodal data structure) may allow an authenticated client to read data but only allow certain “maintainers” to edit or delete data. Certain use cases may also require nodal data structures to implement content-based access control. For example, if one user has a private nodal data structure but wishes to work with a collaborator on some pre-existing knowledge within it, the user may copy their data to create an entirely new nodal data structure shared with their collaborator or can give content-based access to a small portion of their knowledge stored within their nodal data structure to their collaborator.

In addition to authentication, nodal data structures must implement a standard API to create, read, update, and delete actions to be performed by an authenticated client. This API may also support bulk operations and querying. This will allow an authenticated client, like a system administrator of the analytics server, to input knowledge derived from raw data into a nodal data structure on the user's behalf. Suggested schemas of metadata and suggested types of named relationships between each “standard” unit of work (e.g., file, message, contact, web page, etc.) can be created to allow customized access. Unstructured data, non-standard units of work, or Data Types which do not yet have a suggested schema, could be inserted into the nodal data structures according to a generally suggested schema or best practices.

In some embodiments, the nodal data structure may be represented in whole or in part through one or more relational databases, table-based object stores (e.g., the low-level client-side storage API IndexedDB). Additionally or alternatively, the nodal data structure may be represented in whole or in part through graph databases (e.g., Dgraph®, Neo4j®, etc.) as they more easily support varied relationships, unstructured data, and complex relational and higher-order queries. Additionally or alternatively, the nodal data structure may be represented in whole or in part through other distributed database platforms, protocols, systems, etc. such as blockchains, Solid Pods, and more. The analytics server may store, access, and edit data in one or more nodal data structures represented as described herein (or otherwise) and/or any combination therein.

In some embodiments, the analytics server may optimize the nodal data structures for the ability to query higher-order relationships to obtain insights. These kinds of queries tend to be slower in a relational database because they necessitate expensive joins, and Indexed DB stores lack a structured query language to easily query higher-order relationships. One non-limiting solution may include storing data in relational and graph databases depending on the type of data and how well it fits predefined schemas. In this example, the analytics server may use graph databases for initial capture and ingestion of unstructured data, such as that from the span tracking system, associations or “facts” learned through NLP of text content, and profile information unique to an application obtained from its backend API. Subsequently, structured entities and relationships could be kept in a more schematized relational database or object-oriented table store. Data in the graph databases can be run through algorithms (e.g., correlational algorithms) and be used to recommend additions or updates to, or relationships between records in the more structured ontological relational tables. Relational databases may also prove to be a better setting for any data that is shared among users, and thus requires a strict schema of permissions.

In addition to defining storage standards, the nodal data structure protocol may need to implement a standard for how data and entities can be linked, versioned, de-duplicated, or correlated across different nodal data structures. For example, a user may have contact information about Bill Gates in a private nodal data structure, shared information about Bill Gates' finances for a project they are collaborating on with others in a shared nodal data structure, and have access to information about Bill Gates from the public website stored on a different nodal data structures. This potentially overlapping information may first be synchronized, de-duplicated, or otherwise correlated for the user. In some embodiments, this task may be deferred to the users or developer (e.g., creators of a Knowledge App) to make design decisions in how they display the information obtained by querying each nodal data structure. In other embodiments, there may also be some system, internal or external to the three nodal data structures, which can correlate information between them.

FIG. 79 is a flow diagram of a process/method 7900 executed in an electronic work (or workflow) management system, according to an embodiment.

At step 7910, the analytics server may link a pair of nodes within a set of nodes of a nodal data structure based on a first node within the pair of nodes having an identifier that satisfies a relevance threshold with respect to a second node within the pair of nodes, wherein each node within the set of nodes corresponds to an action performed on at least one computing device of a plurality of computing devices.

As described herein, the analytics server may generate a nodal data structure representing related workflow components or units of work (e.g., files, web-browser history, etc.). For instance, the analytics server may periodically monitor various files (or any other units of work) accessible to a network of computers and may generate a representative nodal data structure. The analytics server may also monitor user interactions with those files and revise the nodal data structure accordingly.

Additionally, the analytics server may actively (e.g., in real time) or passively (periodically) monitor user activities, as described herein. For instance, as depicted in and escribed with respect to FIG. 40, the analytics server may monitor actions performed by different users. In an example, the analytics server may monitor how employees interact with each other and other electronic content using their company-issued computing devices. Using various methods and systems discussed herein, the analytics server may update the nodal data structure, such that related content are identified and knowledge is extracted.

As discussed herein, the analytics server can utilize a series of algorithms and methods that take disparate historical archives of information and interconnect the isolated components within each archive into a nodal data structure. These algorithms build associations (within the nodal data structure) by looking at the activity, past and present, of its users within the data archives and within the systems used to access the data. By generating, maintaining, and understanding the context around data, the nodal data structure can become a living knowledge base, which is more than a simple index of projects, files, communication, and people.

At step 7920, the analytics server may, in response to determining that at least one computing device within the plurality of computing devices is accessing electronic content determine at least one node within the set of nodes of the nodal data structure that corresponds to the electronic content and present context data associated with the electronic content accessed by the at least one computing device accessing the electronic content and at least one of the identified node and any other node linked to the identified node, the context data identifying at least one of a file, a user, or a message associated with the identified node or any other node linked to the identified node.

As discussed herein, the analytics server may determine what electronic content is accessed on a user's computer and may identify a node within the nodal data structure that is relevant to the electronic content being accessed. As a result, the analytics server may also display data associated with the identified node and/or any linked nodes within the nodal data structure using various GUIs discussed herein.

The foregoing method descriptions and the process flow diagrams are provided merely as illustrative examples and are not intended to require or imply that the steps of the various embodiments must be performed in the order presented. The steps in the foregoing embodiments may be performed in any order. Words such as “then,” “next,” etc. are not intended to limit the order of the steps; these words are simply used to guide the reader through the description of the methods. Although process flow diagrams may describe the operations as a sequential process, many of the operations can be performed in parallel or concurrently. In addition, the order of the operations may be re-arranged. A process may correspond to a method, a function, a procedure, a subroutine, a subprogram, and the like. When a process corresponds to a function, the process termination may correspond to a return of the function to a calling function or a main function.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of this disclosure or the claims.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module, which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the embodiments described herein and variations thereof. Various modifications to these embodiments will be readily apparent to those skilled in the art, and the principles defined herein may be applied to other embodiments without departing from the spirit or scope of the subject matter disclosed herein. Thus, the present disclosure is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What we claim is:

1. A method comprising:
linking, by a processor, a pair of nodes within a set of nodes of a nodal data structure based on a first node within the pair of nodes having an identifier that satisfies a relevance threshold with respect to a second node within the pair of nodes, wherein each node within the set of nodes corresponds to an action performed on at least one computing device of a plurality of computing devices;
in response to determining that at least one computing device within the plurality of computing devices is accessing electronic content:
determining, by the processor, at least one node within the set of nodes of the nodal data structure that corresponds to the electronic content; and
presenting, by the processor, context data associated with the electronic content accessed by the at least one computing device accessing the electronic content and at least one of the identified node and any other node linked to the identified node, the context data identifying at least one of a file, a user, or a message associated with the identified node or any other node linked to the identified node.

2. The method of claim 1, wherein the context data comprises identification data associated with at least one of a file or a message associated with the at least one node or the at least one other node linked to the at least one node.

3. The method of claim 1, wherein the context data comprises identification data associated with at least one of a uniform resource locator, a note, a task, an event, an email address, or a physical address associated with the at least one node or the at least one other node linked to the at least one node.

4. The method of claim 1, wherein the context data comprises identification data associated with a person, a team, or an organization associated with the at least one node or the at least one other node linked to the at least one node.

5. The method of claim 1, wherein the context data is organized based on a category associated with the context data.

6. The method of claim 1, wherein at least a first part of the context data is stored in a first data repository and a second part of the context data is stored within a second data repository.

7. The method of claim 1, wherein a first node from the nodal data structure is stored in a first data repository and a second node from the nodal data structure is stored in a second data repository.

8. The method of claim 1, wherein the processor executes an artificial intelligence model to identify a likelihood of relevance value for each pair of nodes.

9. The method of claim 1, further comprising:
displaying, by the processor, an input element configured to receive a query term; and
displaying, by the processor, data associated with the query term.

10. A system comprising:
a server comprising a processor and a non-transitory computer-readable medium containing instructions that when executed by the processor causes the processor to perform operations comprising:
linking a pair of nodes within a set of nodes of a nodal data structure based on a first node within the pair of nodes having an identifier that satisfies a relevance threshold with respect to a second node within the pair of nodes, wherein each node within the set of nodes corresponds to an action performed on at least one computing device of a plurality of computing devices;
in response to determining that at least one computing device within the plurality of computing devices is accessing electronic content:
determining at least one node within the set of nodes of the nodal data structure that corresponds to the electronic content; and
presenting context data associated with the electronic content accessed by the at least one computing device accessing the electronic content and at least one of the identified node and any other node linked to the identified node, the context data identifying at least one of a file, a user, or a message associated with the identified node or any other node linked to the identified node.

11. The system of claim 10, wherein the context data comprises identification data associated with at least one of a file or a message associated with the at least one node or the at least one other node linked to the at least one node.

12. The system of claim 10, wherein the context data comprises identification data associated with at least one of a uniform resource locator, a note, a task, an event, an email address, or a physical address associated with the at least one node or the at least one other node linked to the at least one node.

13. The system of claim 10, wherein the context data comprises identification data associated with a person, a team, or an organization associated with the at least one node or the at least one other node linked to the at least one node.

14. The system of claim 10, wherein the context data is organized based on a category associated with the context data.

15. The system of claim 10, wherein at least a first part of the context data is stored in a first data repository and a second part of the context data is stored within a second data repository.

16. The system of claim 10, wherein a first node from the nodal data structure is stored in a first data repository and a second node from the nodal data structure is stored in a second data repository.

17. The system of claim 10, wherein the processor executes an artificial intelligence model to identify a likelihood of relevance value for each pair of nodes.

18. The system of claim 10, wherein the instruction further cause the processor to:
display an input element configured to receive a query term; and
display data associated with the query term.

19. A computer system comprising:
a data repository storing data associated with a set of nodes within a nodal data structure;
a plurality of computing devices having access to the set of data; and
a processor in communication with each computing device and the electronic data repository, the processor configured to:
link a pair of nodes within a set of nodes of a nodal data structure based on a first node within the pair of nodes having an identifier that satisfies a relevance threshold with respect to a second node within the pair of nodes, wherein each node within the set of nodes corresponds to an action performed on at least one computing device of a plurality of computing devices;
in response to determining that at least one computing device within the plurality of computing devices is accessing electronic content:
determine at least one node within the set of nodes of the nodal data structure that corresponds to the electronic content; and
present context data associated with the electronic content accessed by the at least one computing device accessing the electronic content and at least one of the identified node and any other node linked to the identified node, the context data identifying at least one of a file, a user, or a message associated with the identified node or any other node linked to the identified node.

20. The computer system of claim 19, wherein the context data comprises identification data associated with at least one of a file or a message associated with the at least one node or the at least one other node linked to the at least one node.
